(19) United States
(12) Patent Application Publication
(10) Pub. No.: US 2012/0313570 A1
(43) Pub. Date: Dec. 13, 2012

(54) NONAQUEOUS ELECTROLYTE AND NONAQUEOUS ELECTROLYTE BATTERY, AND BATTERY PACK, ELECTRONIC APPLIANCE, ELECTRIC VEHICLE, ELECTRICITY STORAGE APPARATUS, AND ELECTRIC POWER SYSTEM EACH USING NONAQUEOUS ELECTROLYTE BATTERY

(75) Inventors: Yuko Ohtaniuchi, Fukushima (JP); Tadahiko Kubota, Kanagawa (JP)

(73) Assignee: SONY CORPORATION, Tokyo (JP)

(21) Appl. No.: 13/481,408

(22) Filed: May 25, 2012

(30) Foreign Application Priority Data
Jun. 8, 2011 (JP) 2011-128606

(51) Int. Cl. H02J 7/00; H01M 10/056

(52) U.S. Cl. 320/103; 429/200; 429/163

(57) ABSTRACT

A nonaqueous electrolyte includes: a nonaqueous electrolytic solution containing a nonaqueous solvent, an electrolyte salt, an overcharge controlling agent capable of generating a redox reaction at a prescribed potential, and at least one member selected from the compounds (1) to (10).

### FIELD

The present technology relates to a nonaqueous electrolyte and a nonaqueous electrolyte battery using the same, and in particular, the present technology relates to a nonaqueous electrolyte capable of inhibiting a lowering of load characteristics and a nonaqueous electrolyte battery using the same. Also, the present technology relates to a battery pack, an electronic appliance, an electric vehicle, an electricity storage apparatus, and an electric power system each using such a nonaqueous electrolyte battery.

### BACKGROUND

In recent years, portable electronic appliances such as a video camera, a digital still camera, a mobile phone, and a laptop personal computer have widely spread, and it is strongly demanded to realize downsizing, weight reduction, and long life thereof. Following this, the development of batteries as a power source, in particular, secondary batteries which are lightweight and from which a high energy density is obtainable is advanced.

Above all, lithium ion secondary batteries utilizing intercalation and deintercalation of a lithium ion for a charge and discharge reaction, lithium metal secondary batteries utilizing deposition and dissolution of a lithium metal, and the like are greatly expected. This is because a high energy density is obtainable as compared with lead batteries and nickel-cadmium batteries.

Now, the lithium ion secondary batteries or lithium metal secondary batteries are very high in an energy density per unit volume and use a combustible organic solvent as a nonaqueous electrolyte. In nonaqueous electrolyte secondary batteries using an organic solvent, safety security is one of the most important problems, and above all, overcharge protection is important. For example, in nickel-cadmium batteries, if a charge voltage increases at the time of overcharge, an overcharge preventing system acts due to consumption of charge energy by a chemical reaction of water contained in an electrolytic solution. On the other hand, in the lithium secondary batteries which are of a nonaqueous system, since there is no consumption of charge energy by a chemical reaction of water, a different system as a replacement thereof is needed.

As the overcharge prevention system in nonaqueous electrolyte batteries, there are proposed a method for utilizing a chemical reaction and a method for utilizing an electronic circuit. The latter is chiefly adopted from the standpoint of practical use. However, in the method by an electronic circuit, not only the costs are high, but there are various restrictions in product design.

Then, in the nonaqueous electrolyte batteries, the development of a technology of preventing the overcharge utilizing a chemical reaction is advanced. Above all, as one of means for chemical overcharge protection, there is attempted a method for adding a suitable redox reagent to an electrolytic solution. According to this method, in the case where the reversibility of a reaction of the redox reagent is good, a protection system of reciprocating within the battery to consume an overcharge current exists.

Examples of using such a redox reagent include a method described in Patent Document 1 (Japanese Patent No. 351201). Patent Document 1 describes the use of an aromatic compound having a fluorine ester/ether and a silyl group. Patent Document 2 (JP-T-2010-521050) describes the use of a nitroxide compound. Patent Document 3 (JP-T-2009-527096) describes the use of a triphenylamine compound. Patent Document 4 (JP-T-2009-514149) describes the use of a combination of vinylene carbonate or sultone and an anisole based compound. Patent Document 5 (JP-T-2008-541041) describes the use of an N-oxide compound. Patent Document 6 (JP-T-2007-531972) describes the use of a cyclable compound including an aromatic compound. Patent Document 7 (JP-T-2007-531970) describes a battery including a plurality of series-connected rechargeable lithium ion cells each containing a redox reagent-containing electrolyte.

### SUMMARY

However, the present inventors applied the redox reagents described in the foregoing patent documents to actual lithium ion batteries, and as a result, it has been noted that inhibition of a charge termination voltage by the electrochemical reaction and an effect for homogenizing a discharge capacity to be brought thereby are insufficient.

In this way, if the effect for inhibiting an increase of charge voltage is insufficient, a cell voltage increases at the time of overcharge. The increase of the cell voltage causes extraction of excessive lithium from a positive electrode and deposition of metallic lithium onto a negative electrode. It has become clear that when the battery is exposed in this state under a high-temperature atmosphere, constituent materials in the inside of the battery cause a reaction, resulting in a lowering of load characteristics such as a lowering of the discharge capacity.

It is therefore desirable to provide a nonaqueous electrolyte and a nonaqueous electrolyte battery, in which even in the case where an overcharge state is revealed, a lowering of load characteristics is hardly caused, and a battery pack, an electronic appliance, an electric vehicle, an electricity storage apparatus, and an electric power system each using the nonaqueous electrolyte battery.

A nonaqueous electrolyte of one embodiment of the present technology includes a nonaqueous solvent, an electrolyte salt, an overcharge controlling agent capable of generating a redox reaction at a prescribed potential, and at least one member selected from the following compounds (1) to (10).

Li[PFₘ₁R11₆₋ₘ₁] Compound (1)

In the formula, R11 represents a perfluoroalkyl group or a perfluoroaryl group; and m1 represents an integer of from 0 to 6.

LiN(SO₂R21)₂ Compound (2)

In the formula, R21 represents a perfluoroalkyl group, a perfluoroaryl group, or a halogen group.

Li[BFₘ₃R31₄₋ₘ₃] Compound (3)

In the formula, R31 represents a perfluoroalkyl group or a perfluoroaryl group; and m3 represents an integer of from 0 to 4.

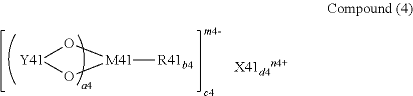

In the formula, X41 represents a Group 1 element or a Group 2 element in the long form of the periodic table, or aluminum; M41 represents a transition metal element, or a Group 13 element, a Group 14 element or a Group 15 element in the long form periodic table; R41 represents a halogen group; Y41 represents —C(═O)—R42-C(═O)—, —C(═O)—C(R43)₂-, or —C(═O)—C(═O)—; R42 represents an alkylene group, a halogenated alkylene group, an arylene group, or a halogenated arylene group; each R43 independently represents an alkyl group, a halogenated alkyl group, an aryl group, or a halogenated aryl group; a4 represents an integer of from 1 to 4; b4 represents 0, 2, or 4; and each of c4, d4, m4, and n4 represents an integer of from 1 to 3.

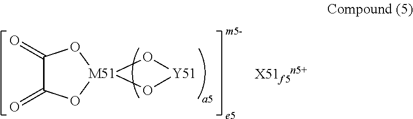

In the formula, X51 represents a Group 1 element or a Group 2 element in the long form of the periodic table; M51 represents a transition metal element, or a Group 13 element, a Group 14 element or a Group 15 element in the long form of the periodic table; Y51 represents —C(═O)—(C(R51)₂)_{b5}-C(═O)—, —(R53)₂C—(C(R52)₂)_{c5}-C(═O)—, —(R53)₂C—(C(R52)₂)_{c5}-C(R53)₂-, —(R53)₂C—(C(R52)₂)_{c5}-S(═O)₂—, —S(═O)₂—(C(R52)₂)_{d5}-S(═O)₂—, or —C(═O)—(C(R52)₂)_{d5}-S(═O)₂—; each of R51 and R53 independently represents a hydrogen group, an alkyl group, a halogen group, or a halogenated alkyl group, provided that at least one of R51 and R53 represents a halogen group or a halogenated alkyl group; each R52 independently represents a hydrogen group, an alkyl group, a halogen group, or a halogenated alkyl group; each of a5, e5, and n5 represents 1 or 2; each of b5 and d5 represents an integer of from 1 to 4; c5 represents an integer of from 0 to 4; and each of f5 and m5 represents an integer of from 1 to 3.

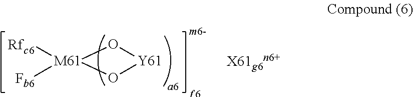

In the formula, X61 represents a Group 1 element or a Group 2 element in the long form of the periodic table; M61 represents a transition metal element, or a Group 13 element, a Group 14 element or a Group 15 element in the long form of the periodic table; Rf represents a fluorinated alkyl group or a fluorinated aryl group, each having a carbon number of from 1 to 10; Y61 represents —C(═O)—(C(R61)₂)_{d6}-C(═O)—, —(R62)₂C—(C(R61)₂)_{d6}-C(═O)—, —(R62)₂C—(C(R61)₂)_{d6}-C(R62)₂-, —(R62)₂C—(C(R61)₂)_{d6}-S(═O)₂—, —S(═O)₂—(C(R61)₂)ₑ₆-S(═O)₂—, or —C(═O)—(C(R61)₂)ₑ₆-S(═O)₂—; each R61 independently represents a hydrogen group, an alkyl group, a halogen group, or a halogenated alkyl group; each R62 independently represents a hydrogen group, an alkyl group, a halogen group, or a halogenated alkyl group, provided that at least one of R62s represents a halogen group or a halogenated alkyl group; each a6, f6, and n6 represents 1 or 2; each of b6, c6, and e6 represents an integer of from 1 to 4; d6 represents an integer of from 0 to 4; and each of g6 and m6 represents an integer of from 1 to 3.

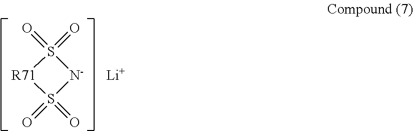

In the formula, R71 represents a linear or branched perfluoroalkylene group having a carbon number of from 2 to 4.

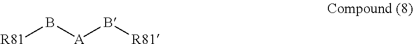

In the formula, each of R81 and R81′ independently represents an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or each of which may be a halogenated group, and R81 and R81′ may be the same as or different from each other and may be connected to each other to form a ring; each of A, B, and B′ represents an oxygen atom, a sulfur atom, —C(═O)—, —S(═O)—, —S(═O)₂—, —C(Rd)(Re)—, —Si(Rd)(Re)—, or —N(Rf)—, and A, B, and B′ may be the same as or different from each other; and each of Rd, Re, and Rf independently represents a hydrogen group, a halogen group, an alkyl group, an alkenyl group, an alkynyl group, an aryl group, or a heterocyclic group, or an alkyl group, an alkenyl group, an alkynyl group, each of which is substituted with an aromatic hydrocarbon group or an alicyclic hydrocarbon group, or each of which may be a halogenated group, provided that the case where all of A, B, and B′ are —C(Rd)(Re)—, and the case where B and A, or B′ and A, are an oxygen atom are excluded.

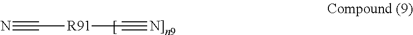

In the formula, R91 represents a single bond or a divalent connecting group; and n9 represents 0 or a natural number.

O̅═̅C̅═̅N̅—̅R̅1̅0̅1̅̅N̅═̅C̅═̅O̅]̅ₙ̅₁̅₀̅|̅ Compound (10)

In the formula, R101 represents a single bond or a divalent connecting group; and n10 represents 0 or a natural number.

A nonaqueous electrolyte battery of one embodiment of the present technology is provided with a group of electrodes including a positive electrode and a negative electrode and the foregoing nonaqueous electrolyte.

As in the embodiment of the present technology, by using a nonaqueous electrolyte containing both at least one compound of the compounds (1) to (3) and an overcharge controlling agent capable of electrochemically inhibiting a voltage increase at the time of charge by a redox reaction generated at a prescribed potential, it is possible to allow a compound having high thermal stability to stably remain in a nonaqueous electrolytic solution. Also, by using a nonaqueous electrolyte containing both at least one compound of the compounds (4) to (8) and (10) and an overcharge controlling agent capable of electrochemically inhibiting a voltage increase at the time of charge by a redox reaction generated at a prescribed potential, it is possible to form a protective film on the positive electrode and the negative electrode, thereby inhibiting deposition of the overcharge controlling agent. Also, by using a nonaqueous electrolyte containing both at least one compound of the compounds (9) and (10) and an overcharge controlling agent capable of electrochemically inhibiting a voltage increase at the time of charge by a redox reaction generated at a prescribed potential, elution of a transition metal from the positive electrode and deposition of a transition metal onto the negative electrode to be caused thereby can be inhibited.

A battery pack, an electronic appliance, an electric vehicle, an electricity storage apparatus, and an electric power system of embodiments of the present technology are provided with the foregoing nonaqueous electrolyte battery.

When the nonaqueous electrolyte of the embodiment of the present technology is applied to a nonaqueous electrolyte battery, a lowering of load characteristics after the overcharge can be inhibited.

### BRIEF DESCRIPTION OF THE DRAWINGS

FIG. 1 is a sectional view showing a configuration of a nonaqueous electrolyte battery according to a second embodiment of the present technology.

FIG. 2 is a sectional view showing enlargedly a part of a wound electrode body according to the nonaqueous electrolyte battery shown in FIG. 1.

FIG. 3 is an exploded perspective view showing a configuration of a nonaqueous electrolyte battery according to a third embodiment of the present technology.

FIG. 4 is a sectional view showing a sectional configuration of a wound electrode body shown in FIG. 3 along an I-I line.

FIG. 5 is a block diagram showing an example of a configuration of a battery pack according to an embodiment of the present technology.

FIG. 6 is a diagrammatic view showing an example applied to an electricity storage system for house using a nonaqueous electrolyte battery according to the present technology.

FIG. 7 is a diagrammatic view showing diagrammatically an example of a configuration of a hybrid vehicle adopting a series hybrid system to which the present technology is applied.

### DETAILED DESCRIPTION

Embodiments of the present technology are hereunder described by reference to the accompanying drawings. Incidentally, the description is made in the following order.

1. First embodiment (an example of a nonaqueous electrolyte according to the present technology)

2. Second embodiment (an example of a nonaqueous electrolyte battery of a cylindrical type using a nonaqueous electrolyte according to the present technology)

3. Third embodiment (an example of a nonaqueous electrolyte battery of a laminated film type using a nonaqueous electrolyte according to the present technology)

4. Fourth embodiment (an example of a battery pack using a nonaqueous electrolyte battery according to the present technology)

5. Fifth embodiment (an example of an electricity storage system using a nonaqueous electrolyte battery according to the present technology)

### 1. First Embodiment

In a first embodiment, a configuration and a manufacturing method of a nonaqueous electrolytic solution and a nonaqueous electrolyte in a gel form (hereinafter properly referred to as “gel electrolyte”) are described, respectively.

### (1-1) Nonaqueous Electrolytic Solution

The first embodiment is concerned with a nonaqueous electrolytic solution to be used for a nonaqueous electrolyte battery. The nonaqueous electrolytic solution is a liquid nonaqueous electrolyte.

The nonaqueous electrolytic solution according to the present technology contains a compound capable of electrochemically inhibiting a voltage increase at the time of overcharge (hereinafter properly referred to as “overcharge controlling agent”) together with a nonaqueous solvent and an electrolyte salt. Also, the nonaqueous electrolytic solution according to the present technology further contains the compound according to the present technology for the purpose of inhibiting a lowering of load characteristics through the use in combination with the foregoing overcharge controlling agent.

### [Overcharge Controlling Agent]

The nonaqueous electrolytic solution according to the present technology contains, as an essential component, an overcharge controlling agent for the purpose of electrochemically inhibiting a voltage increase at the time of charge. The overcharge controlling agent is hereunder described.

The overcharge controlling agent is, for example, composed of a material capable of generating a redox reaction at a potential slightly higher than a positive electrode potential at the time of full charge of a nonaqueous electrolyte battery. Incidentally, the potential at which a redox reaction of the overcharge controlling agent is generated is not limited to the foregoing potential, and a material capable of generating a redox reaction at a potential lower than the positive electrode potential at the time of full charge may be used as the overcharge controlling agent. The full charge state of the nonaqueous electrolyte battery as referred to herein means a state in which the battery voltage becomes a voltage set up as a charge termination voltage. That is, in the case where the nonaqueous electrolyte battery containing the overcharge controlling agent is overcharged exceeding a prescribed potential, the overcharge controlling agent generates a redox reaction due to oxidation activity of the positive electrode surface, whereby an increase of the voltage (potential of the positive electrode) of the nonaqueous electrolyte battery can be inhibited. Specifically, the overcharge controlling agent is an oxidizable and reducible material capable of repeatedly transporting an electric charge between the positive electrode and the negative electrode by repetition of the matter that in the case of reaching a prescribed positive electrode potential, not only the overcharge controlling agent is oxidized and diffused into the negative electrode side, but it is reduced in the negative electrode side and again diffused into the positive electrode side.

By using such an overcharge controlling agent, scattering of a discharge capacity to be caused due to the overcharge of the nonaqueous electrolyte battery can be inhibited. Also, decomposition of the nonaqueous electrolytic solution to be caused due to the matter that the positive electrode potential becomes excessively high due to the overcharge, and elution, deposition, and the like of a transition metal can be inhibited.

For example, the following overcharge controlling agents (1) to (12) can be used as the overcharge controlling agent. The overcharge controlling agent is a single compound or a mixture of two or more kinds of compounds represented by the overcharge controlling agents (1) to (12).

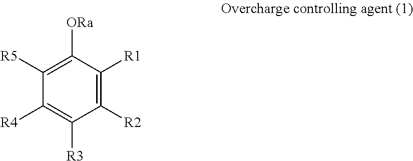

In the formula, Ra represents a linear or branched alkyl group, or a partially or wholly halogenated group thereof; and each of R1 to R5 independently represents an alkoxy group, a halogen group, a nitrile group, or a linear or branched alkyl group, or a partially or wholly halogenated group thereof; or Ra and R1 to R5 are connected to each other between the adjacent groups, provided that the connection of Ra and R1 to R5 excludes the case where all of R1 to R5 are an alkoxy group.

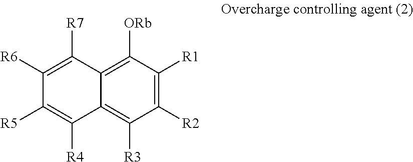

In the formula, Rb represents a linear or branched alkyl group, or a partially or wholly halogenated group thereof; and each of R1 to R7 independently represents an alkoxy group, a halogen group, or a linear or branched alkyl group, or a partially or wholly halogenated group thereof; or Rb and R1 to R7 are connected to each other between the adjacent groups, provided that the connection of Rb and R1 to R7 excludes the case where all of R1 to R7 are an alkoxy group.

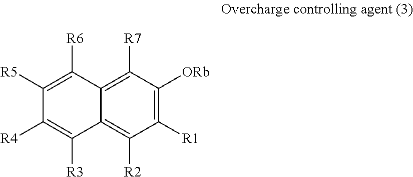

In the formula, Rb and R1 to R7 are the same as those in the foregoing overcharge controlling agent (2).

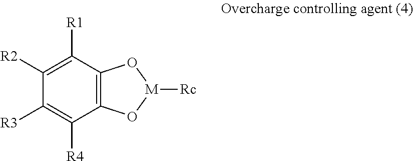

In the formulation, M represents a transition metal element, or a Group 13 element, a Group 14 element or a Group 15 element in the long form of the periodic table; Rc represents an aryl group or a heterocyclic group, or a partially or wholly halogenated group thereof; each of R1 to R4 independently represents an alkoxy group, a halogen group, or a linear or branched alkyl group, or a partially or wholly halogenated group thereof, or R1 to R4 are connected to each other between the adjacent groups.

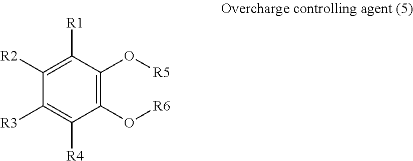

In the formula, each of R1 to R4 independently represents an alkoxy group, a halogen group, or a linear or branched alkyl group, or a partially or wholly halogenated group thereof, or R1 to R4 are connected to each other between the adjacent groups; each of R5 and R6 represents an alkoxy group, a halogen group, or a linear or branched alkyl group, or a partially or wholly halogenated group thereof, or R5 and R6 are connected to each other to form a group; and the group formed by connection of R5 and R6 to each other is an alkylene group, a partially or wholly halogenated alkylene group, or a connecting group represented by the following general formula (A).

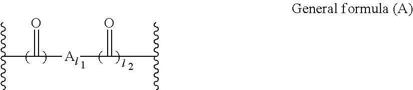

In the general formula (A), each of l₁ and l₂ independently represents an integer of from 0 to 2; and A represents an alkylene group having a carbon number of from 0 to 2, or a partially or wholly halogenated alkylene group.

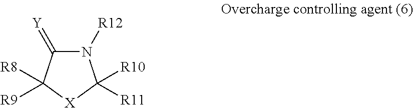

In the formula, X represents N-oxide or an N-oxo group; Y represents an oxygen atom or a sulfur group; each of R8 to R11 independently represents an alkyl group, an alkenyl group, or an alkynyl group, or a partially or wholly halogenated group, or R8 and R9, or R10 and R11 are connected to each other to form a connecting group; and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with a nitrile group, a heterocyclic group, an aromatic hydrocarbon group, or an alicyclic hydrocarbon group, or a halogenated group thereof, an ether group, an amide group, a carbonate group, a phosphate group, a thio ester group, or a cyclic ether- or chain ether-substituted alkyl group.

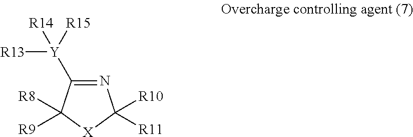

In the formula, X, Y, and R8 to R11 are the same as those in the foregoing overcharge controlling agent (6); when Y is an oxygen atom, then each of R14 and R15 represents a lone electron pair, and when Y is a sulfur atom, then each of R14 and R15 independently represents a lone electron pair or an oxo group; and R13 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group.

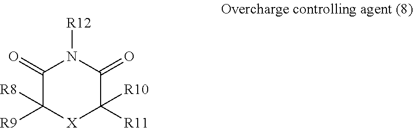

In the formula, X and R8 to R11 are the same as those in the foregoing overcharge controlling agent (6); and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group.

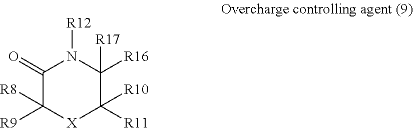

In the formula, X, R8 to R11, and R12 are the same as those in the foregoing overcharge controlling agent (8); and each of R16 and R17 independently represents an alkyl group, an alkenyl group, or an alkynyl group, or a partially or wholly halogenated group thereof, or R16 and R17 are connected to each other to form a connecting group.

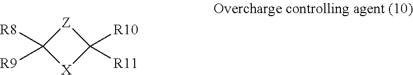

In the formula, X and R8 to R11 are the same as those in the foregoing overcharge controlling agent (8); and Z represents any one of the following general formulae (B1) to (B6).

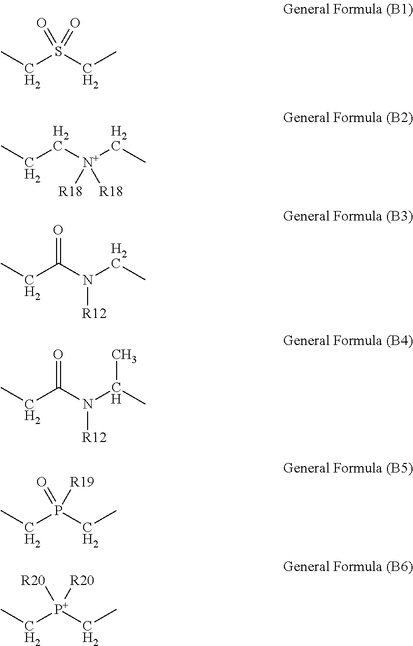

In the general formulae (B1) to (B6), R12 is the same as that in the foregoing overcharge controlling agent (8); each R18 independently represents an alkyl group, an alkenyl group, or an alkynyl group, or a partially or wholly halogenated group thereof, or R18 and R19 are connected to each other to form a group; R19 represents a hydrogen group, a hydroxyl group, an alkyl group, an aryl group, an aralkyl group, a cycloalkyl group, or an ether group; and each R20 independently represents a hydrogen group, an alkyl group, an aryl group, an aralkyl group, an alkenyl group, an alkynyl group, a cycloalkyl group, or a glycidyl group.

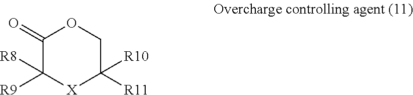

In the formula, X is the same as that in the foregoing overcharge controlling agent (8); each of R8 to R11 independently represents an alkyl group, an alkenyl group, or an alkynyl group, or a carbonate group, or a partially or wholly halogenated group, or R8 and R9, or R10 and R11 are connected to each other to form a connecting group.

Overcharge controlling agent (12)

Li₂B₁₂FₛD₁₂₋ₛ

In the formula, s is 4 or more and not more than 12 in average; and D represents hydrogen, chlorine, or bromine.

Examples of the compound of the overcharge controlling agent (1) include the following overcharge controlling agents (1-1) to (1-81). Also, similarly, examples of the compounds of the overcharge controlling agents (2) to (12) include the following overcharge controlling agents (2-1) to (2-2), overcharge controlling agents (3-1) to (3-7), overcharge controlling agents (4-1) to (4-75), overcharge controlling agents (5-1) to (5-6), overcharge controlling agents (6-1) to (6-13), overcharge controlling agents (7-1) to (7-2), overcharge controlling agents (8-1) to (8-5), overcharge controlling agents (9-1) to (9-12), overcharge controlling agents (10-1) to (10-7), overcharge controlling agents (11-1) to (11-6), and overcharge controlling agents (12-1) to (12-2), respectively. However, other compounds may also be used so far as they have any one of the structures represented by the general formulae (1) to (12).

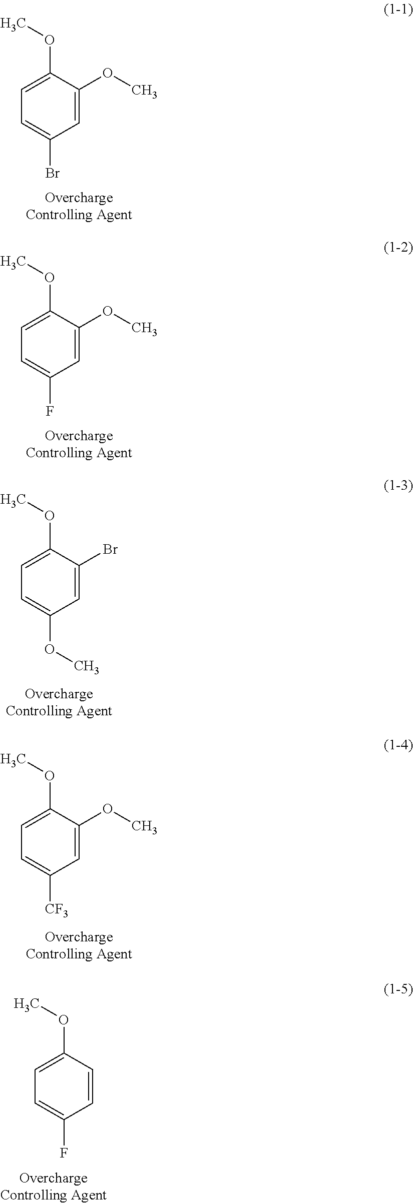

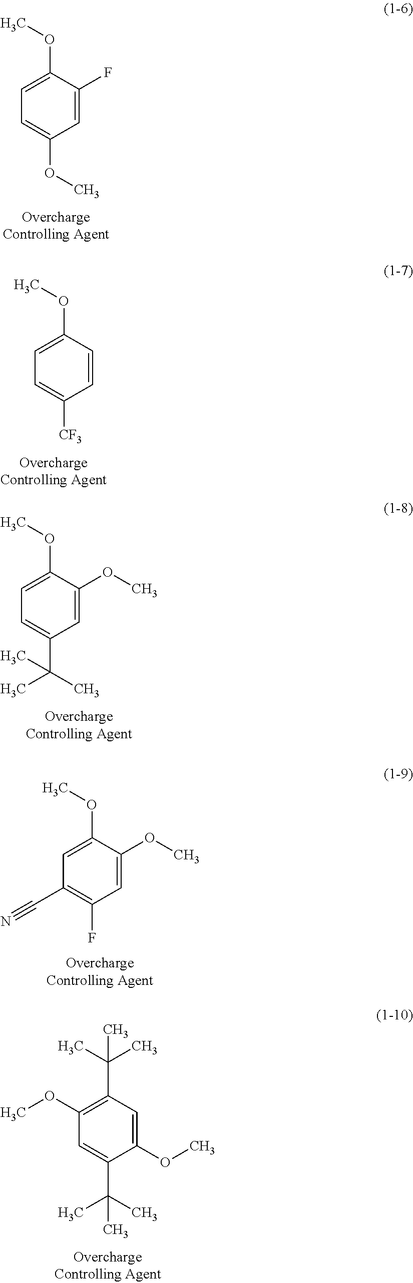

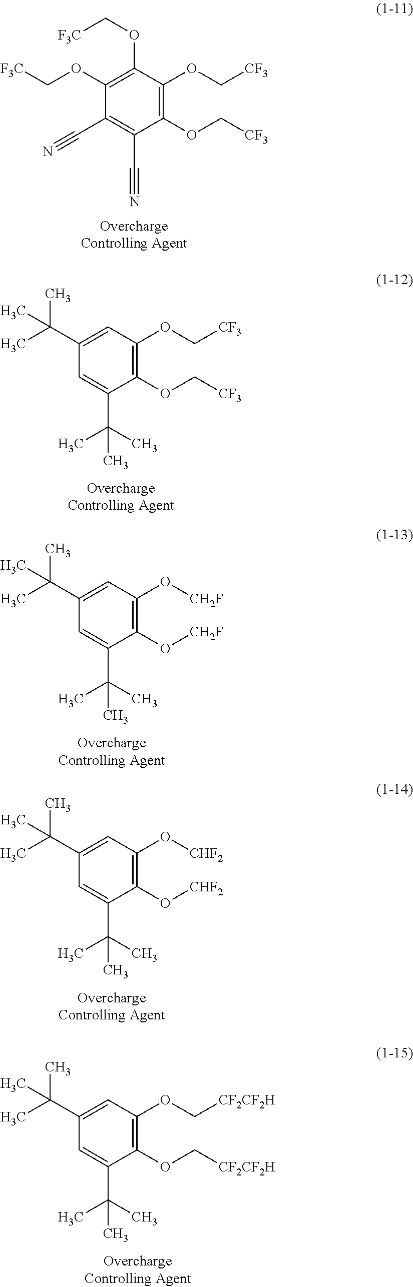

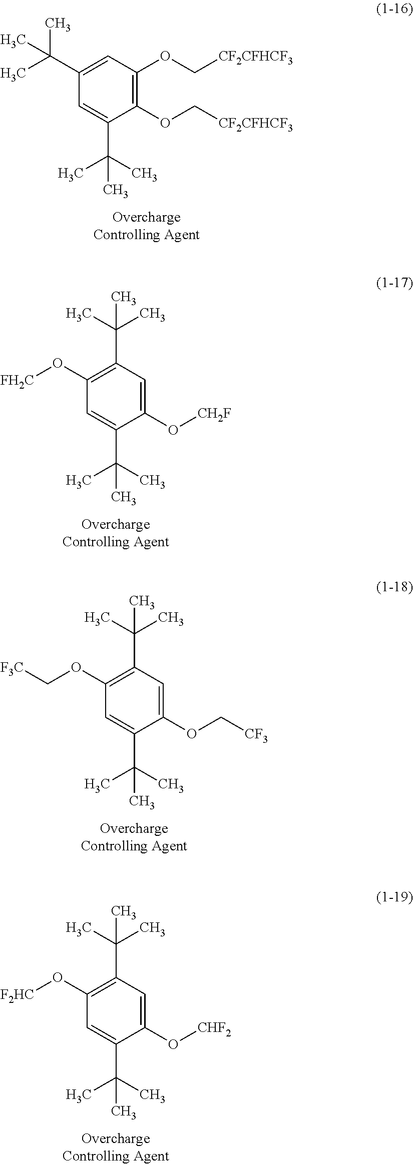

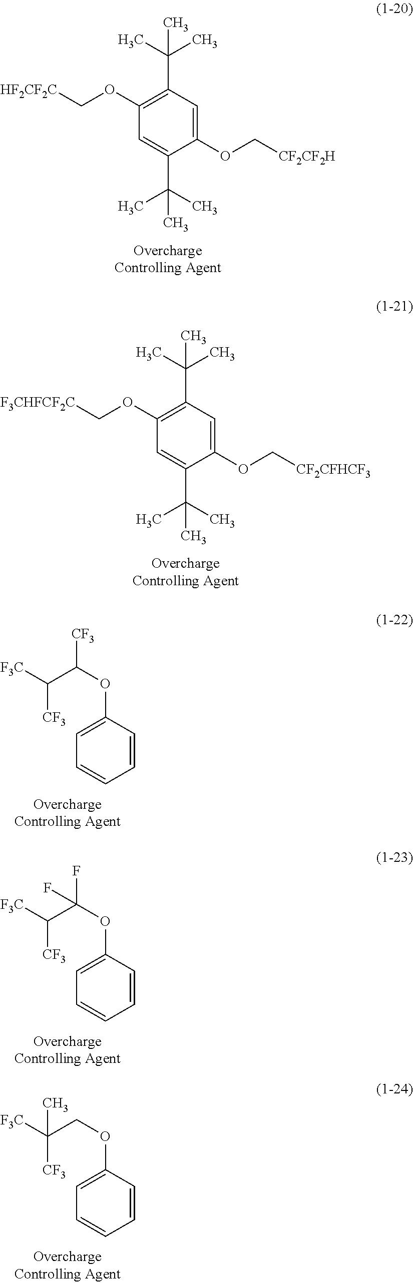

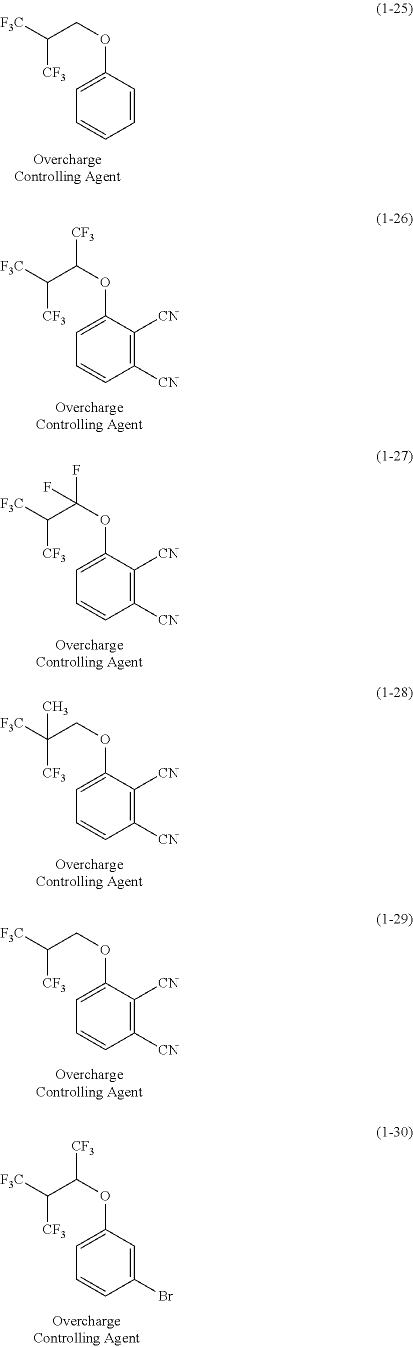

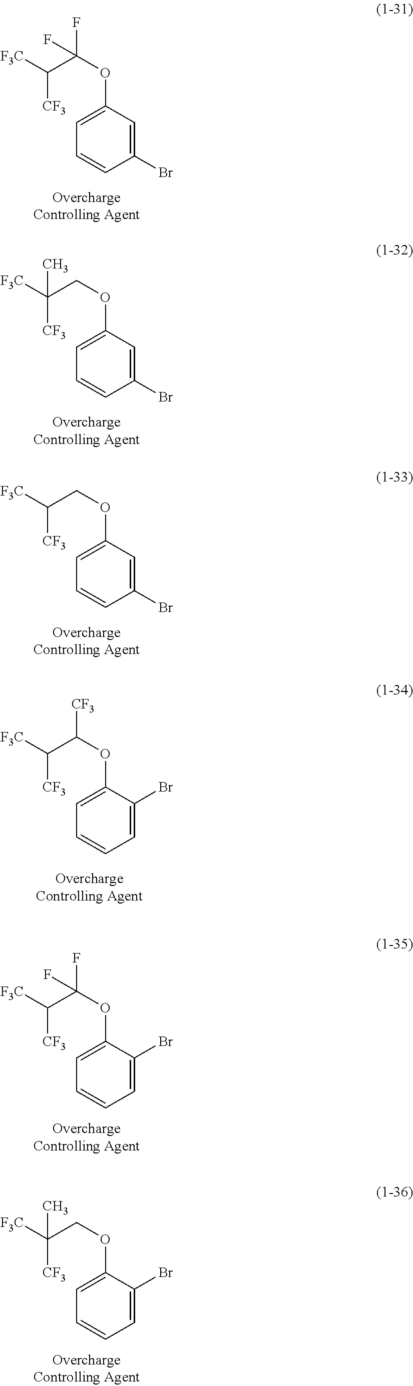

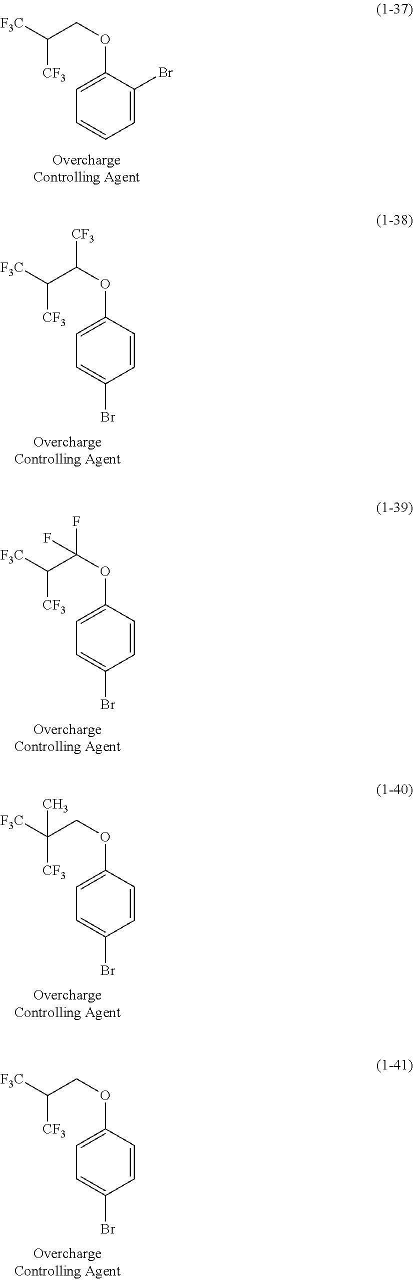

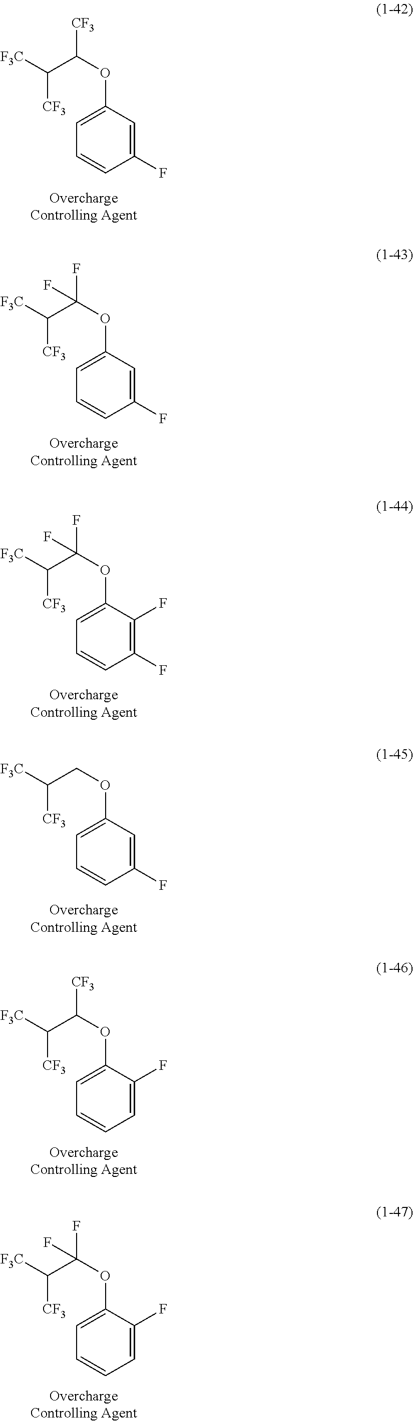

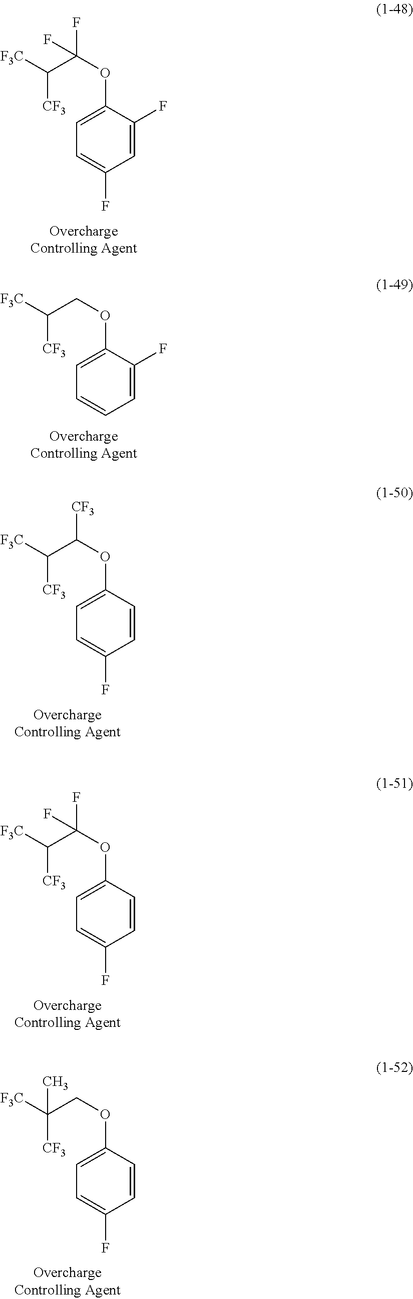

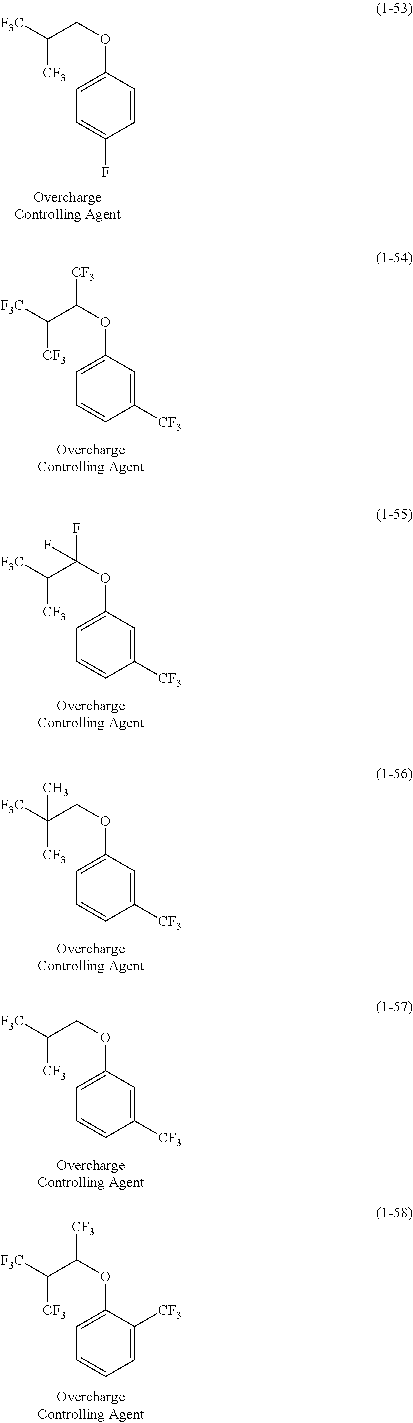

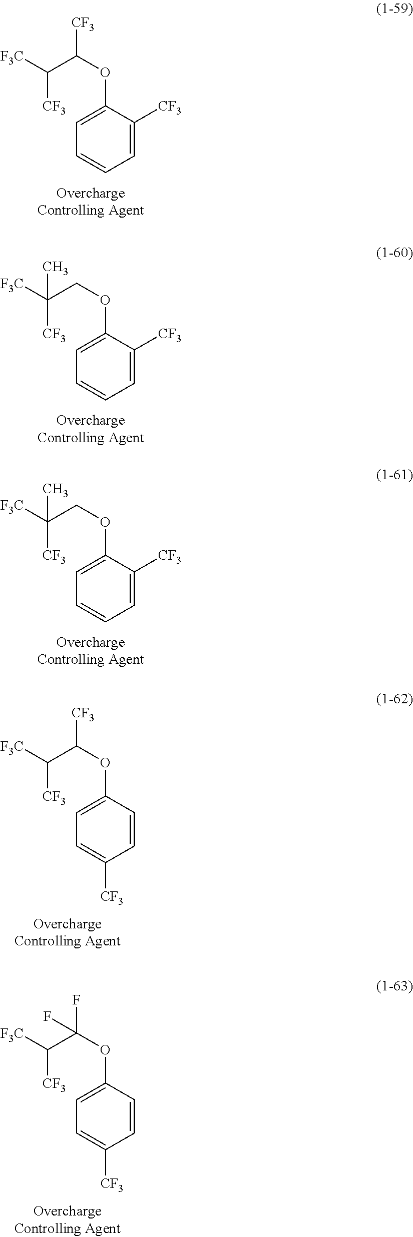

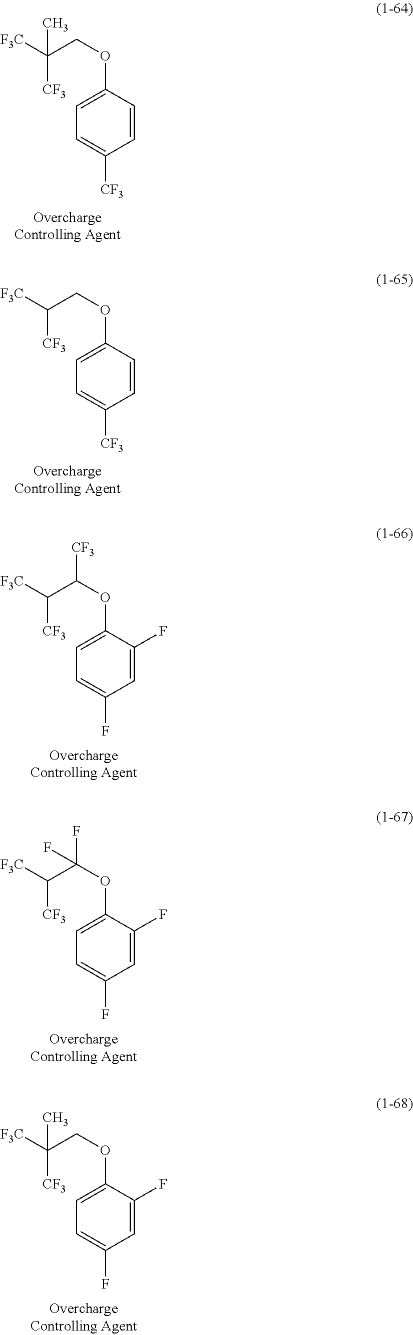

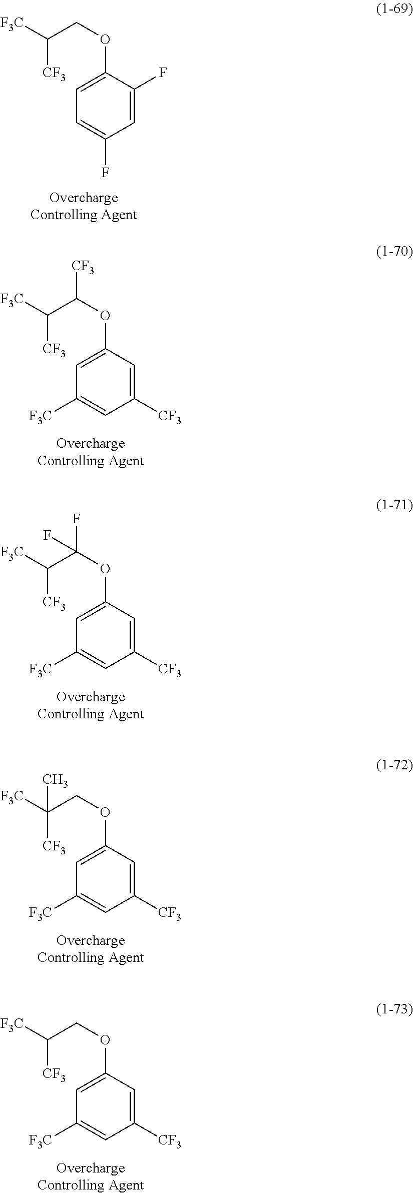

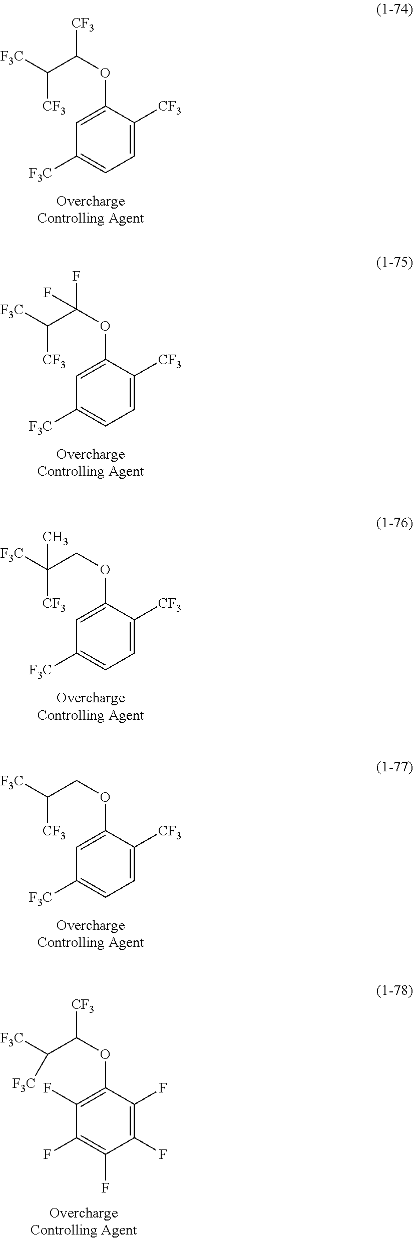

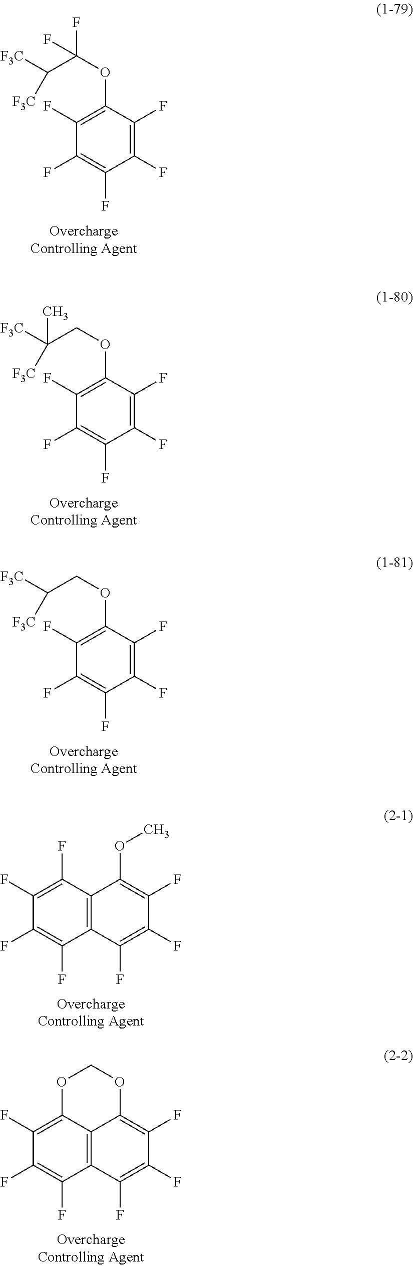

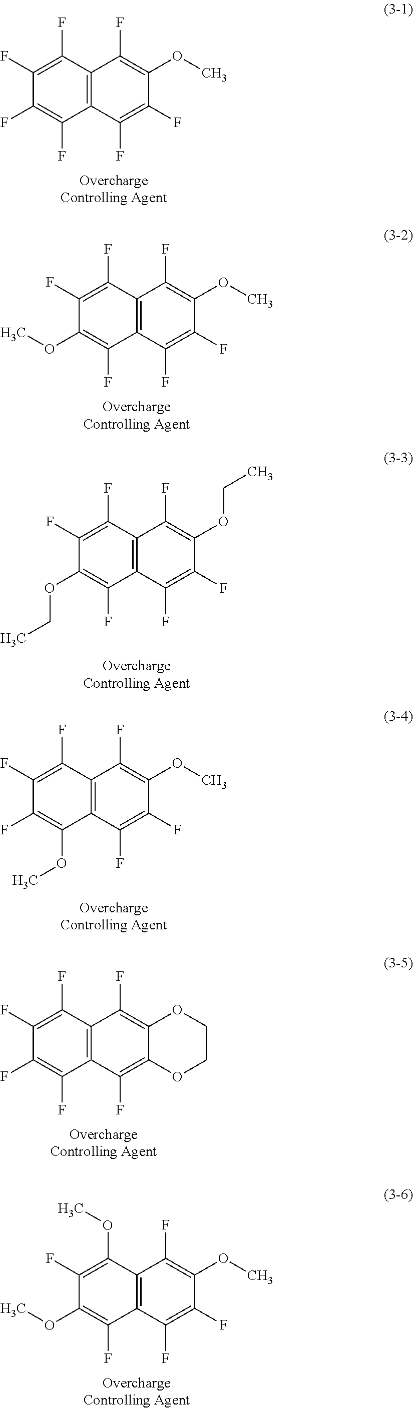

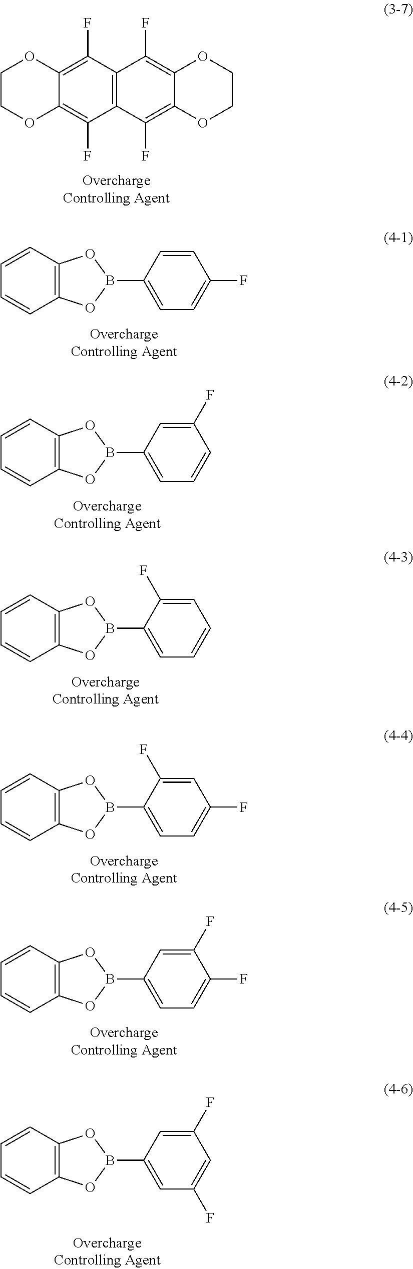

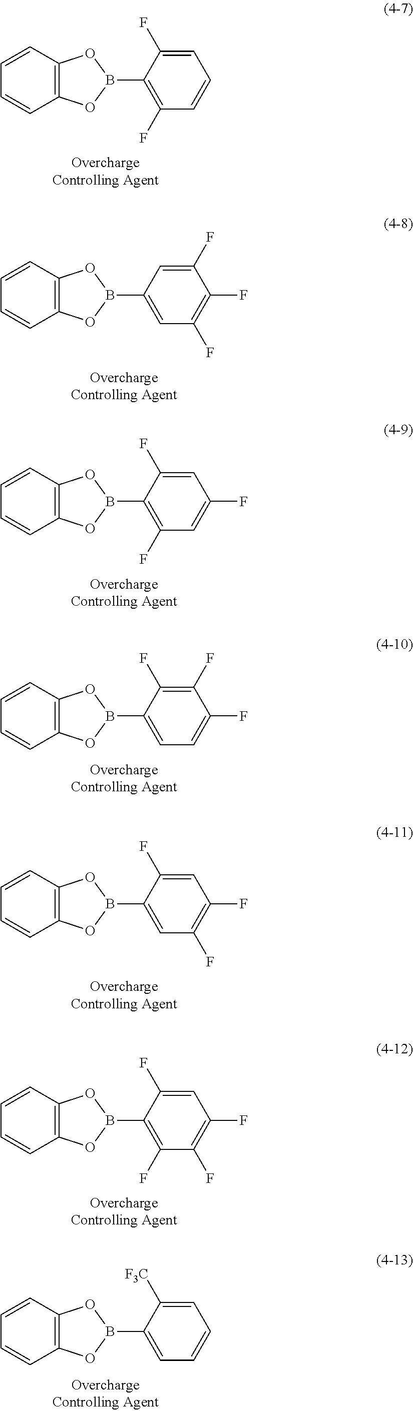

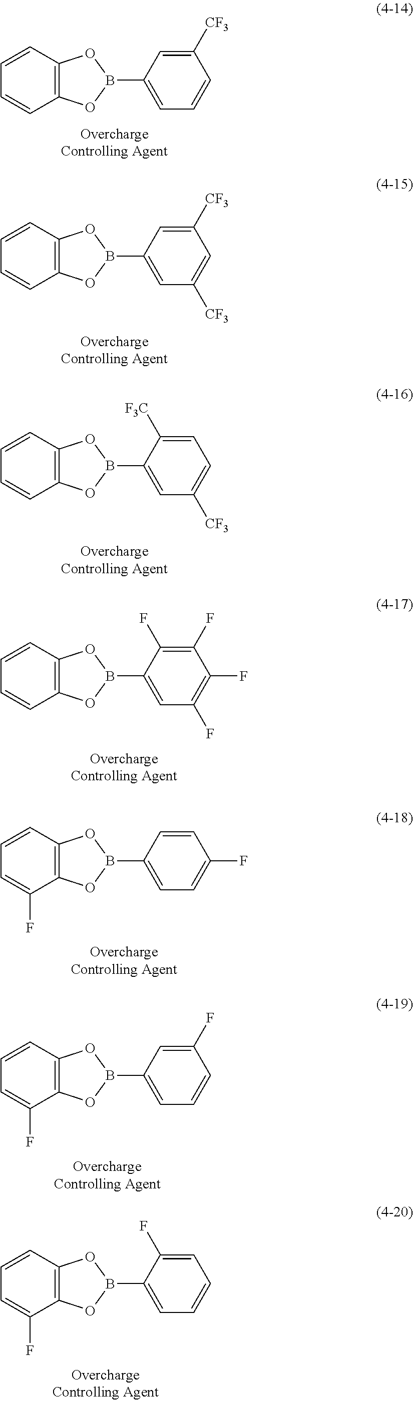

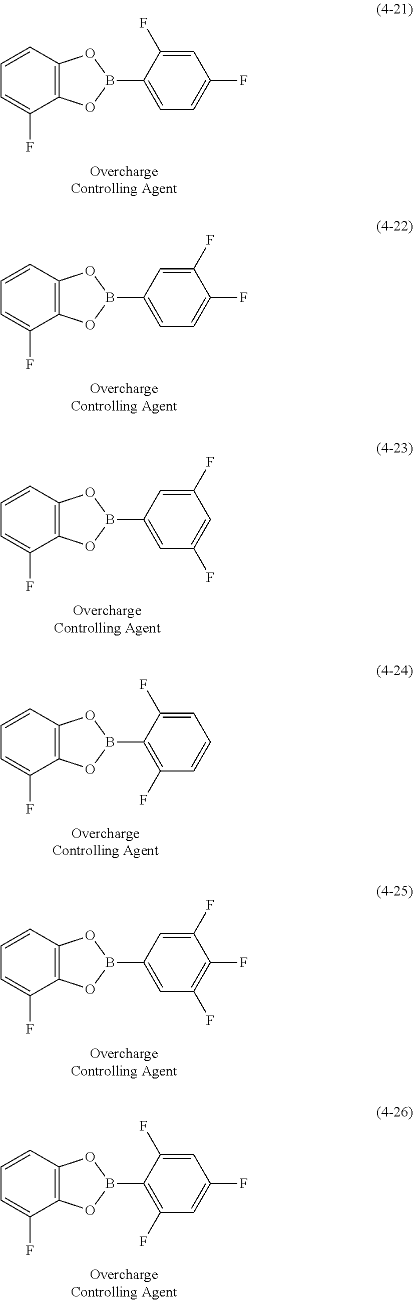

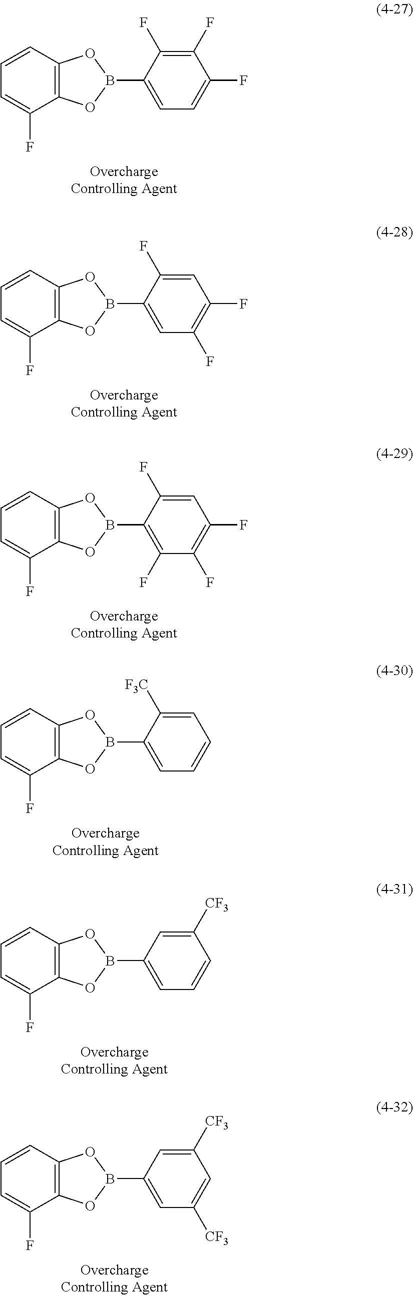

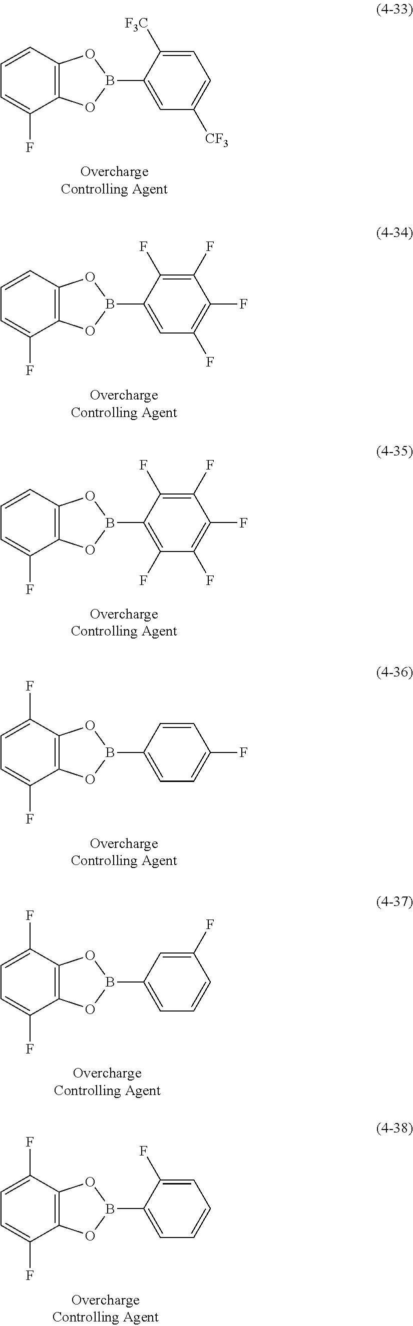

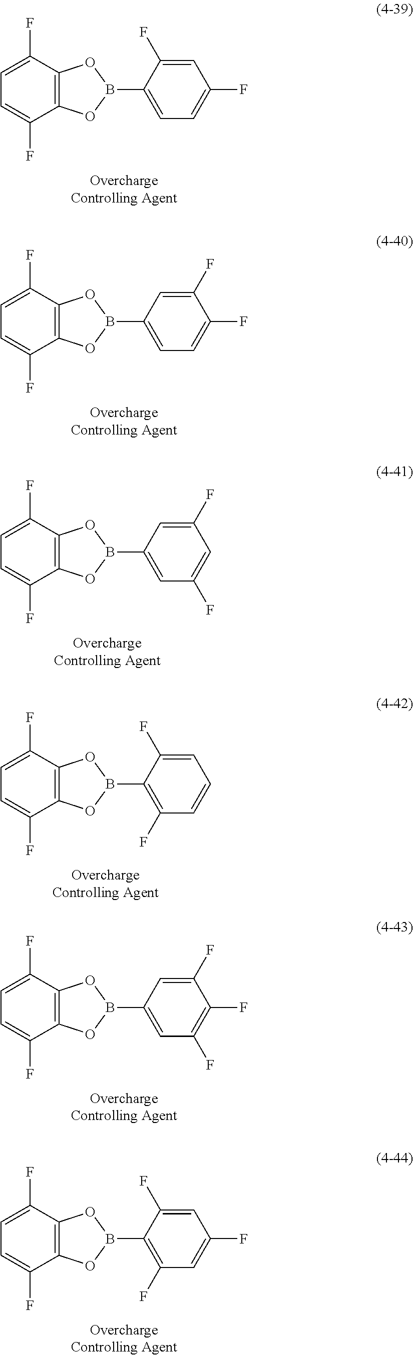

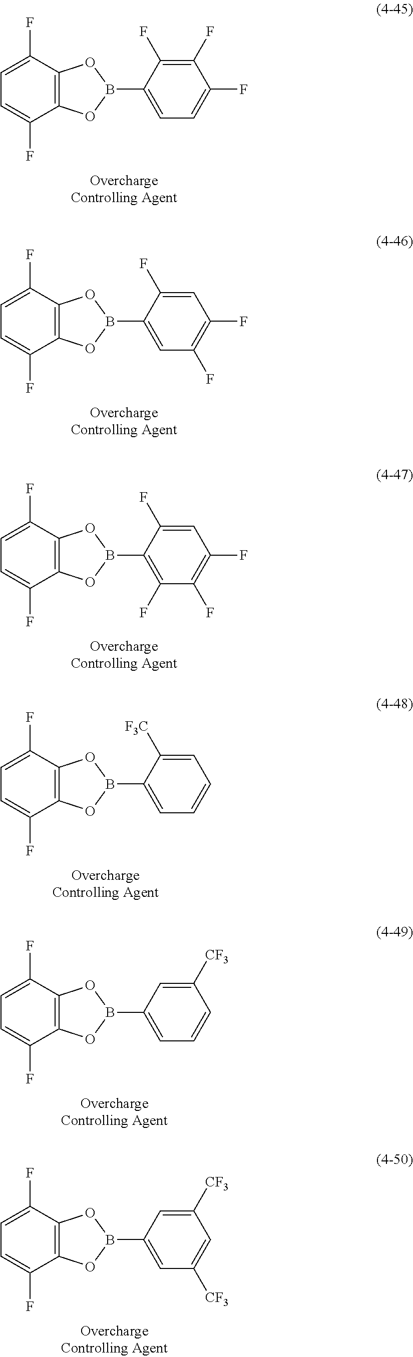

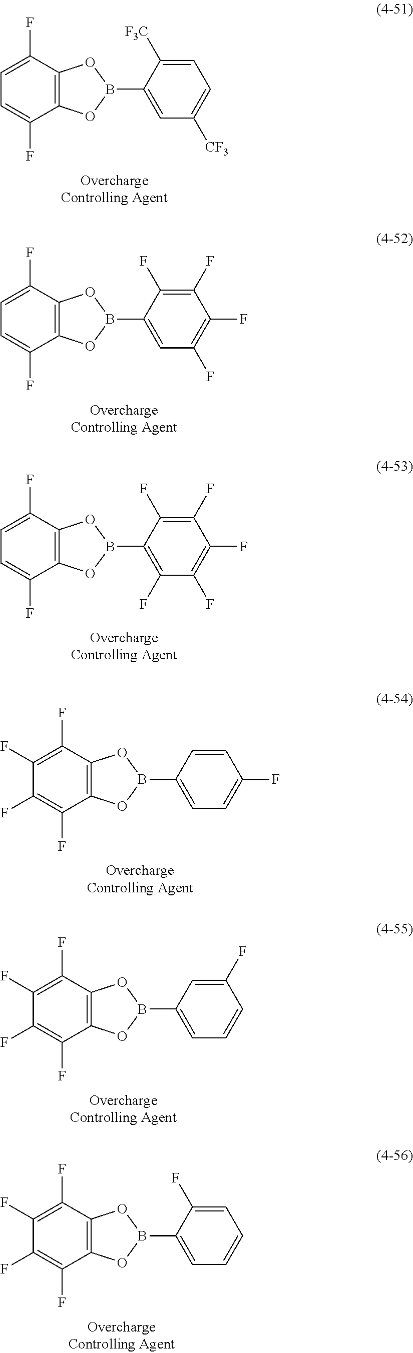

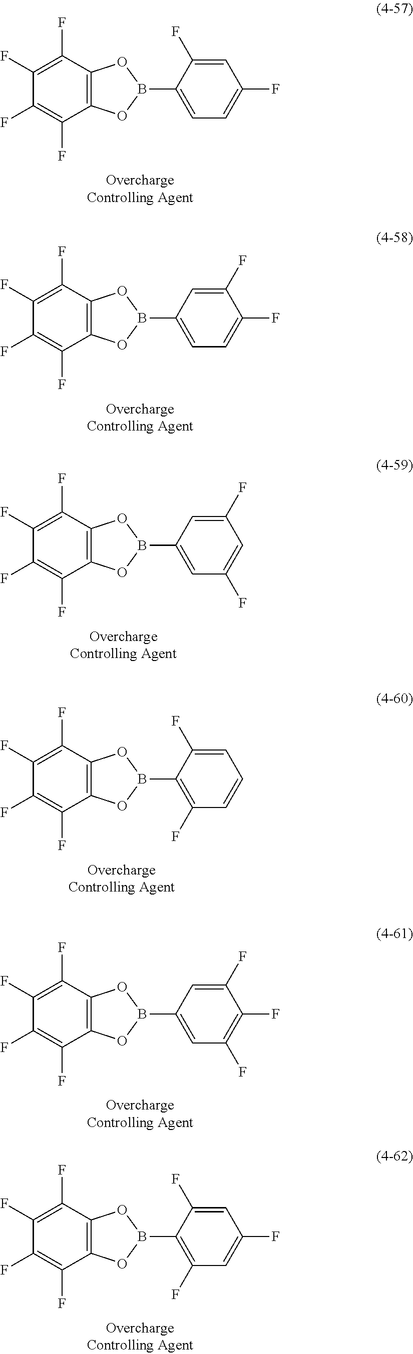

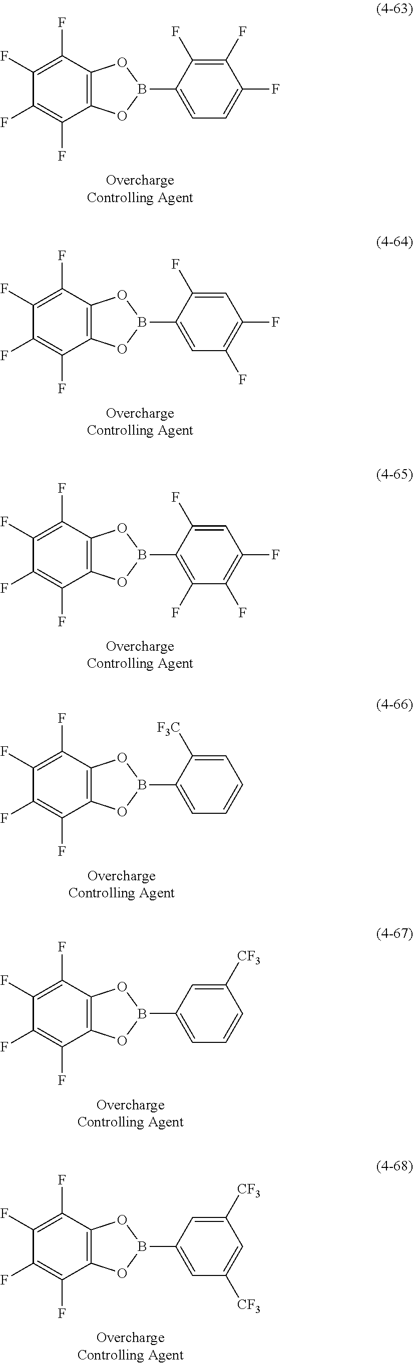

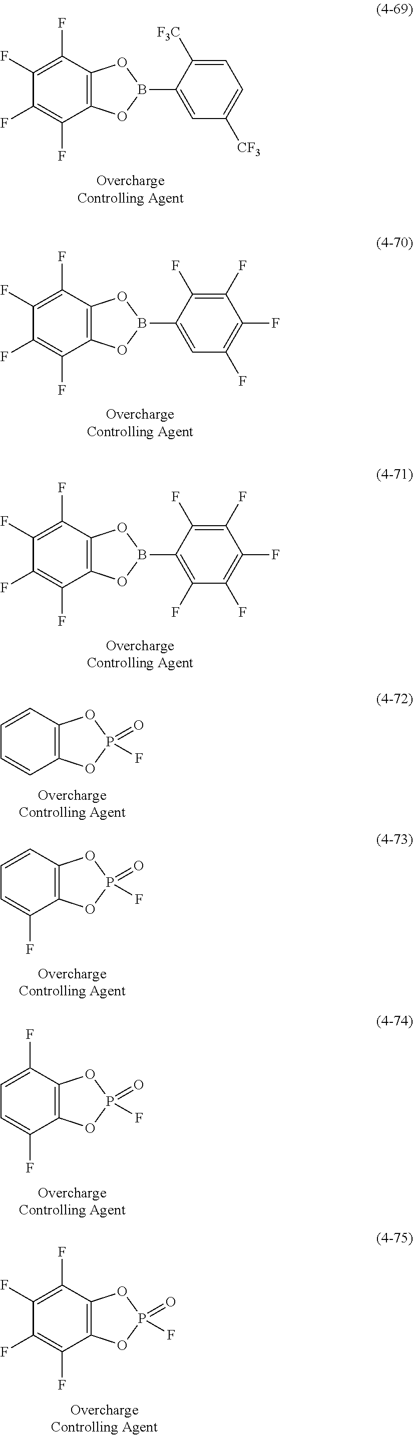

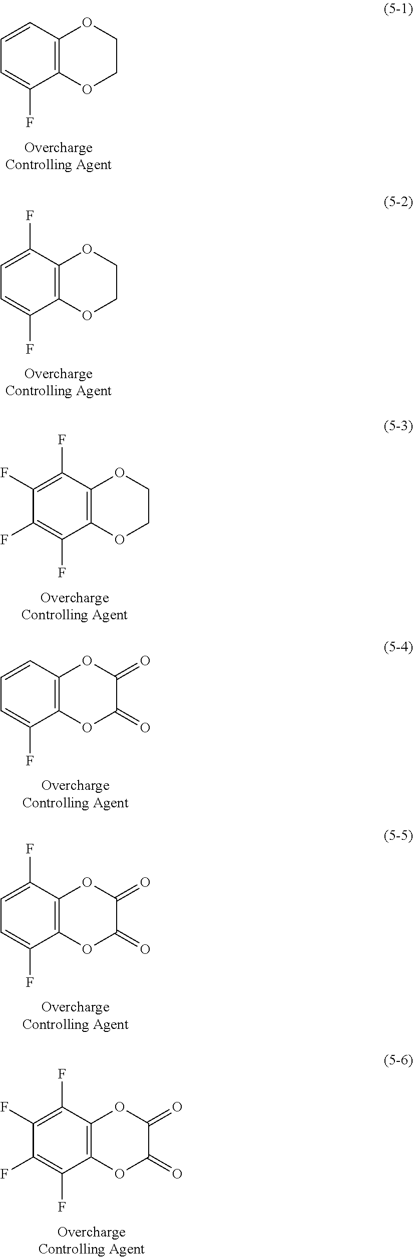

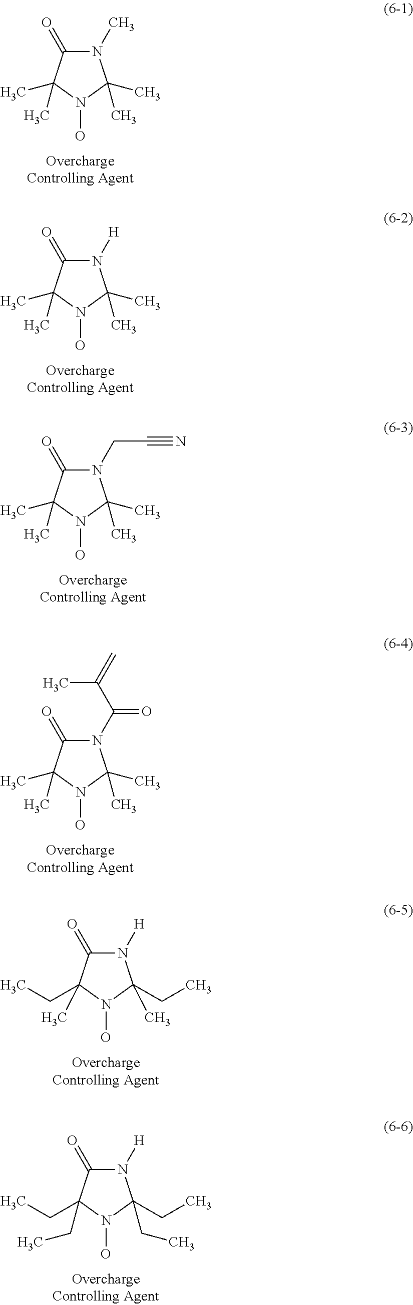

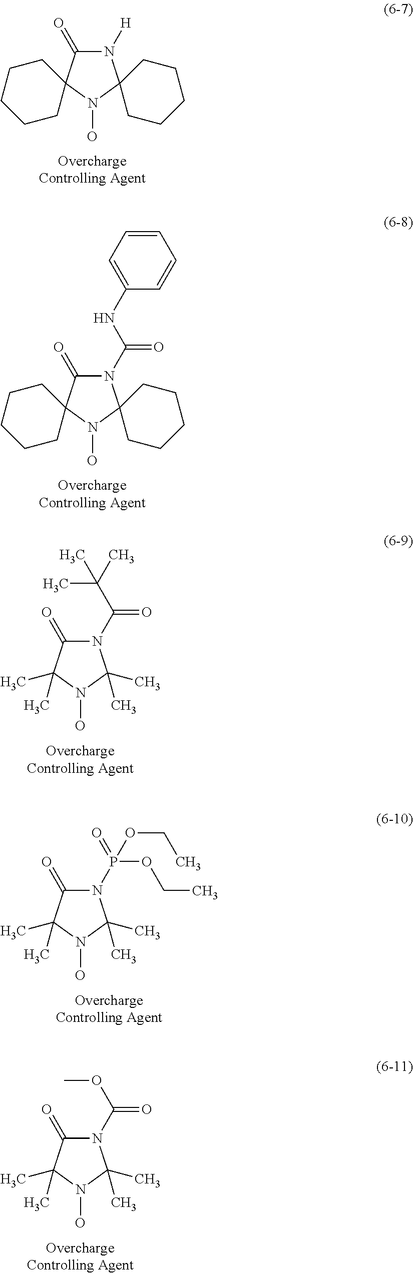

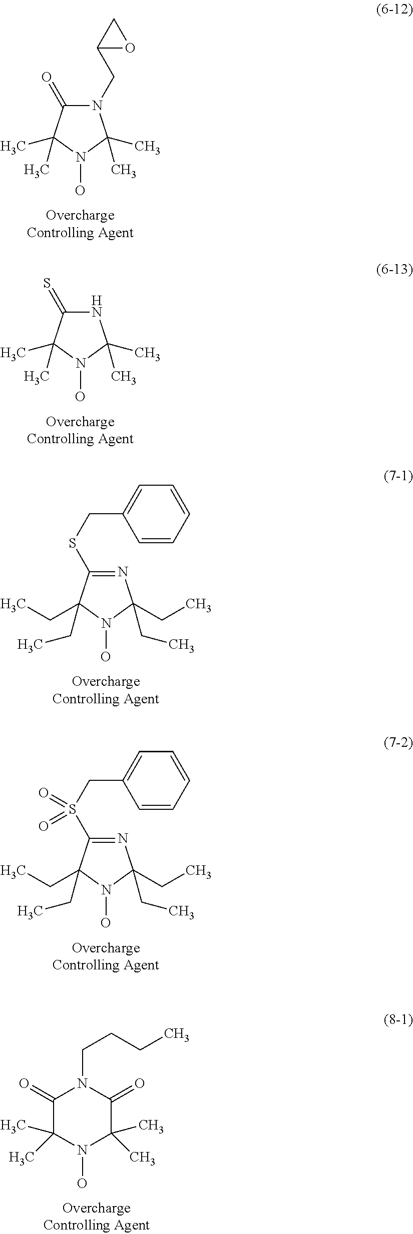

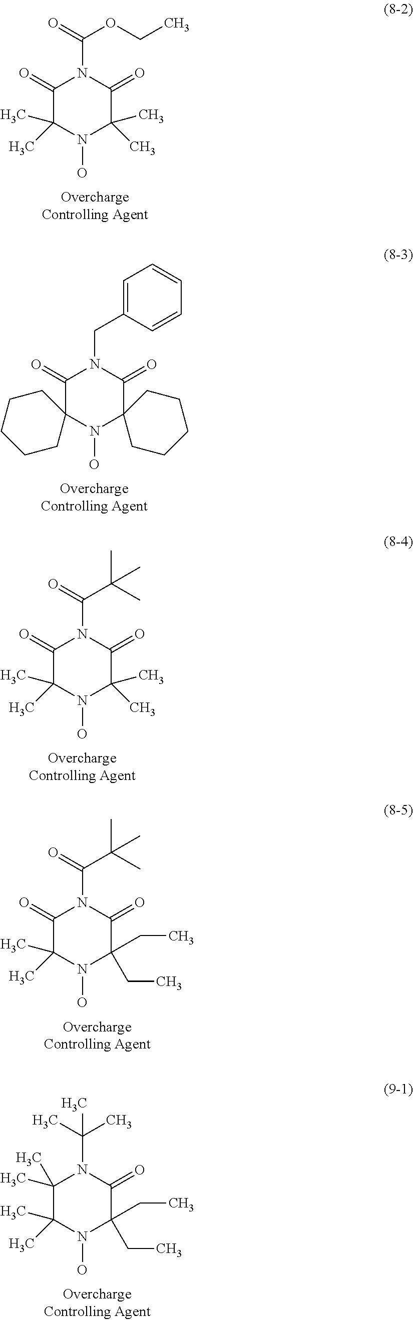

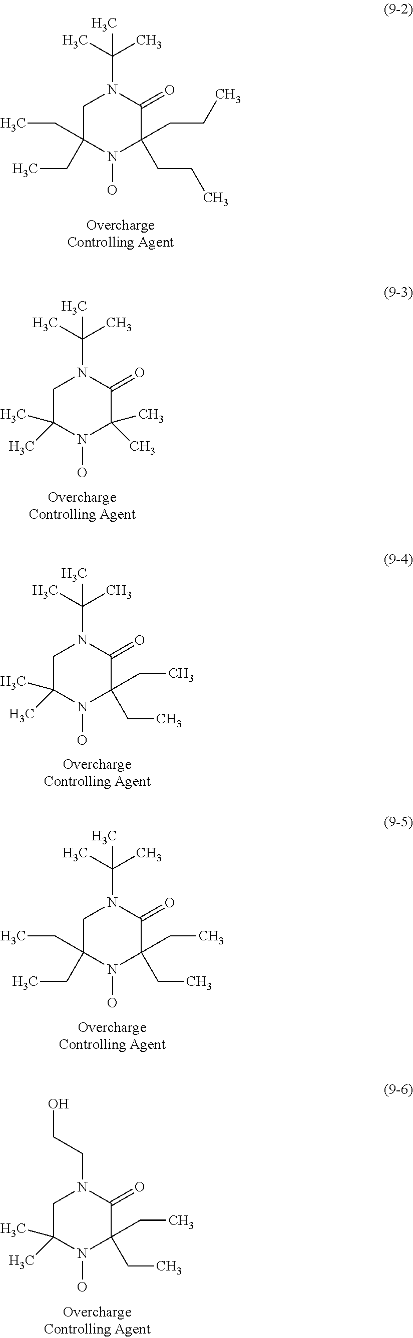

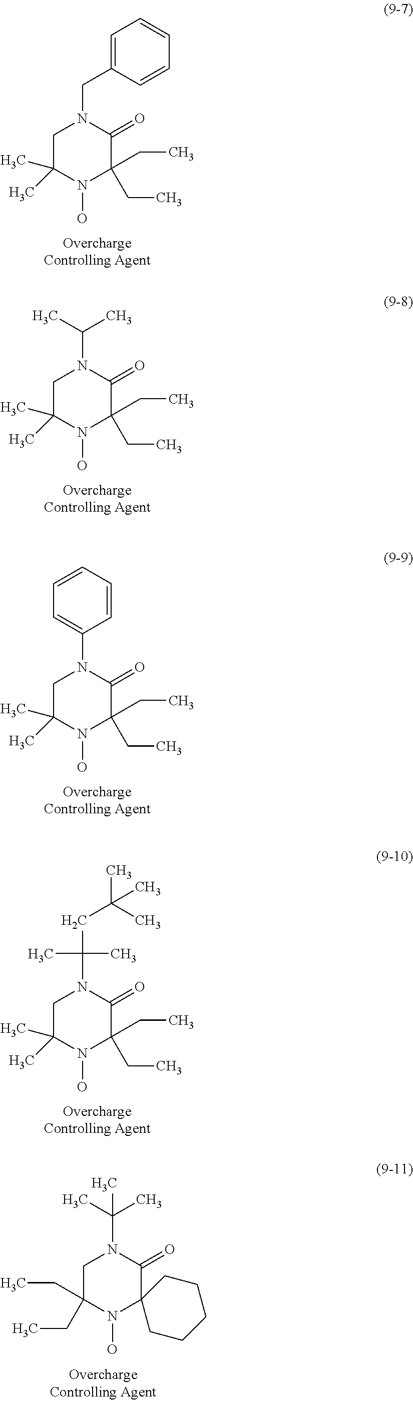

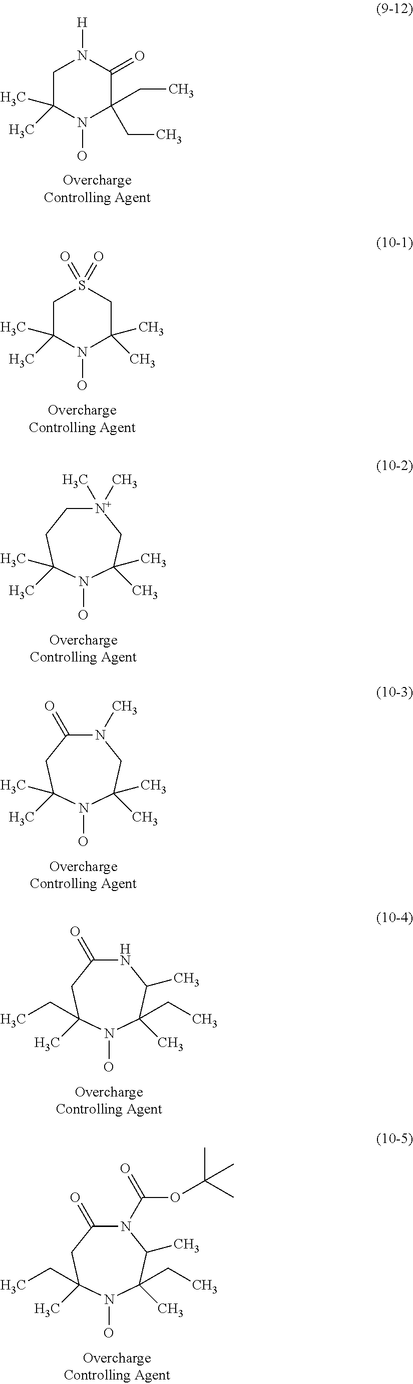

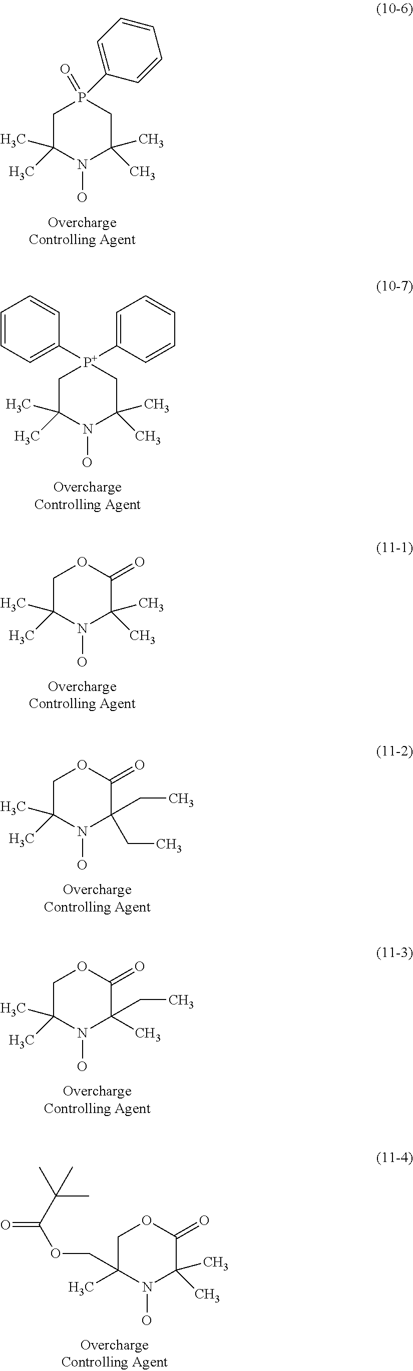

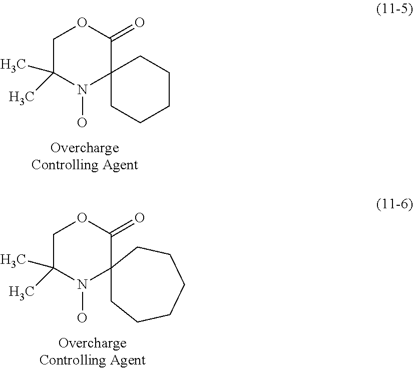

Overcharge Controlling Agent (12-1)

Li₂B₁₂F₁₂

Overcharge Controlling Agent (12-2)

Li₂B₁₂FₜH₁₂₋ₜ (t=9 to 12 in average)

A content of the overcharge controlling agent in the nonaqueous electrolytic solution is preferably 0.1% by mass or more and not more than 50% by mass, and more preferably 0.5% by mass or more and not more than 10% by mass. This is because an effect for inhibiting a voltage increase at the time of charge is sufficiently exhibited. Incidentally, the foregoing content is applied to all of the cases where the nonaqueous electrolytic solution contains one kind or two or more kinds of the overcharge controlling agent.

### [Compound According to the Present Technology]

When the compound according to the present technology is added to the nonaqueous electrolytic solution together with the foregoing overcharge controlling agent, a lowering of load characteristics after the overcharge can be inhibited. The compound according to the present technology is hereunder described.

For example, the following compounds (1) to (10) can be used as the compound according to the present technology. The compound according to the present technology may be a single compound or a mixture of two or more kinds of compounds represented by the compounds (1) to (10).

Li[PFₘ₁R11₆₋ₘ₁] Compound (1)

In the formula, R11 represents a perfluoroalkyl group or a perfluoroaryl group; and m1 represents an integer of from 0 to 6.

LiN(SO₂R21)₂

In the formula, R21 represents a perfluoroalkyl group, a perfluoroaryl group, or a halogen group.

Li[BFₘ₃R31₄₋ₘ₃] Compound (3)

In the formula, R31 represents a perfluoroalkyl group or a perfluoroaryl group; and m3 represents an integer of from 0 to 4.

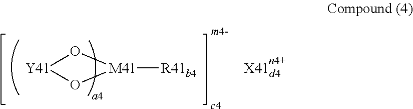

In the formula, X41 represents a Group 1 element or a Group 2 element in the long form of the periodic table, or aluminum; M41 represents a transition metal element, or a Group 13 element, a Group 14 element or a Group 15 element in the long form of the periodic table; R41 represents a halogen group; Y41 represents —C(═O)—R42-C(═O)—, —C(═O)—C(R43)₂-, or —C(═O)—C(═O)—; R42 represents an alkylene group, a halogenated alkylene group, an arylene group, or a halogenated arylene group; each R43 independently represents an alkyl group, a halogenated alkyl group, an aryl group, or a halogenated aryl group; a4 represents an integer of from 1 to 4; b4 represents 0, 2, or 4; and each of c4, d4, m4, and n4 represents an integer of from 1 to 3.

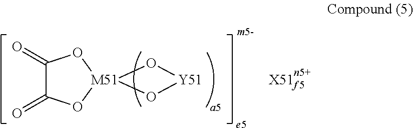

In the formula, X51 represents a Group 1 element or a Group 2 element in the long form of the periodic table; M51 represents a transition metal element, or a Group 13 element, a Group 14 element or a Group 15 element in the long form of the periodic table; Y51 represents —C(═O)—(C(R51)₂)_{b5}-C(═O)—, —(R53)₂C—(C(R52)₂)_{c5}-C(═O)—, —(R53)₂C—(C(R52)₂)_{c5}-C(R53)₂-, —(R53)₂C—(C(R52)₂)_{c5}-S(═O)₂—, —S(═O)₂—(C(R52)₂)_{d5}-S(═O)₂—, or —C(═O)—(C(R52)₂)_{d5}-S(═O)₂—; each of R51 and R53 independently represents a hydrogen group, an alkyl group, a halogen group, or a halogenated alkyl group, provided that at least one of R51 and R53 represents a halogen group or a halogenated alkyl group; each R52 independently represents a hydrogen group, an alkyl group, a halogen group, or a halogenated alkyl group; each of a5, e5, and n5 represents 1 or 2; each of b5 and d5 represents an integer of from 1 to 4; c5 represents an integer of from 0 to 4; and each of f5 and m5 represents an integer of from 1 to 3.

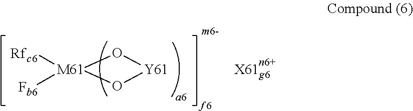

In the formula, X61 represents a Group 1 element or a Group 2 element in the long form of the periodic table; M61 represents a transition metal element, or a Group 13 element, a Group 14 element or a Group 15 element in the long form of the periodic table; Rf represents a fluorinated alkyl group or a fluorinated aryl group, each having a carbon number of from 1 to 10; Y61 represents —C(═O)—(C(R61)₂)_{d6}-C(═O)—, —(R62)₂C—(C(R61)₂)_{d6}-C(═O)—, —(R62)₂C—(C(R61)₂)_{d6}-C(R62)₂-, —(R62)₂C—(C(R61)₂)_{d6}-S(═O)₂—, —S(═O)₂—(C(R61)₂)ₑ₆-S(═O)₂—, or —C(═O)—(C(R61)₂)ₑ₆-S(═O)₂—; each R61 independently represents a hydrogen group, an alkyl group, a halogen group, or a halogenated alkyl group; each R62 independently represents a hydrogen group, an alkyl group, a halogen group, or a halogenated alkyl group, provided that at least one of R62s represents a halogen group or a halogenated alkyl group; each a6, f6, and n6 represents 1 or 2; each of b6, c6, and e6 represents an integer of from 1 to 4; d6 represents an integer of from 0 to 4; and each of g6 and m6 represents an integer of from 1 to 3.

Incidentally, the Group 1 element in the long form of the periodic table as referred to herein is hydrogen (H), lithium (Li), sodium (Na), potassium (K), rubidium (Rb), cesium (Cs), or francium (Fr). The Group 2 element as referred to herein is beryllium (Be), magnesium (Mg), calcium (Ca), strontium (Sr), barium (Ba), or radium (Ra). The Group 13 element as referred to herein is boron, aluminum (Al), gallium (Ga), indium (In), or thallium (Tl). The Group 14 element as referred to herein is carbon, silicon, germanium (Ge), tin (Sn), or lead (Pb). The Group 15 element as referred to herein is nitrogen, phosphorus, arsenic (As), antimony (Sb), or bismuth (Bi).

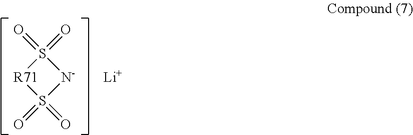

In the formula, R71 represents a linear or branched perfluoroalkylene group having a carbon number of from 2 to 4.

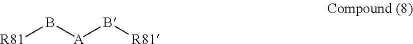

In the formula, each of R81 and R81′ independently represents an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or each of which may be a halogenated group, and R81 and R81′ may be the same as or different from each other and may be connected to each other to form a ring; each of A, B, and B′ represents an oxygen atom, a sulfur atom, —C(═O)—, —S(═O)—, —S(═O)₂—, —C(Rd)(Re)—, —Si(Rd)(Re)—, or —N(Rf)—, and A, B, and B′ may be the same as or different from each other; and each of Rd, Re, and Rf independently represents a hydrogen group, a halogen group, an alkyl group, an alkenyl group, an alkynyl group, an aryl group, or a heterocyclic group, or an alkyl group, an alkenyl group, an alkynyl group, each of which is substituted with an aromatic hydrocarbon group or an alicyclic hydrocarbon group, or each of which may be a halogenated group, provided that the case where all of A, B, and B′ are —C(Rd)(Re)—, and the case where B and A, or B′ and A, are an oxygen atom are excluded.

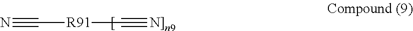

In the formula, R91 represents a single bond or a divalent connecting group; and n9 represents 0 or a natural number.

O═C═N—R101N═C═O]ₙ₁₀| Compound (10)

In the formula, R101 represents a single bond or a divalent connecting group; and n10 represents 0 or a natural number.

A content of the compound selected among the compounds (1) to (10) is preferably 0.001% by mass or more and not more than 30% by mass relative to the nonaqueous electrolytic solution. In the case where the content falls within the foregoing range, an effect for inhibiting a lowering of load characteristics after the overcharge to be brought by the addition of the compound selected among the compounds (1) to (10) is sufficiently obtainable. Also, a lowering of stability of the nonaqueous electrolyte to be caused due to the excessive addition of the compound selected among the compounds (1) to (10) can be inhibited.

Specific examples of the compound represented by the compound (1) include the following compounds. At least one member of the following compounds can be used as the compound represented by the compound (1). That is, examples thereof include Li[PF₃(CF₃)₃], Li[PF₃(C₂F₅)₃], Li[PF₄ (C₂F₅)₂], Li[PF₄ (CF₃)₂], Li[PF₄ (C₃F₇)₂], Li[PF₅(CF₃)], Li[PF₅(C₂F₅)], Li[PF₅(C₃F₇)], Li[PF₂ (C₂F₅)₄], and Li[PF₂ (CF₃)₄].

Specific examples of the compound represented by the compound (2) include the following compounds. At least one member of the following compounds can be used as the compound represented by the compound (2). That is, examples thereof include LiN(SO₂CF₃)₂, LiN(SO₂C₂F₅)₂, LiN(SO₂C₃F₇)₂, LiN(SO₂C₄H₉)₂, LiN(SO₂CF₃)(SO₂C₂F₅), and LiN(SO₂F)₂.

Specific examples of the compound represented by the compound (3) include the following compounds. At least one member of the following compounds can be used as the compound represented by the compound (3). That is, examples thereof include LiBF₄, Li[BF₃(CF₃)], Li[BF₃(C₂F₅)], Li[BF₂(CF₃)₂], Li[BF(CF₃)₃], Li[B (CF₃)₄], Li[BF₂(C₂F₅)₂], Li[BF(C₂F₅)₃], Li[B(C₂F₅)₄], Li[BF₃(C₃F₇)], Li[BF₂ (C₃F₇)₂], Li[BF (C₃F₇)₃], and Li[B(F₃F₇)₄].

The compound selected among those represented by the compounds (1) to (3) is a thermally stable salt having excellent thermal stability. Incidentally, though the compound selected among those represented by the compounds (1) to (3) has such a problem that it is easily subjected to a decomposition reaction on the positive electrode, according to the present technology, it is contained together with the foregoing overcharge controlling agent, and therefore, an increase of the positive electrode potential is inhibited, whereby the compound selected among those represented by the compounds (1) to (3) can stably exist in the nonaqueous electrolyte. As a result, as compared with the case where the overcharge controlling agent does not exist, the satisfactory thermal stability can be maintained by the compound selected among those represented by the compounds (1) to (3) remaining in the nonaqueous electrolytic solution even after the overcharge. Here, with respect to LiBF₄, a part thereof also functions as a protective film forming agent capable of forming a protective film. In a battery using a nonaqueous electrolytic solution containing LiBF₄, not only a part of LiBF₄ is consumed at the time of initial charge, but the residue of LiBF₄ exists as a thermally stable salt having excellent thermal stability.

Specific examples of the compound represented by the compound (4) include the following Compounds (4-1) to (4-6). At least one member of the following Compounds (4-1) to (4-6) can be used as the compound represented by the compound (4).

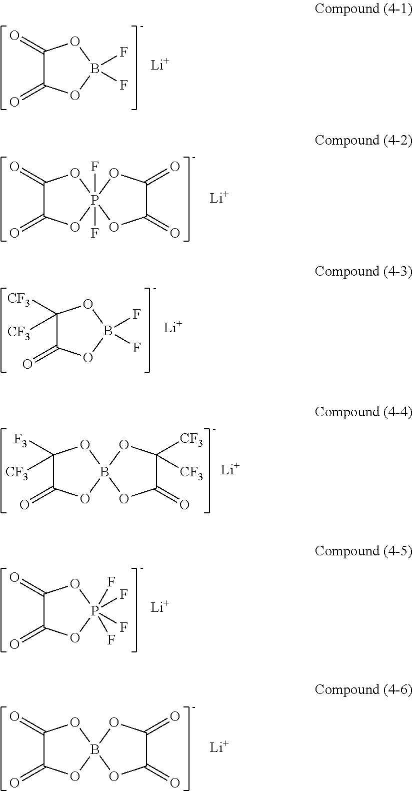

Specific examples of the compound represented by the compound (5) include the following Compounds (5-1) to (5-4). At least one member of the following Compounds (5-1) to (5-4) can be used as the compound represented by the compound (5).

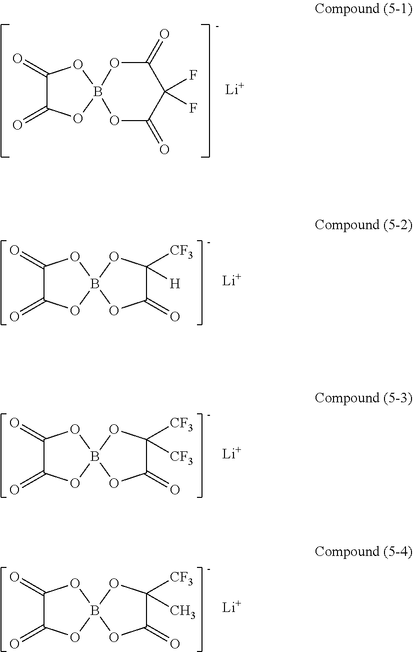

Specific examples of the compound represented by the compound (6) include the following Compound (6-1).

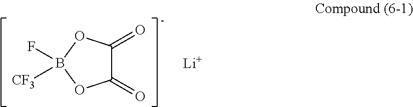

Specific examples of the compound represented by the compound (7) include the following Compounds (7-1) to (7-4). At least one member of the following Compounds (7-1) to (7-4) can be used as the compound represented by the compound (7).

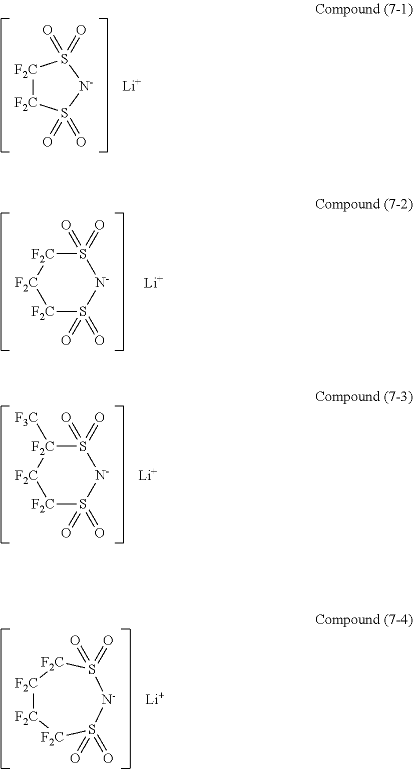

The compound selected among those represented by the compounds (4) to (7) is a protective film forming agent which is decomposed at the time of initial charge of a nonaqueous electrolyte battery using this nonaqueous electrolytic solution, thereby forming a film on the surface of at least one of the positive electrode and the negative electrode. For that reason, the decomposition of the foregoing overcharge controlling agent at the time of initial charge of the nonaqueous electrolyte battery can be inhibited. As a result, as compared with the case where any of the compounds represented by the compounds (4) to (7) does not exist, the concentration of the overcharge controlling agent in the nonaqueous electrolyte after the initial charge can be kept high, and therefore, the voltage increase of the nonaqueous electrolyte battery in an overcharged state of the nonaqueous electrolyte battery is inhibited. As a result, a decomposition reaction of the nonaqueous electrolyte is also inhibited, and as compared with the case where only either the compound selected among those represented by the compounds (4) to (7) or the foregoing overcharge controlling agent exists, a lowering of load characteristics after the overcharge is inhibited in comparison with that before the overcharge.

Specific examples of the compound represented by the compound (8) include the following compounds. At least one member of the following Compounds (8-1) to (8-13) can be used as the compound represented by the compound (8).

Examples of a carboxylic acid anhydride include succinic anhydride, glutaric anhydride, and maleic anhydride.

Examples of a disulfonic anhydride include ethanedisulfonic anhydride and propanedisulfonic anhydride.

Examples of an anhydride between a carboxylic acid and a sulfonic acid include sulfobenzoic anhydride, sulfopropionic anhydride, and sulfobutyric anhydride.

Examples of acyclic lactone include γ-butyrolactone and γ-valerolactone.

Examples of a cyclic lactam include N-methyl-2-pyrrolidone, N-ethyl-2-pyrrolidone, N-propyl-2-pyrrolidone, N-cyclohexyl-2-pyrrolidone, and N-phenyl-2-pyrrolidone.

Examples of a cyclic ether include 1,3-dioxolane, 4-methyl-1,3-dioxolane, 1,3-dioxane, and 1,4-dioxane.

Examples of a chain ether include 1,2-dimethoxyethane.

Examples of a cyclic sulfone include sulfolane.

Examples of a carboxylic acid ester include methyl acetate, ethyl acetate, methyl propionate, ethyl propionate, methyl butyrate, methyl isobutyrate, methyl trimethylacetate, and ethyl trimethylacetate.

Examples of a fluorinated chain carbonate include fluoromethylmethyl carbonate, bis(fluoromethyl)carbonate, and difluoromethylmethyl carbonate.

Examples of a cyclic carbonate include vinylene carbonate, methyl vinylene carbonate, ethyl vinylene carbonate, 4,5-dimethyl-1,3-dioxol-2-one, 4,5-diethyl-1,3-dioxol-2-one, 4-fluoro-1,3-dioxol-2-one, 4-trifluoromethyl-1,3-dioxol-2-one, vinyl ethylene carbonate, 4-methyl-4-vinyl-1,3-dioxol-2-one, 4-ethyl-4-vinyl-1,3-dioxolan-2-one, 4-n-propyl-4-vinyl-1,3-dioxolan-2-one, 5-methyl-4-vinyl-1,3-dioxolan-2-one, 4,4-divinyl-1,3-dioxolan-2-one, 4,5-divinyl-1,3-dioxolan-2-one, 4-methylene-1,3-dioxolan-2-one, 4,4-dimethyl-5-methylene-1,3-dioxolan-2-one, 4,4-diethyl-5-methylene-1,3-dioxolan-2-one, 4-fluoro-1,3-dioxolan-2-one, 4,5-difluoro-1,3-dioxolan-2-one, catechol carbonate, and compounds represented by the following Compounds (8-1) to (8-9).

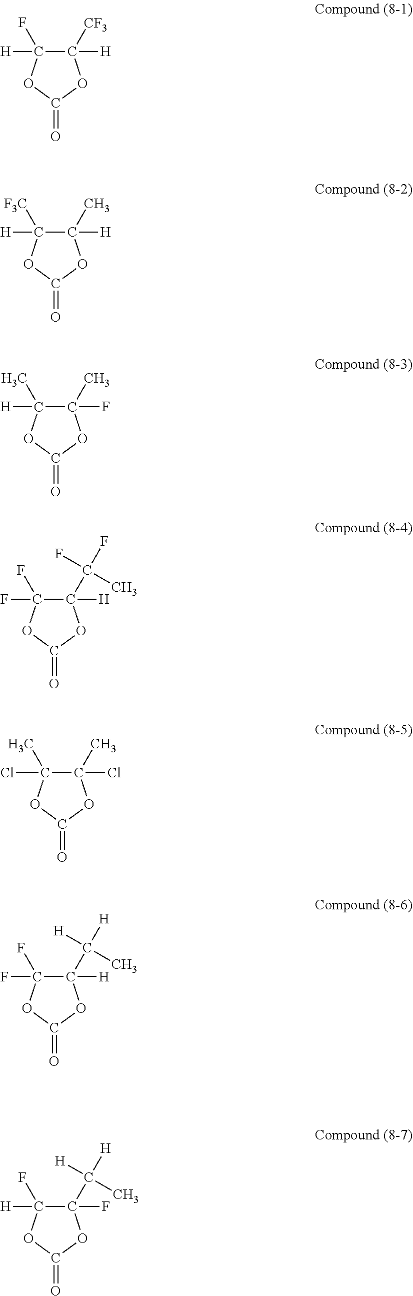

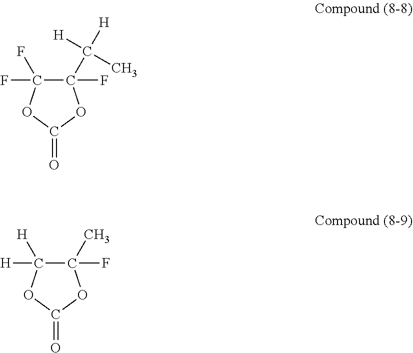

Also, specific examples of the compound represented by the compound (8) include the following compounds.

Examples of a sultone include propane sultone, propene sultone, and ethylene sulfite.

Examples of a methylene bisulfate include the following Compounds (8-10) to (8-13).

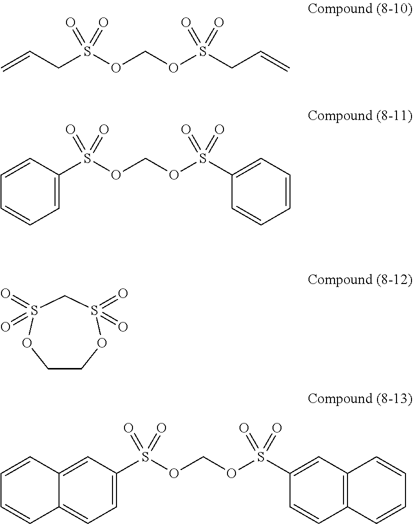

Similar to the compounds represented by the compounds (4) to (7), the compound represented by the compound (8) is a protective film forming agent which is decomposed at the time of initial charge of a nonaqueous electrolyte battery using this nonaqueous electrolytic solution, thereby forming a film on the surface of at least one of the positive electrode and the negative electrode. For that reason, the decomposition of the foregoing overcharge controlling agent at the time of initial charge of the nonaqueous electrolyte battery can be inhibited. As a result, as compared with the case where the compound represented by the compound (8) does not exist, the concentration of the overcharge controlling agent in the nonaqueous electrolyte after the initial charge can be kept high, and therefore, the voltage increase of the nonaqueous electrolyte battery in an overcharged state of the nonaqueous electrolyte battery is inhibited. As a result, a decomposition reaction of the nonaqueous electrolyte is also inhibited, and as compared with the case where only either the compound represented by the compound (8) or the foregoing overcharge controlling agent exists, a lowering of load characteristics after the overcharge is inhibited in comparison with that before the overcharge.

Specific examples of the compound represented by the compound (9) include the following nitriles. At least one member of the following compounds can be used as the compound represented by the compound (9).

Examples of a mononitrile compound include acetonitrile, propionitrile, butyronitrile, valeronitrile, hexanenitrile, octanenitirle, undecanenitrile, decanenitrile, 4-cyanocyclohexene, cyclohexanecarbonitrile, benzonitrile, and phenylacetonitrile.

Examples of a dinitrile compound include succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 1,4-dicyanopentane, 2,5-dimethyl-2,5-hexanecarbodinitrile, 2,6-dicyanoheptane, 2,7-dicyanooctane, 2,8-dicyanononane, 1,6-dicyanodecane, 3,3′-oxydipropionitrile, 3,3′-thiodipropionitrile, 1,4-dicyano-2-butene, hexenedinitrile, 1,2-dicyanobenzene, 1,3-dicyanobenzene, and 1,4-dicyanobenzene.

Examples of a trinitrile compound include 1,2,3-propanetricarbonitrile, 1,3,5-cyclohexanetricarbonitirile, 1,3,5-heptanetricarbonitrile, 1,2,3-tris(2-cyanoethoxy)propane, and tris(2-cyanoethyl)amine.

Examples of a tetranitrile compound include 7,7,8,8-tetracyanoquinodimethane, 2,5-dimethyl-7,7,8,8-tetracyanoquinodimethane, and 2,5-difluoro-7,7,8,8-tetracyanoquinodimethane.

The compound composed of a nitrile represented by the compound (9) is a complex forming agent which forms a complex together with a transition metal ion when it exists in the nonaqueous electrolytic solution. In the case where the compound represented by the compound (9) does not exist, deposition of a transition metal occurs on the negative electrode, whereby the transition metal ion concentration in the nonaqueous electrolyte decreases. For that reason, the equilibrium moves, and elution of the transition metal from the positive electrode continuously occurs. As a result, since the positive electrode potential increases, the film on the positive electrode is decomposed, and the compound selected among the compounds represented by the compounds (1) to (12), which is able to electrochemically inhibit the increase of the charge voltage is oxidized and decomposed, whereby the voltage of the lithium ion battery increases. Also, the deposition of the transition metal increases the film on the negative electrode. In the case where both the compound represented by the compound (9) and the foregoing overcharge controlling agent are contained, in view of the fact that a complex is formed, a redox reaction potential of the transition metal ion changes, whereby in particular, the deposition of the transition metal onto the negative electrode is inhibited, and the transition metal ion concentration in the nonaqueous electrolyte is kept constant. For that reason, as compared with the case where only either the compound represented by the compound (9) or the foregoing overcharge controlling agent exists, a lowering of load characteristics after the overcharge is inhibited.

Specific examples of the compound represented by the compound (10) include the following isocyanates. At least one member of the following compounds can be used as the compound represented by the compound (10).

Examples of a monoisocyanate compound include 1-isocyanatoethane, 3-isocyanato-1-propene, 2-isocyanatopropane, 1-isocyanatopropane, 1-isocyanatobutane, 2-isocyanato-2-methylpropane, 2-isocyanatobutane, methylisocyanatoformate, 1-isocyanatopentane, ethylisocyanatoformate, isocyanatobenzene, 1-chloro-3-isocyanatopropane, isocyanatocyclohexane, isocyanatohexane, and 1-isocyanatoheptane.

Examples of a diisocyanate compound include diisocyanatomethane, 1,3-diisocyanatopropane, 1,4-diisocyanatobutane, 1,6-diisocyanatohexane, 1,8-diisocyanatooctane, 1,12-diisocyanatododecane, carbonyldiisocyanate, 1,4-diisocyanatobutane-1,4-dione, and 1,5-diisocyanatopentane-1,5-dione.

Similar to the compounds represented by the compounds (4) to (7), the compound composed of an isocyanate represented by the compound (10) is a protective film forming agent which is decomposed at the time of initial charge of a nonaqueous electrolyte battery using this nonaqueous electrolytic solution, thereby forming a film on the surface of at least one of the positive electrode and the negative electrode. For that reason, the decomposition of the foregoing overcharge controlling agent at the time of initial charge of the nonaqueous electrolyte battery can be inhibited. As a result, as compared with the case where the compound represented by the compound (10) does not exist, the concentration of the overcharge controlling agent in the nonaqueous electrolyte after the initial charge can be kept high, and therefore, the voltage increase of the nonaqueous electrolyte battery in an overcharged state of the nonaqueous electrolyte battery is inhibited. As a result, a decomposition reaction of the nonaqueous electrolyte is also inhibited, and as compared with the case where only either the compound represented by the compound (10) or the foregoing overcharge controlling agent exists, a lowering of load characteristics after the overcharge is inhibited in comparison with that before the overcharge. Also, similar to the compound composed of a nitrile represented by the compound (9), the compound represented by the compound (10) is able to form a complex together with a transition metal ion, a lowering of load characteristics after the overcharge is more inhibited.

### [Nonaqueous Solvent]

The nonaqueous solvent contains at least one member of organic solvents as described below.

Examples of the nonaqueous solvent include the following compounds. That is, examples thereof include ethylene carbonate, propylene carbonate, butylene carbonate, dimethyl carbonate, diethyl carbonate, ethylmethyl carbonate, methylpropyl carbonate, 1,2-dimethoxyethane, and tetrahydrofuran. Furthermore, examples thereof include 2-methyltetrahydrofuran, tetrahydropyran, 1,3-dioxolane, 4-methyl-1,3-dioxolane, 1,3-dioxane, and 1,4-dioxane. Furthermore, examples thereof include methyl acetate, ethyl acetate, methyl propionate, ethyl propionate, methyl butyrate, methyl isobutyrate, methyl trimethylacetate, and ethyl trimethyl acetate. Furthermore, examples thereof include N,N-dimethylformamide, N-methylpyrrolidinone, and N-methyloxazolidinone. Furthermore, examples thereof include N,N′-dimethylimidazolidinone, nitromethane, nitroethane, sulfolane, trimethyl phosphate, and dimethyl sulfoxide. This is because in the nonaqueous electrolyte battery using a nonaqueous electrolytic solution, excellent battery capacity, cycle characteristics and storage characteristics, and the like are obtainable.

Above all, at least one member of ethylene carbonate, propylene carbonate, dimethyl carbonate, diethyl carbonate, and ethylmethyl carbonate is preferable. This is because excellent battery capacity, cycle characteristics and storage characteristics, and the like are obtainable. In that case, a combination of a high viscosity (high dielectric constant) solvent (for example, relative dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate is more preferable. This is because dissociation properties of the electrolyte salt and mobility of the ion are enhanced.

In particular, it is preferable that the solvent contains at least one member of unsaturated carbon-bonding cyclic carbonates represented by the following formulae (1) to (3). This is because a stable protective film is formed on the surface of the electrode at the time of charge and discharge of the nonaqueous electrolyte battery, and therefore, a decomposition reaction of the nonaqueous electrolytic solution is inhibited. This unsaturated carbon-bonding cyclic carbonate is a cyclic carbonate having one or two or more unsaturated carbon bonds. R31 and R32 may be a group the same as or different from each other. This is also applicable to R33 to R36. A content of the unsaturated carbon-bonding cyclic carbonate in the nonaqueous solvent is, for example, 0.01% by mass or more and not more than 10% by mass. However, the unsaturated carbon-bonding cyclic carbonate is not limited to compounds described below but may be other compound.

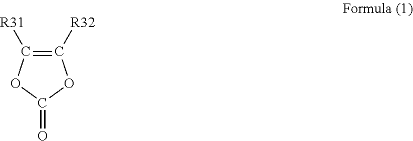

In the formula, each of R31 and R32 independently represents a hydrogen group, a halogen group, an alkyl group, or a halogenated alkyl group.

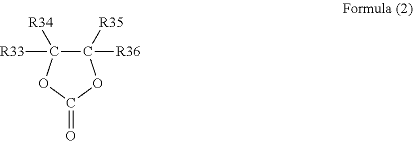

In the formula, each of R33 to R36 independently represents a hydrogen group, an alkyl group, a vinyl group, or an allyl group, provided that at least one of R33 to R36 is a vinyl group or an allyl group.

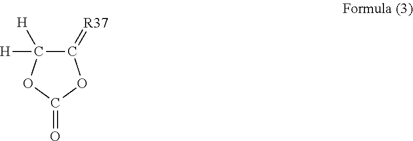

In the formula, R37 represents an alkylene group.

The unsaturated carbon-bonding cyclic carbonate represented by the formula (1) is a vinylene carbonate based compound. Examples of this vinylene carbonate based compound include the following compounds. That is, examples thereof include vinylene carbonate, methyl vinylene carbonate, and ethyl vinylene carbonate. Furthermore, examples thereof include 4,5-dimethyl-1,3-dioxol-2-one, 4,5-diethyl-1,3-dioxol-2-one, 4-fluoro-1,3-dioxol-2-one, and 4-trifluoromethyl-1,3-dioxol-2-one. Of these, vinylene carbonate is preferable. This is because not only this material is easily available, but high effects are obtainable.

The unsaturated carbon-bonding cyclic carbonate represented by the formula (2) is a vinyl ethylene carbonate based compound. Examples of this vinyl ethylene carbonate based compound include the following compounds. That is, examples thereof include vinyl ethylene carbonate, 4-methyl-4-vinyl-1,3-dioxolan-2-one, and 4-ethyl-4-vinyl-1,3-dioxolan-2-one. Furthermore, examples thereof include 4-n-propyl-4-vinyl-1,3-dioxolan-2-one, 5-methyl-4-vinyl-1,3-dioxolan-2-one, 4,4-divinyl-1,3-dioxolan-2-one, and 4,5-divinyl-1,3-dioxolan-2-one. Of these, vinyl ethylene carbonate is preferable. This is because not only this material is easily available, but high effects are obtainable. As a matter of course, as to R33 to R36, all of them may be a vinyl group or an allyl group, or a vinyl group and an allyl group may be mixed together.

The unsaturated carbon-bonding cyclic carbonate represented by the formula (3) is a methylene ethylene carbonate based compound. Examples of this methylene ethylene carbonate based compound include the following compounds. That is, examples thereof include 4-methylene-1,3-dioxolan-2-one, 4,4-dimethyl-5-methylene-1,3-dioxolan-2-one, and 4,4-diethyl-5-methylene-1,3-dioxolan-2-one. This methylene ethylene carbonate based compound may also be a compound having two methylene groups in addition to a compound having one methylene group as represented by the formula (3).

Incidentally, in addition to the compounds represented by the formulae (1) to (3), the unsaturated carbon-bonding cyclic carbonate may be a catechol carbonate having a benzene ring, or the like.

Also, it is preferable that the nonaqueous solvent contains at least one member of a halogenated chain carbonate represented by the following formula (4) and a halogenated cyclic carbonate represented by following formula (5). This is because a stable protective film is formed on the surface of the electrode at the time of charge and discharge of the nonaqueous electrolyte battery, and therefore, a decomposition reaction of the nonaqueous electrolytic solution is inhibited. This halogenated chain carbonate is a chain carbonate containing a halogen as a constituent element, and this halogenated cyclic carbonate is a cyclic carbonate containing a halogen as a constituent element. Incidentally, R41 to R46 in the formula (4) may be a group the same as or different from each other. This is also applicable to R47 to R50 in the formula (5). A content of the halogenated chain carbonate or halogenated cyclic carbonate in the nonaqueous solvent is, for example, 0.01% by mass or more and not more than 50% by mass. However, the halogenated chain carbonate or halogenated cyclic carbonate is not limited to compounds described below but may be other compound.

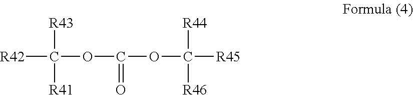

In the formula, each of R41 to R46 independently represents a hydrogen group, a halogen group, an alkyl group, or a halogenated alkyl group, provided that at least one of R41 to R46 is a halogen group or a halogenated alkyl group.

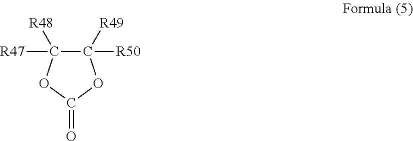

In the formula, each of R47 to R50 independently represents a hydrogen group, a halogen group, an alkyl group, or a halogenated alkyl group, provided that at least one or R47 to R50 is a halogen group or a halogenated alkyl group.

The kind of the halogen is not particularly limited. Above all, fluorine, chlorine, and bromine are preferable, and fluorine is more preferable. This is because higher effects than those of other halogens are obtainable. However, as to the number of halogens, 2 is more preferable than 1, and furthermore, the number of halogens may be 3 or more. This is because in the case of using the nonaqueous electrolytic solution for the nonaqueous electrolyte battery, at the time of an electrode reaction, the capability of forming a protective film on the surface of the electrode becomes high, and a firmer and more stable protective film is formed, and therefore, a decomposition reaction of the electrolytic solution is more inhibited.

Examples of the halogenated chain carbonate include fluoromethylmethyl carbonate, bis(fluoromethyl)carbonate, and difluoromethylmethyl carbonate.

Examples of the halogenated cyclic carbonate include compounds represented by the following formulae (5-1) to (5-21). That is, examples thereof include 4-fluoro-1,3-dioxolan-2-one of the formula (5-1), 4-chloro-1,3-dioxolan-2-one of the formula (5-2), and 4,5-difluoro-1,3-dioxolan-2-one of the formula (5-3). Furthermore, examples thereof include tetrafluoro-1,3-dioxolan-2-one of the formula (5-4), 4-chloro-5-fluoro-1,3-dioxolan-2-one of the formula (5-5), and 4,5-dichloro-1,3-dioxolan-2-one of the formula (5-6). Furthermore, examples thereof include tetrachloro-1,3-dioxolan-2-one of the formula (5-7), 4,5-bistrifluoromethyl-1,3-dioxolan-2-one of the formula (5-8), and 4-trifluoromethyl-1,3-dioxolan-2-one of the formula (5-9). Furthermore, examples thereof include 4,5-difluoro-4,5-dimethyl-1,3-dioxolan-2-one of the formula (5-10) and 4,4-difluoro-5-methyl-1,3-dioxolan-2-one of the formula (5-11). Furthermore, examples thereof include 4-ethyl-13-6-difluoro-1,3-dioxolan-2-one of the formula (5-12), 4-fluoro-5-trifluoromethyl-1,3-dioxolan-2-one of the formula (5-13), and 4-methyl-5-trifluoromethyl-1,3-dioxolan-2-one of the formula (5-14). Furthermore, examples thereof include 4-fluoro-4,5-dimethyl-1,3-dioxolan-2-one of the formula (5-15) and 5-(1,1,1-fluoroethyl)-4,4-difluoro-1,3-dioxolan-2-one of the formula (5-16). Furthermore, examples thereof include 4,5-dichloro-4,5-dimethyl-1,3-dioxolan-2-one of the formula (5-17), 4-ethyl-5-fluoro-1,3-dioxolan-2-one of the formula (5-18), and 4-ethyl-4,5-difluoro-1,3-dioxolan-2-one of the formula (5-19). Furthermore, examples thereof include 4-ethyl-4,13-6-trifluoro-1,3-dioxolan-2-one of the formula (5-20) and 4-fluoro-4-methyl-1,3-dioxolan-2-one of the formula (5-21).

These halogenated cyclic carbonates also include geometric isomers thereof. Above all, 4-fluoro-1,3-dioxolan-2-one represented by the formula (5-1) and 4,5-difluoro-1,3-dioxolan-2-one represented by the formula (5-3) are preferable, with the latter being more preferable. In particular, in 4,5-difluoro-1,3-dioxolan-2-one, a trans isomer is more preferable than a cis isomer. This is because not only this material is easily available, but high effects are obtainable.

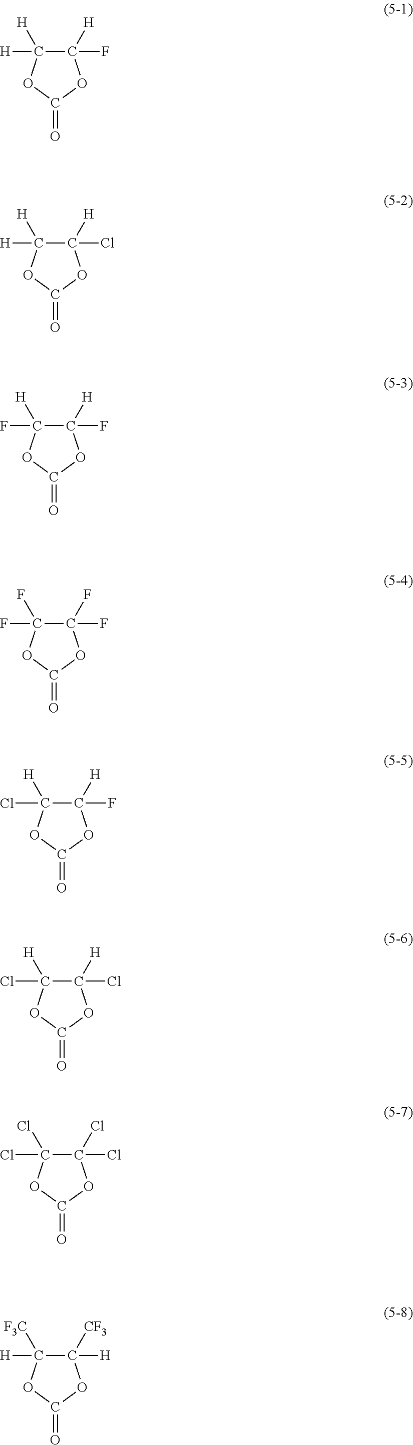

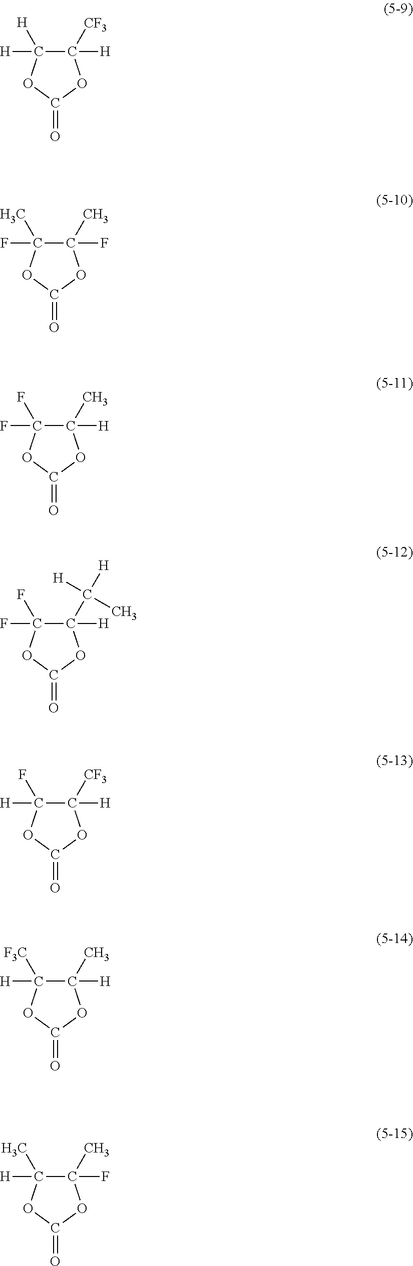

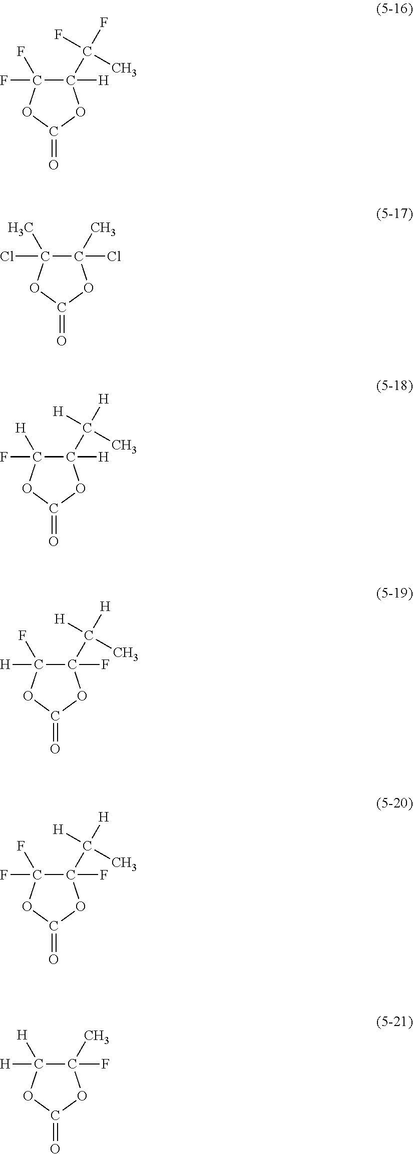

Also, it is preferable that the nonaqueous solvent contains a sultone (cyclic sulfonate). This is because the chemical stability of the nonaqueous electrolytic solution is more enhanced. Examples of this sultone include propane sultone and propene sultone. A content of the sultone in the nonaqueous solvent is, for example, from 0.5% by mass or more and not more than 5% by mass. However, the sultone is not limited to the foregoing compounds but may be other compound.

Furthermore, it is preferable that the nonaqueous solvent contains an acid anhydride. This is because the chemical stability of the nonaqueous electrolytic solution is more enhanced. Examples of the acid anhydride include a carboxylic acid anhydride, a disulfonic anhydride, and an acid anhydride between a carboxylic acid and a sulfonic acid. Examples of the carboxylic acid anhydride include succinic anhydride, glutaric anhydride, and maleic anhydride. Examples of the disulfonic anhydride include ethanedisulfonic anhydride and propanedisulfonic anhydride. Examples of the acid anhydride between a carboxylic acid and a sulfonic acid include sulfobenzoic anhydride, sulfopropionic anhydride, and sulfobutyric anhydride. A content of the acid anhydride in the nonaqueous solvent is, for example, from 0.5% by mass or more and not more than 5% by mass. However, the acid anhydride is not limited to the foregoing compounds but may be other compound.

Similarly, it is preferable that the nonaqueous solvent contains a nitrile compound. This is because the chemical stability of the nonaqueous electrolytic solution is more enhanced. Examples of this nitrile compound include succinonitrile, acetonitrile, glutaronitrile, adiponitrile, methoxyacetonitrile, and 3-methoxypropionitrile. A content of the nitrile compound in the nonaqueous solvent is, for example, from 0.5% by mass or more and not more than 5% by mass. However, the nitrile compound is not limited to the foregoing compounds but may be other compound.

### [Electrolyte Salt]

For example, the electrolyte salt contains anyone kind or two or more kinds of light metal salts such as a lithium salt. However, the electrolyte salt may be other salt than the light metal salt.

Examples of the lithium salt include the following materials. That is, examples thereof include lithium hexafluorophosphate (LiPF₆), lithium tetrafluoroborate (LiBF₄), lithium perchlorate (LiClO₄), and lithium hexafluoroarsenate (LiAsFO₆). Furthermore, examples thereof include lithium tetraphenylborate (LiB(C₆H₅)₄), lithium methanesulfonate (LiCH₃SO₃), lithium trifluoromethanesulfonate (LiCF₃SO₃), and lithium tetrachloroaluminate (LiAlCl₄). Furthermore, examples thereof include dilithium hexafluorosilicate (Li₂SiF₆), lithium chloride (LiCl), and lithium bromide (LiBr). Furthermore, examples thereof include lithium monofluorophosphate (LiPFO₃) and lithium difluorophosphate (LiPF₂O₂). This is because in the nonaqueous electrolyte battery using a nonaqueous electrolytic solution, excellent battery capacity, cycle characteristics and storage characteristics, and the like are obtainable. However, the electrolyte salt is not limited to the foregoing compounds but may be other compound.

Above all, at least one member of lithium hexafluorophosphate, lithium tetrafluoroborate, lithium perchlorate, and lithium hexafluoroarsenate is preferable, with lithium hexafluorophosphate being more preferable. This is because an internal resistance is lowered, and a higher effect for enhancing battery characteristics is obtainable.

Incidentally, in the case of using lithium tetrafluoroborate (LiBF₄) as the compound according to the present technology, it is preferable to use, as the electrolyte salt, other compound than lithium tetrafluoroborate (LiBF₄).

A content of the electrolyte salt is preferably from 0.3 moles/kg to 3.0 moles/kg relative to the nonaqueous solvent. This is because high ionic conductivity is obtainable.

### (1-2) Gel Electrolyte:

As other constitution, a gel electrolyte in which the foregoing nonaqueous electrolytic solution is held by a polymer compound to form a gel can also be adopted.

### [Polymer Compound]

The polymer compound may be a compound capable of absorbing the solvent to form a gel. Examples thereof include a fluorine based polymer compound such as polyvinylidene fluoride and a copolymer of vinylidene fluoride and hexafluoropropylene; an ether based polymer compound such as polyethylene oxide and a crosslinked material containing polyethylene oxide or polyethylene oxide; and a polymer compound containing, as a repeating unit, polyacrylonitrile, polypropylene oxide, or polymethyl methacrylate. The polymer compound may be used singly or in admixture of two or more kinds thereof.

In particular, from the standpoint of redox stability, a fluorine based polymer compound is desirable. Above all, a copolymer containing vinylidene fluoride and hexafluoropropylene as components is preferable. Furthermore, this copolymer may contain, as a component, an unsaturated dibasic acid monoester such as monomethyl maleate, a halogenated ethylene such as trifluorochloroethylene, a cyclic carbonate of an unsaturated compound such as vinylene carbonate, an epoxy group-containing acrylic vinyl monomer, or the like. This is because higher characteristics are obtainable.

Incidentally, a method for forming an electrolyte layer in a gel form is described later.

### [Effect]

By applying the nonaqueous electrolyte of the first embodiment to a nonaqueous electrolyte battery, a high effect for inhibiting a lowering of load characteristics after the overcharge can be obtained.

### 2. Second Embodiment

In a second embodiment, a nonaqueous electrolyte battery of a cylindrical type using the nonaqueous electrolytic solution or gel electrolyte according to the first embodiment is described.

### (2-1) Configuration of Nonaqueous Electrolyte Battery:

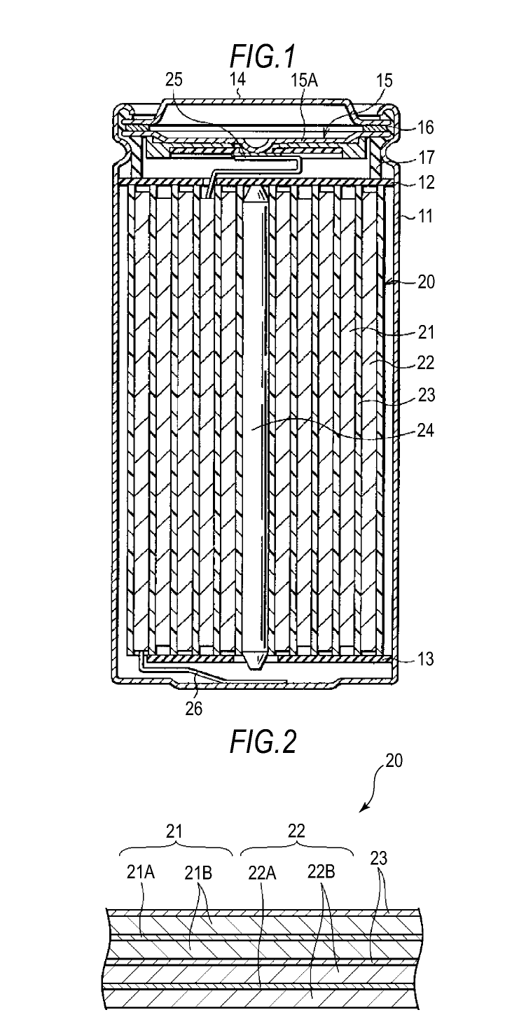

FIG. 1 illustrates a sectional structure of a nonaqueous electrolyte battery according to the second embodiment. This nonaqueous electrolyte battery is, for example, a lithium ion secondary battery.

This nonaqueous electrolyte battery is of a so-called cylindrical type and has a wound electrode body 20 having a pair of a strip-shaped positive electrode 21 and a strip-shaped negative electrode 22 wound via a separator 23 in the inside of a substantially hollow columnar battery can 11. The battery can 11 is, for example, constituted of nickel-plated iron, and one end thereof is closed, with the other end being opened. In the inside of the battery can 11, a pair of insulating plates 12 and 13 is respectively disposed vertical to the winding peripheral face so as to interpose the wound electrode body 20 therebetween.

In the open end of the battery can 11, a battery lid 14 is installed by caulking with a safety valve mechanism 15 and a positive temperature coefficient device (PTC device) 16 provided in the inside of this battery lid 14 via a gasket 17, and the inside of the battery can 11 is hermetically sealed. The battery lid 14 is, for example, constituted of the same material as that in the battery can 11. The safety valve mechanism 15 is electrically connected to the battery lid 14 via the positive temperature coefficient device 16. In this safety valve mechanism 15, when the internal pressure of the battery reaches a fixed value or more due to an internal short circuit or heating from the outside or the like, a disc plate 15A is reversed, whereby electrical connection between the battery lid 14 and the wound electrode body 20 is disconnected. When the temperature increases, the positive temperature coefficient device 16 controls the current by an increase of the resistance value, thereby preventing abnormal heat generation to be caused due to a large current from occurring. The gasket 17 is, for example, constituted of an insulating material, and asphalt is coated on the surface thereof.

For example, a center pin 24 is inserted on the center of the wound electrode body 20. In the wound electrode body 20, a positive electrode lead 25 made of aluminum or the like is connected to the positive electrode 21; and a negative electrode lead 26 made of nickel or the like is connected to the negative electrode 22. The positive electrode lead 25 is electrically connected to the battery lid 14 by means of welding to the safety valve mechanism 15; and the negative electrode lead 26 is electrically connected to the battery can 11 by means of welding.

FIG. 2 illustrates enlargedly a part of the wound electrode body 20 shown in FIG. 1. In the second embodiment, the same positive electrode active material as the positive electrode active material in the first embodiment can be used. The positive electrode 21, the negative electrode 22, and the separator 23 are hereunder described in detail.

### [Positive Electrode]

The positive electrode 21 has, for example, a structure in which a positive electrode active material layer 21B is provided on the both surfaces of a positive electrode collector 21A having a pair of surfaces opposing to each other. While illustration is omitted, the positive electrode active material layer 21B may be provided on only one surface of the positive electrode collector 21A. The positive electrode collector 21A is, for example, constituted of a metal foil such as an aluminum foil.

The positive electrode active material 21B is, for example, constituted to contain a positive electrode active material, an electrically conductive agent, and a binder. As the positive electrode active material, any one kind or two or more kinds of positive electrode materials capable of intercalating and deintercalating lithium as a positive electrode active material are contained, and other materials such as a binder and an electrically conductive agent may be contained, if desired.

As the positive electrode material capable of intercalating and deintercalating lithium, lithium-containing compounds such as a lithium oxide, a lithium phosphate, a lithium sulfide, and an intercalation compound containing lithium are suitable. A mixture of two or more kinds thereof may be used. In order to increase the energy density, lithium-containing compounds containing lithium, a transition metal element, and oxygen (O) are preferable. Examples of such a lithium-containing compound include a lithium complex oxide having a structure of a layered rock salt represented by the following formula (I); and a lithium complex phosphate having a structure of an olivine type represented by the following formula (II). As the lithium-containing compound, those containing, as the transition metal element, at least one member selected from the group consisting of cobalt (Co), nickel (Ni), manganese (Mn), and iron (Fe) are more preferable. Examples of such a lithium-containing compound include a lithium complex oxide having a structure of a layered rock salt type represented by the following formula (III), (IV) or (V); a lithium complex oxide having a structure of a spinel type represented by the following formula (VI); and a lithium complex phosphate having a structure of an olivine type represented by the following formula (VII). Specific examples thereof include LiNi_{0.50}Co_{0.20}Mn_{0.30}O₂, LiₐCoO₂ (a≅1), Li_{b}NiO₂ (b≅1), Li_{c1}Ni_{c2}Co_{1-c2}O₂ (c1≅1, 0<c2<1), Li_{d}Mn₂O₄ (d≅1), and LiₑFₑPO₄ (e≅1).

LiₚNi_{(1-q-r)}Mn_{q}M1ᵣO_{(2-y)}X_{z} Formula (I)

In the formula, M1 represents at least one member selected from the group consisting of elements of Groups 2 to 15 other than nickel (Ni) and manganese (Mn); X represents at least one member selected from the group consisting of a Group 16 element and a Group 17 element other than oxygen (O); and p, q, r, y, and z are values falling within the ranges of 0≦p≦1.5, 0≦q≦1.0, 0≦r≦1.0, −0.10≦y≦0.20, and 0≦z≦0.2, respectively.

LiₐM2_{b}PO₄ Formula (II)

In the formula, M2 represents at least one member selected from the group consisting of elements of Groups 2 to 15; and a and b are values falling within the ranges of 0≦a≦2.0 and 0.5≦b≦2.0, respectively.

Li_{f}Mn_{(1-g-h)}Ni_{g}M3ₕO₍₂₋ⱼ₎Fₖ Formula (III)

In the following, M3 represents at least one member selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); and f, g, h, j, and k are values falling within the ranges of 0.8≦f≦1.2, 0<g<0.5, 0≦h≦0.5, (g+h)<1, −0.1≦j≦0.2, and 0≦k≦0.1, respectively. Incidentally, the composition of lithium varies depending upon the state of charge and discharge; and the value of f represents a value in a completely discharged state.

LiₘNi₍₁₋ₙ₎M4ₙO₍₂₋ₚ₎F_{q} Formula (IV)

In the formula, M4 represents at least one member selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); and m, n, p, and q represent values falling within the ranges of 0.8≦m≦1.2, 0.005≦n≦0.5, −0.1≦p≦0.2, and 0≦q≦0.1, respectively. Incidentally, the composition of lithium varies depending upon the state of charge and discharge, and the value of m represents a value in a completely discharged state.

LiᵣCo₍₁₋ₛ₎M5ₛO₍₂₋ₜ₎Fᵤ Formula (V)

In the formula, M5 represents at least one member selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); and r, s, t, and u represent values falling within the ranges of 0.8≦r≦1.2, 0≦s<0.5, −0.1≦t≦0.2, and 0≦u≦0.1, respectively. Incidentally, the composition of lithium varies depending upon the state of charge and discharge, and the value of r represents a value in a completely discharged state.

LiᵥMn_{(2-w)}M6_{w}OₓF_{y} Formula (VI)

In the formula, M6 represents at least one member selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); and v, w, x, and y represent values falling within the ranges of 0.9≦v≦1.1, 0≦w≦0.6, 3.7≦x≦4.1, and 0≦y≦0.1, respectively. Incidentally, the composition of lithium varies depending upon the state of charge and discharge, and the value of v represents a value in a completely discharged state.

Li_{z}M7PO₄ Formula (VII)

In the formula, M7 represents at least one member selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr); and z represents a value falling within the range of 0.9≦z≦1.1. Incidentally, the composition of lithium varies depending upon the state of charge and discharge, and the value of z represents a value in a completely discharged state.

Moreover, from the viewpoint that higher electrode filling properties and cycle characteristics are obtainable, lithium may be formed as a complex particle obtained by coating the surface of a core particle composed of any one of the foregoing lithium-containing compounds by a fine particle composed of any one of other lithium-containing compounds.

Besides, examples of the positive electrode material capable of intercalating and deintercalating lithium ion include an oxide, a disulfide, a chalcogenide, and an electrically conductive polymer. Examples of the oxide include vanadium oxide (V₂O₅), titanium dioxide (TiO₂), and manganese dioxide (MnO₂). Examples of the disulfide include disulfides such as iron disulfide (FeS₂), titanium disulfide (TiS₂), and molybdenum disulfide (MoS₂). The chalcogenide is especially preferably a layered compound and a spinel type compound, and examples thereof include niobium diselenide (NbSe₂). Examples of the electrically conductive polymer include sulfur, polyaniline, polythiophene, polyacetylene, and polypyrrole. As a matter of course, the positive electrode material may be other material than those described above. Also, the foregoing series of positive electrode materials may be arbitrarily combined and used in admixture of two or more kinds thereof.

Also, examples of the electrically conductive agent which is used include a carbon material such as carbon black and graphite. As the binder, at least one member selected from the group consisting of a resin material such as polyvinylidene fluoride (PVdF), polytetrafluoroethylene (PTFE), polyacrylonitrile (PAN), a styrene-butadiene rubber (SBR), and carboxymethyl cellulose (CMC) and a copolymer composed mainly of such a resin material is used.

### [Negative Electrode]

The negative electrode 22 has, for example, a structure in which a negative electrode active material layer 22B is provided on the both surfaces of a negative electrode collector 22A having a pair of surfaces opposing to each other. While illustration is omitted, the negative electrode active material layer 22B may be provided on only one surface of the negative electrode collector 22A.

The negative electrode collector 22A is, for example, constituted of a metal foil such as a copper (Cu) foil, a nickel (Ni) foil, and a stainless steel (SUS) foil. It is preferable that the surface of this negative electrode collector 22A is roughed. This is because adhesion between the negative electrode collector 22A and the negative electrode active material layer 22B is enhanced due to a so-called anchor effect. In that case, the surface of the negative electrode collector 22A may be roughed in at least a region opposing to the negative electrode active material layer 22B. Examples of a method for achieving roughing include a method for forming fine particles by an electrolysis treatment. This electrolysis treatment as referred to herein is a method in which fine particles are formed on the surface of the negative electrode collector 22A in an electrolysis vessel by means of electrolysis, thereby providing recesses and projections. A copper foil which is fabricated by the electrolysis is generally named as “electrolytic copper foil”. Incidentally, the surface roughness of the negative electrode collector 22A may be arbitrarily set up.

The negative electrode active material layer 22B is, for example, constituted to contain any one kind or two or more kinds of negative electrode materials capable of intercalating and deintercalating lithium as a negative electrode active material, and it is constituted to contain the same electrically conductive agent and binder as those in the positive electrode active material layer 21B, if desired.

Incidentally, in this nonaqueous electrolyte battery, an electrochemical equivalent of the negative electrode material capable of intercalating and deintercalating lithium is larger than an electrochemical equivalent of the positive electrode 21, and a lithium metal does not theoretically deposit on the negative electrode 22 on the way of charge.

Also, this nonaqueous electrolyte battery is designed in such a manner that an open circuit voltage (namely, a battery voltage) in a completely charged state falls within the range of, for example, 4.20 V or more and not more than 6.00 V. Also, for example, it is preferable that the open circuit voltage in a fully charged state is 4.25 V or more and not more than 6.00 V. When the open circuit voltage in a fully charged state is 4.25 V or more, in comparison with a 4.20-V battery, even when the same positive electrode active material is concerned, a deintercalation amount of lithium per unit mass is large, and therefore, the amounts of the positive electrode material and the negative electrode material are regulated in response thereto. According to this, a high energy density is obtainable.

Examples of the negative electrode material capable of intercalating and deintercalating lithium include carbon materials such as hardly graphitized carbon, easily graphitized carbon, graphite, pyrolytic carbons, cokes, vitreous carbons, organic polymer compound calcined materials, carbon fibers, and active carbon. Of these, examples of the cokes include pitch coke, needle coke, and petroleum coke. The organic polymer compound calcined material as referred to herein is a material obtained through carbonization by calcining a polymer material such as phenol resins and furan resins at an appropriate temperature, and a part thereof is classified into hardly graphitized carbon or easily graphitized carbon. Such a carbon material is preferable because a change in the crystal structure to be generated at the time of charge and discharge is very small, a high charge and discharge capacity is obtainable, and satisfactory cycle characteristics are obtainable. In particular, graphite is preferable because its electrochemical equivalent is large, and a high energy density is obtainable. Also, hardly graphitized carbon is preferable because excellent cycle characteristics are obtainable. Moreover, a material having a low charge and discharge potential, specifically one having a charge and discharge potential close to a lithium metal, is preferable because a high energy density of the battery can be easily realized.

Examples of the negative electrode material capable of intercalating and deintercalating lithium also include a material capable of intercalating and deintercalating lithium and containing, as a constituent element, at least one member selected from the group consisting of metal elements and semi-metal elements. This is because by using such a material, a high energy density is obtainable. In particular, the joint use of such a material with the carbon material is more preferable because not only a high energy density is obtainable, but excellent cycle characteristics are obtainable. This negative electrode material may be a simple substance, an alloy, or a compound of a metal element or a semi-metal element. Also, the negative electrode material may be an electrode material having one or two or more kinds of such a phase in at least a part thereof. Incidentally, in the present technology, the alloy includes alloys containing at least one metal element and at least one semi-metal element in addition to alloys composed of two or more metal elements. Also, the negative electrode material may contain a non-metal element. Examples of its texture include a solid solution, a eutectic (eutectic mixture), an intermetallic compound, and one in which two or more thereof coexist.

Examples of the metal element or semi-metal element which constitutes this negative electrode material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). These may be crystalline or amorphous.

Of these, ones containing, as a constituent element, a metal element or a semi-metal element belonging to the Group 4B in the short form of the periodic table are preferable, and ones containing, as a constituent element, at least one of silicon (Si) and tin (Sn) are especially preferable as this negative electrode material. This is because silicon (Si) and tin (Sn) have large capability of intercalating and deintercalating lithium, and a high energy density is obtainable.

Examples of alloys of tin (Sn) include alloys containing, as a second constituent element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). Examples of alloys of silicon (Si) include alloys containing, as a second constituent element other than silicon (Si), at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

Examples of compounds of tin (Sn) or compounds of silicon (Si) include compounds containing oxygen (O) or carbon (C), and these compounds may contain the foregoing second constituent element in addition to tin (Sn) or silicon (Si).

Of these, SnCoC-containing materials containing tin (Sn), cobalt (Co), and carbon (C) as constituent elements and having a content of carbon of 9.9% by mass or more and not more than 29.7% by mass and a proportion of cobalt (Co) of 30% by mass or more and not more than 70% by mass relative to the total sum of tin (Sn) and cobalt (Co) are preferable as this negative electrode material. This is because in the foregoing composition range, not only a high energy density is obtainable, but excellent cycle characteristics are obtainable.

This SnCoC-containing material may further contain other constituent element, if desired. As such other constituent element, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), or bismuth (Bi) is preferable, and two or more kinds of these elements may be contained. This is because the capacity or cycle characteristics can be more enhanced.

Incidentally, this SnCoC-containing material has a phase containing tin, cobalt, and carbon, and it is preferable that this phase has a low crystalline or amorphous structure. Also, in this SnCoC-containing material, it is preferable that at least a part of carbon (C) that is the constituent element is bound to the metal element or semi-metal element that is other constituent element. This is because though it may be considered that a lowering of the cycle characteristics is caused due to aggregation or crystallization of tin (Sn) or the like, when carbon (C) is bound to other element, such aggregation or crystallization can be suppressed.

Examples of a measurement method for examining the binding state of elements include X-ray photoelectron spectroscopy (XPS). In this XPS, so far as graphite is concerned, a peak of the 1s orbit (C1s) of carbon appears at 284.5 eV in an energy-calibrated apparatus such that a peak of the 4f orbit of a gold atom (Au4f) is obtained at 84.0 eV. Also, so far as surface contamination carbon is concerned, a peak of the 1s orbit (C1s) of carbon appears at 284.8 eV. On the contrary, in the case where a charge density of the carbon element is high, for example, when carbon is bound to a metal element or a semi-metal element, the peak of C1s appears in a lower region than 284.5 eV. That is, when a peak of a combined wave of C1s obtained regarding the SnCoC-containing material appears in a lower region than 284.5 eV, at least a part of carbon contained in the SnCoC-containing material is bound to a metal element or a semi-metal element as other constituent element.

Incidentally, in the XPS measurement, for example, the peak of C1s is used for correcting the energy axis of a spectrum. In general, since surface contamination carbon exists on the surface, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of carbon in the SnCoC-containing material, the peak of the surface contamination carbon and the peak of the carbon in the SnCoC-containing material are separated from each other by means of analysis using, for example, a commercially available software program. In the analysis of the waveform, the position of a main peak existing on the lowest binding energy side is used as an energy reference (284.8 eV).

### [Separator]

The separator 23 partitions the positive electrode 21 and the negative electrode 22 from each other and allows a lithium ion to pass therethrough while preventing a short circuit of the current to be caused due to the contact of the both electrodes from occurring. The separator 23 is, for example, constituted of a porous film made of a synthetic resin such as polytetrafluoroethylene, polypropylene, and polyethylene; or a porous film made of a ceramic. The separator 23 may have a structure in which two or more kinds of such a porous film are laminated.

The separator 23 is impregnated with a nonaqueous electrolytic solution that is a liquid nonaqueous electrolyte. This nonaqueous electrolytic solution contains a nonaqueous solvent and an electrolyte salt dissolved in this nonaqueous solvent.

The separator 23 is constituted so as to contain anyone of polypropylene (PP), polyvinylidene fluoride (PVdF), or polytetrafluoroethylene (PTFE) other than polyethylene. Also, the separator 23 may be constituted of a porous film made of a ceramic, and a mixture of several kinds among polyethylene (PE), polypropylene (PP), and polytetrafluoroethylene (PTFE) may be used as a porous film. Furthermore, polyvinylidene fluoride (PVdF) and a ceramic such as alumina (Al₂O₃) and silica (SiO₂) may be coated on the surface of a porous film made of polyethylene (PE), polypropylene (PP), or polytetrafluoroethylene (PTFE). Also, a structure in which two or more kinds of a porous film of polyethylene (PE), polypropylene (PP), or polytetrafluoroethylene (PTFE) are laminated may be used. A porous film made of a polyolefin is preferable because it is excellent in an effect for preventing a short circuit from occurring and is able to contrive to enhance the safety of a battery due to a shutdown effect.

### [Nonaqueous Electrolytic Solution or Gel Electrolyte]

For the nonaqueous electrolytic solution, the nonaqueous electrolytic solution of the first embodiment can be used. Also, a gel electrolyte having a nonaqueous electrolytic solution held by a matrix polymer may be used.

### (2-2) Manufacturing Method of Nonaqueous Electrolyte Battery

### [Manufacturing Method of Positive Electrode]

A positive electrode active material, an electrically conductive agent, and a binder are mixed to prepare a positive electrode mixture, and this positive electrode mixture is dispersed in a solvent such as N-methyl-2-pyrrolidone to prepare a positive electrode mixture slurry in a paste form. Subsequently, this positive electrode mixture slurry is coated on the positive electrode collector 21A, and the solvent is dried. The resultant is compression molded by a roll press or the like to form the positive electrode active material layer 21B. There is thus fabricated the positive electrode 21.

### [Manufacturing Method of Negative Electrode]

A negative electrode active material and a binder are mixed to prepare a negative electrode mixture, and this negative electrode mixture is dispersed in a solvent such as N-methyl-2-pyrrolidone to prepare a negative electrode mixture slurry in a paste form. Subsequently, this negative electrode mixture slurry is coated on the negative electrode collector 22A, and the solvent is dried. The resultant is compression molded by a roll press or the like to form the negative electrode active material layer 22B. There is thus fabricated the negative electrode 22.

### [Preparation of Nonaqueous Electrolytic Solution]

The nonaqueous electrolytic solution is prepared by dissolving an electrolyte salt in a nonaqueous solvent.

### [Assembling of Nonaqueous Electrolyte Battery]

The positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23 to form the wound electrode body 20. A tip end of the positive electrode lead 25 is welded to the safety valve mechanism 15; a tip end of the negative electrode lead 26 is also welded to the battery can 11. Thereafter, the wound surface of the wound electrode body 20 is interposed between a pair of the insulating plates 12 and 13 and housed in the inside of the battery can 11. After housing the wound electrode body 20 is housed in the inside of the battery can 11, the electrolytic solution is injected into the inside of the battery can 11 and impregnated in the separator 23. Thereafter, the battery lid 14, the safety valve mechanism 15, and the positive temperature coefficient device 16 are fixed to the open end of the battery can 11 upon being caulked via the gasket 17. According to this, there is formed the nonaqueous electrolyte battery shown in FIG. 1.

In this nonaqueous electrolyte battery, when charged, for example, a lithium ion is deintercalated from the positive electrode active material layer 21B and intercalated in the negative electrode active material layer 22B via the nonaqueous electrolytic solution. Also, when discharged, for example, a lithium ion is deintercalated from the negative electrode active material layer 22B and intercalated in the positive electrode active material layer 21B via the nonaqueous electrolytic solution.

### [Effects]

According to the nonaqueous electrolyte battery of the second embodiment, a high effect for inhibiting a lowering of load characteristics after the overcharge can be obtained.

### 3. Third Embodiment

In a third embodiment, a nonaqueous electrolyte battery of a laminated film type using the nonaqueous electrolyte of the first embodiment is described. In the third embodiment, an example using a gel electrolyte is described.

### (3-1) Configuration of Nonaqueous Electrolyte Battery

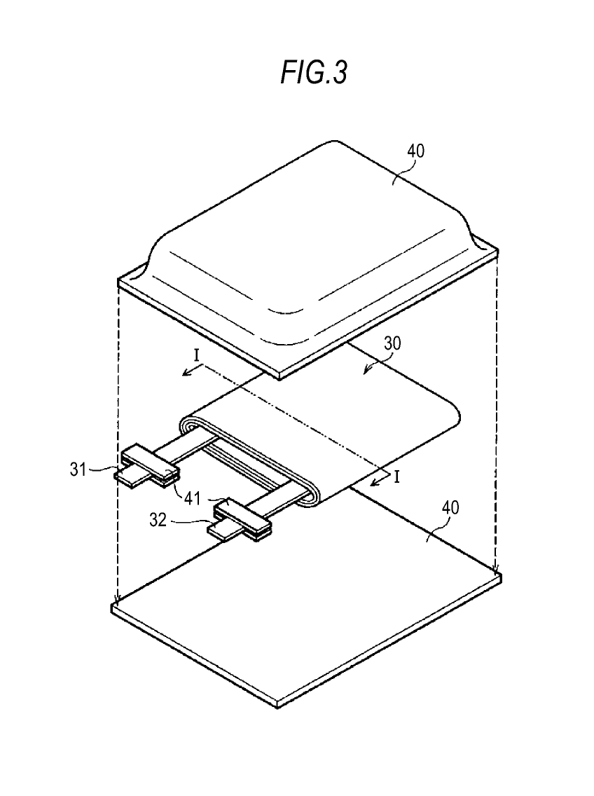

FIG. 3 illustrates a configuration of a nonaqueous electrolyte battery according to the third embodiment. This nonaqueous electrolyte battery is of a so-called laminated film type and is one in which a wound electrode body 30 having a positive electrode lead 31 and a negative electrode lead 32 installed therein is housed in the inside of a film-shaped package member 40.

The positive electrode lead 31 and the negative electrode lead 32 are each led out in, for example, the same direction from the inside of the package member 40 toward the outside thereof. Each of the positive electrode lead 31 and the negative electrode lead 32 is, for example, constituted of a metal material such as aluminum, copper, nickel, and stainless steel and formed in a thin plate state or a network state.

The package member 40 is, for example, composed of a laminated film in which a resin layer is formed on the both surfaces of a metal layer. In the laminated film, an outer resin layer is formed on the surface of the metal layer exposing to the outside of the battery, and an inner resin layer is formed on the inner surface of the battery opposing to a power generating element such as the wound electrode body 30.

The metal layer bears the most important role for preventing invasion of moisture, oxygen, and light to protect the contents, and aluminum (Al) is most frequently used from the standpoints of light weight, elongation, costs, and easiness of processing. The outer resin layer has a beautiful appearance, toughness, flexibility, and the like, and a resin material such as nylon and polyethylene terephthalate (PET) is used. The inner resin layer has a portion which is melted by hear or ultrasonic waves and mutually fused. Therefore, a polyolefin is appropriate, and cast polypropylene (CPP) is frequently used. If desired, an adhesive layer may be provided between the metal layer and the outer resin layer or inner resin layer.

In the package member 40, for example, a recess for housing the wound electrode body 30, which is formed from the inner resin layer side toward the direction of the outer resin layer by means of deep drawing, is provided, and the inner resin layer is disposed opposing to the wound electrode body 30. The opposing inner resin layers of the package member 40 are brought into close contact with each other in an external edge of the recess by means of fusion or the like. A contact film 41 for the purpose of enhancing adhesion between the inner resin layer of the package member 40 and the positive electrode lead 31 or the negative electrode lead 32 each composed of a metal material is disposed between the package member 40 and the positive electrode lead 31 or the negative electrode lead 32. The contact film 41 is composed of a resin material having high adhesion to the metal material, and it is constituted of, for example, a polyolefin resin such as polyethylene, polypropylene, and modified polyethylene or modified polypropylene obtained by modifying such a material.

Incidentally, the package member 40 may be constituted of a laminated film having other structure, a polymer film such as polypropylene, or a metal film in place of the foregoing aluminum laminated film in which a metal layer is composed of aluminum (Al).

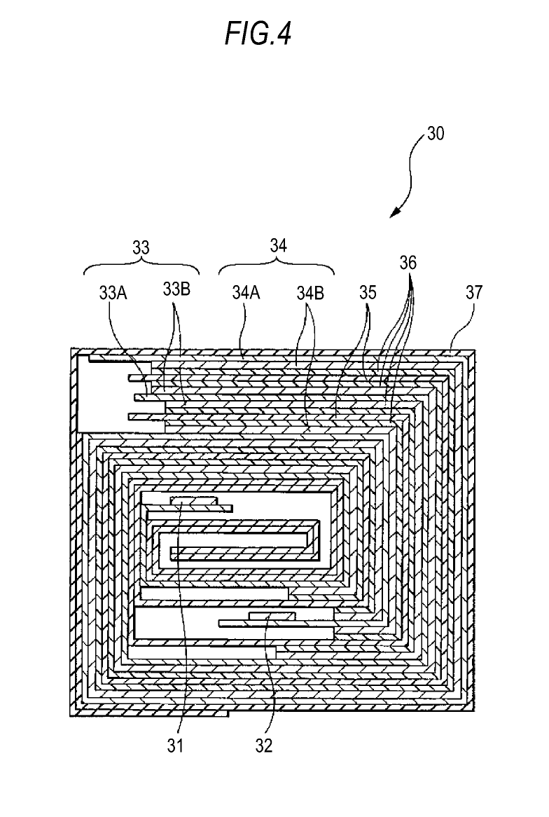

FIG. 4 illustrates a sectional structure of the wound electrode body 30 shown in FIG. 3 along an I-I line. The wound electrode body 30 is one prepared by laminating a positive electrode 33 and a negative electrode 34 via a separator 35 and an electrolyte layer 36 composed of a gel electrolyte and winding the laminate, and an outermost peripheral part thereof is protected by a protective tape 37, as the need arises.

### [Positive Electrode]

The positive electrode 33 has a structure in which a positive electrode active material layer 33B is provided on one surface or both surfaces of a positive electrode collector 33A. The configuration of each of the positive electrode collector 33A and the positive electrode active material layer 33B is the same as the configuration of each of the positive electrode collector 21A and the positive electrode active material layer 21B of the second embodiment.

### [Negative Electrode]

The negative electrode 34 has a structure in which a negative electrode active material layer 34B is provided on one surface or both surfaces of a negative electrode collector 34A, and the negative electrode active material layer 34B and the positive electrode active material layer 33B are disposed opposing to each other. The configuration of each of the negative electrode collector 34A and the negative electrode active material layer 34B is the same as the configuration of each of the negative electrode collector 22A and the negative electrode active material layer 22B in the second embodiment.

### [Separator]

The separator 35 is the same as the separator 23 in the second embodiment.

### [Nonaqueous Electrolyte]

The electrolyte layer 36 is the gel electrolyte described in the first embodiment. The gel electrolyte is preferable because not only a high ionic conductivity is obtainable, but the liquid leakage of the battery can be prevented from occurring. Also, the nonaqueous electrolytic solution may be used as described in the second embodiment.

### (3-2) Manufacturing Method of Nonaqueous Electrolyte Battery

This nonaqueous electrolyte battery can be, for example, manufactured in the following manner.

### [Manufacturing Method of Positive Electrode and Negative Electrode]

Each of the positive electrode 33 and the negative electrode 34 can be fabricated in the same method as that in the second embodiment.

### [Assembling of Nonaqueous Electrolyte Battery]

A precursor solution containing a nonaqueous electrolytic solution, a polymer compound, and a mixed solvent is coated on each of the positive electrode 33 and the negative electrode 34, and the mixed solvent is then vaporized to form the electrolyte layer 36. Thereafter, the positive electrode lead 31 is installed in an end of the positive electrode collector 33A by means of welding, and the negative electrode lead 32 is also installed in an end of the negative electrode collector 34A by means of welding.

Subsequently, the positive electrode 33 and the negative electrode 34 each provided with the electrolyte layer 36 are laminated via the separator 35 to form a laminate, the laminate is then wound in the longitudinal direction thereof, and the protective tape 37 is allowed to adhere to the outermost peripheral part to form the wound electrode body 30. Finally, for example, the wound electrode body 30 is interposed between the package members 40, and the outer edges of the package members 40 are brought into intimate contact with each other by means of heat fusion or the like, thereby sealing the wound electrode body 30. On that occasion, the contact film 41 is inserted between each of the positive electrode lead 31 and the negative electrode lead 32 and the package member 40. According to this, the nonaqueous electrolyte battery shown in FIGS. 3 and 4 is completed.

This nonaqueous electrolyte battery may also be fabricated in the following manner. That is, a composition for electrolyte containing a nonaqueous electrolytic solution, a monomer that is a raw material of the polymer compound, a polymerization initiator, and optionally, other material such as a polymerization inhibitor is prepared and injected into the inside of the package member 40, and thereafter, an opening of the package member 40 is hermetically sealed by means of heat fusion in a vacuum atmosphere. Subsequently, the monomer is polymerized upon heating to form a polymer compound, thereby forming the electrolyte layer 36 in a gel form.

Also, the nonaqueous electrolyte battery may be fabricated in the following manner. That is, a polymer compound is held on the surface of the separator 35, a nonaqueous electrolytic solution is injected into the inside of the package member 40, and thereafter, an opening of the package member 40 is hermetically sealed by means of heat fusion in a vacuum atmosphere. Subsequently, the nonaqueous electrolytic solution is held on the polymer compound upon heating, thereby forming the electrolyte layer 36 in a gel form.

### [Effect]

In the third embodiment, the same effect as that in the second embodiment is obtainable.

### 4. Fourth Embodiment

In a fourth embodiment, a battery pack provided with a nonaqueous electrolyte battery using the nonaqueous electrolyte battery in each of the second embodiment and the third embodiment is described.

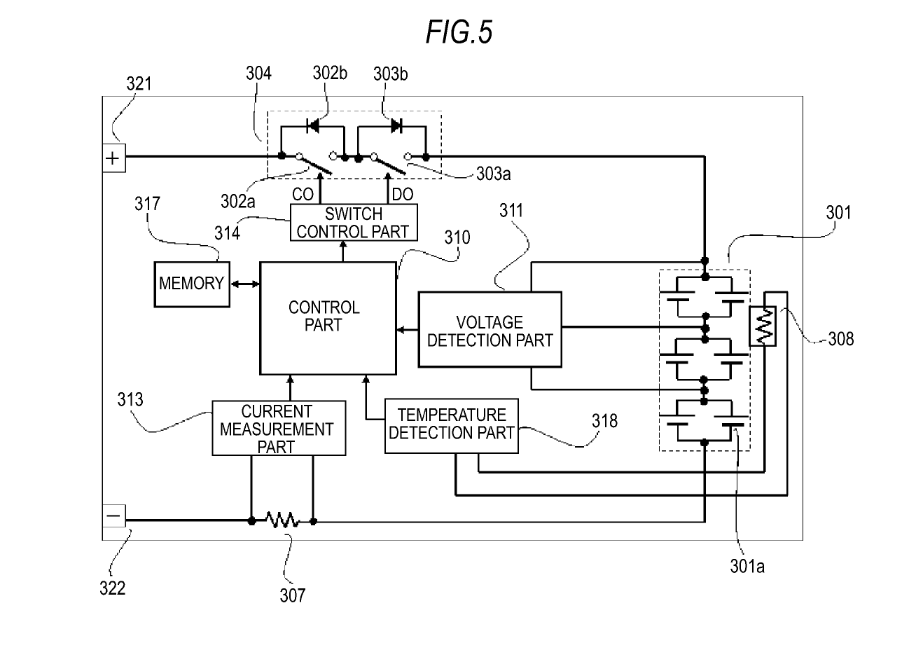

FIG. 5 is a block diagram showing an example of a circuit configuration in the case where the nonaqueous electrolyte battery according to the present technology is applied to a battery pack. The battery pack includes an assembled battery 301, a package, a switch part 304 provided with a charge control switch 302a and a discharge control switch 303a, a current detection resistor 307, a temperature detection device 308, and a control part 310.

Also, the battery pack includes a positive electrode terminal 321 and a negative electrode terminal 322, and at the time of charge, the positive electrode terminal 321 and the negative electrode terminal 322 are connected to a positive electrode terminal and a negative electrode terminal of a battery charger, respectively, whereby charge is carried out. Also, at the time of using an electronic appliance, the positive electrode terminal 321 and the negative electrode terminal 322 are connected to a positive electrode terminal and a negative electrode terminal of the electronic appliance, respectively, whereby discharge is carried out.

In the assembled battery 301, a plurality of nonaqueous electrolyte batteries 301a are connected in series and/or in parallel. This nonaqueous electrolyte battery 301a is the nonaqueous electrolyte battery according to the present technology. Incidentally, in FIG. 5, though the case where six nonaqueous electrolyte batteries 301a are connected to each other, two in parallel and three in series (2P3S) is shown, besides, any connection method such as n in parallel and m in series (each of n and m is an integer) may be adopted.

The switch part 304 includes the charge control switch 302a and a diode 302b and also the discharge control switch 303a and a diode 303b, and is controlled by the control part 310. The diode 302b has a polarity of the reverse direction against a charge current flowing in the direction from the positive electrode terminal 321 to the assembled battery 301 and of the forward direction against a discharge current flowing in the direction from the negative terminal 322 to the assembled battery 301. The diode 303b has a polarity of the forward direction against the charge current and of the reverse direction against the discharge current. Incidentally, in this example, though the switch part is provided on the “+” side, it may also be provided on the “−” side.

In the case where the battery voltage becomes an overcharge detection voltage, the charge control switch 302a is turned off and controlled by a charge and discharge control part in such a manner that the charge current does not flow into a current path of the assembled battery 301. After the charge control switch 302a is turned off, it becomes possible to undergo only discharge by going through the diode 302b. Also, in the case where a large current flows at the time of charge, the charge control switch 302a is turned off and controlled by the control part 310 in such a manner that the charge current which flows into the current path of the assembled battery 301 is interrupted.

In the case where the battery voltage becomes an overdischarge detection voltage, the discharge control switch 303a is turned off and controlled by the control part 310 in such a manner that the discharge current does not flow into the current path of the assembled battery 301. After the discharge control switch 303a is turned off, it becomes possible to undergo only charge by going through the diode 303b. Also, in the case where a large current flows at the time of discharge, the discharge control switch 303a is turned off and controlled by the control part 310 in such a manner that the discharge current which flows into the current path of the assembled battery 301 is interrupted.

The temperature detection device 308 is, for example, a thermistor and is provided in the vicinity of the assembled battery 301, and it measures a temperature of the assembled battery 301 and supplies the measured temperature to the control part 310. A voltage detection part 311 measures voltages of the assembled battery 301 and the respective nonaqueous electrolyte batteries 301a constituting the assembled battery 301, and it A/D converts this measured voltage and supplies the converted voltage to the control part 310. A current measurement part 313 measures the current by using the current detection resistor 307 and supplies this measured current to the control part 310.

A switch control part 314 controls the charge control switch 302a and the discharge control switch 303a of the switch part 304 on the basis of the voltage and the current inputted from the voltage detection part 311 and the current measurement part 313, respectively. When the voltage of any one of the nonaqueous electrolyte batteries 301a becomes not more than an overcharge detection voltage or an overdischarge detection voltage, or a large current suddenly flows, the switch control part 314 sends a control signal to the switch part 304, thereby preventing overcharge or overdischarge, or overcurrent charge and discharge from occurring.

Here, for example, in the case where the nonaqueous electrolyte battery is a lithium ion secondary battery, the overcharge detection voltage is, for example, determined as 4.20 V±0.05 V, and the overdischarge detection voltage is, for example, determined as 2.4 V±0.1 V.

As the charge and discharge switch, a semiconductor switch, for example, MOSFET, etc., can be used. In that case, a parasitic diode of MOSFET functions as the diodes 302b and 303b. In the case where a P-channel type FET is used as the charge and discharge switch, the switch control part 314 supplies control signals DO and CO to respective gates of the charge control switch 302a and the discharge control switch 303a, respectively. In the case of the P-channel type, the charge control switch 302a and the discharge control switch 303a are turned on by a gate potential lower by a prescribed value or more than a source potential. That is, in the usual charge and discharge operations, the charge control switch 302a and the discharge control switch 303a are turned in the ON state while taking the control signals CO and DO as low levels.

Then, for example, on the occasion of overcharge or overdischarge, the charge control switch 302a and the discharge control switch 303a are turned in the OFF state while taking the control signals CO and DO as high levels.

A memory 317 is composed of RAM or ROM and is, for example, composed of EPROM (erasable programmable read only memory) that is a non-volatile memory, or the like. The memory 317 previously stores numerical values calculated by the control part 310, an inner battery resistance value of the respective nonaqueous electrolyte battery 301a in an initial state measured at the stage of a manufacturing step, and so on. Also, it is possible to properly achieve rewriting. Also, by allowing the memory 317 to store a complete charge capacity of the nonaqueous electrolyte battery 301a, the memory 317 is able to calculate, for example, a remaining capacity together with the control part 310.

In a temperature detection part 318, the temperature is measured using the temperature detection device 308, thereby carrying out the charge and discharge control at the time of abnormal heat generation or carrying out the correction in calculating the remaining capacity.

### 5. Fifth Embodiment

In a fifth embodiment, an appliance, for example, an electronic appliance, an electric vehicle, an electricity storage apparatus, etc., which is mounted with each of the nonaqueous electrolyte batteries according to the second embodiment and the third embodiment and the battery pack according to the fourth embodiment, is described. The nonaqueous electrolyte battery and the battery pack described in the second to fourth embodiments can be used for the purpose of supplying an electric power to an appliance, for example, an electronic appliance, an electric vehicle, an electricity storage apparatus, etc.

Examples of the electronic appliance include a laptop personal computer, PDA (personal digital assistants), a mobile phone, a cordless phone handset, a video movie camera, a digital still camera, an electronic book, an electronic dictionary, a music player, a radio, a headphone, a game player, a navigation system, a memory card, a pacemaker, a hearing aid, a power tool, an electric shaver, a refrigerator, an air conditioner, a television receiver, a stereo, a water heater, a microwave oven, a dishwasher, a washing machine, a dryer, an illuminator, a toy, a medical appliance, a robot, a road conditioner, and a signal.

Also, examples of the electric vehicle include a railway vehicle, a golf cart, an electric cart, and an electric car (inclusive of a hybrid car), and the foregoing nonaqueous electrolyte battery and battery pack are used as a driving power source or auxiliary power source for these electric vehicles.

Examples of the electricity storage apparatus include a power source for electricity storage used for buildings including houses or electric power generation facilities.

Among the foregoing application examples, specific examples of the electricity storage system using an electricity storage apparatus to which the nonaqueous electrolyte battery according to the present technology is applied are hereunder described.

Examples of this electricity storage system include the following configurations. A first electricity storage system is an electricity storage system in which the electricity storage apparatus is charged by an electric power generation apparatus for performing the electric power generation from renewable energy. A second electricity storage system is an electricity storage system having an electricity storage apparatus and supplying an electric power to an electronic appliance to be connected to the electricity storage apparatus. A third electricity storage system is an electric appliance which receives the supply of an electric power from an electricity storage apparatus. These electricity storage systems are carried out as a system for contriving to efficiently supply an electric power in cooperation with an external electric power supply network.

Furthermore, a fourth electricity storage system is an electric vehicle having a conversion apparatus of receiving the supply of an electric power from an electricity storage apparatus and converting it to a driving force of the vehicle and a control apparatus of performing information processing regarding the vehicle control on the basis of the information regarding the electricity storage apparatus. A fifth electricity storage system is an electric power system including an electric power information transmission and reception part for transmitting and receiving signals relative to other appliance via a network and performing charge and discharge control of the foregoing electricity storage apparatus on the basis of the information which the transmission and reception part receives. A sixth electricity storage system is an electric power system of receiving the supply of an electric power from the foregoing electricity storage apparatus, or supplying an electric power to the electricity storage apparatus from the electric power generation apparatus or electric power network. The electricity storage systems are hereunder described.

### (5-1) Electricity Storage System in House as Application Example

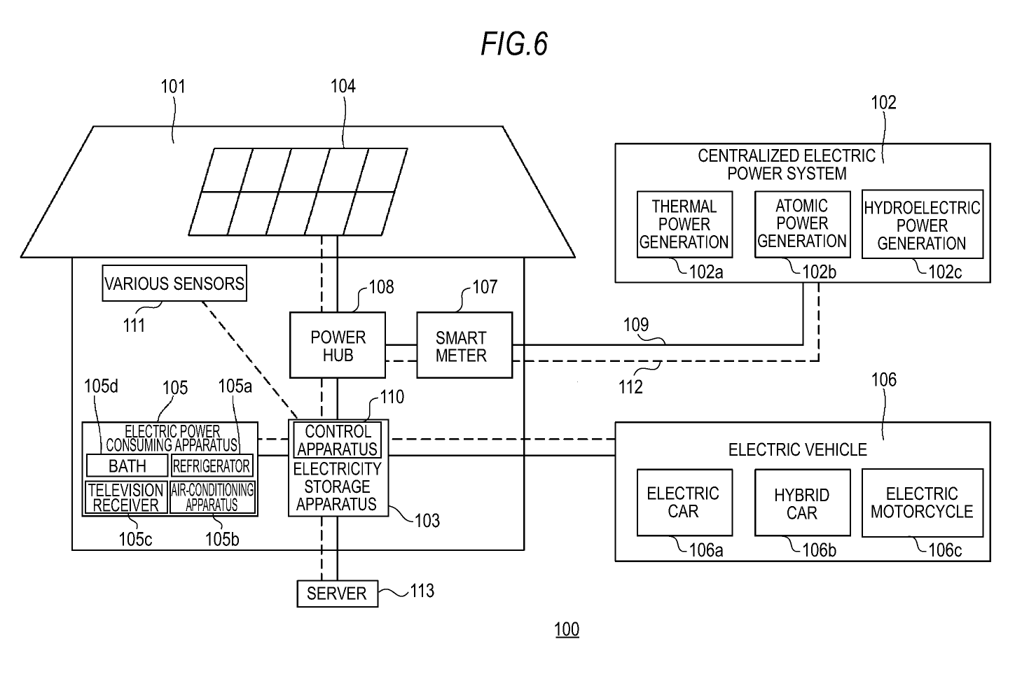

An example in which the electricity storage apparatus using the nonaqueous electrolyte battery according to the present technology is applied to an electricity storage system for house is described by reference to FIG. 6. For example, in an electricity storage system 100 for a house 101, an electric power is supplied to an electricity storage apparatus 103 from a centralized electric power system 102 including thermal power generation 102a, atomic power generation 102b, hydroelectric power generation 102c, and the like via an electric power network 109, an information network 112, a smart meter 107, a power hub 108, and the like. At the same time, an electric power is supplied to the electricity storage apparatus 103 from an independent power source such as a domestic electric power generation apparatus 104. The electric power supplied from the electricity storage apparatus 103 is stored. An electric power to be used in the house 101 is supplied using the electricity storage apparatus 103. The same electricity storage system can be used for not only the house 101 but buildings.

The house 101 is provided with the electric power generation apparatus 104, an electric power consuming apparatus 105, the electricity storage apparatus 103, a control apparatus 110 for controlling various apparatuses, the smart meter 107, and various sensors 111 for acquiring information. The respective apparatuses are connected to each other by the electric power network 109 and the information network 112. As the electric power generation apparatus 104, a solar cell, a fuel cell, and the like are utilized, and the generated electric power is supplied to the electric power consuming apparatus 105 and/or the electricity storage apparatus 103. The electric power consuming apparatus 105 includes a refrigerator 105a, an air-conditioning apparatus 105b, a television receiver 105c, a bath 105d, and so on. Furthermore, the electric power consuming apparatus 105 includes an electric vehicle 106. The electric vehicle 106 includes an electric car 106a, a hybrid car 106b, and an electric motorcycle 106c.

The nonaqueous electrolyte battery according to the present technology is applied to the electricity storage apparatus 103. The nonaqueous electrolyte battery according to the present technology may be, for example, constituted of the foregoing lithium ion secondary battery. The smart meter 107 is provided with a function to measure the use amount of a commercial electric power and transmit the measured use amount to an electric power company. The electric power network 109 may be combined with any one or a plurality of direct current electricity supply, alternating current electricity supply, and non-contact electricity supply.

Examples of the various sensors 111 include a human sensitive sensor, an illuminance sensor, an object detection sensor, a consumed electric power sensor, a vibration sensor, a contact sensor, a temperature sensor, and an infrared ray sensor. The information acquired by the various sensors 111 is transmitted to the control apparatus 110. According to the information from the sensors 111, the state of weather, the state of a human, or the like is grasped, and the electric power consuming apparatus 105 is automatically controlled, thereby enabling one to minimize the energy consumption. Furthermore, the control apparatus 110 is able to transmit the information regarding the house 101 to an external electric power company or the like via internet.

Processing such as branching of an electric power line and direct current-alternating current conversion is performed by the power hub 108. Examples of a communication system of the information network 112 which is connected to the control apparatus 110 include a method of using a communication interface such as UART (universal asynchronous receive-transceiver) and a method of utilizing a sensor network according to the radio communication standards such as Bluetooth, ZigBee, and Wi-Fi. The Bluetooth system is applied to the multimedia communication, thereby enabling one to achieve communication of one-to-many connections. The ZigBee uses the physical layer of IEEE (Institute of Electrical and Electronics Engineers) 802.15.4. IEEE 802.15.4 is a name of the wireless personal area network standards called PAN (personal area network) or WPAN (wireless personal area network).

The control apparatus 110 is connected to an external server 113. This server 113 may be controlled by any one of the house 101, an electric power company and a service provider. Examples of the information which the server 113 transmits and receives include consumed electric power information, life pattern information, electric power charge, weather information, natural disaster information, and electric power trade. Though a domestic electric power consuming apparatus (for example, a television receiver) may transmit and receive such information, an apparatus outside the home (for example, a mobile phone, etc.) may also transmit and receive the information. Such information may be displayed on an appliance having a display function, for example, a television receiver, a mobile phone, PDA (personal digital assistants), etc.

The control apparatus 110 for controlling the respective parts is constituted of CPU (central processing unit), RAM (random access memory), ROM (read only memory), and so on, and in this example, the control apparatus 110 is housed in the electricity storage apparatus 103. The control apparatus 110 is connected to the electricity storage apparatus 103, the domestic electric power generation apparatus 104, the electric power consuming apparatus 105, the various sensors 111, and the server 113 by the information network 112, and for example, it has a function to adjust the use amount of a commercial electric power and the amount of electric power generation. Incidentally, besides, the control apparatus 110 may include a function to perform electric power trade in the electric power market.

In the light of the above, the generated electric power of not only the centralized electric power system 102 whose electric power comes from the thermal power generation 102a, the atomic power generation 102b, the hydroelectric power generation 102c, and the like but the domestic electric power generation apparatus 104 (by photovoltaic power generation and wind power generation) can be stored in the electricity storage apparatus 103. In consequence, even when the generated electric power of the domestic electric power generation apparatus 104 changes, it is possible to undergo the control such that the amount of electric power to be sent out externally is made constant, or only a necessary amount of discharge is achieved. For example, there may also be adopted a manner of use such that not only an electric power obtained by photovoltaic power generation is stored in the electricity storage apparatus 103, but a late-night electric power whose charge is inexpensive in the night is stored in the electricity storage apparatus 103, and the electric power stored by the electricity storage apparatus 103 is discharged and utilized in a time zone of the daytime where the charge is expensive.

Incidentally, in this example, while an example in which the control apparatus 110 is housed within the electricity storage apparatus 103 has been described, the control apparatus 110 may be housed within the smart meter 107, or may be constituted alone. Furthermore, the electricity storage system 100 may be used while making a plurality of homes in an apartment house objective, or making a plurality of independent houses objective.

### (5-2) Electricity Storage System in Vehicle as Application Example

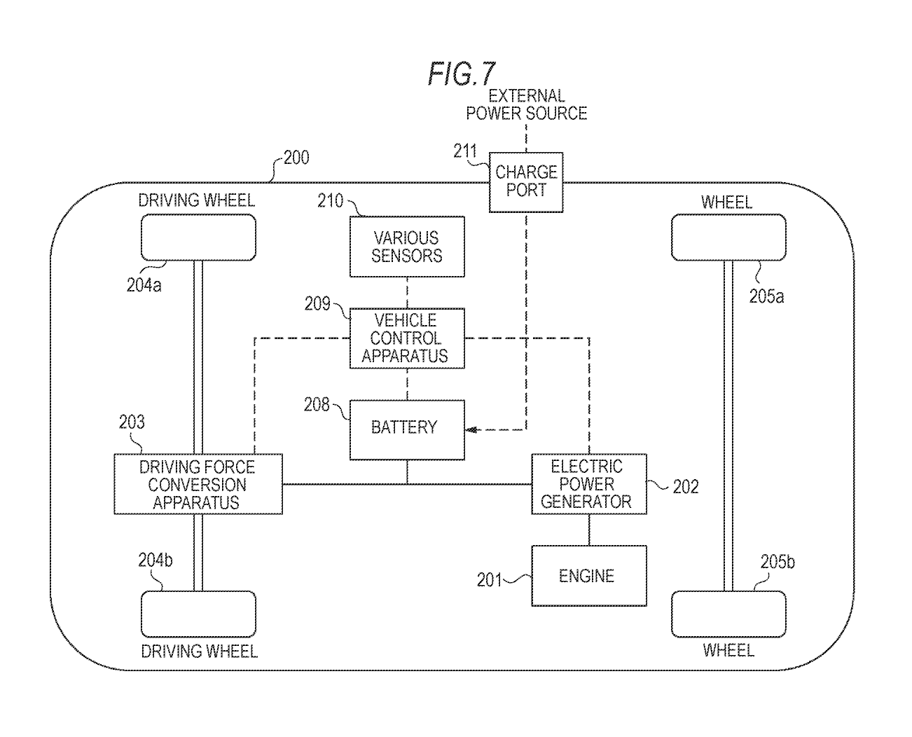

An example in which the present technology is applied to an electricity storage system for vehicle is described by reference to FIG. 7. FIG. 7 diagrammatically shows an example of a configuration of a hybrid vehicle adopting a series hybrid system to which the present technology is applied. The series hybrid system is a vehicle running with an electric power driving force conversion apparatus using an electric power generated by an electric power generator to be operated by an engine, or an electric power obtained by once storing the foregoing electric power in a battery.

This hybrid vehicle 200 is mounted with an engine 201, an electric power generator 202, an electric power driving force conversion apparatus 203, a driving wheel 204a, a driving wheel 204b, a wheel 205a, a wheel 205b, a battery 208, a vehicle control apparatus 209, various sensors 210, and a charge port 211. The foregoing nonaqueous electrolyte battery according to the present technology is applied to the battery 208.

The hybrid vehicle 200 runs using the electric power driving force conversion apparatus 203 as a power source. An example of the electric power driving force conversion apparatus 203 is a motor. The electric power driving force conversion apparatus 203 is actuated by the electric power of the battery 208, and a torque of this electric power driving force conversion apparatus 203 is transmitted to the driving wheels 204a and 204b. Incidentally, any of an alternating current motor or a direct current motor is applicable to the electric power driving force conversion apparatus 203 by using direct current-alternating current (DC-AC) conversion or reverse conversion (AC-DC conversion) in a necessary area. The various sensors 210 control the engine speed via the vehicle control apparatus 209, or control an opening of a non-illustrated throttle valve (throttle opening). The various sensors 210 include a speed sensor, an acceleration sensor, and an engine speed sensor.

A torque of the engine 201 is transmitted to the electric power generator 202, and an electric power produced in the electric power generator 202 by that torque can be stored in the battery 208.

When the hybrid vehicle 200 slows down due to a non-illustrated braking mechanism, the resistance at the time of slowdown is added as a torque to the electric power driving force conversion apparatus 203, and a regenerative electric power produced by the electric power driving force conversion apparatus 203 due to that torque is stored in the battery 208.

When the battery 208 is connected to an external power source of the hybrid vehicle 200, it receives the supply of an electric power from the external power source through the charge port 211 as an input port, and it is also possible to store the received electric power.

While illustration is omitted, an information processing apparatus for undergoing the information processing regarding vehicle control on the basis of the information regarding a nonaqueous electrolyte battery may be included. Examples of such an information processing apparatus include an information processing apparatus for undergoing display of a remaining battery life on the basis of the information regarding the remaining battery life.

Incidentally, as described above, the series hybrid vehicle running with a motor using an electric power generated by an electric power generator to be operated by an engine, or an electric power obtained by once storing the foregoing electric power in a battery has been described as an example. However, it is possible to effectively apply the present technology to a parallel hybrid vehicle using outputs of all of an engine and a motor as driving sources, which is used by properly switching three systems including running with only the engine, running with only the motor, and running with both of the engine and the motor. Furthermore, it is possible to effectively apply the present technology to a so-called electric vehicle running by driving with only a drive motor without using an engine.

### EXAMPLES

The present technology is hereunder described in detail with reference to the following Examples and Comparative Examples. Incidentally, compounds used in the following respective Examples and Comparative Examples are as follows.

### [Overcharge Controlling Agent]

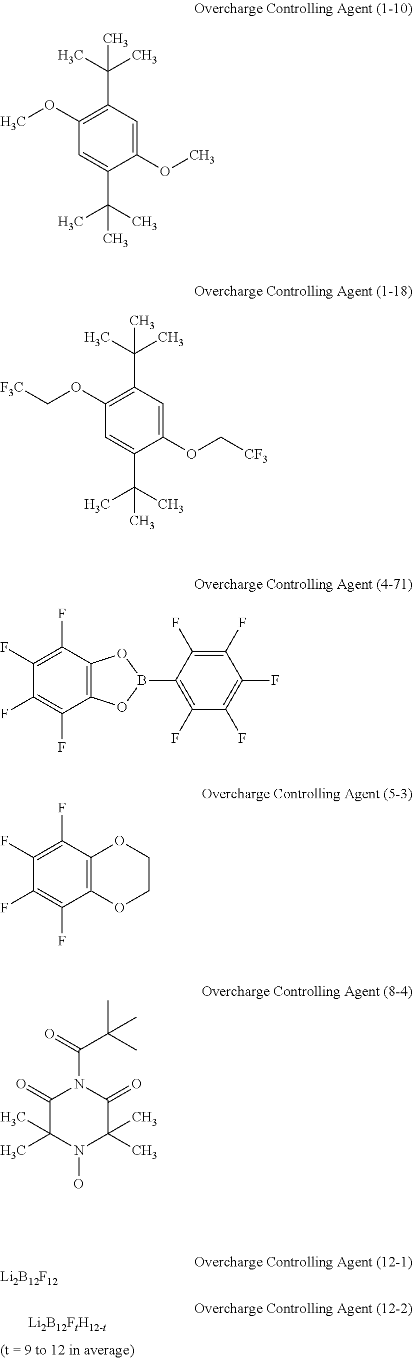

Incidentally, a positive electrode potential (vs. Li/Li⁺) of each of the compounds of the overcharge controlling agents at the time of reaction is shown in the following Table 1.

TABLE 1

| | Positive electrode potential at |
|---|---|
| | the time of reaction (vs. Li/Li⁺) [V] |
| Overcharge controlling agent (1-10) | 3.92 |
| Overcharge controlling agent (1-18) | 4.29 |
| Overcharge controlling agent (4-71) | 4.42 |
| Overcharge controlling agent (5-3) | 4.74 |
| Overcharge controlling agent (8-4) | 4.06 |
| Overcharge controlling agent (12-1) | 4.74 |
| Overcharge controlling agent (12-2) | 4.55 |

### Example 1-1-1

### [Fabrication of Positive Electrode]

Lithium carbonate (Li₂CO₃) and cobalt carbonate (CoCO₃) were mixed in a molar ratio of 0.5/1 and then baked in air at 900° C. for 5 hours to obtain a lithium cobalt complex oxide (LiCoO₂). Subsequently, 91 parts by mass of the lithium cobalt complex oxide (LiCoO₂) as a positive electrode active material, 6 parts by mass of graphite as an electrically conductive agent, and 3 parts by mass of polyvinylidene fluoride (PVdF) as a binder were mixed to prepare a positive electrode mixture. Subsequently, the positive electrode mixture was dispersed in N-methyl-2-pyrrolidone to prepare a positive electrode mixture slurry in a paste form. Finally, the positive electrode mixture slurry was uniformly coated on the both surfaces of a positive electrode collector made of a strip-shaped aluminum foil having a thickness of 12 μm by using a coating apparatus, and after drying, the resultant was compression molded by a roll press to fabricate a positive electrode having a positive electrode active material layer formed thereon.

### [Fabrication of Negative Electrode]

96 parts by mass of a granular graphite powder having an average particle size of 20 μm as a negative electrode active material, 1.5 parts by mass of an acrylic acid-modified material of a styrene-butadiene copolymer as a binder, a 1.5 parts by mass of carboxymethyl cellulose as a thickener, and a suitable amount of water were stirred to prepare a negative electrode slurry. Subsequently, the negative electrode mixture slurry was uniformly coated on the both surfaces of a negative electrode collector made of a strip-shaped copper foil having a thickness of 15 μm by using a coating apparatus, and after drying, the resultant was compression molded by a roll press to fabricate a negative electrode having a negative electrode active material layer formed thereon.

### [Preparation of Nonaqueous Electrolytic Solution]

Ethylene carbonate (EC), dimethyl carbonate (DMC), and ethylmethyl carbonate (EMC) were mixed in a proportion of EC/DMC/EMC of 30/40/30 (mass ratio) to form a nonaqueous solvent, and thereafter, lithium hexafluorophosphate (LiPF₆) as an electrolyte salt was mixed and dissolved in a concentration of 1.0 mole/kg in the nonaqueous solvent. Subsequently, the foregoing Overcharge Controlling Agent (1-10) as an overcharge controlling agent was added and dissolved in the nonaqueous solvent having the electrolyte salt dissolved therein in such a manner that its content in the whole composition of a nonaqueous electrolytic solution was 5.0% by mass. Also, succinic anhydride that is a protective film forming agent was added and dissolved as the compound according to the present technology therein in such a manner that its content in the whole composition of a nonaqueous electrolytic solution was 1.0% by mass, thereby preparing a nonaqueous electrolytic solution.

### [Assembling of Nonaqueous Electrolyte Battery of a Cylindrical Type]

An aluminum-made positive electrode lead was welded to one end of the positive electrode collector. Also, a nickel-made negative electrode lead was welded to one end of the negative electrode collector. Subsequently, the positive electrode and the negative electrode were laminated via a separator and wound in the longitudinal direction, and a winding end portion was fixed by an adhesive tape to fabricate a wound electrode body. As the separator, a microporous polypropylene film having a thickness of 25 μm was used. Subsequently, a center pin was inserted into the winding center of the wound electrode body. Thereafter, the wound electrode body was housed in the inside of an iron-made battery can plated with nickel while being interposed between a pair of insulating plates. On that occasion, the positive electrode lead was welded to a safety valve mechanism, and the negative electrode lead was also welded to the battery can.

Subsequently, the nonaqueous electrolytic solution was injected into the inside of the battery can in a reduced pressure system and impregnated in the separator. Finally, a battery lid, the safety valve mechanism, and a positive temperature coefficient device were fixed to the open end portion of the battery can upon being caulked via a gasket. There was thus completed a nonaqueous electrolyte battery of a cylindrical type (test battery). Incidentally, in the case of fabricating this battery for test, the thickness of the positive electrode active material layer was regulated in such a manner that the lithium metal did not deposit on the negative electrode at the time of full charge.

### Examples 1-1-2 to 1-1-7

Test batteries of Examples 1-1-2 to 1-1-7 were respectively fabricated in the same manner as that in Example 1-1-1, except that the overcharge controlling agent to be mixed in the nonaqueous electrolytic solution was changed to Overcharge Controlling Agent (1-18), Overcharge Controlling Agent (4-71), Overcharge Controlling Agent (5-3), Overcharge Controlling Agent (8-4), Overcharge Controlling Agent (12-1), and Overcharge Controlling Agent (12-2) as shown in Table 2, respectively in place of the Overcharge Controlling Agent (1-10).

### Examples 1-1-8 to 1-1-14

Test batteries of Examples 1-1-8 to 1-1-14 were respectively fabricated in the same manners as those in Examples 1-1-1 to 1-1-7, except that the compound according to the present technology to be mixed in the nonaqueous electrolytic solution was changed to cyclodisone represented by the formula (8-12).

### Examples 1-1-15 to 1-1-21

Test batteries of Examples 1-1-15 to 1-1-21 were respectively fabricated in the same manners as those in Examples 1-1-1 to 1-1-7, except that the compound according to the present technology to be mixed in the nonaqueous electrolytic solution was changed to propanedicarboxylic anhydride.

### Examples 1-1-22 to 1-1-28

Test batteries of Examples 1-1-22 to 1-1-28 were respectively fabricated in the same manners as those in Examples 1-1-1 to 1-1-7, except that the compound according to the present technology to be mixed in the nonaqueous electrolytic solution was changed to 4-fluoro-1,3-dioxolan-2-one (FEC).

### Examples 1-1-29 to 1-1-35

Test batteries of Examples 1-1-29 to 1-1-35 were respectively fabricated in the same manners as those in Examples 1-1-1 to 1-1-7, except that the compound according to the present technology to be mixed in the nonaqueous electrolytic solution was changed to vinylene carbonate (VC).

### Examples 1-1-36 to 1-1-42

Test batteries of Examples 1-1-36 to 1-1-42 were respectively fabricated in the same manners as those in Examples 1-1-1 to 1-1-7, except that the compound according to the present technology to be mixed in the nonaqueous electrolytic solution was changed to trans-4,5-difluoro-1,3-dioxolan-2-one (t-DFEC).

### Examples 1-1-43 to 1-1-49

Test batteries of Examples 1-1-43 to 1-1-49 were respectively fabricated in the same manners as those in Examples 1-1-1 to 1-1-7, except that the compound according to the present technology to be mixed in the nonaqueous electrolytic solution was changed to propene sultone.

### Examples 1-1-50 to 1-1-56

Test batteries of Examples 1-1-50 to 1-1-56 were respectively fabricated in the same manners as those in Examples 1-1-1 to 1-1-7, except that the compound according to the present technology to be mixed in the nonaqueous electrolytic solution was changed to lithium tetrafluoroborate (LiBF₄), and its mixing amount was set to 0.1 moles/kg. Incidentally, in Examples 1-1-50 to 1-1-56, the concentration of lithium hexafluoroborate (LiPF₆) that is an electrolyte salt was set to 0.9 moles/kg. Also, the content of lithium tetrafluoroborate (LiBF₄) in the whole composition of the nonaqueous electrolytic solution was 0.78% by mass. The lithium tetrafluoroborate (LiBF₄) is a thermally stable salt and also functions as a protective film forming agent.

### Examples 1-1-57 to 1-1-63

Test batteries of Examples 1-1-57 to 1-1-63 were respectively fabricated in the same manners as those in Examples 1-1-1 to 1-1-7, except that the compound according to the present technology to be mixed in the nonaqueous electrolytic solution was changed to lithium bisoxalatoborate (LiBOB) represented by the formula (4-6), and its mixing amount was set to 0.1 moles/kg. Incidentally, in Examples 1-1-57 to 1-1-63, the concentration of lithium hexafluoroborate (LiPF₆) that is an electrolyte salt was set to 0.9 moles/kg. Also, the content of lithium bisoxalatoborate (LiBOB) in the whole composition of the nonaqueous electrolytic solution was 1.59% by mass.

### Examples 1-1-64 to 1-1-70

Test batteries of Examples 1-1-64 to 1-1-70 were respectively fabricated in the same manners as those in Examples 1-1-1 to 1-1-7, except that the compound according to the present technology to be mixed in the nonaqueous electrolytic solution was changed to Li[PF₂ (C₂O₄)₂] represented by the formula (4-2), and its mixing amount was set to 0.1 moles/kg. Incidentally, in Examples 1-1-64 to 1-1-70, the concentration of lithium hexafluoroborate (LiPF₆) that is an electrolyte salt was set to 0.9 moles/kg. Also, the content of Li[PF₂(C₂O₄)₂] in the whole composition of the nonaqueous electrolytic solution was 2.06% by mass.

### Examples 1-1-71 to 1-1-77

Test batteries of Examples 1-1-71 to 1-1-77 were respectively fabricated in the same manners as those in Examples 1-1-1 to 1-1-7, except that the compound according to the present technology to be mixed in the nonaqueous electrolytic solution was changed to LiN(SO₂CF₂)₂CF₂ represented by the formula (7-2), and its mixing amount was set to 0.1 moles/kg. Incidentally, in Examples 1-1-71 to 1-1-77, the concentration of lithium hexafluoroborate (LiPF₆) that is an electrolyte salt was set to 0.9 moles/kg. Also, the content of LiN(SO₂CF₂)₂CF₂ in the whole composition of the nonaqueous electrolytic solution was 2.43% by mass.

### Comparative Examples 1-1-1 to 1-1-7

Test batteries of Comparative Examples 1-1-1 to 1-1-7 were respectively fabricated in the same manners as those in Examples 1-1-1 to 1-1-7, except that the compound according to the present technology was not mixed in the nonaqueous electrolytic solution.

### Comparative Examples 1-1-8 to 1-1-18

Test batteries of Comparative Examples 1-1-8 to 1-1-18 were respectively fabricated in the same manners as those in Examples 1-1-1, 1-1-8, 1-1-15, 1-1-22, 1-1-29, 1-1-36, 1-1-43, 1-1-50, 1-1-57, 1-1-64, and 1-1-71, except that the overcharge controlling agent was not mixed in the nonaqueous electrolytic solution.

### Comparative Example 1-1-19

A test battery of Comparative Example 1-1-19 was fabricated in the same manner as that in Example 1-1-1, except that the overcharge controlling agent and the compound according to the present technology were not mixed in the nonaqueous electrolytic solution.

[Evaluation of Battery: Load Characteristics after the Overcharge]

The test battery of each of the Examples and each of the Comparative Examples was subjected to constant-current charge in an atmosphere at 23° C. at a charge current of 0.2 C until the battery voltage reached 4.2 V and then to constant-voltage charge at 4.2 V, and the charge was terminated at the point of time when a total charge time reached 8 hours. Thereafter, the test battery was subjected to constant-current discharge at a discharge current of 0.2 C until the battery voltage reached 3.0 V. Incidentally, the term “0.2 C” referred to herein is a current value at which a theoretical capacity is completely discharged for 5 hours. After carrying out one cycle of this charge and discharge cycle, the test battery was subjected to constant-current charge at 0.2 C and constant-voltage charge at the second cycle while setting an upper limit voltage to 4.2 V, followed by undergoing constant-current discharge at 1.5 C until the battery voltage reached 3.0 V, thereby measuring a discharge capacity.

Subsequently, the test battery was subjected to constant-current charge at 0.2 C and constant-voltage charge at the third cycle while setting an upper limit voltage to 4.8 V, followed by undergoing constant-current discharge at 0.2 C until the battery voltage reached 3.0 V. Incidentally, the charge at the third cycle was terminated in either the case where the voltage reached 4.8 V, or the case where the total charge time reached 8 hours. After carrying out three cycles of such a charge and discharge operation, similar to the operation at the second cycle, the test battery was subjected to constant-current charge at 0.2 C and constant-voltage charge at the sixth cycle in total while setting an upper limit voltage to 4.2 V, followed by undergoing constant-current discharge at 1.5 C until the battery voltage reached 3.0 V, thereby measuring a discharge capacity. When the discharge capacity at the second cycle was defined as 100%, the discharge capacity at the sixth cycle was calculated as load characteristics after the overcharge.

Evaluation results are shown in the following Tables 2 and 3. Incidentally, in Tables 2 and 3, a “% by mass” is expressed by “wt %”. Also, the same is applicable to the following respective tables.

TABLE 2
[Negative electrode active material: Graphite]

| | | | | | Retention |
|---|---|---|---|---|---|
| | | | | | rate of load |
| | | | | | characteristics |
| | Nonaqueous | Compound | | | after the |
| | solvent | Material | Mixing amount [wt %] | Overcharge controlling agent | overcharge [%] |
| Example 1-1-1 | EC/DMC/EMC = | Succinic anhydride | 1.0 | Overcharge Controlling Agent (1-10) | 92 |
| Example 1-1-2 | 30/40/30 | | | Overcharge Controlling Agent (1-18) | 87 |
| Example 1-1-3 | | | | Overcharge Controlling Agent (4-71) | 92 |
| Example 1-1-4 | | | | Overcharge Controlling Agent (5-3) | 88 |
| Example 1-1-5 | | | | Overcharge Controlling Agent (8-4) | 86 |
| Example 1-1-6 | | | | Overcharge Controlling Agent (12-1) | 88 |
| Example 1-1-7 | | | | Overcharge Controlling Agent (12-2) | 92 |
| Example 1-1-8 | | Cyclodisone | 1.0 | Overcharge Controlling Agent (1-10) | 93 |
| Example 1-1-9 | | (Compound (8-12)) | | Overcharge Controlling Agent (1-18) | 95 |
| Example 1-1-10 | | | | Overcharge Controlling Agent (4-71) | 96 |
| Example 1-1-11 | | | | Overcharge Controlling Agent (5-3) | 89 |
| Example 1-1-12 | | | | Overcharge Controlling Agent (8-4) | 94 |
| Example 1-1-13 | | | | Overcharge Controlling Agent (12-1) | 93 |
| Example 1-1-14 | | | | Overcharge Controlling Agent (12-2) | 91 |
| Example 1-1-15 | | Propanedicarboxylic | 1.0 | Overcharge Controlling Agent (1-10) | 97 |
| Example 1-1-16 | | anhydride | | Overcharge Controlling Agent (1-18) | 93 |
| Example 1-1-17 | | | | Overcharge Controlling Agent (4-71) | 95 |
| Example 1-1-18 | | | | Overcharge Controlling Agent (5-3) | 97 |
| Example 1-1-19 | | | | Overcharge Controlling Agent (8-4) | 98 |
| Example 1-1-20 | | | | Overcharge Controlling Agent (12-1) | 91 |
| Example 1-1-21 | | | | Overcharge Controlling Agent (12-2) | 93 |
| Example 1-1-22 | | FEC | 1.0 | Overcharge Controlling Agent (1-10) | 90 |
| Example 1-1-23 | | | | Overcharge Controlling Agent (1-18) | 97 |
| Example 1-1-24 | | | | Overcharge Controlling Agent (4-71) | 91 |
| Example 1-1-25 | | | | Overcharge Controlling Agent (5-3) | 93 |
| Example 1-1-26 | | | | Overcharge Controlling Agent (8-4) | 92 |
| Example 1-1-27 | | | | Overcharge Controlling Agent (12-1) | 90 |
| Example 1-1-28 | | | | Overcharge Controlling Agent (12-2) | 94 |
| Example 1-1-29 | | VC | 1.0 | Overcharge Controlling Agent (1-10) | |
| Example 1-1-30 | | | | Overcharge Controlling Agent (1-18) | 97 |
| Example 1-1-31 | | | | Overcharge Controlling Agent (4-71) | 95 |
| Example 1-1-32 | | | | Overcharge Controlling Agent (5-3) | 97 |
| Example 1-1-33 | | | | Overcharge Controlling Agent (8-4) | 92 |
| Example 1-1-34 | | | | Overcharge Controlling Agent (12-1) | 90 |
| Example 1-1-35 | | | | Overcharge Controlling Agent (12-2) | 96 |
| Example 1-1-36 | | t-DFEC | 1.0 | Overcharge Controlling Agent (1-10) | 91 |
| Example 1-1-37 | | | | Overcharge Controlling Agent (1-18) | 92 |
| Example 1-1-38 | | | | Overcharge Controlling Agent (4-71) | 91 |
| Example 1-1-39 | | | | Overcharge Controlling Agent (5-3) | 90 |
| Example 1-1-40 | | | | Overcharge Controlling Agent (8-4) | 95 |
| Example 1-1-41 | | | | Overcharge Controlling Agent (12-1) | 95 |
| Example 1-1-42 | | | | Overcharge Controlling Agent (12-2) | 94 |
| Example 1-1-43 | | Propene sultone | 1.0 | Overcharge Controlling Agent (1-10) | 86 |
| Example 1-1-44 | | | | Overcharge Controlling Agent (1-18) | 91 |
| Example 1-1-45 | | | | Overcharge Controlling Agent (4-71) | 96 |
| Example 1-1-46 | | | | Overcharge Controlling Agent (5-3) | 86 |
| Example 1-1-47 | | | | Overcharge Controlling Agent (8-4) | 91 |
| Example 1-1-48 | | | | Overcharge Controlling Agent (12-1) | 85 |
| Example 1-1-49 | | | | Overcharge Controlling Agent (12-2) | 88 |

TABLE 3
[Negative electrode active material: Graphite]

| | | | | | Retention |
|---|---|---|---|---|---|
| | | | | | rate of load |
| | | | | | characteristics |
| | Nonaqueous | Compound | | | after the |
| | solvent | Material | Mixing amount [wt %] | Overcharge controlling agent | overcharge [%] |
| Example 1-1-50 | EC/DMC/EMC = | LiBF₄ | 0.78 | Overcharge Controlling Agent (1-10) | 92 |
| Example 1-1-51 | 30/40/30 | | | Overcharge Controlling Agent (1-18) | 94 |
| Example 1-1-52 | | | | Overcharge Controlling Agent (4-71) | 90 |
| Example 1-1-53 | | | | Overcharge Controlling Agent (5-3) | 92 |
| Example 1-1-54 | | | | Overcharge Controlling Agent (8-4) | 94 |
| Example 1-1-55 | | | | Overcharge Controlling Agent (12-1) | 93 |
| Example 1-1-56 | | | | Overcharge Controlling Agent (12-2) | 93 |
| Example 1-1-57 | | LiBOB | 1.59 | Overcharge Controlling Agent (1-10) | 89 |
| Example 1-1-58 | | (Compound (4-6)) | | Overcharge Controlling Agent (1-18) | 87 |
| Example 1-1-59 | | | | Overcharge Controlling Agent (4-71) | 91 |
| Example 1-1-60 | | | | Overcharge Controlling Agent (5-3) | 90 |
| Example 1-1-61 | | | | Overcharge Controlling Agent (8-4) | 93 |
| Example 1-1-62 | | | | Overcharge Controlling Agent (12-1) | 94 |
| Example 1-1-63 | | | | Overcharge Controlling Agent (12-2) | 87 |
| Example 1-1-64 | | LiPF₂(C₂O₄)₂ | 2.06 | Overcharge Controlling Agent (1-10) | 86 |
| Example 1-1-65 | | (Compound (4-2)) | | Overcharge Controlling Agent (1-18) | 91 |
| Example 1-1-66 | | | | Overcharge Controlling Agent (4-71) | 87 |
| Example 1-1-67 | | | | Overcharge Controlling Agent (5-3) | 90 |
| Example 1-1-68 | | | | Overcharge Controlling Agent (8-4) | 92 |
| Example 1-1-69 | | | | Overcharge Controlling Agent (12-1) | 90 |
| Example 1-1-70 | | | | Overcharge Controlling Agent (12-2) | 89 |
| Example 1-1-71 | | LiN(SO₂CF₂)₂CF₂ | 2.43 | Overcharge Controlling Agent (1-10) | 91 |
| Example 1-1-72 | | (Compound (7-2)) | | Overcharge Controlling Agent (1-18) | 93 |
| Example 1-1-73 | | | | Overcharge Controlling Agent (4-71) | 91 |
| Example 1-1-74 | | | | Overcharge Controlling Agent (5-3) | 87 |
| Example 1-1-75 | | | | Overcharge Controlling Agent (8-4) | 93 |
| Example 1-1-76 | | | | Overcharge Controlling Agent (12-1) | 82 |
| Example 1-1-77 | | | | Overcharge Controlling Agent (12-2) | 89 |
| Comparative | EC/DMC/EMC = | — | — | Overcharge Controlling Agent (1-10) | 64 |
| Example 1-1-1 | 30/40/30 | | | | |
| Comparative | | | | Overcharge Controlling Agent (1-18) | 67 |
| Example 1-1-2 | | | | | |
| Comparative | | | | Overcharge Controlling Agent (4-71) | 68 |
| Example 1-1-3 | | | | | |
| Comparative | | | | Overcharge Controlling Agent (5-3) | 70 |
| Example 1-1-4 | | | | | |
| Comparative | | | | Overcharge Controlling Agent (8-4) | 69 |
| Example 1-1-5 | | | | | |
| Comparative | | | | Overcharge Controlling Agent (12-1) | 71 |
| Example 1-1-6 | | | | | |
| Comparative | | | | Overcharge Controlling Agent (12-2) | 70 |
| Example 1-1-7 | | | | | |
| Comparative | | Succinic anhydride | 1.0 | — | 55 |
| Example 1-1-8 | | | | | |
| Comparative | | Cyclodisone | 1.0 | | 54 |
| Example 1-1-9 | | | | | |
| Comparative | | Propanedicarboxylic | 1.0 | | 60 |
| Example 1-1-10 | | anhydride | | | |
| Comparative | | FEC | 1.0 | | 57 |
| Example 1-1-11 | | | | | |
| Comparative | | VC | 1.0 | | 55 |
| Example 1-1-12 | | | | | |
| Comparative | | t-DFEC | 1.0 | | 53 |
| Example 1-1-13 | | | | | |
| Comparative | | Propene sultone | 1.0 | | 58 |
| Example 1-1-14 | | | | | |
| Comparative | | LiBF₄ | 0.78 | | 55 |
| Example 1-1-15 | | | | | |
| Comparative | | LiBOB | 1.59 | | 52 |
| Example 1-1-16 | | | | | |
| Comparative | | LiPF₂(C₂O₄)₂ | 2.06 | | 50 |
| Example 1-1-17 | | | | | |
| Comparative | | LiN(SO₂CF₂)₂CF₂ | 2.43 | | 52 |
| Example 1-1-18 | | | | | |
| Comparative | | — | — | | 49 |
| Example 1-1-19 | | | | | |

### Examples 1-2-1 to 1-2-7

Test batteries of Examples 1-2-1 to 1-2-7 were respectively fabricated in the same manners as those in Examples 1-2-1 to 1-2-7, except that the compound according to the present technology to be mixed in the nonaqueous electrolytic solution was changed to succinonitrile that is a complex forming agent.

### Examples 1-2-8 to 1-2-14

Test batteries of Examples 1-2-8 to 1-2-14 were respectively fabricated in the same manners as those in Examples 1-2-1 to 1-2-7, except that the compound according to the present technology to be mixed in the nonaqueous electrolytic solution was changed to adiponitrile that is a complex forming agent.

### Examples 1-2-15 to 1-2-21

Test batteries of Examples 1-2-15 to 1-2-21 were respectively fabricated in the same manners as those in Examples 1-2-1 to 1-2-7, except that the compound according to the present technology to be mixed in the nonaqueous electrolytic solution was changed to 7,7,8,8-tetracyanoquinodimethane that is a complex forming agent.

### Examples 1-2-22 to 1-2-28

Test batteries of Examples 1-2-22 to 1-2-28 were respectively fabricated in the same manners as those in Examples 1-2-1 to 1-2-7, except that the compound according to the present technology to be mixed in the nonaqueous electrolytic solution was changed to acetonitrile that is a complex forming agent.

### Examples 1-2-29 to 1-2-35

Test batteries of Examples 1-2-29 to 1-2-35 were respectively fabricated in the same manners as those in Examples 1-2-1 to 1-2-7, except that the compound according to the present technology to be mixed in the nonaqueous electrolytic solution was changed to 1-isocyanatoethane that is a complex forming agent.

### Examples 1-2-36 to 1-2-42

Test batteries of Examples 1-2-36 to 1-2-42 were respectively fabricated in the same manners as those in Examples 1-2-1 to 1-2-7, except that the compound according to the present technology to be mixed in the nonaqueous electrolytic solution was changed to 1,8-diisocyanatooctane that is a complex forming agent.

### Comparative Examples 1-2-1 to 1-2-6

Test batteries of Comparative Examples 1-2-1 to 1-2-6 were respectively fabricated in the same manners as those in Examples 1-2-1, 1-2-8, 1-2-15, 1-2-22, 1-2-29, and 1-2-36, except that the compound according to the present technology was not mixed in the nonaqueous electrolytic solution.

[Evaluation of Battery: Load Characteristics after the Overcharge]

With respect to the respective Examples and Comparative Examples, the load characteristics after the overcharge were confirmed in the same manner as that in Example 1-1-1.

Evaluation results are shown in the following Table 4.

TABLE 4
[Negative electrode active material: Graphite]

| | | | | | Retention |
|---|---|---|---|---|---|
| | | Compound | | | rate of load |
| | Nonaqueous | | Mixing | | characteristics after |
| | solvent | Material | amount [wt %] | Overcharge controlling agent | the overcharge [%] |
| Example 1-2-1 | EC/DMC/EMC = | Succinonitrile | 1.0 | Overcharge Controlling Agent (1-10) | 84 |
| Example 1-2-2 | 30/40/30 | | | Overcharge Controlling Agent (1-18) | 86 |
| Example 1-2-3 | | | | Overcharge Controlling Agent (4-71) | 90 |
| Example 1-2-4 | | | | Overcharge Controlling Agent (5-3) | 88 |
| Example 1-2-5 | | | | Overcharge Controlling Agent (8-4) | 92 |
| Example 1-2-6 | | | | Overcharge Controlling Agent (12-1) | 90 |
| Example 1-2-7 | | | | Overcharge Controlling Agent (12-2) | 90 |
| Example 1-2-8 | | Adiponitrile | 1.0 | Overcharge Controlling Agent (1-10) | 85 |
| Example 1-2-9 | | | | Overcharge Controlling Agent (1-18) | 85 |
| Example 1-2-10 | | | | Overcharge Controlling Agent (4-71) | 88 |
| Example 1-2-11 | | | | Overcharge Controlling Agent (5-3) | 95 |
| Example 1-2-12 | | | | Overcharge Controlling Agent (8-4) | 89 |
| Example 1-2-13 | | | | Overcharge Controlling Agent (12-1) | 91 |
| Example 1-2-14 | | | | Overcharge Controlling Agent (12-2) | 89 |
| Example 1-2-15 | | 7,7,8,8-Tetracyanoquinodimethane | 1.0 | Overcharge Controlling Agent (1-10) | 83 |
| Example 1-2-16 | | | | Overcharge Controlling Agent (1-18) | 91 |
| Example 1-2-17 | | | | Overcharge Controlling Agent (4-71) | 87 |
| Example 1-2-18 | | | | Overcharge Controlling Agent (5-3) | 88 |
| Example 1-2-19 | | | | Overcharge Controlling Agent (8-4) | 93 |
| Example 1-2-20 | | | | Overcharge Controlling Agent (12-1) | 92 |
| Example 1-2-21 | | | | Overcharge Controlling Agent (12-2) | 96 |
| Example 1-2-22 | | Acetonitrile | 1.0 | Overcharge Controlling Agent (1-10) | 87 |
| Example 1-2-23 | | | | Overcharge Controlling Agent (1-18) | 85 |
| Example 1-2-24 | | | | Overcharge Controlling Agent (4-71) | 90 |
| Example 1-2-25 | | | | Overcharge Controlling Agent (5-3) | 90 |
| Example 1-2-26 | | | | Overcharge Controlling Agent (8-4) | 88 |
| Example 1-2-27 | | | | Overcharge Controlling Agent (12-1) | 92 |
| Example 1-2-28 | | | | Overcharge Controlling Agent (12-2) | 92 |
| Example 1-2-29 | | 1-Isocyanatoethane | 1.0 | Overcharge Controlling Agent (1-10) | 84 |
| Example 1-2-30 | | | | Overcharge Controlling Agent (1-18) | 85 |
| Example 1-2-31 | | | | Overcharge Controlling Agent (4-71) | 93 |
| Example 1-2-32 | | | | Overcharge Controlling Agent (5-3) | 87 |
| Example 1-2-33 | | | | Overcharge Controlling Agent (8-4) | 93 |
| Example 1-2-34 | | | | Overcharge Controlling Agent (12-1) | 92 |
| Example 1-2-35 | | | | Overcharge Controlling Agent (12-2) | 91 |
| Example 1-2-36 | | 1,8-Diisocyanatooctane | 1.0 | Overcharge Controlling Agent (1-10) | 84 |
| Example 1-2-37 | | | | Overcharge Controlling Agent (1-18) | 86 |
| Example 1-2-38 | | | | Overcharge Controlling Agent (4-71) | 88 |
| Example 1-2-39 | | | | Overcharge Controlling Agent (5-3) | 93 |
| Example 1-2-40 | | | | Overcharge Controlling Agent (8-4) | 91 |
| Example 1-2-41 | | | | Overcharge Controlling Agent (12-1) | 91 |
| Example 1-2-42 | | | | Overcharge Controlling Agent (12-2) | 89 |
| Comparative | EC/DMC/EMC = | Succinonitrile | 1.0 | — | 38 |
| Example 1-2-1 | 30/40/30 | | | | |
| Comparative | | Adiponitrile | | | 38 |
| Example 1-2-2 | | | | | |
| Comparative | | 7,7,8,8-Tetracyanoquinodimethane | | | 40 |
| Example 1-2-3 | | | | | |
| Comparative | | Acetonitrile | | | 42 |
| Example 1-2-4 | | | | | |
| Comparative | | 1-Isocyanatoethane | | | 43 |
| Example 1-2-5 | | | | | |
| Comparative | | 1,8-Diisocyanatooctane | | | 42 |
| Example 1-2-6 | | | | | |

### Examples 1-3-1 to 1-3-7

As the compound according to the present technology to be mixed in the nonaqueous electrolytic solution, γ-butyrolactone that is a solvent based protective film forming agent was used, and the γ-butyrolactone was mixed with ethylene carbonate (EC), dimethyl carbonate (DMC), and ethylmethyl carbonate (EMC) in a ratio of EC/DMC/EMC/γ-butyrolactone of 25/40/30/5 (mass ratio). That is, the nonaqueous solvents were mixed in a ratio of EC/DMC/EMC of 25/40/30 (mass ratio), and a ratio of γ-butyrolactone was adjusted to 4.12% by mass relative to the whole of the nonaqueous electrolytic solution. Except for that matter, test batteries of Examples 1-3-1 to 1-3-7 were respectively fabricated in the same manners as those in Examples 1-1-1 to 1-1-7.

### Examples 1-3-8 to 1-3-14

Test batteries of Examples 1-3-8 to 1-3-14 were respectively fabricated in the same manners as those in Examples 1-3-1 to 1-3-7, except that the compound according to the present technology to be mixed in the nonaqueous electrolytic solution was changed to N-methyl-2-pyrrolidone (NMP) that is a solvent based protective film forming agent.

### Examples 1-3-15 to 1-3-21

Test batteries of Examples 1-3-15 to 1-3-21 were respectively fabricated in the same manners as those in Examples 1-3-1 to 1-3-7, except that the compound according to the present technology to be mixed in the nonaqueous electrolytic solution was changed to methyl acetate that is a solvent based protective film forming agent.

### Examples 1-3-22 to 1-3-28

Test batteries of Examples 1-3-22 to 1-3-28 were respectively fabricated in the same manners as those in Examples 1-3-1 to 1-3-7, except that the compound according to the present technology to be mixed in the nonaqueous electrolytic solution was changed to ethyl trimethylacetate that is a solvent based protective film forming agent.

### Examples 1-3-29 to 1-3-35

Test batteries of Examples 1-3-29 to 1-3-35 were respectively fabricated in the same manners as those in Examples 1-3-1 to 1-3-7, except that the compound according to the present technology to be mixed in the nonaqueous electrolytic solution was changed to 1,2-dimethoxyethane that is a solvent based protective film forming agent.

### Examples 1-3-36 to 1-3-42

Test batteries of Examples 1-3-36 to 1-3-42 were respectively fabricated in the same manners as those in Examples 1-3-1 to 1-3-7, except that the compound according to the present technology to be mixed in the nonaqueous electrolytic solution was changed to 1,3-dioxane that is a solvent based protective film forming agent.

### Examples 1-3-43 to 1-3-49

Test batteries of Examples 1-3-43 to 1-3-49 were respectively fabricated in the same manners as those in Examples 1-3-1 to 1-3-7, except that the compound according to the present technology to be mixed in the nonaqueous electrolytic solution was changed to fluoromethylmethyl carbonate (FDMC) that is a solvent based protective film forming agent.

### Examples 1-3-50 to 1-3-56

Test batteries of Examples 1-3-50 to 1-3-56 were respectively fabricated in the same manners as those in Examples 1-3-1 to 1-3-7, except that the compound according to the present technology to be mixed in the nonaqueous electrolytic solution was changed to 4-fluoro-1,3-dioxolan-2-one (FEC) that is a solvent based protective film forming agent.

### Examples 1-3-57 to 1-3-63

Test batteries of Examples 1-3-57 to 1-3-63 were respectively fabricated in the same manners as those in Examples 1-3-1 to 1-3-7, except that the compound according to the present technology to be mixed in the nonaqueous electrolytic solution was changed to sulfolane that is a solvent based protective film forming agent.

### Comparative Examples 1-3-1 to 1-3-9

Test batteries of Comparative Examples 1-3-1 to 1-3-9 were respectively fabricated in the same manners as those in Examples 1-3-1, 1-3-8, 1-3-15, 1-3-22, 1-3-29, 1-3-36, 1-3-43, 1-3-50, and 1-3-57, except that the compound according to the present technology was not mixed in the nonaqueous electrolytic solution.

[Evaluation of Battery: Load Characteristics after the Overcharge]

With respect to the respective Examples and Comparative Examples, the load characteristics after the overcharge were confirmed in the same manner as that in Example 1-1-1.

Evaluation results are shown in the following Tables 5 and 6.

TABLE 5
[Negative electrode active material: Graphite]

| | | | | | Retention rate of |
|---|---|---|---|---|---|
| | | Compound | | | load characteristics |
| | Nonaqueous | | Mixing | | after the |
| | solvent | Material | amount [wt %] | Overcharge controlling agent | overcharge [%] |
| Example 1-3-1 | EC/DMC/EMC = | γ-Butyrolactone | 4.12 | Overcharge Controlling Agent (1-10) | 95 |
| Example 1-3-2 | 25/40/30 | | | Overcharge Controlling Agent (1-18) | 90 |
| Example 1-3-3 | | | | Overcharge Controlling Agent (4-71) | 95 |
| Example 1-3-4 | | | | Overcharge Controlling Agent (5-3) | 88 |
| Example 1-3-5 | | | | Overcharge Controlling Agent (8-4) | 90 |
| Example 1-3-6 | | | | Overcharge Controlling Agent (12-1) | 93 |
| Example 1-3-7 | | | | Overcharge Controlling Agent (12-2) | 94 |
| Example 1-3-8 | | NMP | 4.12 | Overcharge Controlling Agent (1-10) | 91 |
| Example 1-3-9 | | | | Overcharge Controlling Agent (1-18) | 87 |
| Example 1-3-10 | | | | Overcharge Controlling Agent (4-71) | 91 |
| Example 1-3-11 | | | | Overcharge Controlling Agent (5-3) | 88 |
| Example 1-3-12 | | | | Overcharge Controlling Agent (8-4) | 85 |
| Example 1-3-13 | | | | Overcharge Controlling Agent (12-1) | 88 |
| Example 1-3-14 | | | | Overcharge Controlling Agent (12-2) | 93 |
| Example 1-3-15 | | Methyl acetate | 4.12 | Overcharge Controlling Agent (1-10) | 93 |
| Example 1-3-16 | | | | Overcharge Controlling Agent (1-18) | 86 |
| Example 1-3-17 | | | | Overcharge Controlling Agent (4-71) | 92 |
| Example 1-3-18 | | | | Overcharge Controlling Agent (5-3) | 87 |
| Example 1-3-19 | | | | Overcharge Controlling Agent (8-4) | 91 |
| Example 1-3-20 | | | | Overcharge Controlling Agent (12-1) | 89 |
| Example 1-3-21 | | | | Overcharge Controlling Agent (12-2) | 94 |
| Example 1-3-22 | | Ethyl trimethylacetate | 4.12 | Overcharge Controlling Agent (1-10) | 91 |
| Example 1-3-23 | | | | Overcharge Controlling Agent (1-18) | 88 |
| Example 1-3-24 | | | | Overcharge Controlling Agent (4-71) | 93 |
| Example 1-3-25 | | | | Overcharge Controlling Agent (5-3) | 89 |
| Example 1-3-26 | | | | Overcharge Controlling Agent (8-4) | 86 |
| Example 1-3-27 | | | | Overcharge Controlling Agent (12-1) | 87 |
| Example 1-3-28 | | | | Overcharge Controlling Agent (12-2) | 94 |
| Example 1-3-29 | | 1,2-Dimethoxyethane | 4.12 | Overcharge Controlling Agent (1-10) | 95 |
| Example 1-3-30 | | | | Overcharge Controlling Agent (1-18) | 87 |
| Example 1-3-31 | | | | Overcharge Controlling Agent (4-71) | 92 |
| Example 1-3-32 | | | | Overcharge Controlling Agent (5-3) | 88 |
| Example 1-3-33 | | | | Overcharge Controlling Agent (8-4) | 88 |
| Example 1-3-34 | | | | Overcharge Controlling Agent (12-1) | 90 |
| Example 1-3-35 | | | | Overcharge Controlling Agent (12-2) | 91 |
| Example 1-3-36 | | 1,3-Dioxane | 4.12 | Overcharge Controlling Agent (1-10) | 92 |
| Example 1-3-37 | | | | Overcharge Controlling Agent (1-18) | 90 |
| Example 1-3-38 | | | | Overcharge Controlling Agent (4-71) | 89 |
| Example 1-3-39 | | | | Overcharge Controlling Agent (5-3) | 88 |
| Example 1-3-40 | | | | Overcharge Controlling Agent (8-4) | 87 |
| Example 1-3-41 | | | | Overcharge Controlling Agent (12-1) | 88 |
| Example 1-3-42 | | | | Overcharge Controlling Agent (12-2) | 94 |
| Example 1-3-43 | | FDMC | 4.12 | Overcharge Controlling Agent (1-10) | 92 |
| Example 1-3-44 | | | | Overcharge Controlling Agent (1-18) | 83 |
| Example 1-3-45 | | | | Overcharge Controlling Agent (4-71) | 93 |
| Example 1-3-46 | | | | Overcharge Controlling Agent (5-3) | 88 |
| Example 1-3-47 | | | | Overcharge Controlling Agent (8-4) | 85 |
| Example 1-3-48 | | | | Overcharge Controlling Agent (12-1) | 87 |
| Example 1-3-49 | | | | Overcharge Controlling Agent (12-2) | 94 |

TABLE 6
[Negative electrode active material: Graphite]

| | | | | | Retention rate of load |
|---|---|---|---|---|---|
| | Nonaqueous | Compound | | | characteristics after the |
| | solvent | Material | Mixing amount [wt %] | Overcharge controlling agent | overcharge [%] |
| Example 1-3-50 | EC/DMC/EMC = | FEC | 4.12 | Overcharge Controlling Agent (1-10) | 91 |
| Example 1-3-51 | 25/40/30 | | | Overcharge Controlling Agent (1-18) | 86 |
| Example 1-3-52 | | | | Overcharge Controlling Agent (4-71) | 90 |
| Example 1-3-53 | | | | Overcharge Controlling Agent (5-3) | 87 |
| Example 1-3-54 | | | | Overcharge Controlling Agent (8-4) | 87 |
| Example 1-3-55 | | | | Overcharge Controlling Agent (12-1) | 84 |
| Example 1-3-56 | | | | Overcharge Controlling Agent (12-2) | 94 |
| Example 1-3-57 | | Sulfolane | 4.12 | Overcharge Controlling Agent (1-10) | 90 |
| Example 1-3-58 | | | | Overcharge Controlling Agent (1-18) | 87 |
| Example 1-3-59 | | | | Overcharge Controlling Agent (4-71) | 90 |
| Example 1-3-60 | | | | Overcharge Controlling Agent (5-3) | 88 |
| Example 1-3-61 | | | | Overcharge Controlling Agent (8-4) | 86 |
| Example 1-3-62 | | | | Overcharge Controlling Agent (12-1) | 86 |
| Example 1-3-63 | | | | Overcharge Controlling Agent (12-2) | 91 |
| Comparative | EC/DMC/EMC = | γ-Butyrolactone | 4.12 | — | 62 |
| Example 1-3-1 | 25/40/30 | | | | |
| Comparative | | NMP | 4.12 | | 48 |
| Example 1-3-2 | | | | | |
| Comparative | | Methyl acetate | 4.12 | | 58 |
| Example 1-3-3 | | | | | |
| Comparative | | Ethyl trimethylacetate | 4.12 | | 52 |
| Example 1-3-4 | | | | | |
| Comparative | | 1,2-Dimethoxyethane | 4.12 | | 55 |
| Example 1-3-5 | | | | | |
| Comparative | | 1,3-Dioxane | 4.12 | | 55 |
| Example 1-3-6 | | | | | |
| Comparative | | FDMC | 4.12 | | 55 |
| Example 1-3-7 | | | | | |
| Comparative | | FEC | 4.12 | | 51 |
| Example 1-3-8 | | | | | |
| Comparative | | Sulfolane | 4.12 | | 51 |
| Example 1-3-9 | | | | | |

### Examples 1-4-1 to 1-4-7

As the compound according to the present technology to be mixed in the nonaqueous electrolytic solution, LiPF₃(C₂F₅)₃ that is a thermally stable salt was used, and the thermally stable salt was mixed in a concentration of 0.1 moles/kg. Also, the concentration of lithium hexafluorophosphate (LiPF₆) that is an electrolyte salt was set to 0.9 moles/kg. At that time, the content of LiPF₃(C₂F₅)₃ that is a thermally stable salt in the whole composition of the nonaqueous electrolytic solution was 3.63% by mass. Except for that matter, test batteries of Examples 1-4-1 to 1-4-7 were respectively fabricated in the same manners as those in Examples 1-1-1 to 1-1-7.

### Examples 1-4-8 to 1-4-14

Test batteries of Examples 1-4-8 to 1-4-14 were respectively fabricated in the same manners as those in Examples 1-4-1 to 1-4-7, except that the compound according to the present technology to be mixed in the nonaqueous electrolytic solution was changed to LiPF₄(CF₃)₂ that is a thermally stable salt. Incidentally, the content of LiPF₄(CF₃)₂ that is a thermally stable salt in the whole composition of the nonaqueous electrolytic solution was 2.06% by mass.

### Examples 1-4-15 to 1-4-21

Test batteries of Examples 1-4-15 to 1-4-21 were respectively fabricated in the same manners as those in Examples 1-4-1 to 1-4-7, except that the compound according to the present technology to be mixed in the nonaqueous electrolytic solution was changed to LiBF(C₂F₅)₃ that is a thermally stable salt. Incidentally, the content of LiBF(C₂F₅)₃ that is a thermally stable salt in the whole composition of the nonaqueous electrolytic solution was 3.18% by mass.

### Examples 1-4-22 to 1-4-28

Test batteries of Examples 1-4-22 to 1-4-28 were respectively fabricated in the same manners as those in Examples 1-4-1 to 1-4-7, except that the compound according to the present technology to be mixed in the nonaqueous electrolytic solution was changed to LiBF₂(C₂F₅)₂ that is a thermally stable salt. Incidentally, the content of LiBF₂(C₂F₅)₂ that is a thermally stable salt in the whole composition of the nonaqueous electrolytic solution was 2.40% by mass.

### Examples 1-4-29 to 1-4-35

Test batteries of Examples 1-4-29 to 1-4-35 were respectively fabricated in the same manners as those in Examples 1-4-1 to 1-4-7, except that the compound according to the present technology to be mixed in the nonaqueous electrolytic solution was changed to LiBF₃(C₂F₅) that is a thermally stable salt. Incidentally, the content of LiBF₃(C₂F₅) that is a thermally stable salt in the whole composition of the nonaqueous electrolytic solution was 3.48% by mass.

### Examples 1-4-36 to 1-4-42

Test batteries of Examples 1-4-36 to 1-4-42 were respectively fabricated in the same manners as those in Examples 1-4-1 to 1-4-7, except that the compound according to the present technology to be mixed in the nonaqueous electrolytic solution was changed to LiN(SO₂CF₃)₂ that is a thermally stable salt. Incidentally, the content of LiN(SO₂CF₃)₂ that is a thermally stable salt in the whole composition of the nonaqueous electrolytic solution was 2.34% by mass.

### Examples 1-4-43 to 1-4-49

Test batteries of Examples 1-4-43 to 1-4-49 were respectively fabricated in the same manners as those in Examples 1-4-1 to 1-4-7, except that the compound according to the present technology to be mixed in the nonaqueous electrolytic solution was changed to LiN(SO₂C₂F₅)₂ that is a thermally stable salt. Incidentally, the content of LiN(SO₂C₂F₅)₂ that is a thermally stable salt in the whole composition of the nonaqueous electrolytic solution was 3.13% by mass.

### Examples 1-4-50 to 1-4-56

Test batteries of Examples 1-4-50 to 1-4-56 were respectively fabricated in the same manners as those in Examples 1-4-1 to 1-4-7, except that the compound according to the present technology to be mixed in the nonaqueous electrolytic solution was changed to LiN(SO₂F)₂ that is a thermally stable salt. Incidentally, the content of LiN(SO₂F)₂ that is a thermally stable salt in the whole composition of the nonaqueous electrolytic solution was 1.54% by mass.

### Comparative Examples 1-4-1 to 1-4-8

Test batteries of Comparative Examples 1-4-1 to 1-4-8 were respectively fabricated in the same manners as those in Examples 1-4-1, 1-4-8, 1-4-15, 1-4-22, 1-4-29, 1-4-36, 1-4-43, and 1-4-50, except that the compound according to the present technology was not mixed in the nonaqueous electrolytic solution.

[Evaluation of Battery: Load Characteristics after the Overcharge]

With respect to the respective Examples and Comparative Examples, the load characteristics after the overcharge were confirmed in the same manner as that in Example 1-1-1.

Evaluation results are shown in the following Tables 7 and 8.

TABLE 7
[Negative electrode active material: Graphite]

| | Electrolyte salt | | Compound | | | Retention rate of load |
|---|---|---|---|---|---|---|
| | | Mixing amount | | Mixing amount | | characteristics after |
| | Material | [moles/kg] | Material | [wt %] | Overcharge controlling agent | the overcharge [%] |
| Example 1-4-1 | LiPF₆ | 0.9 | LiPF₃(C₂F₅)₃ | 3.63 | Overcharge Controlling Agent (1-10) | 91 |
| Example 1-4-2 | | | | | Overcharge Controlling Agent (1-18) | 84 |
| Example 1-4-3 | | | | | Overcharge Controlling Agent (4-71) | 77 |
| Example 1-4-4 | | | | | Overcharge Controlling Agent (5-3) | 91 |
| Example 1-4-5 | | | | | Overcharge Controlling Agent (8-4) | 85 |
| Example 1-4-6 | | | | | Overcharge Controlling Agent (12-1) | 80 |
| Example 1-4-7 | | | | | Overcharge Controlling Agent (12-2) | 80 |
| Example 1-4-8 | | | LiPF₄(CF₃)₂ | 2.06 | Overcharge Controlling Agent (1-10) | 88 |
| Example 1-4-9 | | | | | Overcharge Controlling Agent (1-18) | 89 |
| Example 1-4-10 | | | | | Overcharge Controlling Agent (4-71) | 84 |
| Example 1-4-11 | | | | | Overcharge Controlling Agent (5-3) | 78 |
| Example 1-4-12 | | | | | Overcharge Controlling Agent (8-4) | 92 |
| Example 1-4-13 | | | | | Overcharge Controlling Agent (12-1) | 83 |
| Example 1-4-14 | | | | | Overcharge Controlling Agent (12-2) | 78 |
| Example 1-4-15 | | | LiBF(C₂F₅)₃ | 3.18 | Overcharge Controlling Agent (1-10) | 79 |
| Example 1-4-16 | | | | | Overcharge Controlling Agent (1-18) | 91 |
| Example 1-4-17 | | | | | Overcharge Controlling Agent (4-71) | 90 |
| Example 1-4-18 | | | | | Overcharge Controlling Agent (5-3) | 83 |
| Example 1-4-19 | | | | | Overcharge Controlling Agent (8-4) | 75 |
| Example 1-4-20 | | | | | Overcharge Controlling Agent (12-1) | 94 |
| Example 1-4-21 | | | | | Overcharge Controlling Agent (12-2) | 80 |
| Example 1-4-22 | | | LiBF₂(C₂F₅)₂ | 2.40 | Overcharge Controlling Agent (1-10) | 78 |
| Example 1-4-23 | | | | | Overcharge Controlling Agent (1-18) | 80 |
| Example 1-4-24 | | | | | Overcharge Controlling Agent (4-71) | 90 |
| Example 1-4-25 | | | | | Overcharge Controlling Agent (5-3) | 92 |
| Example 1-4-26 | | | | | Overcharge Controlling Agent (8-4) | 83 |
| Example 1-4-27 | | | | | Overcharge Controlling Agent (12-1) | 75 |
| Example 1-4-28 | | | | | Overcharge Controlling Agent (12-2) | 92 |
| Example 1-4-29 | | | LiBF₃(C₂F₅) | 3.48 | Overcharge Controlling Agent (1-10) | 82 |
| Example 1-4-30 | | | | | Overcharge Controlling Agent (1-18) | 78 |
| Example 1-4-31 | | | | | Overcharge Controlling Agent (4-71) | 84 |
| Example 1-4-32 | | | | | Overcharge Controlling Agent (5-3) | 85 |
| Example 1-4-33 | | | | | Overcharge Controlling Agent (8-4) | 95 |
| Example 1-4-34 | | | | | Overcharge Controlling Agent (12-1) | 84 |
| Example 1-4-35 | | | | | Overcharge Controlling Agent (12-2) | 78 |
| Example 1-4-36 | | | LiN(SO₂CF₃)₂ | 2.34 | Overcharge Controlling Agent (1-10) | 93 |
| Example 1-4-37 | | | | | Overcharge Controlling Agent (1-18) | 81 |
| Example 1-4-38 | | | | | Overcharge Controlling Agent (4-71) | 82 |
| Example 1-4-39 | | | | | Overcharge Controlling Agent (5-3) | 83 |
| Example 1-4-40 | | | | | Overcharge Controlling Agent (8-4) | 87 |
| Example 1-4-41 | | | | | Overcharge Controlling Agent (12-1) | 93 |
| Example 1-4-42 | | | | | Overcharge Controlling Agent (12-2) | 84 |
| Example 1-4-43 | | | LiN(SO₂C₂F₅)₂ | 3.13 | Overcharge Controlling Agent (1-10) | 78 |
| Example 1-4-44 | | | | | Overcharge Controlling Agent (1-18) | 93 |
| Example 1-4-45 | | | | | Overcharge Controlling Agent (4-71) | 81 |
| Example 1-4-46 | | | | | Overcharge Controlling Agent (5-3) | 81 |
| Example 1-4-47 | | | | | Overcharge Controlling Agent (8-4) | 82 |
| Example 1-4-48 | | | | | Overcharge Controlling Agent (12-1) | 88 |
| Example 1-4-49 | | | | | Overcharge Controlling Agent (12-2) | 92 |

TABLE 8
[Negative electrode active material: Graphite]

| | Electrolyte salt | | Compound | | | Retention rate of load |
|---|---|---|---|---|---|---|
| | | Mixing amount | | Mixing amount | | characteristics after |
| | Material | [moles/kg] | Material | [wt %] | Overcharge controlling agent | the overcharge [%] |
| Example 1-4-50 | LiPF₆ | 0.9 | LiN(SO₂F)₂ | 1.54 | Overcharge Controlling Agent (1-10) | 88 |
| Example 1-4-51 | | | | | Overcharge Controlling Agent (1-18) | 79 |
| Example 1-4-52 | | | | | Overcharge Controlling Agent (4-71) | 95 |
| Example 1-4-53 | | | | | Overcharge Controlling Agent (5-3) | 82 |
| Example 1-4-54 | | | | | Overcharge Controlling Agent (8-4) | 82 |
| Example 1-4-55 | | | | | Overcharge Controlling Agent (12-1) | 80 |
| Example 1-4-56 | | | | | Overcharge Controlling Agent (12-2) | 90 |
| Comparative | LiPF₆ | 0.9 | LiPF₃(C₂F₅)3 | 3.63 | — | 52 |
| Example 1-4-1 | | | | | | |
| Comparative | | | LiPF₄(CF₃)₂ | 2.06 | | 53 |
| Example 1-4-2 | | | | | | |
| Comparative | | | LiBF(C₂F₅)₃ | 3.18 | | 49 |
| Example 1-4-3 | | | | | | |
| Comparative | | | LiBF₂(C₂F₅)₂ | 2.40 | | 56 |
| Example 1-4-4 | | | | | | |
| Comparative | | | LiBF₃(C₂F₅) | 3.48 | | 56 |
| Example 1-4-5 | | | | | | |
| Comparative | | | LiN(SO₂CF₃)₂ | 2.34 | | 51 |
| Example 1-4-6 | | | | | | |
| Comparative | | | LiN(SO₂C₂F₅)₂ | 3.13 | | 50 |
| Example 1-4-7 | | | | | | |
| Comparative | | | LiN(SO₂F)₂ | 1.54 | | 51 |
| Example 1-4-8 | | | | | | |

As is clear from Tables 2 to 8, in Examples 1-1-1 to 1-1-77, Examples 1-2-1 to 1-2-42, Examples 1-3-1 to 1-3-63, and Examples 1-4-1 to 1-4-56, in which the compound according to the present technology was added, the retention rate of load characteristics after the overcharge cycle was significantly larger than that in Comparative Examples 1-1-1 to 1-1-7, in which only the overcharge controlling agent was added. Also, in these Examples, the retention rate of load characteristics after the overcharge cycle was significantly enhanced as compared with that in Comparative Examples 1-1-8 to Comparative Examples 1-1-18, in which only the compound according to the present technology was added, but the overcharge controlling agent was not added. That is, a high retention rate of load characteristics could be realized by jointly using the overcharge controlling agent and the compound according to the present technology.

### Example 1-5-1

As the compound according to the present technology to be mixed in the nonaqueous electrolytic solution, both succinic anhydride (Compound 1) that is a protective film forming agent and 1,3-dioxane (Compound 2) that is a solvent based protective film forming agent were added. The succinic anhydride was mixed in a concentration of 1.0% by mass in the whole composition of the nonaqueous electrolytic solution. The 1,3-dioxane was mixed together with ethylene carbonate (EC), dimethyl carbonate (DMC), and ethylmethyl carbonate (EMC) in a proportion of EC/DMC/EMC/1,3-dioxane of 25/40/30/5 (mass ratio). That is, the nonaqueous solvents were mixed in a ratio of EC/DMC/EMC of 25/40/30 (mass ratio), and a ratio of 1,3-dioxane was adjusted to 4.08% by mass relative to the whole of the nonaqueous electrolytic solution. Except for that matter, a test battery of Example 1-5-1 was fabricated in the same manner as that in Example 1-1-1.

### Example 1-5-2

A test battery was fabricated in the same manner as that in Example 1-5-1, except that the solvent based protective film forming agent to be mixed in the nonaqueous electrolytic solution was changed to 4-fluoro-1,3-dioxolan-2-one (FEC). Incidentally, the content of 4-fluoro-1,3-dioxolan-2-one (FEC) that is a solvent based protective film forming agent in the whole composition of the nonaqueous electrolytic solution was 4.08% by mass.

### Examples 1-5-3 to 1-5-4

Test batteries of Examples 1-5-3 to 1-5-4 were respectively fabricated in the same manners as those in Examples 1-5-1 and 1-5-2, except that propanedisulfonic anhydride was used as the protective film forming agent to be mixed in the nonaqueous electrolytic solution in place of the succinic anhydride.

### Examples 1-5-5 to 1-5-6

Test batteries of Examples 1-5-5 to 1-5-6 were respectively fabricated in the same manners as those in Examples 1-5-1 and 1-5-2, except that vinylene carbonate (VC) was used as the protective film forming agent to be mixed in the nonaqueous electrolytic solution in place of the succinic anhydride.

### Examples 1-5-7 to 1-5-8

Test batteries of Examples 1-5-7 to 1-5-8 were respectively fabricated in the same manners as those in Examples 1-5-1 and 1-5-2, except that trans-4,5-difluoro-1,3-dioxolan-2-one (t-DFEC) was used as the protective film forming agent to be mixed in the nonaqueous electrolytic solution in place of the succinic anhydride.

### Examples 1-5-9 to 1-5-10

Test batteries of Examples 1-5-9 to 1-5-10 were respectively fabricated in the same manners as those in Examples 1-5-1 and 1-5-2, except that lithium tetrafluoroborate (LiBF₄) was used as the protective film forming agent to be mixed in the nonaqueous electrolytic solution in place of the succinic anhydride, and its mixing amount was set to 0.1 moles/kg. Incidentally, in Examples 1-5-9 to 1-5-10, the concentration of lithium hexafluoroborate (LiPF₆) that is an electrolyte salt was set to 0.9 moles/kg. Also, the content of lithium tetrafluoroborate (LiBF₄) in the whole composition of the nonaqueous electrolytic solution was 0.78% by mass.

### Examples 1-5-11 to 1-5-20

Test batteries of Examples 1-5-11 to 1-5-20 were respectively fabricated in the same manners as those in Examples 1-5-1 to 1-5-10, except that Overcharge Controlling Agent (1-18) was used as the overcharge controlling agent to be mixed in the nonaqueous electrolytic solution in place of the Overcharge Controlling Agent (1-10).

### Examples 1-5-21 to 1-5-30

Test batteries of Examples 1-5-21 to 1-5-30 were respectively fabricated in the same manners as those in Examples 1-5-1 to 1-5-10, except that Overcharge Controlling Agent (4-71) was used as the overcharge controlling agent to be mixed in the nonaqueous electrolytic solution in place of the Overcharge Controlling Agent (1-10).

### Examples 1-5-31 to 1-5-40

Test batteries of Examples 1-5-31 to 1-5-40 were respectively fabricated in the same manners as those in Examples 1-5-1 to 1-5-10, except that Overcharge Controlling Agent (5-3) was used as the overcharge controlling agent to be mixed in the nonaqueous electrolytic solution in place of the Overcharge Controlling Agent (1-10).

### Examples 1-5-41 to 1-5-50

Test batteries of Examples 1-5-41 to 1-5-50 were respectively fabricated in the same manners as those in Examples 1-5-1 to 1-5-10, except that Overcharge Controlling Agent (8-4) was used as the overcharge controlling agent to be mixed in the nonaqueous electrolytic solution in place of the Overcharge Controlling Agent (1-10).

### Examples 1-5-51 to 1-5-60

Test batteries of Examples 1-5-51 to 1-5-60 were respectively fabricated in the same manners as those in Examples 1-5-1 to 1-5-10, except that Overcharge Controlling Agent (12-1) was used as the overcharge controlling agent to be mixed in the nonaqueous electrolytic solution in place of the Overcharge Controlling Agent (1-10).

### Examples 1-5-61 to 1-5-70

Test batteries of Examples 1-5-61 to 1-5-70 were respectively fabricated in the same manners as those in Examples 1-5-1 to 1-5-10, except that Overcharge Controlling Agent (12-2) was used as the overcharge controlling agent to be mixed in the nonaqueous electrolytic solution in place of the Overcharge Controlling Agent (1-10).

[Evaluation of Battery: Load Characteristics after the Overcharge]

With respect to the respective Examples, the load characteristics after the overcharge were confirmed in the same manner as that in Example 1-1-1.

Evaluation results are shown in the following Tables 9 and 10.

TABLE 9
[Negative electrode active material: Graphite]

| | | | | | | | | | Retention rate |
|---|---|---|---|---|---|---|---|---|---|
| | | Electrolyte salt | | Compound 1 | | Compound 2 | | | of load character- |
| | | | Mixing | | Mixing | | Mixing | Overcharge | istics after the |
| | Nonaqueous solvent | | amount | | amount | | amount | controlling | overcharge |
| | [mass ratio] | Material | [moles/kg] | Material | [wt %] | Material | [wt %] | agent | [%] |
| Example 1-5-1 | EC/DMC/EMC = | LiPF₆ | 1.0 | Succinic | 1.0 | 1,3-Dixoane | 4.08 | Overcharge | 98 |
| Example 1-5-2 | 25/40/30 | | | anhydride | | FEC | | controlling | 92 |
| Example 1-5-3 | | | | Propanedisulfonic | | 1,3-Dixoane | | agent (1-10) | 89 |
| Example 1-5-4 | | | | anhydride | | FEC | | | 93 |
| Example 1-5-5 | | | | VC | | 1,3-Dixoane | | | 95 |
| Example 1-5-6 | | | | | | FEC | | | 94 |
| Example 1-5-7 | | | | t-DFEC | | 1,3-Dixoane | | | 89 |
| Example 1-5-8 | | | | | | FEC | | | 92 |
| Example 1-5-9 | | LiPF₆ | 0.9 | LiBF₄ | 0.78 | 1,3-Dixoane | | | 95 |
| Example 1-5-10 | | | | | | FEC | | | 94 |
| Example 1-5-11 | | LiPF₆ | 1.0 | Succinic | 1.0 | 1,3-Dixoane | 4.08 | Overcharge | 96 |
| Example 1-5-12 | | | | anhydride | | FEC | | controlling | 93 |
| Example 1-5-13 | | | | Propanedisulfonic | | 1,3-Dixoane | | agent (1-18) | 89 |
| Example 1-5-14 | | | | anhydride | | FEC | | | 89 |
| Example 1-5-15 | | | | VC | | 1,3-Dixoane | | | 92 |
| Example 1-5-16 | | | | | | FEC | | | 98 |
| Example 1-5-17 | | | | t-DFEC | | 1,3-Dixoane | | | 92 |
| Example 1-5-18 | | | | | | FEC | | | 94 |
| Example 1-5-19 | | LiPF₆ | 0.9 | LiBF₄ | 0.78 | 1,3-Dixoane | | | 92 |
| Example 1-5-20 | | | | | | FEC | | | 98 |
| Example 1-5-21 | | LiPF₆ | 1.0 | Succinic | 1.0 | 1,3-Dixoane | 4.08 | Overcharge | 97 |
| Example 1-5-22 | | | | anhydride | | FEC | | controlling | 96 |
| Example 1-5-23 | | | | Propanedisulfonic | | 1,3-Dixoane | | agent (4-71) | 94 |
| Example 1-5-24 | | | | anhydride | | FEC | | | 88 |
| Example 1-5-25 | | | | VC | | 1,3-Dixoane | | | 99 |
| Example 1-5-26 | | | | | | FEC | | | 92 |
| Example 1-5-27 | | | | t-DFEC | | 1,3-Dixoane | | | 97 |
| Example 1-5-28 | | | | | | FEC | | | 88 |
| Example 1-5-29 | | LiPF₆ | 0.9 | LiBF₄ | 078 | 1,3-Dixoane | | | 96 |
| Example 1-5-30 | | | | | | FEC | | | 88 |
| Example 1-5-31 | | LiPF₆ | 1.0 | Succinic | 1.0 | 1,3-Dixoane | 4.08 | Overcharge | 85 |
| Example 1-5-32 | | | | anhydride | | FEC | | controlling | 93 |
| Example 1-5-33 | | | | Propanedisulfonic | | 1,3-Dixoane | | agent (5-3) | 96 |
| Example 1-5-34 | | | | anhydride | | FEC | | | 93 |
| Example 1-5-35 | | | | VC | | 1,3-Dixoane | | | 94 |
| Example 1-5-36 | | | | | | FEC | | | 96 |

TABLE 10
[Negative electrode active material: Graphite]

| | | | | | | | | | Retention rate |
|---|---|---|---|---|---|---|---|---|---|
| | | Electrolyte salt | | Compound 1 | | Compound 2 | | | of load character- |
| | | | Mixing | | Mixing | | Mixing | Overcharge | istics after the |
| | Nonaqueous solvent | | amount | | amount | | amount | controlling | overcharge |
| | [mass ratio] | Material | [moles/kg] | Material | [wt %] | Material | [wt %] | agent | [%] |
| Example 1-5-37 | EC/DMC/EMC = | LiPF₆ | 1.0 | t-DFEC | 1.0 | 1,3-Dixoane | 4.08 | Overcharge | 90 |
| Example 1-5-38 | 25/40/30 | | | | | FEC | | controlling | 93 |
| Example 1-5-39 | | LiPF₆ | 0.9 | LiBF₄ | 0.78 | 1,3-Dixoane | | agent (5-3) | 94 |
| Example 1-5-40 | | | | | | FEC | | | 89 |
| Example 1-5-41 | | LiPF₆ | 1.0 | Succinic | 1.0 | 1,3-Dixoane | 4.08 | Overcharge | 90 |
| Example 1-5-42 | | | | anhydride | | FEC | | controlling | 88 |
| Example 1-5-43 | | | | Propanedisulfonic | | 1,3-Dixoane | | agent (8-4) | 94 |
| Example 1-5-44 | | | | anhydride | | FEC | | | 91 |
| Example 1-5-45 | | | | VC | | 1,3-Dixoane | | | 93 |
| Example 1-5-46 | | | | | | FEC | | | 96 |
| Example 1-5-47 | | | | t-DFEC | | 1,3-Dixoane | | | 97 |
| Example 1-5-48 | | | | | | FEC | | | 92 |
| Example 1-5-49 | | LiPF₆ | 0.9 | LiBF₄ | 0.78 | 1,3-Dixoane | | | 90 |
| Example 1-5-50 | | | | | | FEC | | | 98 |
| Example 1-5-51 | | LiPF₆ | 1.0 | Succinic | 1.0 | 1,3-Dixoane | 4.08 | Overcharge | 96 |
| Example 1-5-52 | | | | anhydride | | FEC | | controlling | 95 |
| Example 1-5-53 | | | | Propanedisulfonic | | 1,3-Dixoane | | agent (12-1) | 88 |
| Example 1-5-54 | | | | anhydride | | FEC | | | 90 |
| Example 1-5-55 | | | | VC | | 1,3-Dixoane | | | 90 |
| Example 1-5-56 | | | | | | FEC | | | 90 |
| Example 1-5-57 | | | | t-DFEC | | 1,3-Dixoane | | | 97 |
| Example 1-5-58 | | | | | | FEC | | | 98 |
| Example 1-5-59 | | LiPF₆ | 0.9 | LiBF₄ | 0.78 | 1,3-Dixoane | | | 92 |
| Example 1-5-60 | | | | | | FEC | | | 98 |
| Example 1-5-61 | | LiPF₆ | 1.0 | Succinic | 1.0 | 1,3-Dixoane | 4.08 | Overcharge | 95 |
| Example 1-5-62 | | | | anhydride | | FEC | | controlling | 94 |
| Example 1-5-63 | | | | Propanedisulfonic | | 1,3-Dixoane | | agent (12-2) | 90 |
| Example 1-5-64 | | | | anhydride | | FEC | | | 91 |
| Example 1-5-65 | | | | VC | | 1,3-Dixoane | | | 95 |
| Example 1-5-66 | | | | | | FEC | | | 96 |
| Example 1-5-67 | | | | t-DFEC | | 1,3-Dixoane | | | 89 |
| Example 1-5-68 | | | | | | FEC | | | 89 |
| Example 1-5-69 | | LiPF₆ | 0.9 | LiBF₄ | 0.78 | 1,3-Dixoane | | | 96 |
| Example 1-5-70 | | | | | | FEC | | | 97 |

### Example 1-6-1

As the compound according to the present technology to be mixed in the nonaqueous electrolytic solution, both succinonitrile (Compound 1) that is a complex forming agent and 1,3-dioxane (Compound 2) that is a solvent based protective film forming agent were added. The succinonitrile was mixed in a concentration of 1.0% by mass in the whole composition of the nonaqueous electrolytic solution. The 1,3-dioxane was mixed together with ethylene carbonate (EC), dimethyl carbonate (DMC), and ethylmethyl carbonate (EMC) in a proportion of EC/DMC/EMC/1,3-dioxane of 25/40/30/5 (mass ratio). That is, the nonaqueous solvents were mixed in a ratio of EC/DMC/EMC of 25/40/30 (mass ratio), and a ratio of 1,3-dioxane was adjusted to 4.08% by mass relative to the whole of the nonaqueous electrolytic solution. Except for that matter, a test battery of Example 1-6-1 was fabricated in the same manner as that in Example 1-1-1.

### Example 1-6-2

A test battery was fabricated in the same manner as that in Example 1-6-1, except that the solvent based protective film forming agent to be mixed in the nonaqueous electrolytic solution was changed to 4-fluoro-1,3-dioxolan-2-one (FEC). Incidentally, the content of 4-fluoro-1,3-dioxolan-2-one (FEC) that is a solvent based protective film forming agent in the whole composition of the nonaqueous electrolytic solution was 4.08% by mass.

### Examples 1-6-3 to 1-6-4

Test batteries of Examples 1-6-3 to 1-6-4 were respectively fabricated in the same manners as those in Examples 1-6-1 and 1-6-2, except that adiponitrile was used as the protective film forming agent to be mixed in the nonaqueous electrolytic solution in place of the succinonitrile.

### Examples 1-6-5 to 1-6-6

Test batteries of Examples 1-6-5 to 1-6-6 were respectively fabricated in the same manners as those in Examples 1-6-1 and 1-6-2, except that 7,7,8,8-tetracyanoquinodimethane was used as the protective film forming agent to be mixed in the nonaqueous electrolytic solution in place of the succinonitrile.

### Examples 1-6-7 to 1-6-8

Test batteries of Examples 1-6-7 to 1-6-8 were respectively fabricated in the same manners as those in Examples 1-6-1 and 1-6-2, except that acetonitrile was used as the protective film forming agent to be mixed in the nonaqueous electrolytic solution in place of the succinonitrile.

### Examples 1-6-9 to 1-6-16

Test batteries of Examples 1-6-9 to 1-6-16 were respectively fabricated in the same manners as those in Examples 1-6-1 to 1-6-8, except that Overcharge Controlling Agent (1-18) was used as the overcharge controlling agent to be mixed in the nonaqueous electrolytic solution in place of the Overcharge Controlling Agent (1-10).

### Examples 1-6-17 to 1-6-24

Test batteries of Examples 1-6-17 to 1-6-24 were respectively fabricated in the same manners as those in Examples 1-6-1 to 1-6-8, except that Overcharge Controlling Agent (4-71) was used as the overcharge controlling agent to be mixed in the nonaqueous electrolytic solution in place of the Overcharge Controlling Agent (1-10).

### Examples 1-6-25 to 1-6-32

Test batteries of Examples 1-6-25 to 1-6-32 were respectively fabricated in the same manners as those in Examples 1-6-1 to 1-6-8, except that Overcharge Controlling Agent (5-3) was used as the overcharge controlling agent to be mixed in the nonaqueous electrolytic solution in place of the Overcharge Controlling Agent (1-10).

### Examples 1-6-33 to 1-6-40

Test batteries of Examples 1-6-33 to 1-6-40 were respectively fabricated in the same manners as those in Examples 1-6-1 to 1-6-8, except that Overcharge Controlling Agent (8-4) was used as the overcharge controlling agent to be mixed in the nonaqueous electrolytic solution in place of the Overcharge Controlling Agent (1-10).

### Examples 1-6-41 to 1-6-48

Test batteries of Examples 1-6-41 to 1-6-48 were respectively fabricated in the same manners as those in Examples 1-6-1 to 1-6-8, except that Overcharge Controlling Agent (12-1) was used as the overcharge controlling agent to be mixed in the nonaqueous electrolytic solution in place of the Overcharge Controlling Agent (1-10).

### Examples 1-6-49 to 1-6-56

Test batteries of Examples 1-6-49 to 1-6-56 were respectively fabricated in the same manners as those in Examples 1-6-1 to 1-6-8, except that Overcharge Controlling Agent (12-2) was used as the overcharge controlling agent to be mixed in the nonaqueous electrolytic solution in place of the Overcharge Controlling Agent (1-10).

[Evaluation of Battery: Load Characteristics after the Overcharge]

With respect to the respective Examples, the load characteristics after the overcharge were confirmed in the same manner as that in Example 1-1-1.

Evaluation results are shown in the following Tables 11 and 12.

TABLE 11
[Negative electrode active material: Graphite]

| | | | | | | | | | Retention rate |
|---|---|---|---|---|---|---|---|---|---|
| | | | | | | | | | of load |
| | | Electrolyte salt | | Compound 1 | | Compound 2 | | | characteristics |
| | Nonaqueous | | Mixing | | Mixing | | Mixing | Overcharge | after the |
| | solvent [mass | | amount | | amount | | amount | controlling | overcharge |
| | ratio] | Material | [moles/kg] | Material | [wt %] | Material | [wt %] | agent | [%] |
| Example 1-6-1 | EC/DMC/EMC = | LiPF₆ | 1.0 | Succinonitrile | 1.0 | 1,3-Dixoane | 4.08 | Overcharge | 84 |
| Example 1-6-2 | 25/40/30 | | | | | FEC | | controlling | 87 |
| Example 1-6-3 | | | | Adiponitrile | | 1,3-Dixoane | | agent (1-10) | 84 |
| Example 1-6-4 | | | | | | FEC | | | 90 |
| Example 1-6-5 | | | | 7,7,8,8-Tetracyano- | | 1,3-Dixoane | | | 83 |
| Example 1-6-6 | | | | quinodimentane | | FEC | | | 81 |
| Example 1-6-7 | | | | Acetonitrile | | 1,3-Dixoane | | | 90 |
| Example 1-6-8 | | | | | | FEC | | | 89 |
| Example 1-6-9 | | LiPF₆ | 1.0 | Succinonitrile | 1.0 | 1,3-Dixoane | 4.08 | Overcharge | 86 |
| Example 1-6-10 | | | | | | FEC | | controlling | 87 |
| Example 1-6-11 | | | | Adiponitrile | | 1,3-Dixoane | | agent (1-18) | 87 |
| Example 1-6-12 | | | | | | FEC | | | 87 |
| Example 1-6-13 | | | | 7,7,8,8-Tetracyano- | | 1,3-Dixoane | | | 93 |
| Example 1-6-14 | | | | quinodimentane | | FEC | | | 92 |
| Example 1-6-15 | | | | Acetonitrile | | 1,3-Dixoane | | | 89 |
| Example 1-6-16 | | | | | | FEC | | | 90 |
| Example 1-6-17 | | LiPF₆ | 1.0 | Succinonitrile | 1.0 | 1,3-Dixoane | 4.08 | Overcharge | 93 |
| Example 1-6-18 | | | | | | FEC | | controlling | 93 |
| Example 1-6-19 | | | | Adiponitrile | | 1,3-Dixoane | | agent (4-71) | 90 |
| Example 1-6-20 | | | | | | FEC | | | 88 |
| Example 1-6-21 | | | | 7,7,8,8-Tetracyano- | | 1,3-Dixoane | | | 91 |
| Example 1-6-22 | | | | quinodimentane | | FEC | | | 84 |
| Example 1-6-23 | | | | Acetonitrile | | 1,3-Dixoane | | | 91 |
| Example 1-6-24 | | | | | | FEC | | | 90 |
| Example 1-6-25 | | LiPF₆ | 1.0 | Succinonitrile | 1.0 | 1,3-Dixoane | 4.08 | Overcharge | 89 |
| Example 1-6-26 | | | | | | FEC | | controlling | 89 |
| Example 1-6-27 | | | | Adiponitrile | | 1,3-Dixoane | | agent (5-3) | 96 |
| Example 1-6-28 | | | | | | FEC | | | 93 |
| Example 1-6-29 | | | | 7,7,8,8-Tetracyano- | | 1,3-Dixoane | | | 88 |
| Example 1-6-30 | | | | quinodimentane | | FEC | | | 91 |
| Example 1-6-31 | | | | Acetonitrile | | 1,3-Dixoane | | | 91 |
| Example 1-6-32 | | | | | | FEC | | | 89 |

TABLE 12
[Negative electrode active material: Graphite]

| | | | | | | | | | Retention rate |
|---|---|---|---|---|---|---|---|---|---|
| | | | | | | | | | of load |
| | | Electrolyte salt | | Compound 1 | | Compound 2 | | | characteristics |
| | Nonaqueous | | Mixing | | Mixing | | Mixing | Overcharge | after the |
| | solvent [mass | | amount | | amount | | amount | controlling | overcharge |
| | ratio] | Material | [moles/kg] | Material | [wt %] | Material | [wt %] | agent | [%] |
| Example 1-6-33 | EC/DMC/EMC = | LiPF₆ | 1.0 | Succinonitrile | 1.0 | 1,3-Dixoane | 4.08 | Overcharge | 98 |
| Example 1-6-34 | 25/40/30 | | | | | FEC | | controlling | 95 |
| Example 1-6-35 | | | | Adiponitrile | | 1,3-Dixoane | | agent (8-4) | 94 |
| Example 1-6-36 | | | | | | FEC | | | 92 |
| Example 1-6-37 | | | | 7,7,8,8-Tetracyano- | | 1,3-Dixoane | | | 95 |
| Example 1-6-38 | | | | quinodimentane | | FEC | | | 95 |
| Example 1-6-39 | | | | Acetonitrile | | 1,3-Dixoane | | | 89 |
| Example 1-6-40 | | | | | | FEC | | | 94 |
| Example 1-6-41 | | LiPF₆ | 1.0 | Succinonitrile | 1.0 | 1,3-Dixoane | 4.08 | Overcharge | 94 |
| Example 1-6-42 | | | | | | FEC | | controlling | 93 |
| Example 1-6-43 | | | | Adiponitrile | | 1,3-Dixoane | | agent (12-1) | 94 |
| Example 1-6-44 | | | | | | FEC | | | 90 |
| Example 1-6-45 | | | | 7,7,8,8-Tetracyano- | | 1,3-Dixoane | | | 98 |
| Example 1-6-46 | | | | quinodimentane | | FEC | | | 93 |
| Example 1-6-47 | | | | Acetonitrile | | 1,3-Dixoane | | | 93 |
| Example 1-6-48 | | | | | | FEC | | | 93 |
| Example 1-6-49 | | LiPF₆ | 1.0 | Succinonitrile | 1.0 | 1,3-Dixoane | 4.08 | Overcharge | 92 |
| Example 1-6-50 | | | | | | FEC | | controlling | 92 |
| Example 1-6-51 | | | | Adiponitrile | | 1,3-Dixoane | | agent (12-2) | 90 |
| Example 1-6-52 | | | | | | FEC | | | 93 |
| Example 1-6-53 | | | | 7,7,8,8-Tetracyano- | | 1,3-Dixoane | | | 94 |
| Example 1-6-54 | | | | quinodimentane | | FEC | | | 93 |
| Example 1-6-55 | | | | Acetonitrile | | 1,3-Dixoane | | | 91 |
| Example 1-6-56 | | | | | | FEC | | | 93 |

### Example 1-7-1

As the compound according to the present technology to be mixed in the nonaqueous electrolytic solution, both LiPF₃(C₂F₅)₃ (Compound 1) that is a thermally stable salt and 1,3-dioxane (Compound 2) that is a solvent based protective film forming agent were added. LiPF₃(C₂F₅)₃ was mixed in a concentration of 0.1 moles/kg in the whole composition of the nonaqueous electrolytic solution, and the concentration of lithium hexafluorophosphate (LiPF₆) that is a thermally stable salt was set to 0.9 moles/kg. At that time, the content of LiPF₃(C₂F₅)₃ (Compound 1) that is a thermally stable salt in the whole composition of the nonaqueous electrolytic solution was 3.63% by mass. The 1,3-dioxane was mixed together with ethylene carbonate (EC), dimethyl carbonate (DMC), and ethylmethyl carbonate (EMC) in a proportion of EC/DMC/EMC/1,3-dioxane of 25/40/30/5 (mass ratio). That is, the nonaqueous solvents were mixed in a ratio of EC/DMC/EMC of 25/40/30 (mass ratio), and a ratio of 1,3-dioxane was adjusted to 4.02% by mass relative to the whole of the nonaqueous electrolytic solution. Except for that matter, a test battery of Example 1-7-1 was fabricated in the same manner as that in Example 1-1-1.

### Example 1-7-2

A test battery was fabricated in the same manner as that in Example 1-7-1, except that the solvent based protective film forming agent to be mixed in the nonaqueous electrolytic solution was changed to 4-fluoro-1,3-dioxolan-2-one (FEC). Incidentally, the content of 4-fluoro-1,3-dioxolan-2-one (FEC) that is a solvent based protective film forming agent in the whole composition of the nonaqueous electrolytic solution was 4.02% by mass.

### Examples 1-7-3 to 1-7-4

Test batteries of Examples 1-7-3 to 1-7-4 were respectively fabricated in the same manners as those in Examples 1-7-1 and 1-7-2, except that LiBF₂(C₂F₅)₂ was used as the protective film forming agent to be mixed in the nonaqueous electrolytic solution in place of LiPF₃(C₂F₅)₃. Incidentally, the content of LiBF₂(C₂F₅)₂ that is a thermally stable salt in the whole composition of the nonaqueous electrolytic solution was 2.40% by mass.

### Examples 1-7-5 to 1-7-6

Test batteries of Examples 1-7-5 to 1-7-6 were respectively fabricated in the same manners as those in Examples 1-7-1 and 1-7-2, except that LiN(SO₂CF₃)₂ was used as the protective film forming agent to be mixed in the nonaqueous electrolytic solution in place of LiPF₃(C₂F₅)₃. Incidentally, the content of LiN(SO₂CF₃)₂ that is a thermally stable salt in the whole composition of the nonaqueous electrolytic solution was 2.34% by mass.

### Examples 1-7-7 to 1-7-8

Test batteries of Examples 1-7-7 to 1-7-8 were respectively fabricated in the same manners as those in Examples 1-7-1 and 1-7-2, except that LiN(SO₂F)₂ was used as the protective film forming agent to be mixed in the nonaqueous electrolytic solution in place of LiPF₃(C₂F₅)₃. Incidentally, the content of LiN(SO₂F)₂ that is a thermally stable salt in the whole composition of the nonaqueous electrolytic solution was 1.54% by mass.

### Examples 1-7-9 to 1-7-16

Test batteries of Examples 1-7-9 to 1-7-16 were respectively fabricated in the same manners as those in Examples 1-7-1 to 1-7-8, except that Overcharge Controlling Agent (1-18) was used as the overcharge controlling agent to be mixed in the nonaqueous electrolytic solution in place of the Overcharge Controlling Agent (1-10).

### Examples 1-7-17 to 1-7-24

Test batteries of Examples 1-7-17 to 1-7-24 were respectively fabricated in the same manners as those in Examples 1-7-1 to 1-7-8, except that Overcharge Controlling Agent (4-71) was used as the overcharge controlling agent to be mixed in the nonaqueous electrolytic solution in place of the Overcharge Controlling Agent (1-10).

### Examples 1-7-25 to 1-7-32

Test batteries of Examples 1-7-25 to 1-7-32 were respectively fabricated in the same manners as those in Examples 1-7-1 to 1-7-8, except that Overcharge Controlling Agent (5-3) was used as the overcharge controlling agent to be mixed in the nonaqueous electrolytic solution in place of the Overcharge Controlling Agent (1-10).

### Examples 1-7-33 to 1-7-40

Test batteries of Examples 1-7-33 to 1-7-40 were respectively fabricated in the same manners as those in Examples 1-7-1 to 1-7-8, except that Overcharge Controlling Agent (8-4) was used as the overcharge controlling agent to be mixed in the nonaqueous electrolytic solution in place of the Overcharge Controlling Agent (1-10).

### Examples 1-7-41 to 1-7-48

Test batteries of Examples 1-7-41 to 1-7-48 were respectively fabricated in the same manners as those in Examples 1-7-1 to 1-7-8, except that Overcharge Controlling Agent (12-1) was used as the overcharge controlling agent to be mixed in the nonaqueous electrolytic solution in place of the Overcharge Controlling Agent (1-10).

### Examples 1-7-49 to 1-7-56

Test batteries of Examples 1-7-49 to 1-7-56 were respectively fabricated in the same manners as those in Examples 1-7-1 to 1-7-8, except that Overcharge Controlling Agent (12-2) was used as the overcharge controlling agent to be mixed in the nonaqueous electrolytic solution in place of the Overcharge Controlling Agent (1-10).

[Evaluation of Battery: Load Characteristics after the Overcharge]

With respect to the respective Examples, the load characteristics after the overcharge were confirmed in the same manner as that in Example 1-1-1.

Evaluation results are shown in the following Tables 13 and 14.

TABLE 13
[Negative electrode active material: Graphite]

| | | | | | | | | | Retention rate |
|---|---|---|---|---|---|---|---|---|---|
| | | | | | | | | | of load |
| | | Electrolyte salt | | Compound 1 | | Compound 2 | | | characteristics |
| | Nonaqueous | | Mixing | | Mixing | | Mixing | Overcharge | after the |
| | solvent [mass | | amount | | amount | | amount | controlling | overcharge |
| | ratio] | Material | [moles/kg] | Material | [wt %] | Material | [wt %] | agent | [%] |
| Example 1-7-1 | EC/DMC/EMC = | LiPF₆ | 0.9 | LiPF₃(C₂F₅)₃ | 3.63 | 1,3-Dixoane | 4.02 | Overcharge | 94 |
| Example 1-7-2 | 25/40/30 | | | | | FEC | | controlling | 93 |
| Example 1-7-3 | | | | LiBF₂(C₂F₅)₂ | 2.40 | 1,3-Dixoane | | agent (1-10) | 80 |
| Example 1-7-4 | | | | | | FEC | | | 85 |
| Example 1-7-5 | | | | LiN(SO₂CF₃)₂ | 2.34 | 1,3-Dixoane | | | 95 |
| Example 1-7-6 | | | | | | FEC | | | 94 |
| Example 1-7-7 | | | | LiN(SO₂F)₂ | 1.54 | 1,3-Dixoane | | | 95 |
| Example 1-7-8 | | | | | | FEC | | | 88 |
| Example 1-7-9 | | LiPF₆ | 0.9 | LiPF₃(C₂F₅)₃ | 3.63 | 1,3-Dixoane | 4.02 | Overcharge | 79 |
| Example | | | | | | FEC | | controlling | 86 |
| 1-7-10 | | | | | | | | agent (1-18) | |
| Example 1-7-11 | | | | LiBF₂(C₂F₅)₂ | 2.40 | 1,3-Dixoane | | | 77 |
| Example | | | | | | FEC | | | 80 |
| 1-7-12 | | | | | | | | | |
| Example | | | | LiN(SO₂CF₃)₂ | 2.34 | 1,3-Dixoane | | | 80 |
| 1-7-13 | | | | | | | | | |
| Example | | | | | | FEC | | | 80 |
| 1-7-14 | | | | | | | | | |
| Example | | | | LiN(SO₂F)₂ | 1.54 | 1,3-Dixoane | | | 75 |
| 1-7-15 | | | | | | | | | |
| Example | | | | | | FEC | | | 77 |
| 1-7-16 | | | | | | | | | |
| Example | | LiPF₆ | 0.9 | LiPF₃(C₂F₅)₃ | 3.63 | 1,3-Dixoane | 4.02 | Overcharge | 82 |
| 1-7-17 | | | | | | | | controlling | |
| Example | | | | | | FEC | | agent (4-71) | 73 |
| 1-7-18 | | | | | | | | | |
| Example | | | | LiBF₂(C₂F₅)₂ | 2.40 | 1,3-Dixoane | | | 93 |
| 1-7-19 | | | | | | | | | |
| Example | | | | | | FEC | | | 88 |
| 1-7-20 | | | | | | | | | |
| Example | | | | LiN(SO₂CF₃)₂ | 2.34 | 1,3-Dixoane | | | 81 |
| 1-7-21 | | | | | | | | | |
| Example | | | | | | FEC | | | 86 |
| 1-7-22 | | | | | | | | | |
| Example | | | | LiN(SO₂F)₂ | 1.54 | 1,3-Dixoane | | | 97 |
| 1-7-23 | | | | | | | | | |
| Example | | | | | | FEC | | | 96 |
| 1-7-24 | | | | | | | | | |
| Example | | LiPF₆ | 0.9 | LiPF₃(C₂F₅)₃ | 3.63 | 1,3-Dixoane | 4.02 | Overcharge | 89 |
| 1-7-25 | | | | | | | | controlling | |
| Example | | | | | | FEC | | agent (5-3) | 95 |
| 1-7-26 | | | | | | | | | |
| Example | | | | LiBF₂(C₂F₅)₂ | 2.40 | 1,3-Dixoane | | | 93 |
| 1-7-27 | | | | | | | | | |
| Example | | | | | | FEC | | | 89 |
| 1-7-28 | | | | | | | | | |
| Example | | | | LiN(SO₂CF₃)₂ | 2.34 | 1,3-Dixoane | | | 84 |
| 1-7-29 | | | | | | | | | |
| Example | | | | | | FEC | | | 79 |
| 1-7-30 | | | | | | | | | |
| Example | | | | LiN(SO₂F)₂ | 1.54 | 1,3-Dixoane | | | 81 |
| 1-7-31 | | | | | | | | | |
| Example | | | | | | FEC | | | 81 |
| 1-7-32 | | | | | | | | | |

TABLE 14
[Negative electrode active material: Graphite]

| | | | | | | | | | Retention rate |
|---|---|---|---|---|---|---|---|---|---|
| | | | | | | | | | of load |
| | | Electrolyte salt | | Compound 1 | | Compound 2 | | | characteristics |
| | Nonaqueous | | Mixing | | Mixing | | Mixing | Overcharge | after the |
| | solvent [mass | | amount | | amount | | amount | controlling | overcharge |
| | ratio] | Material | [moles/kg] | Material | [wt %] | Material | [wt %] | agent | [%] |
| Example | EC/DMC/EMC = | LiPF₆ | 0.9 | LiPF₃(C₂F₅)₃ | 3.63 | 1,3-Dixoane | 4.02 | Overcharge | 87 |
| 1-7-33 | 25/40/30 | | | | | | | controlling | |
| Example | | | | | | FEC | | agent (8-4) | 87 |
| 1-7-34 | | | | | | | | | |
| Example | | | | LiBF₂(C₂F₅)₂ | 2.40 | 1,3-Dixoane | | | 84 |
| 1-7-35 | | | | | | | | | |
| Example | | | | | | FEC | | | 84 |
| 1-7-36 | | | | | | | | | |
| Example | | | | LiN(SO₂CF₃)₂ | 2.34 | 1,3-Dixoane | | | 81 |
| 1-7-37 | | | | | | | | | |
| Example | | | | | | FEC | | | 81 |
| 1-7-38 | | | | | | | | | |
| Example | | | | LiN(SO₂F)₂ | 1.54 | 1,3-Dixoane | | | 79 |
| 1-7-39 | | | | | | | | | |
| Example | | | | | | FEC | | | 80 |
| 1-7-40 | | | | | | | | | |
| Example | | LiPF₆ | 0.9 | LiPF₃(C₂F₅)₃ | 3.63 | 1,3-Dixoane | 4.02 | Overcharge | 81 |
| 1-7-41 | | | | | | | | controlling | |
| Example | | | | | | FEC | | agent (12-1) | 81 |
| 1-7-42 | | | | | | | | | |
| Example | | | | LiBF₂(C₂F₅)₂ | 2.40 | 1,3-Dixoane | | | 73 |
| 1-7-43 | | | | | | | | | |
| Example | | | | | | FEC | | | 78 |
| 1-7-44 | | | | | | | | | |
| Example | | | | LiN(SO₂CF₃)₂ | 2.34 | 1,3-Dixoane | | | 96 |
| 1-7-45 | | | | | | | | | |
| Example | | | | | | FEC | | | 92 |
| 1-7-46 | | | | | | | | | |
| Example | | | | LiN(SO₂F)₂ | 1.54 | 1,3-Dixoane | | | 80 |
| 1-7-47 | | | | | | | | | |
| Example | | | | | | FEC | | | 78 |
| 1-7-48 | | | | | | | | | |
| Example | | LiPF₆ | 0.9 | LiPF₃(C₂F₅)₃ | 3.63 | 1,3-Dixoane | 4.02 | Overcharge | 84 |
| 1-7-49 | | | | | | | | controlling | |
| Example | | | | | | FEC | | agent (12-2) | 80 |
| 1-7-50 | | | | | | | | | |
| Example | | | | LiBF₂(C₂F₅)₂ | 2.40 | 1,3-Dixoane | | | 90 |
| 1-7-51 | | | | | | | | | |
| Example | | | | | | FEC | | | 90 |
| 1-7-52 | | | | | | | | | |
| Example | | | | LiN(SO₂CF₃)₂ | 2.34 | 1,3-Dixoane | | | 81 |
| 1-7-53 | | | | | | | | | |
| Example | | | | | | FEC | | | 80 |
| 1-7-54 | | | | | | | | | |
| Example | | | | LiN(SO₂F)₂ | 1.54 | 1,3-Dixoane | | | 91 |
| 1-7-55 | | | | | | | | | |
| Example | | | | | | FEC | | | 89 |
| 1-7-56 | | | | | | | | | |

As is clear from Tables 9 to 14, in all of Examples 1-5-1 to 1-5-70, Examples 1-6-1 to 1-6-56, and Examples 1-7-1 to 1-7-56, the retention rate of load characteristics after the overcharge cycle was significantly larger than the retention rate of load characteristics in the respective Comparative Examples. For that reason, even in the case of combining the protective film forming agent, the complex forming agent, or the thermally stable salt with the solvent based protective film forming agent, the effect for inhibiting a lowering of load characteristics was obtained.

### Examples 2-1-1 to 2-7-56

An SnCoC-containing material containing, as constituent elements, tin (Sn), cobalt (Co), and carbon (C) was used as the negative electrode active material in place of the granular graphite powder.

The negative electrode was fabricated in the following manner.

A tin/cobalt/indium/titanium alloy powder and a carbon powder were mixed, and an SnCoC-containing material was then synthesized from the mixture by utilizing a mechanochemical reaction. As a result of analysis of a composition of this SnCoC-containing material, a content of tin was 48% by mass, a content of cobalt was 23% by mass, a content of carbon was 20% by mass, and a proportion of cobalt relative to a total sum of tin and cobalt (Co/(Sn+Co)) was 32% by mass.

Subsequently, 80 parts by mass of the foregoing SnCoC-containing material powder as a negative electrode active material, 12 parts by mass of graphite as an electrically conductive agent, and 8 parts by mass of polyvinylidene fluoride as a binder were mixed, and the mixture was dispersed in N-methyl-2-pyrrolidone as a solvent, thereby preparing a negative electrode mixture slurry. Finally, the negative electrode mixture slurry was uniformly coated on the both surfaces of a negative electrode collector made of a strip-shaped copper foil having a thickness of 15 μm by using a coating apparatus, and after drying, the resultant was compression molded by using a roll press to fabricate a negative electrode having a negative electrode active material layer formed thereon.

Test batteries of Examples 2-1-1 to 2-7-56 were respectively fabricated in the same manners as those in Examples 1-1-1 to 1-7-56, except for using such a negative electrode.

[Evaluation of Battery: Load Characteristics after the Overcharge]

With respect to the respective Examples and Comparative Examples, the load characteristics after the overcharge were confirmed in the same manner as that in Example 1-1-1, except that the lower limit voltage (discharge termination voltage) at the time of discharge at each of the first cycle and the third to fifth cycles was set to 2.5 V.

Evaluation results are shown in the following Tables 15 to 27.

TABLE 15
[Negative electrode active material: SnCoC-containing material]

| | | | | | Retention rate |
|---|---|---|---|---|---|
| | | | | | of load |
| | | | | | characteristics |
| | Nonaqueous | Compound | | | after the |
| | solvent | Material | Mixing amount [wt %] | Overcharge controlling agent | overcharge [%] |
| Example 2-1-1 | EC/DMC/EMC = | Succinic anhydride | 1.0 | Overcharge Controlling Agent (1-10) | 79 |
| Example 2-1-2 | 30/40/30 | | | Overcharge Controlling Agent (1-18) | 76 |
| Example 2-1-3 | | | | Overcharge Controlling Agent (4-71) | 88 |
| Example 2-1-4 | | | | Overcharge Controlling Agent (5-3) | 81 |
| Example 2-1-5 | | | | Overcharge Controlling Agent (8-4) | 76 |
| Example 2-1-6 | | | | Overcharge Controlling Agent (12-1) | 84 |
| Example 2-1-7 | | | | Overcharge Controlling Agent (12-2) | 76 |
| Example 2-1-8 | | Cyclodisone | 1.0 | Overcharge Controlling Agent (1-10) | 93 |
| Example 2-1-9 | | (Compound (8-12)) | | Overcharge Controlling Agent (1-18) | 90 |
| Example 2-1-10 | | | | Overcharge Controlling Agent (4-71) | 93 |
| Example 2-1-11 | | | | Overcharge Controlling Agent (5-3) | 72 |
| Example 2-1-12 | | | | Overcharge Controlling Agent (8-4) | 84 |
| Example 2-1-13 | | | | Overcharge Controlling Agent (12-1) | 83 |
| Example 2-1-14 | | | | Overcharge Controlling Agent (12-2) | 82 |
| Example 2-1-15 | | Propanedicarboxylic | 1.0 | Overcharge Controlling Agent (1-10) | 94 |
| Example 2-1-16 | | anhydride | | Overcharge Controlling Agent (1-18) | 80 |
| Example 2-1-17 | | | | Overcharge Controlling Agent (4-71) | 85 |
| Example 2-1-18 | | | | Overcharge Controlling Agent (5-3) | 85 |
| Example 2-1-19 | | | | Overcharge Controlling Agent (8-4) | 90 |
| Example 2-1-20 | | | | Overcharge Controlling Agent (12-1) | 87 |
| Example 2-1-21 | | | | Overcharge Controlling Agent (12-2) | 82 |
| Example 2-1-22 | | FEC | 1.0 | Overcharge Controlling Agent (1-10) | 80 |
| Example 2-1-23 | | | | Overcharge Controlling Agent (1-18) | 88 |
| Example 2-1-24 | | | | Overcharge Controlling Agent (4-71) | 86 |
| Example 2-1-25 | | | | Overcharge Controlling Agent (5-3) | 83 |
| Example 2-1-26 | | | | Overcharge Controlling Agent (8-4) | 83 |
| Example 2-1-27 | | | | Overcharge Controlling Agent (12-1) | 85 |
| Example 2-1-28 | | | | Overcharge Controlling Agent (12-2) | 86 |
| Example 2-1-29 | | VC | 1.0 | Overcharge Controlling Agent (1-10) | 94 |
| Example 2-1-30 | | | | Overcharge Controlling Agent (1-18) | 80 |
| Example 2-1-31 | | | | Overcharge Controlling Agent (4-71) | 89 |
| Example 2-1-32 | | | | Overcharge Controlling Agent (5-3) | 82 |
| Example 2-1-33 | | | | Overcharge Controlling Agent (8-4) | 87 |
| Example 2-1-34 | | | | Overcharge Controlling Agent (12-1) | 87 |
| Example 2-1-35 | | | | Overcharge Controlling Agent (12-2) | 85 |
| Example 2-1-36 | | t-DFEC | 1.0 | Overcharge Controlling Agent (1-10) | 84 |
| Example 2-1-37 | | | | Overcharge Controlling Agent (1-18) | 80 |
| Example 2-1-38 | | | | Overcharge Controlling Agent (4-71) | 77 |
| Example 2-1-39 | | | | Overcharge Controlling Agent (5-3) | 80 |
| Example 2-1-40 | | | | Overcharge Controlling Agent (8-4) | 83 |
| Example 2-1-41 | | | | Overcharge Controlling Agent (12-1) | 91 |
| Example 2-1-42 | | | | Overcharge Controlling Agent (12-2) | 81 |
| Example 2-1-43 | | Propene sultone | 1.0 | Overcharge Controlling Agent (1-10) | 81 |
| Example 2-1-44 | | | | Overcharge Controlling Agent (1-18) | 80 |
| Example 2-1-45 | | | | Overcharge Controlling Agent (4-71) | 90 |
| Example 2-1-46 | | | | Overcharge Controlling Agent (5-3) | 77 |
| Example 2-1-47 | | | | Overcharge Controlling Agent (8-4) | 82 |
| Example 2-1-48 | | | | Overcharge Controlling Agent (12-1) | 76 |
| Example 2-1-49 | | | | Overcharge Controlling Agent (12-2) | 80 |

TABLE 16
[Negative electrode active material: SnCoC-containing material]

| | | | | | Retention rate |
|---|---|---|---|---|---|
| | | | | | of load |
| | | | | | characteristics |
| | Nonaqueous | Compound | | | after the |
| | solvent | Material | Mixing amount [wt %] | Overcharge controlling agent | overcharge [%] |
| Example 2-1-50 | EC/DMC/EMC = | LiBF₄ | 0.78 | Overcharge Controlling Agent (1-10) | 89 |
| Example 2-1-51 | 30/40/30 | | | Overcharge Controlling Agent (1-18) | 86 |
| Example 2-1-52 | | | | Overcharge Controlling Agent (4-71) | 79 |
| Example 2-1-53 | | | | Overcharge Controlling Agent (5-3) | 85 |
| Example 2-1-54 | | | | Overcharge Controlling Agent (8-4) | 86 |
| Example 2-1-55 | | | | Overcharge Controlling Agent (12-1) | 84 |
| Example 2-1-56 | | | | Overcharge Controlling Agent (12-2) | 80 |
| Example 2-1-57 | | LiBOB | 1.59 | Overcharge Controlling Agent (1-10) | 82 |
| Example 2-1-58 | | (Compound (4-6)) | | Overcharge Controlling Agent (1-18) | 78 |
| Example 2-1-59 | | | | Overcharge Controlling Agent (4-71) | 86 |
| Example 2-1-60 | | | | Overcharge Controlling Agent (5-3) | 88 |
| Example 2-1-61 | | | | Overcharge Controlling Agent (8-4) | 85 |
| Example 2-1-62 | | | | Overcharge Controlling Agent (12-1) | 85 |
| Example 2-1-63 | | | | Overcharge Controlling Agent (12-2) | 83 |
| Example 2-1-64 | | LiPF₂(C₂O₄)₂ | 2.06 | Overcharge Controlling Agent (1-10) | 74 |
| Example 2-1-65 | | (Compound (4-2) | | Overcharge Controlling Agent (1-18) | 78 |
| Example 2-1-66 | | | | Overcharge Controlling Agent (4-71) | 76 |
| Example 2-1-67 | | | | Overcharge Controlling Agent (5-3) | 82 |
| Example 2-1-68 | | | | Overcharge Controlling Agent (8-4) | 82 |
| Example 2-1-69 | | | | Overcharge Controlling Agent (12-1) | 83 |
| Example 2-1-70 | | | | Overcharge Controlling Agent (12-2) | 78 |
| Example 2-1-71 | | LiN(SO₂CF₂)₂CF₂ | 2.43 | Overcharge Controlling Agent (1-10) | 80 |
| Example 2-1-72 | | (Compound (7-2)) | | Overcharge Controlling Agent (1-18) | 80 |
| Example 2-1-73 | | | | Overcharge Controlling Agent (4-71) | 77 |
| Example 2-1-74 | | | | Overcharge Controlling Agent (5-3) | 81 |
| Example 2-1-75 | | | | Overcharge Controlling Agent (8-4) | 85 |
| Example 2-1-76 | | | | Overcharge Controlling Agent (12-1) | 71 |
| Example 2-1-77 | | | | Overcharge Controlling Agent (12-2) | 81 |
| Comparative | EC/DMC/EMC = | — | — | Overcharge Controlling Agent (1-10) | 54 |
| Example 2-1-1 | 30/40/30 | | | | |
| Comparative | | | | Overcharge Controlling Agent (1-18) | 56 |
| Example 2-1-2 | | | | | |
| Comparative | | | | Overcharge Controlling Agent (4-71) | 63 |
| Example 2-1-3 | | | | | |
| Comparative | | | | Overcharge Controlling Agent (5-3) | 62 |
| Example 2-1-4 | | | | | |
| Comparative | | | | Overcharge Controlling Agent (8-4) | 69 |
| Example 2-1-5 | | | | | |
| Comparative | | | | Overcharge Controlling Agent (12-1) | 65 |
| Example 2-1-6 | | | | | |
| Comparative | | | | Overcharge Controlling Agent (12-2) | 57 |
| Example 2-1-7 | | | | | |
| Comparative | | Succinic anhydride | 1.0 | — | 52 |
| Example 2-1-8 | | | | | |
| Comparative | | Cyclodisone | 1.0 | | 54 |
| Example 2-1-9 | | | | | |
| Comparative | | Propanedicarboxylic | 1.0 | | 57 |
| Example 2-1-10 | | anhydride | | | |
| Comparative | | FEC | 1.0 | | 45 |
| Example 2-1-11 | | | | | |
| Comparative | | VC | 1.0 | | 48 |
| Example 2-1-12 | | | | | |
| Comparative | | t-DFEC | 1.0 | | 42 |
| Example 2-1-13 | | | | | |
| Comparative | | Propene sultone | 1.0 | | 51 |
| Example 2-1-14 | | | | | |
| Comparative | | LiBF₄ | 0.78 | | 48 |
| Example 2-1-15 | | | | | |
| Comparative | | LiBOB | 1.59 | | 53 |
| Example 2-1-16 | | | | | |
| Comparative | | LiPF₂(C₂O₄)₂ | 2.06 | | 43 |
| Example 2-1-17 | | | | | |
| Comparative | | LiN(SO₂CF₂)₂CF₂ | 2.43 | | 44 |
| Example 2-1-18 | | | | | |
| Comparative | | — | — | | 50 |
| Example 2-1-19 | | | | | |

TABLE 17
[Negative electrode active material: SnCoC-containing material]

| | | | | | Retention rate of |
|---|---|---|---|---|---|
| | | Compound | | | load characteristics |
| | Nonaqueous | | Mixing | | after the |
| | solvent | Material | amount [wt %] | Overcharge controlling agent | overcharge [%] |
| Example 2-2-1 | EC/DMC/EMC = | Succinonitrile | 1.0 | Overcharge Controlling Agent (1-10) | 72 |
| Example 2-2-2 | 30/40/30 | | | Overcharge Controlling Agent (1-18) | 74 |
| Example 2-2-3 | | | | Overcharge Controlling Agent (4-71) | 79 |
| Example 2-2-4 | | | | Overcharge Controlling Agent (5-3) | 80 |
| Example 2-2-5 | | | | Overcharge Controlling Agent (8-4) | 79 |
| Example 2-2-6 | | | | Overcharge Controlling Agent (12-1) | 80 |
| Example 2-2-7 | | | | Overcharge Controlling Agent (12-2) | 80 |
| Example 2-2-8 | | Adiponitrile | 1.0 | Overcharge Controlling Agent (1-10) | 75 |
| Example 2-2-9 | | | | Overcharge Controlling Agent (1-18) | 75 |
| Example 2-2-10 | | | | Overcharge Controlling Agent (4-71) | 76 |
| Example 2-2-11 | | | | Overcharge Controlling Agent (5-3) | 80 |
| Example 2-2-12 | | | | Overcharge Controlling Agent (8-4) | 77 |
| Example 2-2-13 | | | | Overcharge Controlling Agent (12-1) | 80 |
| Example 2-2-14 | | | | Overcharge Controlling Agent (12-2) | 80 |
| Example 2-2-15 | | 7,7,8,8-Tetracyanoquinodimethane | 1.0 | Overcharge Controlling Agent (1-10) | 71 |
| Example 2-2-16 | | | | Overcharge Controlling Agent (1-18) | 79 |
| Example 2-2-17 | | | | Overcharge Controlling Agent (4-71) | 77 |
| Example 2-2-18 | | | | Overcharge Controlling Agent (5-3) | 74 |
| Example 2-2-19 | | | | Overcharge Controlling Agent (8-4) | 82 |
| Example 2-2-20 | | | | Overcharge Controlling Agent (12-1) | 80 |
| Example 2-2-21 | | | | Overcharge Controlling Agent (12-2) | 82 |
| Example 2-2-22 | | Acetonitrile | 1.0 | Overcharge Controlling Agent (1-10) | 73 |
| Example 2-2-23 | | | | Overcharge Controlling Agent (1-18) | 76 |
| Example 2-2-24 | | | | Overcharge Controlling Agent (4-71) | 77 |
| Example 2-2-25 | | | | Overcharge Controlling Agent (5-3) | 78 |
| Example 2-2-26 | | | | Overcharge Controlling Agent (8-4) | 77 |
| Example 2-2-27 | | | | Overcharge Controlling Agent (12-1) | 79 |
| Example 2-2-28 | | | | Overcharge Controlling Agent (12-2) | 81 |
| Example 2-2-29 | | 1-Isocyanatoethane | 1.0 | Overcharge Controlling Agent (1-10) | 75 |
| Example 2-2-30 | | | | Overcharge Controlling Agent (1-18) | 76 |
| Example 2-2-31 | | | | Overcharge Controlling Agent (4-71) | 80 |
| Example 2-2-32 | | | | Overcharge Controlling Agent (5-3) | 74 |
| Example 2-2-33 | | | | Overcharge Controlling Agent (8-4) | 81 |
| Example 2-2-34 | | | | Overcharge Controlling Agent (12-1) | 82 |
| Example 2-2-35 | | | | Overcharge Controlling Agent (12-2) | 78 |
| Example 2-2-36 | | 1,8-Diisocyanatooctane | 1.0 | Overcharge Controlling Agent (1-10) | 73 |
| Example 2-2-37 | | | | Overcharge Controlling Agent (1-18) | 79 |
| Example 2-2-38 | | | | Overcharge Controlling Agent (4-71) | 79 |
| Example 2-2-39 | | | | Overcharge Controlling Agent (5-3) | 79 |
| Example 2-2-40 | | | | Overcharge Controlling Agent (8-4) | 82 |
| Example 2-2-41 | | | | Overcharge Controlling Agent (12-1) | 79 |
| Example 2-2-42 | | | | Overcharge Controlling Agent (12-2) | 79 |
| Comparative | EC/DMC/EMC = | Succinonitrile | 1.0 | — | 36 |
| Example 2-2-1 | 30/40/30 | | | | |
| Comparative | | Adiponitrile | | | 35 |
| Example 2-2-2 | | | | | |
| Comparative | | 7,7,8,8-Tetracyanoquinodimethane | | | 40 |
| Example 2-2-3 | | | | | |
| Comparative | | Acetonitrile | | | 37 |
| Example 2-2-4 | | | | | |
| Comparative | | 1-Isocyanatoethane | | | 41 |
| Example 2-2-5 | | | | | |
| Comparative | | 1,8-Diisocyanatooctane | | | 38 |
| Example 2-2-6 | | | | | |

TABLE 18
[Negative electrode active material: SnCoC-containing material]

| | | | | | Retention rate of load |
|---|---|---|---|---|---|
| | Nonaqueous | Compound | | | characteristics after the |
| | solvent | Material | Mixing amount [wt %] | Overcharge controlling agent | overcharge [%] |
| Example 2-3-1 | EC/DMC/EMC = | γ-Butyrolactone | 4.12 | Overcharge Controlling Agent (1-10) | 89 |
| Example 2-3-2 | 25/40/30 | | | Overcharge Controlling Agent (1-18) | 85 |
| Example 2-3-3 | | | | Overcharge Controlling Agent (4-71) | 90 |
| Example 2-3-4 | | | | Overcharge Controlling Agent (5-3) | 88 |
| Example 2-3-5 | | | | Overcharge Controlling Agent (8-4) | 84 |
| Example 2-3-6 | | | | Overcharge Controlling Agent (12-1) | 90 |
| Example 2-3-7 | | | | Overcharge Controlling Agent (12-2) | 89 |
| Example 2-3-8 | | NMP | 4.12 | Overcharge Controlling Agent (1-10) | 89 |
| Example 2-3-9 | | | | Overcharge Controlling Agent (1-18) | 79 |
| Example 2-3-10 | | | | Overcharge Controlling Agent (4-71) | 86 |
| Example 2-3-11 | | | | Overcharge Controlling Agent (5-3) | 82 |
| Example 2-3-12 | | | | Overcharge Controlling Agent (8-4) | 84 |
| Example 2-3-13 | | | | Overcharge Controlling Agent (12-1) | 85 |
| Example 2-3-14 | | | | Overcharge Controlling Agent (12-2) | 87 |
| Example 2-3-15 | | Methyl acetate | 4.12 | Overcharge Controlling Agent (1-10) | 92 |
| Example 2-3-16 | | | | Overcharge Controlling Agent (1-18) | 85 |
| Example 2-3-17 | | | | Overcharge Controlling Agent (4-71) | 91 |
| Example 2-3-18 | | | | Overcharge Controlling Agent (5-3) | 88 |
| Example 2-3-19 | | | | Overcharge Controlling Agent (8-4) | 86 |
| Example 2-3-20 | | | | Overcharge Controlling Agent (12-1) | 87 |
| Example 2-3-21 | | | | Overcharge Controlling Agent (12-2) | 87 |
| Example 2-3-22 | | Ethyl trimethylacetate | 4.12 | Overcharge Controlling Agent (1-10) | 90 |
| Example 2-3-23 | | | | Overcharge Controlling Agent (1-18) | 85 |
| Example 2-3-24 | | | | Overcharge Controlling Agent (4-71) | 91 |
| Example 2-3-25 | | | | Overcharge Controlling Agent (5-3) | 89 |
| Example 2-3-26 | | | | Overcharge Controlling Agent (8-4) | 81 |
| Example 2-3-27 | | | | Overcharge Controlling Agent (12-1) | 87 |
| Example 2-3-28 | | | | Overcharge Controlling Agent (12-2) | 91 |
| Example 2-3-29 | | 1,2-Dimethoxyethane | 4.12 | Overcharge Controlling Agent (1-10) | 92 |
| Example 2-3-30 | | | | Overcharge Controlling Agent (1-18) | 90 |
| Example 2-3-31 | | | | Overcharge Controlling Agent (4-71) | 93 |
| Example 2-3-32 | | | | Overcharge Controlling Agent (5-3) | 87 |
| Example 2-3-33 | | | | Overcharge Controlling Agent (8-4) | 90 |
| Example 2-3-34 | | | | Overcharge Controlling Agent (12-1) | 90 |
| Example 2-3-35 | | | | Overcharge Controlling Agent (12-2) | 91 |
| Example 2-3-36 | | 1,3-Dioxane | 4.12 | Overcharge Controlling Agent (1-10) | 96 |
| Example 2-3-37 | | | | Overcharge Controlling Agent (1-18) | 90 |
| Example 2-3-38 | | | | Overcharge Controlling Agent (4-71) | 93 |
| Example 2-3-39 | | | | Overcharge Controlling Agent (5-3) | 87 |
| Example 2-3-40 | | | | Overcharge Controlling Agent (8-4) | 82 |
| Example 2-3-41 | | | | Overcharge Controlling Agent (12-1) | 86 |
| Example 2-3-42 | | | | Overcharge Controlling Agent (12-2) | 90 |
| Example 2-3-43 | | FDMC | 4.12 | Overcharge Controlling Agent (1-10) | 93 |
| Example 2-3-44 | | | | Overcharge Controlling Agent (1-18) | 89 |
| Example 2-3-45 | | | | Overcharge Controlling Agent (4-71) | 90 |
| Example 2-3-46 | | | | Overcharge Controlling Agent (5-3) | 89 |
| Example 2-3-47 | | | | Overcharge Controlling Agent (8-4) | 87 |
| Example 2-3-48 | | | | Overcharge Controlling Agent (12-1) | 87 |
| Example 2-3-49 | | | | Overcharge Controlling Agent (12-2) | 86 |

TABLE 19
[Negative electrode active material: SnCoC-containing material]

| | | | | | Retention rate of load |
|---|---|---|---|---|---|
| | Nonaqueous | Compound | | | characteristics after the |
| | solvent | Material | Mixing amount [wt %] | Overcharge controlling agent | overcharge [%] |
| Example 2-3-50 | EC/DMC/EMC = | FEC | 4.12 | Overcharge Controlling Agent (1-10) | 88 |
| Example 2-3-51 | 25/40/30 | | | Overcharge Controlling Agent (1-18) | 90 |
| Example 2-3-52 | | | | Overcharge Controlling Agent (4-71) | 86 |
| Example 2-3-53 | | | | Overcharge Controlling Agent (5-3) | 83 |
| Example 2-3-54 | | | | Overcharge Controlling Agent (8-4) | 85 |
| Example 2-3-55 | | | | Overcharge Controlling Agent (12-1) | 84 |
| Example 2-3-56 | | | | Overcharge Controlling Agent (12-2) | 87 |
| Example 2-3-57 | | Sulfolane | 4.12 | Overcharge Controlling Agent (1-10) | 90 |
| Example 2-3-58 | | | | Overcharge Controlling Agent (1-18) | 84 |
| Example 2-3-59 | | | | Overcharge Controlling Agent (4-71) | 89 |
| Example 2-3-60 | | | | Overcharge Controlling Agent (5-3) | 84 |
| Example 2-3-61 | | | | Overcharge Controlling Agent (8-4) | 85 |
| Example 2-3-62 | | | | Overcharge Controlling Agent (12-1) | 86 |
| Example 2-3-63 | | | | Overcharge Controlling Agent (12-2) | 87 |
| Comparative | EC/DMC/EMC = | γ-Butyrolactone | 4.12 | — | 60 |
| Example 2-3-1 | 25/40/30 | | | | |
| Comparative | | NMP | 4.12 | | 45 |
| Example 2-3-2 | | | | | |
| Comparative | | Methyl acetate | 4.12 | | 57 |
| Example 2-3-3 | | | | | |
| Comparative | | Ethyl trimethylacetate | 4.12 | | 50 |
| Example 2-3-4 | | | | | |
| Comparative | | 1,2-Dimethoxyethane | 4.12 | | 57 |
| Example 2-3-5 | | | | | |
| Comparative | | 1,3-Dioxane | 4.12 | | 54 |
| Example 2-3-6 | | | | | |
| Comparative | | FDMC | 4.12 | | 51 |
| Example 2-3-7 | | | | | |
| Comparative | | FEC | 4.12 | | 48 |
| Example 2-3-8 | | | | | |
| Comparative | | Sulfolane | 4.12 | | 50 |
| Example 2-3-9 | | | | | |

TABLE 20
[Negative electrode active material: SnCoC-containing material]

| | Electrolyte salt | | Compound | | | |
|---|---|---|---|---|---|---|
| | | Mixing | | Mixing | | Retention rate of load |
| | | amount | | amount | | characteristics after |
| | Material | [moles/kg] | Material | [wt %] | Overcharge controlling agent | the overcharge [%] |
| Example 2-4-1 | LiPF₆ | 0.9 | LiPF₃(C₂F₅)₃ | 3.63 | Overcharge Controlling Agent (1-10) | 77 |
| Example 2-4-2 | | | | | Overcharge Controlling Agent (1-18) | 77 |
| Example 2-4-3 | | | | | Overcharge Controlling Agent (4-71) | 73 |
| Example 2-4-4 | | | | | Overcharge Controlling Agent (5-3) | 83 |
| Example 2-4-5 | | | | | Overcharge Controlling Agent (8-4) | 81 |
| Example 2-4-6 | | | | | Overcharge Controlling Agent (12-1) | 72 |
| Example 2-4-7 | | | | | Overcharge Controlling Agent (12-2) | 78 |
| Example 2-4-8 | | | LiPF₄(CF₃)₂ | 2.06 | Overcharge Controlling Agent (1-10) | 78 |
| Example 2-4-9 | | | | | Overcharge Controlling Agent (1-18) | 80 |
| Example 2-4-10 | | | | | Overcharge Controlling Agent (4-71) | 77 |
| Example 2-4-11 | | | | | Overcharge Controlling Agent (5-3) | 74 |
| Example 2-4-12 | | | | | Overcharge Controlling Agent (8-4) | 77 |
| Example 2-4-13 | | | | | Overcharge Controlling Agent (12-1) | 82 |
| Example 2-4-14 | | | | | Overcharge Controlling Agent (12-2) | 75 |
| Example 2-4-15 | | | LiBF(C₂F₅)₃ | 3.18 | Overcharge Controlling Agent (1-10) | 74 |
| Example 2-4-16 | | | | | Overcharge Controlling Agent (1-18) | 80 |
| Example 2-4-17 | | | | | Overcharge Controlling Agent (4-71) | 80 |
| Example 2-4-18 | | | | | Overcharge Controlling Agent (5-3) | 76 |
| Example 2-4-19 | | | | | Overcharge Controlling Agent (8-4) | 72 |
| Example 2-4-20 | | | | | Overcharge Controlling Agent (12-1) | 76 |
| Example 2-4-21 | | | | | Overcharge Controlling Agent (12-2) | 75 |
| Example 2-4-22 | | | LiBF₂(C₂F₅)₂ | 2.40 | Overcharge Controlling Agent (1-10) | 77 |
| Example 2-4-23 | | | | | Overcharge Controlling Agent (1-18) | 78 |
| Example 2-4-24 | | | | | Overcharge Controlling Agent (4-71) | 74 |
| Example 2-4-25 | | | | | Overcharge Controlling Agent (5-3) | 77 |
| Example 2-4-26 | | | | | Overcharge Controlling Agent (8-4) | 78 |
| Example 2-4-27 | | | | | Overcharge Controlling Agent (12-1) | 71 |
| Example 2-4-28 | | | | | Overcharge Controlling Agent (12-2) | 82 |
| Example 2-4-29 | | | LiBF₃(C₂F₅) | 3.48 | Overcharge Controlling Agent (1-10) | 77 |
| Example 2-4-30 | | | | | Overcharge Controlling Agent (1-18) | 73 |
| Example 2-4-31 | | | | | Overcharge Controlling Agent (4-71) | 77 |
| Example 2-4-32 | | | | | Overcharge Controlling Agent (5-3) | 76 |
| Example 2-4-33 | | | | | Overcharge Controlling Agent (8-4) | 76 |
| Example 2-4-34 | | | | | Overcharge Controlling Agent (12-1) | 77 |
| Example 2-4-35 | | | | | Overcharge Controlling Agent (12-2) | 72 |
| Example 2-4-36 | | | LiN(SO₂CF₃)₂ | 2.34 | Overcharge Controlling Agent (1-10) | 76 |
| Example 2-4-37 | | | | | Overcharge Controlling Agent (1-18) | 81 |
| Example 2-4-38 | | | | | Overcharge Controlling Agent (4-71) | 77 |
| Example 2-4-39 | | | | | Overcharge Controlling Agent (5-3) | 77 |
| Example 2-4-40 | | | | | Overcharge Controlling Agent (8-4) | 78 |
| Example 2-4-41 | | | | | Overcharge Controlling Agent (12-1) | 77 |
| Example 2-4-42 | | | | | Overcharge Controlling Agent (12-2) | 77 |
| Example 2-4-43 | | | LiN(SO₂C₂F₅)₂ | 3.13 | Overcharge Controlling Agent (1-10) | 71 |
| Example 2-4-44 | | | | | Overcharge Controlling Agent (1-18) | 76 |
| Example 2-4-45 | | | | | Overcharge Controlling Agent (4-71) | 77 |
| Example 2-4-46 | | | | | Overcharge Controlling Agent (5-3) | 73 |
| Example 2-4-47 | | | | | Overcharge Controlling Agent (8-4) | 80 |
| Example 2-4-48 | | | | | Overcharge Controlling Agent (12-1) | 78 |
| Example 2-4-49 | | | | | Overcharge Controlling Agent (12-2) | 78 |

TABLE 21
[Negative electrode active material: SnCoC-containing material]

| | Electrolyte salt | | Compound | | | |
|---|---|---|---|---|---|---|
| | | Mixing | | Mixing | | Retention rate of load |
| | | amount | | amount | | characteristics after |
| | Material | [moles/kg] | Material | [wt %] | Overcharge controlling agent | the overcharge [%] |
| Example 2-4-50 | LiPF₆ | 0.9 | LiN(SO₂F)₂ | 1.54 | Overcharge Controlling Agent (1-10) | 77 |
| Example 2-4-51 | | | | | Overcharge Controlling Agent (1-18) | 71 |
| Example 2-4-52 | | | | | Overcharge Controlling Agent (4-71) | 80 |
| Example 2-4-53 | | | | | Overcharge Controlling Agent (5-3) | 80 |
| Example 2-4-54 | | | | | Overcharge Controlling Agent (8-4) | 75 |
| Example 2-4-55 | | | | | Overcharge Controlling Agent (12-1) | 76 |
| Example 2-4-56 | | | | | Overcharge Controlling Agent (12-2) | 77 |
| Comparative | LiPF₆ | 0.9 | LiPF₃(C₂F₅)₃ | 3.63 | — | 50 |
| Example 2-4-1 | | | | | | |
| Comparative | | | LiPF₄(CF₃)₂ | 2.06 | | 48 |
| Example 2-4-2 | | | | | | |
| Comparative | | | LiBF(C₂F₅)₃ | 3.18 | | 51 |
| Example 2-4-3 | | | | | | |
| Comparative | | | LiBF₂(C₂F₅)₂ | 2.40 | | 48 |
| Example 2-4-4 | | | | | | |
| Comparative | | | LiBF₃(C₂F₅) | 3.48 | | 52 |
| Example 2-4-5 | | | | | | |
| Comparative | | | LiN(SO₂CF₃)₂ | 2.34 | | 44 |
| Example 2-4-6 | | | | | | |
| Comparative | | | LiN(SO₂C₂F₅)₂ | 3.13 | | 50 |
| Example 2-4-7 | | | | | | |
| Comparative | | | LiN(SO₂F)₂ | 1.54 | | 45 |
| Example 2-4-8 | | | | | | |

TABLE 22
[Negative electrode active material: SnCoC-containing material]

| | | | | | | | | | Retention rate |
|---|---|---|---|---|---|---|---|---|---|
| | | | | | | | | | of load |
| | | Electrolyte salt | | Compound 1 | | Compound 2 | | | characteristics |
| | Nonaqueous | | Mixing | | Mixing | | Mixing | Overcharge | after the |
| | solvent [mass | | amount | | amount | | amount | controlling | overcharge |
| | ratio] | Material | [moles/kg] | Material | [wt %] | Material | [wt %] | agent | [%] |
| Example 2-5-1 | EC/DMC/EMC = | LiPF₆ | 1.0 | Succinic | 1.0 | 1,3-Dixoane | 4.08 | Overcharge | 78 |
| Example 2-5-2 | 25/40/30 | | | anhydride | | FEC | | controlling | 80 |
| Example 2-5-3 | | | | Propanedisulfonic | | 1,3-Dixoane | | agent (1-10) | 95 |
| Example 2-5-4 | | | | anhydride | | FEC | | | 94 |
| Example 2-5-5 | | | | VC | | 1,3-Dixoane | | | 93 |
| Example 2-5-6 | | | | | | FEC | | | 94 |
| Example 2-5-7 | | | | t-DFEC | | 1,3-Dixoane | | | 81 |
| Example 2-5-8 | | | | | | FEC | | | 85 |
| Example 2-5-9 | | LiPF₆ | 0.9 | LiBF₄ | 0.78 | 1,3-Dixoane | | | 89 |
| Example 2-5-10 | | | | | | FEC | | | 91 |
| Example 2-5-11 | | LiPF₆ | 1.0 | Succinic | 1.0 | 1,3-Dixoane | 4.08 | Overcharge | 81 |
| Example 2-5-12 | | | | anhydride | | FEC | | controlling | 76 |
| Example 2-5-13 | | | | Propanedisulfonic | | 1,3-Dixoane | | agent (1-18) | 79 |
| Example 2-5-14 | | | | anhydride | | FEC | | | 80 |
| Example 2-5-15 | | | | VC | | 1,3-Dixoane | | | 75 |
| Example 2-5-16 | | | | | | FEC | | | 80 |
| Example 2-5-17 | | | | t-DFEC | | 1,3-Dixoane | | | 85 |
| Example 2-5-18 | | | | | | FEC | | | 87 |
| Example 2-5-19 | | LiPF₆ | 0.9 | LiBF₄ | 0.78 | 1,3-Dixoane | | | 89 |
| Example 2-5-20 | | | | | | FEC | | | 86 |
| Example 2-5-21 | | LiPF₆ | 1.0 | Succinic | 1.0 | 1,3-Dixoane | 4.08 | Overcharge | 89 |
| Example 2-5-22 | | | | anhydride | | FEC | | controlling | 91 |
| Example 2-5-23 | | | | Propanedisulfonic | | 1,3-Dixoane | | agent (4-71) | 79 |
| Example 2-5-24 | | | | anhydride | | FEC | | | 84 |
| Example 2-5-25 | | | | VC | | 1,3-Dixoane | | | 90 |
| Example 2-5-26 | | | | | | FEC | | | 90 |
| Example 2-5-27 | | | | t-DFEC | | 1,3-Dixoane | | | 77 |
| Example 2-5-28 | | | | | | FEC | | | 76 |
| Example 2-5-29 | | LiPF₆ | 0.9 | LiBF₄ | 0.78 | 1,3-Dixoane | | | 77 |
| Example 2-5-30 | | | | | | FEC | | | 80 |
| Example 2-5-31 | | LiPF₆ | 1.0 | Succinic | 1.0 | 1,3-Dixoane | 4.08 | Overcharge | 83 |
| Example 2-5-32 | | | | anhydride | | FEC | | controlling | 80 |
| Example 2-5-33 | | | | Propanedisulfonic | | 1,3-Dixoane | | agent (5-3) | 87 |
| Example 2-5-34 | | | | anhydride | | FEC | | | 89 |
| Example 2-5-35 | | | | VC | | 1,3-Dixoane | | | 80 |
| Example 2-5-36 | | | | | | FEC | | | 84 |

TABLE 23
[Negative electrode active material: SnCoC-containing material]

| | | | | | | | | | Retention rate |
|---|---|---|---|---|---|---|---|---|---|
| | | | | | | | | | of load |
| | | Electrolyte salt | | Compound 1 | | Compound 2 | | | characteristics |
| | Nonaqueous | | Mixing | | Mixing | | Mixing | Overcharge | after the |
| | solvent [mass | | amount | | amount | | amount | controlling | overcharge |
| | ratio] | Material | [moles/kg] | Material | [wt %] | Material | [wt %] | agent | [%] |
| Example 2-5-37 | EC/DMC/EMC = | LiPF₆ | 1.0 | t-DFEC | | 1,3-Dixoane | 4.08 | Overcharge | 81 |
| Example 2-5-38 | 25/40/30 | | | | | FEC | | controlling | 80 |
| Example 2-5-39 | | LiPF₆ | 0.9 | LiBF₄ | 0.78 | 1,3-Dixoane | | agent (5-3) | 86 |
| Example 2-5-40 | | | | | | FEC | | | 90 |
| Example 2-5-41 | | LiPF₆ | 1.0 | Succinic | 1.0 | 1,3-Dixoane | 4.08 | Overcharge | 78 |
| Example 2-5-42 | | | | anhydride | | FEC | | controlling | 82 |
| Example 2-5-43 | | | | Propanedisulfonic | | 1,3-Dixoane | | agent (8-4) | 91 |
| Example 2-5-44 | | | | anhydride | | FEC | | | 89 |
| Example 2-5-45 | | | | VC | | 1,3-Dixoane | | | 89 |
| Example 2-5-46 | | | | | | FEC | | | 87 |
| Example 2-5-47 | | | | t-DFEC | | 1,3-Dixoane | | | 82 |
| Example 2-5-48 | | | | | | FEC | | | 83 |
| Example 2-5-49 | | LiPF₆ | 0.9 | LiBF₄ | 0.78 | 1,3-Dixoane | | | 79 |
| Example 2-5-50 | | | | | | FEC | | | 82 |
| Example 2-5-51 | | LiPF₆ | 1.0 | Succinic | 1.0 | 1,3-Dixoane | 4.08 | Overcharge | 86 |
| Example 2-5-52 | | | | anhydride | | FEC | | controlling | 86 |
| Example 2-5-53 | | | | Propanedisulfonic | | 1,3-Dixoane | | agent (12-1) | 90 |
| Example 2-5-54 | | | | anhydride | | FEC | | | 85 |
| Example 2-5-55 | | | | VC | | 1,3-Dixoane | | | 90 |
| Example 2-5-56 | | | | | | FEC | | | 85 |
| Example 2-5-57 | | | | t-DFEC | | 1,3-Dixoane | | | 98 |
| Example 2-5-58 | | | | | | FEC | | | 96 |
| Example 2-5-59 | | LiPF₆ | 0.9 | LiBF₄ | 0.78 | 1,3-Dixoane | | | 85 |
| Example 2-5-60 | | | | | | FEC | | | 88 |
| Example 2-5-61 | | LiPF₆ | 1.0 | Succinic | 1.0 | 1,3-Dixoane | 4.08 | Overcharge | 75 |
| Example 2-5-62 | | | | anhydride | | FEC | | controlling | 77 |
| Example 2-5-63 | | | | Propanedisulfonic | | 1,3-Dixoane | | agent (12-2) | 82 |
| Example 2-5-64 | | | | anhydride | | FEC | | | 89 |
| Example 2-5-65 | | | | VC | | 1,3-Dixoane | | | 86 |
| Example 2-5-66 | | | | | | FEC | | | 90 |
| Example 2-5-67 | | | | t-DFEC | | 1,3-Dixoane | | | 87 |
| Example 2-5-68 | | | | | | FEC | | | 85 |
| Example 2-5-69 | | LiPF₆ | 0.9 | LiBF₄ | 0.78 | 1,3-Dixoane | | | 80 |
| Example 2-5-70 | | | | | | FEC | | | 80 |

TABLE 24
[Negative electrode active material: SnCoC-containing material]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent [mass | | amount | | amount | | amount | controlling | after the |
| | ratio] | Material | [moles/kg] | Material | [wt %] | Material | [wt %] | agent | overcharge [%] |
| Example 2-6-1 | EC/DMC/EMC = | LiPF₆ | 1.0 | Succinonitrile | 1.0 | 1,3-Dixoane | 4.08 | Overcharge | 78 |
| Example 2-6-2 | 25/40/30 | | | | | FEC | | controlling | 79 |
| Example 2-6-3 | | | | Adiponitrile | | 1,3-Dixoane | | agent (1-10) | 75 |
| Example 2-6-4 | | | | | | FEC | | | 78 |
| Example 2-6-5 | | | | 7,7,8,8-Tetracyano- | | 1,3-Dixoane | | | 75 |
| Example 2-6-6 | | | | quinodimentane | | FEC | | | 73 |
| Example 2-6-7 | | | | Acetonitrile | | 1,3-Dixoane | | | 68 |
| Example 2-6-8 | | | | | | FEC | | | 77 |
| Example 2-6-9 | | LiPF₆ | 1.0 | Succinonitrile | 1.0 | 1,3-Dixoane | 4.08 | Overcharge | 77 |
| Example 2-6-10 | | | | | | FEC | | controlling | 80 |
| Example 2-6-11 | | | | Adiponitrile | | 1,3-Dixoane | | agent (1-18) | 82 |
| Example 2-6-12 | | | | | | FEC | | | 79 |
| Example 2-6-13 | | | | 7,7,8,8-Tetracyano- | | 1,3-Dixoane | | | 80 |
| Example 2-6-14 | | | | quinodimentane | | FEC | | | 87 |
| Example 2-6-15 | | | | Acetonitrile | | 1,3-Dixoane | | | 81 |
| Example 2-6-16 | | | | | | FEC | | | 81 |
| Example 2-6-17 | | LiPF₆ | 1.0 | Succinonitrile | 1.0 | 1,3-Dixoane | 4.08 | Overcharge | 79 |
| Example 2-6-18 | | | | | | FEC | | controlling | 81 |
| Example 2-6-19 | | | | Adiponitrile | | 1,3-Dixoane | | agent (4-71) | 81 |
| Example 2-6-20 | | | | | | FEC | | | 82 |
| Example 2-6-21 | | | | 7,7,8,8-Tetracyano- | | 1,3-Dixoane | | | 79 |
| Example 2-6-22 | | | | quinodimentane | | FEC | | | 74 |
| Example 2-6-23 | | | | Acetonitrile | | 1,3-Dixoane | | | 86 |
| Example 2-6-24 | | | | | | FEC | | | 80 |
| Example 2-6-25 | | LiPF₆ | 1.0 | Succinonitrile | 1.0 | 1,3-Dixoane | 4.08 | Overcharge | 81 |
| Example 2-6-26 | | | | | | FEC | | controlling | 83 |
| Example 2-6-27 | | | | Adiponitrile | | 1,3-Dixoane | | agent (5-3) | 85 |
| Example 2-6-28 | | | | | | FEC | | | 84 |
| Example 2-6-29 | | | | 7,7,8,8-Tetracyano- | | 1,3-Dixoane | | | 75 |
| Example 2-6-30 | | | | quinodimentane | | FEC | | | 79 |
| Example 2-6-31 | | | | Acetonitrile | | 1,3-Dixoane | | | 74 |
| Example 2-6-32 | | | | | | FEC | | | 80 |

TABLE 25
[Negative electrode active material: SnCoC-containing material]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent [mass | | amount | | amount | | amount | controlling | after the |
| | ratio] | Material | [moles/kg] | Material | [wt %] | Material | [wt %] | agent | overcharge [%] |
| Example 2-6-33 | EC/DMC/EMC = | LiPF₆ | 1.0 | Succinonitrile | 1.0 | 1,3-Dixoane | 4.08 | Overcharge | 84 |
| Example 2-6-34 | 25/40/30 | | | | | FEC | | controlling | 84 |
| Example 2-6-35 | | | | Adiponitrile | | 1,3-Dixoane | | agent (8-4) | 78 |
| Example 2-6-36 | | | | | | FEC | | | 87 |
| Example 2-6-37 | | | | 7,7,8,8-Tetracyano- | | 1,3-Dixoane | | | 88 |
| Example 2-6-38 | | | | quinodimentane | | FEC | | | 90 |
| Example 2-6-39 | | | | Acetonitrile | | 1,3-Dixoane | | | 74 |
| Example 2-6-40 | | | | | | FEC | | | 80 |
| Example 2-6-41 | | LiPF₆ | 1.0 | Succinonitrile | 1.0 | 1,3-Dixoane | 4.08 | Overcharge | 82 |
| Example 2-6-42 | | | | | | FEC | | controlling | 83 |
| Example 2-6-43 | | | | Adiponitrile | | 1,3-Dixoane | | agent (12-1) | 81 |
| Example 2-6-44 | | | | | | FEC | | | 87 |
| Example 2-6-45 | | | | 7,7,8,8-Tetracyano- | | 1,3-Dixoane | | | 83 |
| Example 2-6-46 | | | | quinodimentane | | FEC | | | 82 |
| Example 2-6-47 | | | | Acetonitrile | | 1,3-Dixoane | | | 87 |
| Example 2-6-48 | | | | | | FEC | | | 80 |
| Example 2-6-49 | | LiPF₆ | 1.0 | Succinonitrile | 1.0 | 1,3-Dixoane | 4.08 | Overcharge | 86 |
| Example 2-6-50 | | | | | | FEC | | controlling | 81 |
| Example 2-6-51 | | | | Adiponitrile | | 1,3-Dixoane | | agent (12-2) | 85 |
| Example 2-6-52 | | | | | | FEC | | | 78 |
| Example 2-6-53 | | | | 7,7,8,8-Tetracyano- | | 1,3-Dixoane | | | 88 |
| Example 2-6-54 | | | | quinodimentane | | FEC | | | 79 |
| Example 2-6-55 | | | | Acetonitrile | | 1,3-Dixoane | | | 85 |
| Example 2-6-56 | | | | | | FEC | | | 84 |

TABLE 26
[Negative electrode active material: SnCoC-containing material]

| | | | | | | | | | Retention rate |
|---|---|---|---|---|---|---|---|---|---|
| | | | | | | | | | of load |
| | | Electrolyte salt | | Compound 1 | | Compound 2 | | | characteristics |
| | Nonaqueous | | Mixing | | Mixing | | Mixing | Overcharge | after the |
| | solvent [mass | | amount | | amount | | amount | controlling | overcharge |
| | ratio] | Material | [moles/kg] | Material | [wt %] | Material | [wt %] | agent | [%] |
| Example 2-7-1 | EC/DMC/EMC = | LiPF₆ | 0.9 | LiPF₃(C₂F₅)₃ | 3.63 | 1,3-Dixoane | 4.02 | Overcharge | 77 |
| Example 2-7-2 | 25/40/30 | | | | | FEC | | controlling | 79 |
| Example 2-7-3 | | | | LiBF₂(C₂F₅)₂ | 2.40 | 1,3-Dixoane | | agent (1-10) | 77 |
| Example 2-7-4 | | | | | | FEC | | | 75 |
| Example 2-7-5 | | | | LiN(SO₂CF₃)₂ | 2.34 | 1,3-Dixoane | | | 80 |
| Example 2-7-6 | | | | | | FEC | | | 76 |
| Example 2-7-7 | | | | LiN(SO₂F)₂ | 1.54 | 1,3-Dixoane | | | 78 |
| Example 2-7-8 | | | | | | FEC | | | 82 |
| Example 2-7-9 | | LiPF₆ | 0.9 | LiPF₃(C₂F₅)₃ | 3.63 | 1,3-Dixoane | 4.02 | Overcharge | 79 |
| Example | | | | | | FEC | | controlling | 79 |
| 2-7-10 | | | | | | | | agent (1-18) | |
| Example 2-7-11 | | | | LiBF₂(C₂F₅)₂ | 2.40 | 1,3-Dixoane | | | 79 |
| Example | | | | | | FEC | | | 80 |
| 2-7-12 | | | | | | | | | |
| Example | | | | LiN(SO₂CF₃)₂ | 2.34 | 1,3-Dixoane | | | 79 |
| 2-7-13 | | | | | | | | | |
| Example | | | | | | FEC | | | 79 |
| 2-7-14 | | | | | | | | | |
| Example | | | | LiN(SO₂F)₂ | 1.54 | 1,3-Dixoane | | | 72 |
| 2-7-15 | | | | | | | | | |
| Example | | | | | | FEC | | | 74 |
| 2-7-16 | | | | | | | | | |
| Example | | LiPF₆ | 0.9 | LiPF₃(C₂F₅)₃ | 3.63 | 1,3-Dixoane | 4.02 | Overcharge | 74 |
| 2-7-17 | | | | | | | | controlling | |
| Example | | | | | | FEC | | agent (4-71) | 77 |
| 2-7-18 | | | | | | | | | |
| Example | | | | LiBF₂(C₂F₅)₂ | 2.40 | 1,3-Dixoane | | | 73 |
| 2-7-19 | | | | | | | | | |
| Example | | | | | | FEC | | | 79 |
| 2-7-20 | | | | | | | | | |
| Example | | | | LiN(SO₂CF₃)₂ | 2.34 | 1,3-Dixoane | | | 73 |
| 2-7-21 | | | | | | | | | |
| Example | | | | | | FEC | | | 80 |
| 2-7-22 | | | | | | | | | |
| Example | | | | LiN(SO₂F)₂ | 1.54 | 1,3-Dixoane | | | 78 |
| 2-7-23 | | | | | | | | | |
| Example | | | | | | FEC | | | 85 |
| 2-7-24 | | | | | | | | | |
| Example | | LiPF₆ | 0.9 | LiPF₃(C₂F₅)₃ | 3.63 | 1,3-Dixoane | 4.02 | Overcharge | 86 |
| 2-7-25 | | | | | | | | controlling | |
| Example | | | | | | FEC | | agent (5-3) | 80 |
| 2-7-26 | | | | | | | | | |
| Example | | | | LiBF₂(C₂F₅)₂ | 2.40 | 1,3-Dixoane | | | 85 |
| 2-7-27 | | | | | | | | | |
| Example | | | | | | FEC | | | 80 |
| 2-7-28 | | | | | | | | | |
| Example | | | | LiN(SO₂CF₃)₂ | 2.34 | 1,3-Dixoane | | | 81 |
| 2-7-29 | | | | | | | | | |
| Example | | | | | | FEC | | | 74 |
| 2-7-30 | | | | | | | | | |
| Example | | | | LiN(SO₂F)₂ | 1.54 | 1,3-Dixoane | | | 84 |
| 2-7-31 | | | | | | | | | |
| Example | | | | | | FEC | | | 81 |
| 2-7-32 | | | | | | | | | |

TABLE 27
[Negative electrode active material: SnCoC-containing material]

| | | | | | | | | | Retention rate |
|---|---|---|---|---|---|---|---|---|---|
| | | | | | | | | | of load |
| | | Electrolyte salt | | Compound 1 | | Compound 2 | | | characteristics |
| | Nonaqueous | | Mixing | | Mixing | | Mixing | Overcharge | after the |
| | solvent [mass | | amount | | amount | | amount | controlling | overcharge |
| | ratio] | Material | [moles/kg] | Material | [wt %] | Material | [wt %] | agent | [%] |
| Example | EC/DMC/EMC = | LiPF₆ | 0.9 | LiPF₃(C₂F₅)₃ | 3.63 | 1,3-Dixoane | 4.02 | Overcharge | 79 |
| 2-7-33 | 25/40/30 | | | | | | | controlling | |
| Example | | | | | | FEC | | agent (8-4) | 83 |
| 2-7-34 | | | | | | | | | |
| Example | | | | LiBF₂(C₂F₅)₂ | 2.40 | 1,3-Dixoane | | | 80 |
| 2-7-35 | | | | | | | | | |
| Example | | | | | | FEC | | | 84 |
| 2-7-36 | | | | | | | | | |
| Example | | | | LiN(SO₂CF₃)₂ | 2.34 | 1,3-Dixoane | | | 77 |
| 2-7-37 | | | | | | | | | |
| Example | | | | | | FEC | | | 83 |
| 2-7-38 | | | | | | | | | |
| Example | | | | LiN(SO₂F)₂ | 1.54 | 1,3-Dixoane | | | 77 |
| 2-7-39 | | | | | | | | | |
| Example | | | | | | FEC | | | 80 |
| 2-7-40 | | | | | | | | | |
| Example | | LiPF₆ | 0.9 | LiPF₃(C₂F₅)₃ | 3.63 | 1,3-Dixoane | 4.02 | Overcharge | 73 |
| 2-7-41 | | | | | | | | controlling | |
| Example | | | | | | FEC | | agent (12-1) | 74 |
| 2-7-42 | | | | | | | | | |
| Example | | | | LiBF₂(C₂F₅)₂ | 2.40 | 1,3-Dixoane | | | 70 |
| 2-7-43 | | | | | | | | | |
| Example | | | | | | FEC | | | 73 |
| 2-7-44 | | | | | | | | | |
| Example | | | | LiN(SO₂CF₃)₂ | 2.34 | 1,3-Dixoane | | | 79 |
| 2-7-45 | | | | | | | | | |
| Example | | | | | | FEC | | | 76 |
| 2-7-46 | | | | | | | | | |
| Example | | | | LiN(SO₂F)₂ | 1.54 | 1,3-Dixoane | | | 81 |
| 2-7-47 | | | | | | | | | |
| Example | | | | | | FEC | | | 75 |
| 2-7-48 | | | | | | | | | |
| Example | | LiPF₆ | 0.9 | LiPF₃(C₂F₅)₃ | 3.63 | 1,3-Dixoane | 4.02 | Overcharge | 75 |
| 2-7-49 | | | | | | | | controlling | |
| Example | | | | | | FEC | | agent (12-2) | 82 |
| 2-7-50 | | | | | | | | | |
| Example | | | | LiBF₂(C₂F₅)₂ | 2.40 | 1,3-Dixoane | | | 85 |
| 2-7-51 | | | | | | | | | |
| Example | | | | | | FEC | | | 79 |
| 2-7-52 | | | | | | | | | |
| Example | | | | LiN(SO₂CF₃)₂ | 2.34 | 1,3-Dixoane | | | 73 |
| 2-7-53 | | | | | | | | | |
| Example | | | | | | FEC | | | 80 |
| 2-7-54 | | | | | | | | | |
| Example | | | | LiN(SO₂F)₂ | 1.54 | 1,3-Dixoane | | | 82 |
| 2-7-55 | | | | | | | | | |
| Example | | | | | | FEC | | | 81 |
| 2-7-56 | | | | | | | | | |

As is clear from Tables 15 to 27, by adding the compound according to the present technology and the overcharge controlling agent to the nonaqueous electrolytic solution, even in the case of using, as the negative electrode active material, the SnCoC-containing material capable of obtaining a high energy density, similar to the case of using a carbon based negative electrode active material, the effect for inhibiting a lowering of the retention rate of load characteristics after the overcharge was obtained.

### Examples 3-1-1 to 3-7-56

A silicon powder was used as the negative electrode active material in place of the granular graphite powder.

The negative electrode was fabricated in the following manner.

95 parts by mass of a silicon powder as a negative electrode active material and 5 parts by mass of polyimide as a binder were mixed, to which was then added N-methyl-2-pyrrolidone to prepare a negative electrode mixture slurry. Subsequently, this negative electrode mixture slurry was uniformly coated on the both surfaces of the negative electrode collector 22A made of a strip-shaped copper foil having a thickness of 15 μm by using a coating apparatus and dried. The resultant was compression molded and then heated in a vacuum atmosphere at 400° C. for 12 hours to fabricate a negative electrode having a negative electrode active material layer formed thereon.

Test batteries of Examples 3-1-1 to 3-7-56 were respectively fabricated in the same manners as those in Examples 1-1-1 to 1-7-56, except for using such a negative electrode.

[Evaluation of Battery: Load Characteristics after the Overcharge]

With respect to the respective Examples and Comparative Examples, the load characteristics after the overcharge were confirmed in the same manner as that in Example 1-1-1, except that the lower limit voltage (discharge termination voltage) at the time of discharge at each of the first cycle and the third to fifth cycles was set to 2.5 V, and the discharge current at the time of constant-current discharge at the sixth cycle was set to 2 C.

Evaluation results are shown in the following Tables 28 to 40.

TABLE 28
[Negative electrode active material: Silicon]

| | | | | | Retention rate of load |
|---|---|---|---|---|---|
| | Nonaqueous | Compound | | | characteristics after the |
| | solvent | Material | Mixing amount [wt %] | Overcharge controlling agent | overcharge [%] |
| Example 3-1-1 | EC/DMC/EMC = | Succinic anhydride | 1.0 | Overcharge Controlling Agent (1-10) | 73 |
| Example 3-1-2 | 30/40/30 | | | Overcharge Controlling Agent (1-18) | 68 |
| Example 3-1-3 | | | | Overcharge Controlling Agent (4-71) | 78 |
| Example 3-1-4 | | | | Overcharge Controlling Agent (5-3) | 70 |
| Example 3-1-5 | | | | Overcharge Controlling Agent (8-4) | 69 |
| Example 3-1-6 | | | | Overcharge Controlling Agent (12-1) | 73 |
| Example 3-1-7 | | | | Overcharge Controlling Agent (12-2) | 67 |
| Example 3-1-8 | | Cyclodisone | 1.0 | Overcharge Controlling Agent (1-10) | 84 |
| Example 3-1-9 | | (Compound (8-12)) | | Overcharge Controlling Agent (1-18) | 82 |
| Example 3-1-10 | | | | Overcharge Controlling Agent (4-71) | 82 |
| Example 3-1-11 | | | | Overcharge Controlling Agent (5-3) | 67 |
| Example 3-1-12 | | | | Overcharge Controlling Agent (8-4) | 77 |
| Example 3-1-13 | | | | Overcharge Controlling Agent (12-1) | 75 |
| Example 3-1-14 | | | | Overcharge Controlling Agent (12-2) | 74 |
| Example 3-1-15 | | Propanedicarboxylic | 1.0 | Overcharge Controlling Agent (1-10) | 84 |
| Example 3-1-16 | | anhydride | | Overcharge Controlling Agent (1-18) | 71 |
| Example 3-1-17 | | | | Overcharge Controlling Agent (4-71) | 75 |
| Example 3-1-18 | | | | Overcharge Controlling Agent (5-3) | 76 |
| Example 3-1-19 | | | | Overcharge Controlling Agent (8-4) | 80 |
| Example 3-1-20 | | | | Overcharge Controlling Agent (12-1) | 79 |
| Example 3-1-21 | | | | Overcharge Controlling Agent (12-2) | 73 |
| Example 3-1-22 | | FEC | 1.0 | Overcharge Controlling Agent (1-10) | 69 |
| Example 3-1-23 | | | | Overcharge Controlling Agent (1-18) | 78 |
| Example 3-1-24 | | | | Overcharge Controlling Agent (4-71) | 78 |
| Example 3-1-25 | | | | Overcharge Controlling Agent (5-3) | 72 |
| Example 3-1-26 | | | | Overcharge Controlling Agent (8-4) | 75 |
| Example 3-1-27 | | | | Overcharge Controlling Agent (12-1) | 78 |
| Example 3-1-28 | | | | Overcharge Controlling Agent (12-2) | 78 |
| Example 3-1-29 | | VC | 1.0 | Overcharge Controlling Agent (1-10) | 84 |
| Example 3-1-30 | | | | Overcharge Controlling Agent (1-18) | 70 |
| Example 3-1-31 | | | | Overcharge Controlling Agent (4-71) | 79 |
| Example 3-1-32 | | | | Overcharge Controlling Agent (5-3) | 75 |
| Example 3-1-33 | | | | Overcharge Controlling Agent (8-4) | 79 |
| Example 3-1-34 | | | | Overcharge Controlling Agent (12-1) | 79 |
| Example 3-1-35 | | | | Overcharge Controlling Agent (12-2) | 80 |
| Example 3-1-36 | | t-DFEC | 1.0 | Overcharge Controlling Agent (1-10) | 75 |
| Example 3-1-37 | | | | Overcharge Controlling Agent (1-18) | 73 |
| Example 3-1-38 | | | | Overcharge Controlling Agent (4-71) | 66 |
| Example 3-1-39 | | | | Overcharge Controlling Agent (5-3) | 74 |
| Example 3-1-40 | | | | Overcharge Controlling Agent (8-4) | 76 |
| Example 3-1-41 | | | | Overcharge Controlling Agent (12-1) | 81 |
| Example 3-1-42 | | | | Overcharge Controlling Agent (12-2) | 73 |
| Example 3-1-43 | | Propene sultone | 1.0 | Overcharge Controlling Agent (1-10) | 70 |
| Example 3-1-44 | | | | Overcharge Controlling Agent (1-18) | 69 |
| Example 3-1-45 | | | | Overcharge Controlling Agent (4-71) | 80 |
| Example 3-1-46 | | | | Overcharge Controlling Agent (5-3) | 71 |
| Example 3-1-47 | | | | Overcharge Controlling Agent (8-4) | 76 |
| Example 3-1-48 | | | | Overcharge Controlling Agent (12-1) | 66 |
| Example 3-1-49 | | | | Overcharge Controlling Agent (12-2) | 73 |

TABLE 29
[Negative electrode active material: Silicon]

| | | Compound | | | Retention rate of load |
|---|---|---|---|---|---|
| | Nonaqueous | | Mixing amount | | characteristics after the |
| | solvent | Material | [wt %] | Overcharge controlling agent | overcharge [%] |
| Example 3-1-50 | EC/DMC/EMC = | LiBF₄ | 0.78 | Overcharge Controlling Agent (1-10) | 78 |
| Example 3-1-51 | 30/40/30 | | | Overcharge Controlling Agent (1-18) | 79 |
| Example 3-1-52 | | | | Overcharge Controlling Agent (4-71) | 72 |
| Example 3-1-53 | | | | Overcharge Controlling Agent (5-3) | 77 |
| Example 3-1-54 | | | | Overcharge Controlling Agent (8-4) | 75 |
| Example 3-1-55 | | | | Overcharge Controlling Agent (12-1) | 74 |
| Example 3-1-56 | | | | Overcharge Controlling Agent (12-2) | 69 |
| Example 3-1-57 | | LiBOB | 1.59 | Overcharge Controlling Agent (1-10) | 74 |
| Example 3-1-58 | | (Compound (4-6)) | | Overcharge Controlling Agent (1-18) | 71 |
| Example 3-1-59 | | | | Overcharge Controlling Agent (4-71) | 77 |
| Example 3-1-60 | | | | Overcharge Controlling Agent (5-3) | 79 |
| Example 3-1-61 | | | | Overcharge Controlling Agent (8-4) | 76 |
| Example 3-1-62 | | | | Overcharge Controlling Agent (12-1) | 76 |
| Example 3-1-63 | | | | Overcharge Controlling Agent (12-2) | 72 |
| Example 3-1-64 | | LiPF₂(C₂O₄)₂ | 2.06 | Overcharge Controlling Agent (1-10) | 68 |
| Example 3-1-65 | | (Compound (4-2)) | | Overcharge Controlling Agent (1-18) | 71 |
| Example 3-1-66 | | | | Overcharge Controlling Agent (4-71) | 70 |
| Example 3-1-67 | | | | Overcharge Controlling Agent (5-3) | 74 |
| Example 3-1-68 | | | | Overcharge Controlling Agent (8-4) | 74 |
| Example 3-1-69 | | | | Overcharge Controlling Agent (12-1) | 80 |
| Example 3-1-70 | | | | Overcharge Controlling Agent (12-2) | 67 |
| Example 3-1-71 | | LiN(SO₂CF₂)₂CF₂ | 2.43 | Overcharge Controlling Agent (1-10) | 73 |
| Example 3-1-72 | | (Compound (7-2)) | | Overcharge Controlling Agent (1-18) | 73 |
| Example 3-1-73 | | | | Overcharge Controlling Agent (4-71) | 70 |
| Example 3-1-74 | | | | Overcharge Controlling Agent (5-3) | 75 |
| Example 3-1-75 | | | | Overcharge Controlling Agent (8-4) | 80 |
| Example 3-1-76 | | | | Overcharge Controlling Agent (12-1) | 61 |
| Example 3-1-77 | | | | Overcharge Controlling Agent (12-2) | 69 |
| Comparative | EC/DMC/EMC = | — | — | Overcharge Controlling Agent (1-10) | 50 |
| Example 3-1-1 | 30/40/30 | | | | |
| Comparative | | | | Overcharge Controlling Agent (1-18) | 49 |
| Example 3-1-2 | | | | | |
| Comparative | | | | Overcharge Controlling Agent (4-71) | 55 |
| Example 3-1-3 | | | | | |
| Comparative | | | | Overcharge Controlling Agent (5-3) | 58 |
| Example 3-1-4 | | | | | |
| Comparative | | | | Overcharge Controlling Agent (8-4) | 63 |
| Example 3-1-5 | | | | | |
| Comparative | | | | Overcharge Controlling Agent (12-1) | 61 |
| Example 3-1-6 | | | | | |
| Comparative | | | | Overcharge Controlling Agent (12-2) | 49 |
| Example 3-1-7 | | | | | |
| Comparative | | Succinic anhydride | 1.0 | — | 46 |
| Example 3-1-8 | | | | | |
| Comparative | | Cyclodisone | 1.0 | | 50 |
| Example 3-1-9 | | | | | |
| Comparative | | Propanedicarboxylic anhydride | 1.0 | | 50 |
| Example 3-1-10 | | | | | |
| Comparative | | FEC | 1.0 | | 41 |
| Example 3-1-11 | | | | | |
| Comparative | | VC | 1.0 | | 41 |
| Example 3-1-12 | | | | | |
| Comparative | | t-DFEC | 1.0 | | 34 |
| Example 3-1-13 | | | | | |
| Comparative | | Propene sultone | 1.0 | | 47 |
| Example 3-1-14 | | | | | |
| Comparative | | LiBF₄ | 0.78 | | 45 |
| Example 3-1-15 | | | | | |
| Comparative | | LiBOB | 1.59 | | 47 |
| Example 3-1-16 | | | | | |
| Comparative | | LiPF₂(C₂O₄)₂ | 2.06 | | 40 |
| Example 3-1-17 | | | | | |
| Comparative | | LiN(SO₂CF₂)₂CF₂ | 2.43 | | 41 |
| Example 3-1-18 | | | | | |
| Comparative | | — | — | | 52 |
| Example 3-1-19 | | | | | |

TABLE 30
[Negative electrode active material: Silicon]

| | | | | | Retention rate |
|---|---|---|---|---|---|
| | | Compound | | | of load |
| | Nonaqueous | | Mixing amount | | characteristics after |
| | solvent | Material | [wt %] | Overcharge controlling agent | the overcharge [%] |
| Example 3-2-1 | EC/DMC/EMC = | Succinonitrile | 1.0 | Overcharge Controlling Agent (1-10) | 73 |
| Example 3-2-2 | 30/40/30 | | | Overcharge Controlling Agent (1-18) | 71 |
| Example 3-2-3 | | | | Overcharge Controlling Agent (4-71) | 73 |
| Example 3-2-4 | | | | Overcharge Controlling Agent (5-3) | 74 |
| Example 3-2-5 | | | | Overcharge Controlling Agent (8-4) | 74 |
| Example 3-2-6 | | | | Overcharge Controlling Agent (12-1) | 76 |
| Example 3-2-7 | | | | Overcharge Controlling Agent (12-2) | 76 |
| Example 3-2-8 | | Adiponitrile | 1.0 | Overcharge Controlling Agent (1-10) | 70 |
| Example 3-2-9 | | | | Overcharge Controlling Agent (1-18) | 73 |
| Example 3-2-10 | | | | Overcharge Controlling Agent (4-71) | 74 |
| Example 3-2-11 | | | | Overcharge Controlling Agent (5-3) | 81 |
| Example 3-2-12 | | | | Overcharge Controlling Agent (8-4) | 74 |
| Example 3-2-13 | | | | Overcharge Controlling Agent (12-1) | 77 |
| Example 3-2-14 | | | | Overcharge Controlling Agent (12-2) | 78 |
| Example 3-2-15 | | 7,7,8,8-Tetracyanoquinodimethane | 1.0 | Overcharge Controlling Agent (1-10) | 72 |
| Example 3-2-16 | | | | Overcharge Controlling Agent (1-18) | 76 |
| Example 3-2-17 | | | | Overcharge Controlling Agent (4-71) | 74 |
| Example 3-2-18 | | | | Overcharge Controlling Agent (5-3) | 73 |
| Example 3-2-19 | | | | Overcharge Controlling Agent (8-4) | 75 |
| Example 3-2-20 | | | | Overcharge Controlling Agent (12-1) | 76 |
| Example 3-2-21 | | | | Overcharge Controlling Agent (12-2) | 78 |
| Example 3-2-22 | | Acetonitrile | 1.0 | Overcharge Controlling Agent (1-10) | 72 |
| Example 3-2-23 | | | | Overcharge Controlling Agent (1-18) | 72 |
| Example 3-2-24 | | | | Overcharge Controlling Agent (4-71) | 76 |
| Example 3-2-25 | | | | Overcharge Controlling Agent (5-3) | 75 |
| Example 3-2-26 | | | | Overcharge Controlling Agent (8-4) | 73 |
| Example 3-2-27 | | | | Overcharge Controlling Agent (12-1) | 79 |
| Example 3-2-28 | | | | Overcharge Controlling Agent (12-2) | 76 |
| Example 3-2-29 | | 1-Isocyanatoethane | 1.0 | Overcharge Controlling Agent (1-10) | 71 |
| Example 3-2-30 | | | | Overcharge Controlling Agent (1-18) | 72 |
| Example 3-2-31 | | | | Overcharge Controlling Agent (4-71) | 78 |
| Example 3-2-32 | | | | Overcharge Controlling Agent (5-3) | 74 |
| Example 3-2-33 | | | | Overcharge Controlling Agent (8-4) | 76 |
| Example 3-2-34 | | | | Overcharge Controlling Agent (12-1) | 77 |
| Example 3-2-35 | | | | Overcharge Controlling Agent (12-2) | 75 |
| Example 3-2-36 | | 1,8-Diisocyanatooctane | 1.0 | Overcharge Controlling Agent (1-10) | 70 |
| Example 3-2-37 | | | | Overcharge Controlling Agent (1-18) | 69 |
| Example 3-2-38 | | | | Overcharge Controlling Agent (4-71) | 74 |
| Example 3-2-39 | | | | Overcharge Controlling Agent (5-3) | 74 |
| Example 3-2-40 | | | | Overcharge Controlling Agent (8-4) | 75 |
| Example 3-2-41 | | | | Overcharge Controlling Agent (12-1) | 77 |
| Example 3-2-42 | | | | Overcharge Controlling Agent (12-2) | 75 |
| Comparative | EC/DMC/EMC = | Succinonitrile | 1.0 | — | 35 |
| Example 3-2-1 | 30/40/30 | | | | |
| Comparative | | Adiponitrile | | | 37 |
| Example 3-2-2 | | | | | |
| Comparative | | 7,7,8,8-Tetracyanoquinodimethane | | | 35 |
| Example 3-2-3 | | | | | |
| Comparative | | Acetonitrile | | | 38 |
| Example 3-2-4 | | | | | |
| Comparative | | 1-Isocyanatoethane | | | 39 |
| Example 3-2-5 | | | | | |
| Comparative | | 1,8-Diisocyanatooctane | | | 37 |
| Example 3-2-6 | | | | | |

TABLE 31
[Negative electrode active material: Silicon]

| | | | | | Retention rate of load |
|---|---|---|---|---|---|
| | Nonaqueous | Compound | | | characteristics after the |
| | solvent | Material | Mixing amount [wt %] | Overcharge controlling agent | overcharge [%] |
| Example 3-3-1 | EC/DMC/EMC = | γ-Butyrolactone | 4.12 | Overcharge Controlling Agent (1-10) | 85 |
| Example 3-3-2 | 25/40/30 | | | Overcharge Controlling Agent (1-18) | 78 |
| Example 3-3-3 | | | | Overcharge Controlling Agent (4-71) | 87 |
| Example 3-3-4 | | | | Overcharge Controlling Agent (5-3) | 84 |
| Example 3-3-5 | | | | Overcharge Controlling Agent (8-4) | 82 |
| Example 3-3-6 | | | | Overcharge Controlling Agent (12-1) | 89 |
| Example 3-3-7 | | | | Overcharge Controlling Agent (12-2) | 86 |
| Example 3-3-8 | | NMP | 4.12 | Overcharge Controlling Agent (1-10) | 83 |
| Example 3-3-9 | | | | Overcharge Controlling Agent (1-18) | 74 |
| Example 3-3-10 | | | | Overcharge Controlling Agent (4-71) | 79 |
| Example 3-3-11 | | | | Overcharge Controlling Agent (5-3) | 76 |
| Example 3-3-12 | | | | Overcharge Controlling Agent (8-4) | 79 |
| Example 3-3-13 | | | | Overcharge Controlling Agent (12-1) | 84 |
| Example 3-3-14 | | | | Overcharge Controlling Agent (12-2) | 82 |
| Example 3-3-15 | | Methyl acetate | 4.12 | Overcharge Controlling Agent (1-10) | 83 |
| Example 3-3-16 | | | | Overcharge Controlling Agent (1-18) | 79 |
| Example 3-3-17 | | | | Overcharge Controlling Agent (4-71) | 91 |
| Example 3-3-18 | | | | Overcharge Controlling Agent (5-3) | 88 |
| Example 3-3-19 | | | | Overcharge Controlling Agent (8-4) | 85 |
| Example 3-3-20 | | | | Overcharge Controlling Agent (12-1) | 83 |
| Example 3-3-21 | | | | Overcharge Controlling Agent (12-2) | 85 |
| Example 3-3-22 | | Ethyl trimethylacetate | 4.12 | Overcharge Controlling Agent (1-10) | 85 |
| Example 3-3-23 | | | | Overcharge Controlling Agent (1-18) | 80 |
| Example 3-3-24 | | | | Overcharge Controlling Agent (4-71) | 82 |
| Example 3-3-25 | | | | Overcharge Controlling Agent (5-3) | 79 |
| Example 3-3-26 | | | | Overcharge Controlling Agent (8-4) | 77 |
| Example 3-3-27 | | | | Overcharge Controlling Agent (12-1) | 83 |
| Example 3-3-28 | | | | Overcharge Controlling Agent (12-2) | 84 |
| Example 3-3-29 | | 1,2-Dimethoxyethane | 4.12 | Overcharge Controlling Agent (1-10) | 88 |
| Example 3-3-30 | | | | Overcharge Controlling Agent (1-18) | 82 |
| Example 3-3-31 | | | | Overcharge Controlling Agent (4-71) | 90 |
| Example 3-3-32 | | | | Overcharge Controlling Agent (5-3) | 85 |
| Example 3-3-33 | | | | Overcharge Controlling Agent (8-4) | 81 |
| Example 3-3-34 | | | | Overcharge Controlling Agent (12-1) | 83 |
| Example 3-3-35 | | | | Overcharge Controlling Agent (12-2) | 89 |
| Example 3-3-36 | | 1,3-Dioxane | 4.12 | Overcharge Controlling Agent (1-10) | 91 |
| Example 3-3-37 | | | | Overcharge Controlling Agent (1-18) | 81 |
| Example 3-3-38 | | | | Overcharge Controlling Agent (4-71) | 90 |
| Example 3-3-39 | | | | Overcharge Controlling Agent (5-3) | 86 |
| Example 3-3-40 | | | | Overcharge Controlling Agent (8-4) | 78 |
| Example 3-3-41 | | | | Overcharge Controlling Agent (12-1) | 81 |
| Example 3-3-42 | | | | Overcharge Controlling Agent (12-2) | 81 |
| Example 3-3-43 | | FDMC | 4.12 | Overcharge Controlling Agent (1-10) | 87 |
| Example 3-3-44 | | | | Overcharge Controlling Agent (1-18) | 82 |
| Example 3-3-45 | | | | Overcharge Controlling Agent (4-71) | 88 |
| Example 3-3-46 | | | | Overcharge Controlling Agent (5-3) | 84 |
| Example 3-3-47 | | | | Overcharge Controlling Agent (8-4) | 80 |
| Example 3-3-48 | | | | Overcharge Controlling Agent (12-1) | 83 |
| Example 3-3-49 | | | | Overcharge Controlling Agent (12-2) | 86 |

TABLE 32
[Negative electrode active material: Silicon]

| | | | | | Retention rate of load |
|---|---|---|---|---|---|
| | Nonaqueous | Compound | | | characteristics after the |
| | solvent | Material | Mixing amount [wt %] | Overcharge controlling agent | overcharge [%] |
| Example 3-3-50 | EC/DMC/EMC = | FEC | 4.12 | Overcharge Controlling Agent (1-10) | 81 |
| Example 3-3-51 | 25/40/30 | | | Overcharge Controlling Agent (1-18) | 90 |
| Example 3-3-52 | | | | Overcharge Controlling Agent (4-71) | 80 |
| Example 3-3-53 | | | | Overcharge Controlling Agent (5-3) | 78 |
| Example 3-3-54 | | | | Overcharge Controlling Agent (8-4) | 82 |
| Example 3-3-55 | | | | Overcharge Controlling Agent (12-1) | 79 |
| Example 3-3-56 | | | | Overcharge Controlling Agent (12-2) | 82 |
| Example 3-3-57 | | Sulfolane | 4.12 | Overcharge Controlling Agent (1-10) | 89 |
| Example 3-3-58 | | | | Overcharge Controlling Agent (1-18) | 76 |
| Example 3-3-59 | | | | Overcharge Controlling Agent (4-71) | 91 |
| Example 3-3-60 | | | | Overcharge Controlling Agent (5-3) | 77 |
| Example 3-3-61 | | | | Overcharge Controlling Agent (8-4) | 77 |
| Example 3-3-62 | | | | Overcharge Controlling Agent (12-1) | 85 |
| Example 3-3-63 | | | | Overcharge Controlling Agent (12-2) | 85 |
| Comparative | EC/DMC/EMC = | γ-Butyrolactone | 4.12 | — | 63 |
| Example 3-3-1 | 25/40/30 | | | | |
| Comparative | | NMP | 4.12 | | 45 |
| Example 3-3-2 | | | | | |
| Comparative | | Methyl acetate | 4.12 | | 59 |
| Example 3-3-3 | | | | | |
| Comparative | | Ethyl trimethylacetate | 4.12 | | 53 |
| Example 3-3-4 | | | | | |
| Comparative | | 1,2-Dimethoxyethane | 4.12 | | 58 |
| Example 3-3-5 | | | | | |
| Comparative | | 1,3-Dioxane | 4.12 | | 56 |
| Example 3-3-6 | | | | | |
| Comparative | | FDMC | 4.12 | | 52 |
| Example 3-3-7 | | | | | |
| Comparative | | FEC | 4.12 | | 49 |
| Example 3-3-8 | | | | | |
| Comparative | | Sulfolane | 4.12 | | 52 |
| Example 3-3-9 | | | | | |

TABLE 33
[Negative electrode active material: Silicon]

| | Electrolyte salt | | Compound | | | |
|---|---|---|---|---|---|---|
| | | Mixing | | Mixing | | Retention rate of load |
| | | amount | | amount | | characteristics after |
| | Material | [moles/kg] | Material | [wt %] | Overcharge controlling agent | the overcharge [%] |
| Example 3-4-1 | LiPF₆ | 0.9 | LiPF₃(C₂F₅)₃ | 3.63 | Overcharge Controlling Agent (1-10) | 64 |
| Example 3-4-2 | | | | | Overcharge Controlling Agent (1-18) | 75 |
| Example 3-4-3 | | | | | Overcharge Controlling Agent (4-71) | 71 |
| Example 3-4-4 | | | | | Overcharge Controlling Agent (5-3) | 87 |
| Example 3-4-5 | | | | | Overcharge Controlling Agent (8-4) | 72 |
| Example 3-4-6 | | | | | Overcharge Controlling Agent (12-1) | 77 |
| Example 3-4-7 | | | | | Overcharge Controlling Agent (12-2) | 69 |
| Example 3-4-8 | | | LiPF₄(CF₃)₂ | 2.06 | Overcharge Controlling Agent (1-10) | 72 |
| Example 3-4-9 | | | | | Overcharge Controlling Agent (1-18) | 64 |
| Example 3-4-10 | | | | | Overcharge Controlling Agent (4-71) | 73 |
| Example 3-4-11 | | | | | Overcharge Controlling Agent (5-3) | 75 |
| Example 3-4-12 | | | | | Overcharge Controlling Agent (8-4) | 83 |
| Example 3-4-13 | | | | | Overcharge Controlling Agent (12-1) | 78 |
| Example 3-4-14 | | | | | Overcharge Controlling Agent (12-2) | 81 |
| Example 3-4-15 | | | LiBF(C₂F₅)₃ | 3.18 | Overcharge Controlling Agent (1-10) | 72 |
| Example 3-4-16 | | | | | Overcharge Controlling Agent (1-18) | 72 |
| Example 3-4-17 | | | | | Overcharge Controlling Agent (4-71) | 62 |
| Example 3-4-18 | | | | | Overcharge Controlling Agent (5-3) | 80 |
| Example 3-4-19 | | | | | Overcharge Controlling Agent (8-4) | 83 |
| Example 3-4-20 | | | | | Overcharge Controlling Agent (12-1) | 77 |
| Example 3-4-21 | | | | | Overcharge Controlling Agent (12-2) | 72 |
| Example 3-4-22 | | | LiBF₂(C₂F₅)₂ | 2.40 | Overcharge Controlling Agent (1-10) | 68 |
| Example 3-4-23 | | | | | Overcharge Controlling Agent (1-18) | 73 |
| Example 3-4-24 | | | | | Overcharge Controlling Agent (4-71) | 67 |
| Example 3-4-25 | | | | | Overcharge Controlling Agent (5-3) | 81 |
| Example 3-4-26 | | | | | Overcharge Controlling Agent (8-4) | 81 |
| Example 3-4-27 | | | | | Overcharge Controlling Agent (12-1) | 74 |
| Example 3-4-28 | | | | | Overcharge Controlling Agent (12-2) | 75 |
| Example 3-4-29 | | | LiBF₃(C₂F₅) | 3.48 | Overcharge Controlling Agent (1-10) | 75 |
| Example 3-4-30 | | | | | Overcharge Controlling Agent (1-18) | 64 |
| Example 3-4-31 | | | | | Overcharge Controlling Agent (4-71) | 73 |
| Example 3-4-32 | | | | | Overcharge Controlling Agent (5-3) | 77 |
| Example 3-4-33 | | | | | Overcharge Controlling Agent (8-4) | 82 |
| Example 3-4-34 | | | | | Overcharge Controlling Agent (12-1) | 77 |
| Example 3-4-35 | | | | | Overcharge Controlling Agent (12-2) | 78 |
| Example 3-4-36 | | | LiN(SO₂CF₃)₂ | 2.34 | Overcharge Controlling Agent (1-10) | 81 |
| Example 3-4-37 | | | | | Overcharge Controlling Agent (1-18) | 72 |
| Example 3-4-38 | | | | | Overcharge Controlling Agent (4-71) | 70 |
| Example 3-4-39 | | | | | Overcharge Controlling Agent (5-3) | 71 |
| Example 3-4-40 | | | | | Overcharge Controlling Agent (8-4) | 78 |
| Example 3-4-41 | | | | | Overcharge Controlling Agent (12-1) | 78 |
| Example 3-4-42 | | | | | Overcharge Controlling Agent (12-2) | 79 |
| Example 3-4-43 | | | LiN(SO₂C₂F₅)₂ | 3.13 | Overcharge Controlling Agent (1-10) | 74 |
| Example 3-4-44 | | | | | Overcharge Controlling Agent (1-18) | 59 |
| Example 3-4-45 | | | | | Overcharge Controlling Agent (4-71) | 76 |
| Example 3-4-46 | | | | | Overcharge Controlling Agent (5-3) | 80 |
| Example 3-4-47 | | | | | Overcharge Controlling Agent (8-4) | 79 |
| Example 3-4-48 | | | | | Overcharge Controlling Agent (12-1) | 78 |
| Example 3-4-49 | | | | | Overcharge Controlling Agent (12-2) | 64 |

TABLE 34
[Negative electrode active material: Silicon]

| | | | | | | Retention |
|---|---|---|---|---|---|---|
| | Electrolyte salt | | Compound | | | rate of load |
| | | Mixing amount | | Mixing amount | | characteristics after |
| | Material | [moles/kg] | Material | [wt %] | Overcharge controlling agent | the overcharge [%] |
| Example 3-4-50 | LiPF₆ | 0.9 | LiN(SO₂F)₂ | 1.54 | Overcharge Controlling Agent (1-10) | 69 |
| Example 3-4-51 | | | | | Overcharge Controlling Agent (1-18) | 63 |
| Example 3-4-52 | | | | | Overcharge Controlling Agent (4-71) | 71 |
| Example 3-4-53 | | | | | Overcharge Controlling Agent (5-3) | 81 |
| Example 3-4-54 | | | | | Overcharge Controlling Agent (8-4) | 84 |
| Example 3-4-55 | | | | | Overcharge Controlling Agent (12-1) | 76 |
| Example 3-4-56 | | | | | Overcharge Controlling Agent (12-2) | 78 |
| Comparative | LiPF₆ | 0.9 | LiPF₃(C₂F₅)₃ | 3.63 | — | 47 |
| Example 3-4-1 | | | | | | |
| Comparative | | | LiPF₄(CF₃)₂ | 2.06 | | 50 |
| Example 3-4-2 | | | | | | |
| Comparative | | | LiBF(C₂F₅)₃ | 3.18 | | 53 |
| Example 3-4-3 | | | | | | |
| Comparative | | | LiBF₂(C₂F₅)₂ | 2.40 | | 49 |
| Example 3-4-4 | | | | | | |
| Comparative | | | LiBF₃(C₂F₅) | 3.48 | | 52 |
| Example 3-4-5 | | | | | | |
| Comparative | | | LiN(SO₂CF₃)₂ | 2.34 | | 50 |
| Example 3-4-6 | | | | | | |
| Comparative | | | LiN(SO₂C₂F₅)₂ | 3.13 | | 50 |
| Example 3-4-7 | | | | | | |
| Comparative | | | LiN(SO₂F)₂ | 1.54 | | 47 |
| Example 3-4-8 | | | | | | |

TABLE 35
[Negative electrode active material: Silicon]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent | | amount | | amount | | amount | controlling | after the |
| | [mass ratio] | Material | [moles/kg] | Material | [wt %] | Material | [wt %] | agent | overcharge [%] |
| Example 3-5-1 | EC/DMC/ | LiPF₆ | 1.0 | Succinic | 1.0 | 1,3-Dixoane | 4.08 | Overcharge | 74 |
| Example 3-5-2 | EMC = | | | anhydride | | FEC | | controlling | 76 |
| Example 3-5-3 | 25/40/30 | | | Propanedisulfonic | | 1,3-Dixoane | | agent (1-10) | 85 |
| Example 3-5-4 | | | | anhydride | | FEC | | | 88 |
| Example 3-5-5 | | | | VC | | 1,3-Dixoane | | | 92 |
| Example 3-5-6 | | | | | | FEC | | | 84 |
| Example 3-5-7 | | | | t-DFEC | | 1,3-Dixoane | | | 84 |
| Example 3-5-8 | | | | | | FEC | | | 76 |
| Example 3-5-9 | | LiPF₆ | 0.9 | LiBF₄ | 0.78 | 1,3-Dixoane | | | 85 |
| Example 3-5-10 | | | | | | FEC | | | 86 |
| Example 3-5-11 | | LiPF₆ | 1.0 | Succinic | 1.0 | 1,3-Dixoane | 4.08 | Overcharge | 69 |
| Example 3-5-12 | | | | anhydride | | FEC | | controlling | 79 |
| Example 3-5-13 | | | | Propanedisulfonic | | 1,3-Dixoane | | agent (1-18) | 75 |
| Example 3-5-14 | | | | anhydride | | FEC | | | 70 |
| Example 3-5-15 | | | | VC | | 1,3-Dixoane | | | 74 |
| Example 3-5-16 | | | | | | FEC | | | 70 |
| Example 3-5-17 | | | | t-DFEC | | 1,3-Dixoane | | | 80 |
| Example 3-5-18 | | | | | | FEC | | | 76 |
| Example 3-5-19 | | LiPF₆ | 0.9 | LiBF₄ | 0.78 | 1,3-Dixoane | | | 86 |
| Example 3-5-20 | | | | | | FEC | | | 89 |
| Example 3-5-21 | | LiPF₆ | 1.0 | Succinic | 1.0 | 1,3-Dixoane | 4.08 | Overcharge | 84 |
| Example 3-5-22 | | | | anhydride | | FEC | | controlling | 81 |
| Example 3-5-23 | | | | Propanedisulfonic | | 1,3-Dixoane | | agent (4-71) | 78 |
| Example 3-5-24 | | | | anhydride | | FEC | | | 83 |
| Example 3-5-25 | | | | VC | | 1,3-Dixoane | | | 84 |
| Example 3-5-26 | | | | | | FEC | | | 86 |
| Example 3-5-27 | | | | t-DFEC | | 1,3-Dixoane | | | 73 |
| Example 3-5-28 | | | | | | FEC | | | 68 |
| Example 3-5-29 | | LiPF₆ | 0.9 | LiBF₄ | 078 | 1,3-Dixoane | | | 77 |
| Example 3-5-30 | | | | | | FEC | | | 75 |
| Example 3-5-31 | | LiPF₆ | 1.0 | Succinic | 1.0 | 1,3-Dixoane | 4.08 | Overcharge | 75 |
| Example 3-5-32 | | | | anhydride | | FEC | | controlling | 74 |
| Example 3-5-33 | | | | Propanedisulfonic | | 1,3-Dixoane | | agent (5-3) | 85 |
| Example 3-5-34 | | | | anhydride | | FEC | | | 86 |
| Example 3-5-35 | | | | VC | | 1,3-Dixoane | | | 80 |
| Example 3-5-36 | | | | | | FEC | | | 78 |

TABLE 36
[Negative electrode active material: Silicon]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent | | amount | | amount | | amount | controlling | after the |
| | [mass ratio] | Material | [moles/kg] | Material | [wt %] | Material | [wt %] | agent | overcharge [%] |
| Example 3-5-37 | EC/DMC/ | LiPF₆ | 1.0 | t-DFEC | 1.0 | 1,3-Dixoane | 4.08 | Overcharge | 75 |
| Example 3-5-38 | EMC = | | | | | FEC | | controlling | 76 |
| Example 3-5-39 | 25/40/30 | LiPF₆ | 0.9 | LiBF₄ | 0.78 | 1,3-Dixoane | | agent (5-3) | 80 |
| Example 3-5-40 | | | | | | FEC | | | 87 |
| Example 3-5-41 | | LiPF₆ | 1.0 | Succinic | 1.0 | 1,3-Dixoane | 4.08 | Overcharge | 78 |
| Example 3-5-42 | | | | anhydride | | FEC | | controlling | 73 |
| Example 3-5-43 | | | | Propanedisulfonic | | 1,3-Dixoane | | agent (8-4) | 86 |
| Example 3-5-44 | | | | anhydride | | FEC | | | 84 |
| Example 3-5-45 | | | | VC | | 1,3-Dixoane | | | 88 |
| Example 3-5-46 | | | | | | FEC | | | 85 |
| Example 3-5-47 | | | | t-DFEC | | 1,3-Dixoane | | | 80 |
| Example 3-5-48 | | | | | | FEC | | | 81 |
| Example 3-5-49 | | LiPF₆ | 0.9 | LiBF₄ | 0.78 | 1,3-Dixoane | | | 79 |
| Example 3-5-50 | | | | | | FEC | | | 81 |
| Example 3-5-51 | | LiPF₆ | 1.0 | Succinic | 1.0 | 1,3-Dixoane | 4.08 | Overcharge | 81 |
| Example 3-5-52 | | | | anhydride | | FEC | | controlling | 78 |
| Example 3-5-53 | | | | Propanedisulfonic | | 1,3-Dixoane | | agent (12-1) | 84 |
| Example 3-5-54 | | | | anhydride | | FEC | | | 88 |
| Example 3-5-55 | | | | VC | | 1,3-Dixoane | | | 84 |
| Example 3-5-56 | | | | | | FEC | | | 82 |
| Example 3-5-57 | | | | t-DFEC | | 1,3-Dixoane | | | 89 |
| Example 3-5-58 | | | | | | FEC | | | 87 |
| Example 3-5-59 | | LiPF₆ | 0.9 | LiBF₄ | 0.78 | 1,3-Dixoane | | | 78 |
| Example 3-5-60 | | | | | | FEC | | | 75 |
| Example 3-5-61 | | LiPF₆ | 1.0 | Succinic | 1.0 | 1,3-Dixoane | 4.08 | Overcharge | 76 |
| Example 3-5-62 | | | | anhydride | | FEC | | controlling | 69 |
| Example 3-5-63 | | | | Propanedisulfonic | | 1,3-Dixoane | | agent (12-2) | 74 |
| Example 3-5-64 | | | | anhydride | | FEC | | | 77 |
| Example 3-5-65 | | | | VC | | 1,3-Dixoane | | | 90 |
| Example 3-5-66 | | | | | | FEC | | | 87 |
| Example 3-5-67 | | | | t-DFEC | | 1,3-Dixoane | | | 74 |
| Example 3-5-68 | | | | | | FEC | | | 79 |
| Example 3-5-69 | | LiPF₆ | 0.9 | LiBF₄ | 0.78 | 1,3-Dixoane | | | 76 |
| Example 3-5-70 | | | | | | FEC | | | 73 |

TABLE 37
[Negative electrode active material: Silicon]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent | | amount | | amount | | amount | controlling | after the |
| | [mass ratio] | Material | [moles/kg] | Material | [wt %] | Material | [wt %] | agent | overcharge [%] |
| Example 3-6-1 | EC/DMC/ | LiPF₆ | 1.0 | Succinonitrile | 1.0 | 1,3-Dixoane | 4.08 | Overcharge | 78 |
| Example 3-6-2 | EMC = | | | | | FEC | | controlling | 74 |
| Example 3-6-3 | 25/40/30 | | | Adiponitrile | | 1,3-Dixoane | | agent (1-10) | 85 |
| Example 3-6-4 | | | | | | FEC | | | 73 |
| Example 3-6-5 | | | | 7,7,8,8- | | 1,3-Dixoane | | | 79 |
| Example 3-6-6 | | | | Tetracyano- | | FEC | | | 71 |
| | | | | quinodimentane | | | | | |
| Example 3-6-7 | | | | Acetonitrile | | 1,3-Dixoane | | | 75 |
| Example 3-6-8 | | | | | | FEC | | | 71 |
| Example 3-6-9 | | LiPF₆ | 1.0 | Succinonitrile | 1.0 | 1,3-Dixoane | 4.08 | Overcharge | 74 |
| Example 3-6-10 | | | | | | FEC | | controlling | 71 |
| Example 3-6-11 | | | | Adiponitrile | | 1,3-Dixoane | | agent (1-18) | 77 |
| Example 3-6-12 | | | | | | FEC | | | 80 |
| Example 3-6-13 | | | | 7,7,8,8- | | 1,3-Dixoane | | | 80 |
| Example 3-6-14 | | | | Tetracyano- | | FEC | | | 80 |
| | | | | quinodimentane | | | | | |
| Example 3-6-15 | | | | Acetonitrile | | 1,3-Dixoane | | | 74 |
| Example 3-6-16 | | | | | | FEC | | | 76 |
| Example 3-6-17 | | LiPF₆ | 1.0 | Succinonitrile | 1.0 | 1,3-Dixoane | 4.08 | Overcharge | 79 |
| Example 3-6-18 | | | | | | FEC | | controlling | 79 |
| Example 3-6-19 | | | | Adiponitrile | | 1,3-Dixoane | | agent (4-71) | 74 |
| Example 3-6-20 | | | | | | FEC | | | 83 |
| Example 3-6-21 | | | | 7,7,8,8- | | 1,3-Dixoane | | | 78 |
| Example 3-6-22 | | | | Tetracyano- | | FEC | | | 77 |
| | | | | quinodimentane | | | | | |
| Example 3-6-23 | | | | Acetonitrile | | 1,3-Dixoane | | | 80 |
| Example 3-6-24 | | | | | | FEC | | | 79 |
| Example 3-6-25 | | LiPF₆ | 1.0 | Succinonitrile | 1.0 | 1,3-Dixoane | 4.08 | Overcharge | 70 |
| Example 3-6-26 | | | | | | FEC | | controlling | 76 |
| Example 3-6-27 | | | | Adiponitrile | | 1,3-Dixoane | | agent (5-3) | 86 |
| Example 3-6-28 | | | | | | FEC | | | 82 |
| Example 3-6-29 | | | | 7,7,8,8- | | 1,3-Dixoane | | | 81 |
| Example 3-6-30 | | | | Tetracyano- | | FEC | | | 78 |
| | | | | quinodimentane | | | | | |
| Example 3-6-31 | | | | Acetonitrile | | 1,3-Dixoane | | | 78 |
| Example 3-6-32 | | | | | | FEC | | | 77 |

TABLE 38
[Negative electrode active material: Silicon]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent | | amount | | amount | | amount | controlling | after the |
| | [mass ratio] | Material | [moles/kg] | Material | [wt %] | Material | [wt %] | agent | overcharge [%] |
| Example 3-6-33 | EC/DMC/ | LiPF₆ | 1.0 | Succinonitrile | 1.0 | 1,3-Dixoane | 4.08 | Overcharge | 76 |
| Example 3-6-34 | EMC = | | | | | FEC | | controlling | 80 |
| Example 3-6-35 | 25/40/30 | | | Adiponitrile | | 1,3-Dixoane | | agent (8-4) | 74 |
| Example 3-6-36 | | | | | | FEC | | | 79 |
| Example 3-6-37 | | | | 7,7,8,8- | | 1,3-Dixoane | | | 80 |
| Example 3-6-38 | | | | Tetracyano- | | FEC | | | 76 |
| | | | | quinodimentane | | | | | |
| Example 3-6-39 | | | | Acetonitrile | | 1,3-Dixoane | | | 76 |
| Example 3-6-40 | | | | | | FEC | | | 80 |
| Example 3-6-41 | | LiPF₆ | 1.0 | Succinonitrile | 1.0 | 1,3-Dixoane | 4.08 | Overcharge | 79 |
| Example 3-6-42 | | | | | | FEC | | controlling | 83 |
| Example 3-6-43 | | | | Adiponitrile | | 1,3-Dixoane | | agent (12-1) | 78 |
| Example 3-6-44 | | | | | | FEC | | | 80 |
| Example 3-6-45 | | | | 7,7,8,8- | | 1,3-Dixoane | | | 78 |
| Example 3-6-46 | | | | Tetracyano- | | FEC | | | 80 |
| | | | | quinodimentane | | | | | |
| Example 3-6-47 | | | | Acetonitrile | | 1,3-Dixoane | | | 83 |
| Example 3-6-48 | | | | | | FEC | | | 83 |
| Example 3-6-49 | | LiPF₆ | 1.0 | Succinonitrile | 1.0 | 1,3-Dixoane | 4.08 | Overcharge | 80 |
| Example 3-6-50 | | | | | | FEC | | controlling | 76 |
| Example 3-6-51 | | | | Adiponitrile | | 1,3-Dixoane | | agent (12-2) | 78 |
| Example 3-6-52 | | | | | | FEC | | | 85 |
| Example 3-6-53 | | | | 7,7,8,8- | | 1,3-Dixoane | | | 87 |
| Example 3-6-54 | | | | Tetracyano- | | FEC | | | 84 |
| | | | | quinodimentane | | | | | |
| Example 3-6-55 | | | | Acetonitrile | | 1,3-Dixoane | | | 81 |
| Example 3-6-56 | | | | | | FEC | | | 78 |

TABLE 39
[Negative electrode active material: Silicon]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent [mass | | amount | | amount | | amount | controlling | after the |
| | ratio] | Material | [moles/kg] | Material | [wt %] | Material | [wt %] | agent | overcharge [%] |
| Example 3-7-1 | EC/DMC/ | LiPF₆ | 0.9 | LiPF₃(C₂F₅)₃ | 3.63 | 1,3-Dixoane | 4.02 | Overcharge | 67 |
| Example 3-7-2 | EMC = | | | | | FEC | | controlling | 71 |
| Example 3-7-3 | 25/40/30 | | | LiBF₂(C₂F₅)₂ | 2.40 | 1,3-Dixoane | | agent (1-10) | 69 |
| Example 3-7-4 | | | | | | FEC | | | 72 |
| Example 3-7-5 | | | | LiN(SO₂CF₃)₂ | 2.34 | 1,3-Dixoane | | | 82 |
| Example 3-7-6 | | | | | | FEC | | | 82 |
| Example 3-7-7 | | | | LiN(SO₂F)₂ | 1.54 | 1,3-Dixoane | | | 68 |
| Example 3-7-8 | | | | | | FEC | | | 63 |
| Example 3-7-9 | | LiPF₆ | 0.9 | LiPF₃(C₂F₅)₃ | 3.63 | 1,3-Dixoane | 4.02 | Overcharge | 72 |
| Example 3-7-10 | | | | | | FEC | | controlling | 77 |
| Example 3-7-11 | | | | LiBF₂(C₂F₅)₂ | 2.40 | 1,3-Dixoane | | agent (1-18) | 78 |
| Example 3-7-12 | | | | | | FEC | | | 75 |
| Example 3-7-13 | | | | LiN(SO₂CF₃)₂ | 2.34 | 1,3-Dixoane | | | 72 |
| Example 3-7-14 | | | | | | FEC | | | 79 |
| Example 3-7-15 | | | | LiN(SO₂F)₂ | 1.54 | 1,3-Dixoane | | | 64 |
| Example 3-7-16 | | | | | | FEC | | | 70 |
| Example 3-7-17 | | LiPF₆ | 0.9 | LiPF₃(C₂F₅)₃ | 3.63 | 1,3-Dixoane | 4.02 | Overcharge | 75 |
| Example 3-7-18 | | | | | | FEC | | controlling | 73 |
| Example 3-7-19 | | | | LiBF₂(C₂F₅)₂ | 2.40 | 1,3-Dixoane | | agent (4-71) | 68 |
| Example 3-7-20 | | | | | | FEC | | | 65 |
| Example 3-7-21 | | | | LiN(SO₂CF₃)₂ | 2.34 | 1,3-Dixoane | | | 73 |
| Example 3-7-22 | | | | | | FEC | | | 70 |
| Example 3-7-23 | | | | LiN(SO₂F)₂ | 1.54 | 1,3-Dixoane | | | 80 |
| Example 3-7-24 | | | | | | FEC | | | 74 |
| Example 3-7-25 | | LiPF₆ | 0.9 | LiPF₃(C₂F₅)₃ | 3.63 | 1,3-Dixoane | 4.02 | Overcharge | 89 |
| Example 3-7-26 | | | | | | FEC | | controlling | 86 |
| Example 3-7-27 | | | | LiBF₂(C₂F₅)₂ | 2.40 | 1,3-Dixoane | | agent (5-3) | 83 |
| Example 3-7-28 | | | | | | FEC | | | 83 |
| Example 3-7-29 | | | | LiN(SO₂CF₃)₂ | 2.34 | 1,3-Dixoane | | | 69 |
| Example 3-7-30 | | | | | | FEC | | | 72 |
| Example 3-7-31 | | | | LiN(SO₂F)₂ | 1.54 | 1,3-Dixoane | | | 83 |
| Example 3-7-32 | | | | | | FEC | | | 79 |

TABLE 40
[Negative electrode active material: Silicon]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent [mass | | amount | | amount | | amount | controlling | after the |
| | ratio] | Material | [moles/kg] | Material | [wt %] | Material | [wt %] | agent | overcharge [%] |
| Example 3-7-33 | EC/DMC/ | LiPF₆ | 0.9 | LiPF₃(C₂F₅)₃ | 3.63 | 1,3-Dixoane | 4.02 | Overcharge | 79 |
| Example 3-7-34 | EMC = | | | | | FEC | | controlling | 72 |
| Example 3-7-35 | 25/40/30 | | | LiBF₂(C₂F₅)₂ | 2.40 | 1,3-Dixoane | | agent (8-4) | 84 |
| Example 3-7-36 | | | | | | FEC | | | 83 |
| Example 3-7-37 | | | | LiN(SO₂CF₃)₂ | 2.34 | 1,3-Dixoane | | | 76 |
| Example 3-7-38 | | | | | | FEC | | | 77 |
| Example 3-7-39 | | | | LiN(SO₂F)₂ | 1.54 | 1,3-Dixoane | | | 88 |
| Example 3-7-40 | | | | | | FEC | | | 87 |
| Example 3-7-41 | | LiPF₆ | 0.9 | LiPF₃(C₂F₅)₃ | 3.63 | 1,3-Dixoane | 4.02 | Overcharge | 80 |
| Example 3-7-42 | | | | | | FEC | | controlling | 82 |
| Example 3-7-43 | | | | LiBF₂(C₂F₅)₂ | 2.40 | 1,3-Dixoane | | agent (12-1) | 74 |
| Example 3-7-44 | | | | | | FEC | | | 79 |
| Example 3-7-45 | | | | LiN(SO₂CF₃)₂ | 2.34 | 1,3-Dixoane | | | 77 |
| Example 3-7-46 | | | | | | FEC | | | 80 |
| Example 3-7-47 | | | | LiN(SO₂F)₂ | 1.54 | 1,3-Dixoane | | | 76 |
| Example 3-7-48 | | | | | | FEC | | | 78 |
| Example 3-7-49 | | LiPF₆ | 0.9 | LiPF₃(C₂F₅)₃ | 3.63 | 1,3-Dixoane | 4.02 | Overcharge | 74 |
| Example 3-7-50 | | | | | | FEC | | controlling | 71 |
| Example 3-7-51 | | | | LiBF₂(C₂F₅)₂ | 2.40 | 1,3-Dixoane | | agent (12-2) | 74 |
| Example 3-7-52 | | | | | | FEC | | | 82 |
| Example 3-7-53 | | | | LiN(SO₂CF₃)₂ | 2.34 | 1,3-Dixoane | | | 83 |
| Example 3-7-54 | | | | | | FEC | | | 79 |
| Example 3-7-55 | | | | LiN(SO₂F)₂ | 1.54 | 1,3-Dixoane | | | 79 |
| Example 3-7-56 | | | | | | FEC | | | 86 |

As is clear from Tables 28 to 40, by adding the compound according to the present technology and the overcharge controlling agent to the nonaqueous electrolytic solution, even in the case of using silicon as the negative electrode active material, similar to the case of using a carbon based negative electrode active material, the effect for inhibiting a lowering of the retention rate of load characteristics after the overcharge was obtained.

### Examples 4-1-1 to 4-7-56

A nonaqueous electrolyte battery of a laminated film type using, as a negative electrode active material, lithium titanate in place of the granular graphite powder was used as a test battery. Test batteries of Examples 4-1-1 to 4-7-56 were respectively fabricated by using the nonaqueous electrolytic solutions of Examples 1-1-1 to 1-7-56, except for adopting such a battery configuration. The test batteries were fabricated in the following manner.

### [Fabrication of Positive Electrode]

98 parts by mass of lithium cobalt complex oxide (LiCoO₂) obtained in the same manner as that in Example 1-1-1, 0.8 parts by mass of ketjen black as an electrically conductive agent, and 1.2 parts by mass of polyvinylidene fluoride (PVdF) as a binder were mixed to form a positive electrode mixture. Subsequently, the positive electrode mixture was dispersed in N-methyl-2-pyrrolidone to prepare a positive electrode mixture slurry in a paste form. Subsequently, the positive electrode mixture slurry was uniformly coated on the both surfaces of a positive electrode collector made of a strip-shaped aluminum foil having a thickness of 12 μm by a coating apparatus and then dried. Finally, the dried positive electrode mixture was compression molded by using a roll press, thereby fabricating a positive electrode having a positive electrode active material layer formed thereon.

### [Fabrication of Negative Electrode]

85 parts by mass of lithium titanate (Li₄Ti₅O₁₂) as a negative electrode active material, 10 parts by mass of graphite as an electrically conductive agent, and 5 parts by mass of polyvinylidene fluoride (PVdF) as a binder were mixed to prepare a negative electrode mixture. Subsequently, the negative electrode mixture was dispersed in N-methyl-2-pyrrolidone to prepare a negative electrode mixture slurry in a paste form. Subsequently, the negative electrode mixture slurry was uniformly coated on the both surfaces of a negative electrode collector made of a strip-shaped copper foil having a thickness of 18 μm by a coating apparatus and then dried. Finally, the dried negative electrode mixture was compression molded by using a roll press to form a negative electrode having a negative electrode active material layer formed thereon.

### [Assembling of Nonaqueous Electrolyte Battery of Laminated Film Type]

An aluminum-made positive electrode lead was welded to one end of the positive electrode collector. Also, a nickel-made negative electrode lead was welded to one end of the negative electrode collector. Subsequently, the positive electrode and the negative electrode were laminated via a separator and then wound in a flat shape in the longitudinal direction, and a winding end portion was fixed by an adhesive tape to fabricate a wound electrode body. As the separator, a microporous polypropylene film having a thickness of 20 μm was used.

Subsequently, the wound electrode body was interposed between package members, and the outer edges of the package members excluding one side were heat fused, whereby the wound body was housed in the inside of the package member 40 in a bag form. An aluminum laminated film having a three-layered structure having a total thickness of 100 μm, in which a nylon film having a thickness of 30 μm, an aluminum foil having a thickness of 40 μm, and a cast polypropylene film having a thickness of 30 μm were laminated in this order, was used as the package member. Subsequently, a nonaqueous electrolytic solution was injected from an opening of the package member to impregnate the separator with the nonaqueous electrolytic solution, thereby fabricating a wound electrode body. Finally, the opening of the package member was sealed in a vacuum atmosphere by means of heat fusion. There was thus completed a nonaqueous electrolyte battery of a laminated film type (test battery). Incidentally, in the case of fabricating this test battery, the thickness of the positive electrode active material layer was adjusted such that a lithium metal did not deposit on the negative electrode at the time of full charge.

[Evaluation of Battery: Load Characteristics after the Overcharge]

The test battery of each of the Examples and each of the Comparative Examples was subjected to constant-current charge in an atmosphere at 23° C. at a charge current of 0.2 C until the battery voltage reached 2.8 V and then to constant-voltage charge at 2.8 V, and the charge was terminated at the point of time when a total charge time reached 8 hours. Thereafter, the test battery was subjected to constant-current discharge at a discharge current of 0.2 C until the battery voltage reached 1.0 V. Incidentally, the term “0.2 C” referred to herein is a current value at which a theoretical capacity is completely discharged for 5 hours. After carrying out one cycle of this charge and discharge cycle, the test battery was subjected to constant-current charge at 0.2 C and constant-voltage charge at the second cycle while setting an upper limit voltage to 2.8 V, followed by undergoing constant-current discharge at 3.0 C until the battery voltage reached 1.0 V, thereby measuring a discharge capacity.

Subsequently, the test battery was subjected to constant-current charge at 0.2 C and constant-voltage charge at the third cycle while setting an upper limit voltage to 3.3 V, followed by undergoing constant-current discharge at 0.2 C until the battery voltage reached 1.0 V. Incidentally, the charge at the third cycle was terminated in either the case where the voltage reached 3.3 V, or the case where the total charge time reached 8 hours. After carrying out three cycles of such a charge and discharge operation, similar to the operation at the second cycle, the test battery was subjected to constant-current charge at 0.2 C and constant-voltage charge at the sixth cycle in total while setting an upper limit voltage to 2.8 V, followed by undergoing constant-current discharge at 3.0 C until the battery voltage reached 1.0 V, thereby measuring a discharge capacity. When the discharge capacity at the second cycle was defined as 100%, the discharge capacity at the sixth cycle was calculated as load characteristics after the overcharge.

Evaluation results are shown in the following Tables 41 to 53.

TABLE 41
[Negative electrode active material: Lithium titanate]

| | | Compound | | | Retention rate of load |
|---|---|---|---|---|---|
| | Nonaqueous | | Mixing amount | | characteristics after the |
| | solvent | Material | [wt %] | Overcharge controlling agent | overcharge [%] |
| Example 4-1-1 | EC/DMC/EMC = | Succinic anhydride | 1.0 | Overcharge Controlling Agent (1-10) | 75 |
| Example 4-1-2 | 30/40/30 | | | Overcharge Controlling Agent (1-18) | 72 |
| Example 4-1-3 | | | | Overcharge Controlling Agent (4-71) | 83 |
| Example 4-1-4 | | | | Overcharge Controlling Agent (5-3) | 73 |
| Example 4-1-5 | | | | Overcharge Controlling Agent (8-4) | 71 |
| Example 4-1-6 | | | | Overcharge Controlling Agent (12-1) | 78 |
| Example 4-1-7 | | | | Overcharge Controlling Agent (12-2) | 66 |
| Example 4-1-8 | | Cyclodisone | 1.0 | Overcharge Controlling Agent (1-10) | 89 |
| Example 4-1-9 | | (Compound (8-12)) | | Overcharge Controlling Agent (1-18) | 85 |
| Example 4-1-10 | | | | Overcharge Controlling Agent (4-71) | 87 |
| Example 4-1-11 | | | | Overcharge Controlling Agent (5-3) | 69 |
| Example 4-1-12 | | | | Overcharge Controlling Agent (8-4) | 78 |
| Example 4-1-13 | | | | Overcharge Controlling Agent (12-1) | 78 |
| Example 4-1-14 | | | | Overcharge Controlling Agent (12-2) | 80 |
| Example 4-1-15 | | Propanedicarboxylic | 1.0 | Overcharge Controlling Agent (1-10) | 90 |
| Example 4-1-16 | | anhydride | | Overcharge Controlling Agent (1-18) | 77 |
| Example 4-1-17 | | | | Overcharge Controlling Agent (4-71) | 78 |
| Example 4-1-18 | | | | Overcharge Controlling Agent (5-3) | 82 |
| Example 4-1-19 | | | | Overcharge Controlling Agent (8-4) | 84 |
| Example 4-1-20 | | | | Overcharge Controlling Agent (12-1) | 81 |
| Example 4-1-21 | | | | Overcharge Controlling Agent (12-2) | 72 |
| Example 4-1-22 | | FEC | 1.0 | Overcharge Controlling Agent (1-10) | 74 |
| Example 4-1-23 | | | | Overcharge Controlling Agent (1-18) | 79 |
| Example 4-1-24 | | | | Overcharge Controlling Agent (4-71) | 83 |
| Example 4-1-25 | | | | Overcharge Controlling Agent (5-3) | 74 |
| Example 4-1-26 | | | | Overcharge Controlling Agent (8-4) | 81 |
| Example 4-1-27 | | | | Overcharge Controlling Agent (12-1) | 79 |
| Example 4-1-28 | | | | Overcharge Controlling Agent (12-2) | 79 |
| Example 4-1-29 | | VC | 1.0 | Overcharge Controlling Agent (1-10) | 87 |
| Example 4-1-30 | | | | Overcharge Controlling Agent (1-18) | 70 |
| Example 4-1-31 | | | | Overcharge Controlling Agent (4-71) | 87 |
| Example 4-1-32 | | | | Overcharge Controlling Agent (5-3) | 81 |
| Example 4-1-33 | | | | Overcharge Controlling Agent (8-4) | 81 |
| Example 4-1-34 | | | | Overcharge Controlling Agent (12-1) | 84 |
| Example 4-1-35 | | | | Overcharge Controlling Agent (12-2) | 84 |
| Example 4-1-36 | | t-DFEC | 1.0 | Overcharge Controlling Agent (1-10) | 83 |
| Example 4-1-37 | | | | Overcharge Controlling Agent (1-18) | 78 |
| Example 4-1-38 | | | | Overcharge Controlling Agent (4-71) | 72 |
| Example 4-1-39 | | | | Overcharge Controlling Agent (5-3) | 82 |
| Example 4-1-40 | | | | Overcharge Controlling Agent (8-4) | 79 |
| Example 4-1-41 | | | | Overcharge Controlling Agent (12-1) | 84 |
| Example 4-1-42 | | | | Overcharge Controlling Agent (12-2) | 75 |
| Example 4-1-43 | | Propene sultone | 1.0 | Overcharge Controlling Agent (1-10) | 79 |
| Example 4-1-44 | | | | Overcharge Controlling Agent (1-18) | 77 |
| Example 4-1-45 | | | | Overcharge Controlling Agent (4-71) | 82 |
| Example 4-1-46 | | | | Overcharge Controlling Agent (5-3) | 76 |
| Example 4-1-47 | | | | Overcharge Controlling Agent (8-4) | 81 |
| Example 4-1-48 | | | | Overcharge Controlling Agent (12-1) | 67 |
| Example 4-1-49 | | | | Overcharge Controlling Agent (12-2) | 77 |

TABLE 42
[Negative electrode active material: Lithium titanate]

| | | Compound | | | Retention rate of load |
|---|---|---|---|---|---|
| | Nonaqueous | | Mixing amount | | characteristics after the |
| | solvent | Material | [wt %] | Overcharge controlling agent | overcharge [%] |
| Example 4-1-50 | EC/DMC/EMC = | LiBF₄ | 0.78 | Overcharge Controlling Agent (1-10) | 81 |
| Example 4-1-51 | 30/40/30 | | | Overcharge Controlling Agent (1-18) | 83 |
| Example 4-1-52 | | | | Overcharge Controlling Agent (4-71) | 77 |
| Example 4-1-53 | | | | Overcharge Controlling Agent (5-3) | 81 |
| Example 4-1-54 | | | | Overcharge Controlling Agent (8-4) | 76 |
| Example 4-1-55 | | | | Overcharge Controlling Agent (12-1) | 82 |
| Example 4-1-56 | | | | Overcharge Controlling Agent (12-2) | 75 |
| Example 4-1-57 | | LiBOB | 1.59 | Overcharge Controlling Agent (1-10) | 79 |
| Example 4-1-58 | | (Compound (4-6)) | | Overcharge Controlling Agent (1-18) | 77 |
| Example 4-1-59 | | | | Overcharge Controlling Agent (4-71) | 81 |
| Example 4-1-60 | | | | Overcharge Controlling Agent (5-3) | 81 |
| Example 4-1-61 | | | | Overcharge Controlling Agent (8-4) | 83 |
| Example 4-1-62 | | | | Overcharge Controlling Agent (12-1) | 82 |
| Example 4-1-63 | | | | Overcharge Controlling Agent (12-2) | 77 |
| Example 4-1-64 | | LiPF₂(C₂O₄)₂ | 2.06 | Overcharge Controlling Agent (1-10) | 74 |
| Example 4-1-65 | | (Compound (4-2)) | | Overcharge Controlling Agent (1-18) | 73 |
| Example 4-1-66 | | | | Overcharge Controlling Agent (4-71) | 73 |
| Example 4-1-67 | | | | Overcharge Controlling Agent (5-3) | 81 |
| Example 4-1-68 | | | | Overcharge Controlling Agent (8-4) | 78 |
| Example 4-1-69 | | | | Overcharge Controlling Agent (12-1) | 84 |
| Example 4-1-70 | | | | Overcharge Controlling Agent (12-2) | 67 |
| Example 4-1-71 | | LiN(SO₂CF₂)₂CF₂ | 2.43 | Overcharge Controlling Agent (1-10) | 73 |
| Example 4-1-72 | | (Compound (7-2)) | | Overcharge Controlling Agent (1-18) | 75 |
| Example 4-1-73 | | | | Overcharge Controlling Agent (4-71) | 73 |
| Example 4-1-74 | | | | Overcharge Controlling Agent (5-3) | 76 |
| Example 4-1-75 | | | | Overcharge Controlling Agent (8-4) | 86 |
| Example 4-1-76 | | | | Overcharge Controlling Agent (12-1) | 63 |
| Example 4-1-77 | | | | Overcharge Controlling Agent (12-2) | 77 |
| Comparative | EC/DMC/EMC = | — | — | Overcharge Controlling Agent (1-10) | 51 |
| Example 4-1-1 | 30/40/30 | | | | |
| Comparative | | | | Overcharge Controlling Agent (1-18) | 51 |
| Example 4-1-2 | | | | | |
| Comparative | | | | Overcharge Controlling Agent (4-71) | 58 |
| Example 4-1-3 | | | | | |
| Comparative | | | | Overcharge Controlling Agent (5-3) | 61 |
| Example 4-1-4 | | | | | |
| Comparative | | | | Overcharge Controlling Agent (8-4) | 64 |
| Example 4-1-5 | | | | | |
| Comparative | | | | Overcharge Controlling Agent (12-1) | 64 |
| Example 4-1-6 | | | | | |
| Comparative | | | | Overcharge Controlling Agent (12-2) | 52 |
| Example 4-1-7 | | | | | |
| Comparative | | Succinic anhydride | 1.0 | — | 47 |
| Example 4-1-8 | | | | | |
| Comparative | | Cyclodisone | 1.0 | | 53 |
| Example 4-1-9 | | | | | |
| Comparative | | Propanedicarboxylic | 1.0 | | 49 |
| Example 4-1-10 | | anhydride | | | |
| Comparative | | FEC | 1.0 | | 42 |
| Example 4-1-11 | | | | | |
| Comparative | | VC | 1.0 | | 47 |
| Example 4-1-12 | | | | | |
| Comparative | | t-DFEC | 1.0 | | 34 |
| Example 4-1-13 | | | | | |
| Comparative | | Propene sultone | 1.0 | | 51 |
| Example 4-1-14 | | | | | |
| Comparative | | LiBF₄ | 0.78 | | 52 |
| Example 4-1-15 | | | | | |
| Comparative | | LiBOB | 1.59 | | 49 |
| Example 4-1-16 | | | | | |
| Comparative | | LiPF₂(C₂O₄)₂ | 2.06 | | 43 |
| Example 4-1-17 | | | | | |
| Comparative | | LiN(SO₂CF₂)₂CF₂ | 2.43 | | 42 |
| Example 4-1-18 | | | | | |
| Comparative | | — | — | | 50 |
| Example 4-1-19 | | | | | |

TABLE 43
[Negative electrode active material: Lithium titanate]

| | | | | | Retention rate |
|---|---|---|---|---|---|
| | | Compound | | | of load |
| | Nonaqueous | | Mixing amount | | characteristics after |
| | solvent | Material | [wt %] | Overcharge controlling agent | the overcharge [%] |
| Example 4-2-1 | EC/DMC/EMC = | Succinonitrile | 1.0 | Overcharge Controlling Agent (1-10) | 73 |
| Example 4-2-2 | 30/40/30 | | | Overcharge Controlling Agent (1-18) | 73 |
| Example 4-2-3 | | | | Overcharge Controlling Agent (4-71) | 78 |
| Example 4-2-4 | | | | Overcharge Controlling Agent (5-3) | 77 |
| Example 4-2-5 | | | | Overcharge Controlling Agent (8-4) | 82 |
| Example 4-2-6 | | | | Overcharge Controlling Agent (12-1) | 78 |
| Example 4-2-7 | | | | Overcharge Controlling Agent (12-2) | 79 |
| Example 4-2-8 | | Adiponitrile | 1.0 | Overcharge Controlling Agent (1-10) | 77 |
| Example 4-2-9 | | | | Overcharge Controlling Agent (1-18) | 75 |
| Example 4-2-10 | | | | Overcharge Controlling Agent (4-71) | 79 |
| Example 4-2-11 | | | | Overcharge Controlling Agent (5-3) | 81 |
| Example 4-2-12 | | | | Overcharge Controlling Agent (8-4) | 80 |
| Example 4-2-13 | | | | Overcharge Controlling Agent (12-1) | 81 |
| Example 4-2-14 | | | | Overcharge Controlling Agent (12-2) | 80 |
| Example 4-2-15 | | 7,7,8,8-Tetracyanoquinodimethane | 1.0 | Overcharge Controlling Agent (1-10) | 71 |
| Example 4-2-16 | | | | Overcharge Controlling Agent (1-18) | 80 |
| Example 4-2-17 | | | | Overcharge Controlling Agent (4-71) | 77 |
| Example 4-2-18 | | | | Overcharge Controlling Agent (5-3) | 77 |
| Example 4-2-19 | | | | Overcharge Controlling Agent (8-4) | 82 |
| Example 4-2-20 | | | | Overcharge Controlling Agent (12-1) | 83 |
| Example 4-2-21 | | | | Overcharge Controlling Agent (12-2) | 81 |
| Example 4-2-22 | | Acetonitrile | 1.0 | Overcharge Controlling Agent (1-10) | 74 |
| Example 4-2-23 | | | | Overcharge Controlling Agent (1-18) | 77 |
| Example 4-2-24 | | | | Overcharge Controlling Agent (4-71) | 80 |
| Example 4-2-25 | | | | Overcharge Controlling Agent (5-3) | 81 |
| Example 4-2-26 | | | | Overcharge Controlling Agent (8-4) | 75 |
| Example 4-2-27 | | | | Overcharge Controlling Agent (12-1) | 81 |
| Example 4-2-28 | | | | Overcharge Controlling Agent (12-2) | 83 |
| Example 4-2-29 | | 1-Isocyanatoethane | 1.0 | Overcharge Controlling Agent (1-10) | 74 |
| Example 4-2-30 | | | | Overcharge Controlling Agent (1-18) | 74 |
| Example 4-2-31 | | | | Overcharge Controlling Agent (4-71) | 78 |
| Example 4-2-32 | | | | Overcharge Controlling Agent (5-3) | 78 |
| Example 4-2-33 | | | | Overcharge Controlling Agent (8-4) | 79 |
| Example 4-2-34 | | | | Overcharge Controlling Agent (12-1) | 79 |
| Example 4-2-35 | | | | Overcharge Controlling Agent (12-2) | 77 |
| Example 4-2-36 | | 1,8-Diisocyanatooctane | 1.0 | Overcharge Controlling Agent (1-10) | 75 |
| Example 4-2-37 | | | | Overcharge Controlling Agent (1-18) | 75 |
| Example 4-2-38 | | | | Overcharge Controlling Agent (4-71) | 80 |
| Example 4-2-39 | | | | Overcharge Controlling Agent (5-3) | 79 |
| Example 4-2-40 | | | | Overcharge Controlling Agent (8-4) | 80 |
| Example 4-2-41 | | | | Overcharge Controlling Agent (12-1) | 81 |
| Example 4-2-42 | | | | Overcharge Controlling Agent (12-2) | 79 |
| Comparative | EC/DMC/EMC = | Succinonitrile | 1.0 | — | 35 |
| Example 4-2-1 | 30/40/30 | | | | |
| Comparative | | Adiponitrile | | | 33 |
| Example 4-2-2 | | | | | |
| Comparative | | 7,7,8,8-Tetracyanoquinodimethane | | | 36 |
| Example 4-2-3 | | | | | |
| Comparative | | Acetonitrile | | | 36 |
| Example 4-2-4 | | | | | |
| Comparative | | 1-Isocyanatoethane | | | 38 |
| Example 4-2-5 | | | | | |
| Comparative | | 1,8-Diisocyanatooctane | | | 40 |
| Example 4-2-6 | | | | | |

TABLE 44
[Negative electrode active material: Lithium titanate]

| | | | | | Retention rate of load |
|---|---|---|---|---|---|
| | Nonaqueous | Compound | | | characteristics after the |
| | solvent | Material | Mixing amount [wt %] | Overcharge controlling agent | overcharge [%] |
| Example 4-3-1 | EC/DMC/EMC = | γ-Butyrolactone | 4.12 | Overcharge Controlling Agent (1-10) | 81 |
| Example 4-3-2 | 25/40/30 | | | Overcharge Controlling Agent (1-18) | 73 |
| Example 4-3-3 | | | | Overcharge Controlling Agent (4-71) | 80 |
| Example 4-3-4 | | | | Overcharge Controlling Agent (5-3) | 80 |
| Example 4-3-5 | | | | Overcharge Controlling Agent (8-4) | 81 |
| Example 4-3-6 | | | | Overcharge Controlling Agent (12-1) | 87 |
| Example 4-3-7 | | | | Overcharge Controlling Agent (12-2) | 87 |
| Example 4-3-8 | | NMP | 4.12 | Overcharge Controlling Agent (1-10) | 78 |
| Example 4-3-9 | | | | Overcharge Controlling Agent (1-18) | 67 |
| Example 4-3-10 | | | | Overcharge Controlling Agent (4-71) | 77 |
| Example 4-3-11 | | | | Overcharge Controlling Agent (5-3) | 73 |
| Example 4-3-12 | | | | Overcharge Controlling Agent (8-4) | 71 |
| Example 4-3-13 | | | | Overcharge Controlling Agent (12-1) | 84 |
| Example 4-3-14 | | | | Overcharge Controlling Agent (12-2) | 80 |
| Example 4-3-15 | | Methyl acetate | 4.12 | Overcharge Controlling Agent (1-10) | 80 |
| Example 4-3-16 | | | | Overcharge Controlling Agent (1-18) | 78 |
| Example 4-3-17 | | | | Overcharge Controlling Agent (4-71) | 86 |
| Example 4-3-18 | | | | Overcharge Controlling Agent (5-3) | 85 |
| Example 4-3-19 | | | | Overcharge Controlling Agent (8-4) | 81 |
| Example 4-3-20 | | | | Overcharge Controlling Agent (12-1) | 80 |
| Example 4-3-21 | | | | Overcharge Controlling Agent (12-2) | 82 |
| Example 4-3-22 | | Ethyl trimethylacetate | 4.12 | Overcharge Controlling Agent (1-10) | 79 |
| Example 4-3-23 | | | | Overcharge Controlling Agent (1-18) | 76 |
| Example 4-3-24 | | | | Overcharge Controlling Agent (4-71) | 82 |
| Example 4-3-25 | | | | Overcharge Controlling Agent (5-3) | 74 |
| Example 4-3-26 | | | | Overcharge Controlling Agent (8-4) | 75 |
| Example 4-3-27 | | | | Overcharge Controlling Agent (12-1) | 84 |
| Example 4-3-28 | | | | Overcharge Controlling Agent (12-2) | 80 |
| Example 4-3-29 | | 1,2-Dimethoxyethane | 4.12 | Overcharge Controlling Agent (1-10) | 88 |
| Example 4-3-30 | | | | Overcharge Controlling Agent (1-18) | 78 |
| Example 4-3-31 | | | | Overcharge Controlling Agent (4-71) | 89 |
| Example 4-3-32 | | | | Overcharge Controlling Agent (5-3) | 84 |
| Example 4-3-33 | | | | Overcharge Controlling Agent (8-4) | 81 |
| Example 4-3-34 | | | | Overcharge Controlling Agent (12-1) | 70 |
| Example 4-3-35 | | | | Overcharge Controlling Agent (12-2) | 85 |
| Example 4-3-36 | | 1,3-Dioxane | 4.12 | Overcharge Controlling Agent (1-10) | 85 |
| Example 4-3-37 | | | | Overcharge Controlling Agent (1-18) | 72 |
| Example 4-3-38 | | | | Overcharge Controlling Agent (4-71) | 87 |
| Example 4-3-39 | | | | Overcharge Controlling Agent (5-3) | 83 |
| Example 4-3-40 | | | | Overcharge Controlling Agent (8-4) | 75 |
| Example 4-3-41 | | | | Overcharge Controlling Agent (12-1) | 74 |
| Example 4-3-42 | | | | Overcharge Controlling Agent (12-2) | 76 |
| Example 4-3-43 | | FDMC | 4.12 | Overcharge Controlling Agent (1-10) | 85 |
| Example 4-3-44 | | | | Overcharge Controlling Agent (1-18) | 79 |
| Example 4-3-45 | | | | Overcharge Controlling Agent (4-71) | 81 |
| Example 4-3-46 | | | | Overcharge Controlling Agent (5-3) | 75 |
| Example 4-3-47 | | | | Overcharge Controlling Agent (8-4) | 74 |
| Example 4-3-48 | | | | Overcharge Controlling Agent (12-1) | 82 |
| Example 4-3-49 | | | | Overcharge Controlling Agent (12-2) | 77 |

TABLE 45
[Negative electrode active material: Lithium titanate]

| | | | | | Retention rate of load |
|---|---|---|---|---|---|
| | Nonaqueous | Compound | | | characteristics after the |
| | solvent | Material | Mixing amount [wt %] | Overcharge controlling agent | overcharge [%] |
| Example 4-3-50 | EC/DMC/EMC = | FEC | 4.12 | Overcharge Controlling Agent (1-10) | 78 |
| Example 4-3-51 | 25/40/30 | | | Overcharge Controlling Agent (1-18) | 88 |
| Example 4-3-52 | | | | Overcharge Controlling Agent (4-71) | 76 |
| Example 4-3-53 | | | | Overcharge Controlling Agent (5-3) | 73 |
| Example 4-3-54 | | | | Overcharge Controlling Agent (8-4) | 83 |
| Example 4-3-55 | | | | Overcharge Controlling Agent (12-1) | 73 |
| Example 4-3-56 | | | | Overcharge Controlling Agent (12-2) | 82 |
| Example 4-3-57 | | Sulfolane | 4.12 | Overcharge Controlling Agent (1-10) | 84 |
| Example 4-3-58 | | | | Overcharge Controlling Agent (1-18) | 74 |
| Example 4-3-59 | | | | Overcharge Controlling Agent (4-71) | 87 |
| Example 4-3-60 | | | | Overcharge Controlling Agent (5-3) | 77 |
| Example 4-3-61 | | | | Overcharge Controlling Agent (8-4) | 73 |
| Example 4-3-62 | | | | Overcharge Controlling Agent (12-1) | 79 |
| Example 4-3-63 | | | | Overcharge Controlling Agent (12-2) | 81 |
| Comparative | EC/DMC/EMC = | γ-Butyrolactone | 4.12 | — | 59 |
| Example 4-3-1 | 25/40/30 | | | | |
| Comparative | | NMP | 4.12 | | 46 |
| Example 4-3-2 | | | | | |
| Comparative | | Methyl acetate | 4.12 | | 57 |
| Example 4-3-3 | | | | | |
| Comparative | | Ethyl trimethylacetate | 4.12 | | 52 |
| Example 4-3-4 | | | | | |
| Comparative | | 1,2-Dimethoxyethane | 4.12 | | 57 |
| Example 4-3-5 | | | | | |
| Comparative | | 1,3-Dioxane | 4.12 | | 61 |
| Example 4-3-6 | | | | | |
| Comparative | | FDMC | 4.12 | | 54 |
| Example 4-3-7 | | | | | |
| Comparative | | FEC | 4.12 | | 48 |
| Example 4-3-8 | | | | | |
| Comparative | | Sulfolane | 4.12 | | 49 |
| Example 4-3-9 | | | | | |

TABLE 46
[Negative electrode active material: Lithium titanate]

| | | | | | | Retention |
|---|---|---|---|---|---|---|
| | Electrolyte salt | | Compound | | | rate of load |
| | | Mixing amount | | Mixing amount | | characteristics after |
| | Material | [moles/kg] | Material | [wt %] | Overcharge controlling agent | the overcharge [%] |
| Example 4-4-1 | LiPF₆ | 0.9 | LiPF₃(C₂F₅)₃ | 3.63 | Overcharge Controlling Agent (1-10) | 69 |
| Example 4-4-2 | | | | | Overcharge Controlling Agent (1-18) | 69 |
| Example 4-4-3 | | | | | Overcharge Controlling Agent (4-71) | 68 |
| Example 4-4-4 | | | | | Overcharge Controlling Agent (5-3) | 73 |
| Example 4-4-5 | | | | | Overcharge Controlling Agent (8-4) | 77 |
| Example 4-4-6 | | | | | Overcharge Controlling Agent (12-1) | 82 |
| Example 4-4-7 | | | | | Overcharge Controlling Agent (12-2) | 68 |
| Example 4-4-8 | | | LiPF₄(CF₃)₂ | 2.06 | Overcharge Controlling Agent (1-10) | 66 |
| Example 4-4-9 | | | | | Overcharge Controlling Agent (1-18) | 66 |
| Example 4-4-10 | | | | | Overcharge Controlling Agent (4-71) | 68 |
| Example 4-4-11 | | | | | Overcharge Controlling Agent (5-3) | 70 |
| Example 4-4-12 | | | | | Overcharge Controlling Agent (8-4) | 68 |
| Example 4-4-13 | | | | | Overcharge Controlling Agent (12-1) | 78 |
| Example 4-4-14 | | | | | Overcharge Controlling Agent (12-2) | 73 |
| Example 4-4-15 | | | LiBF(C₂F₅)₃ | 3.18 | Overcharge Controlling Agent (1-10) | 69 |
| Example 4-4-16 | | | | | Overcharge Controlling Agent (1-18) | 68 |
| Example 4-4-17 | | | | | Overcharge Controlling Agent (4-71) | 76 |
| Example 4-4-18 | | | | | Overcharge Controlling Agent (5-3) | 76 |
| Example 4-4-19 | | | | | Overcharge Controlling Agent (8-4) | 78 |
| Example 4-4-20 | | | | | Overcharge Controlling Agent (12-1) | 81 |
| Example 4-4-21 | | | | | Overcharge Controlling Agent (12-2) | 77 |
| Example 4-4-22 | | | LiBF₂(C₂F₅)₂ | 2.40 | Overcharge Controlling Agent (1-10) | 66 |
| Example 4-4-23 | | | | | Overcharge Controlling Agent (1-18) | 73 |
| Example 4-4-24 | | | | | Overcharge Controlling Agent (4-71) | 69 |
| Example 4-4-25 | | | | | Overcharge Controlling Agent (5-3) | 70 |
| Example 4-4-26 | | | | | Overcharge Controlling Agent (8-4) | 79 |
| Example 4-4-27 | | | | | Overcharge Controlling Agent (12-1) | 80 |
| Example 4-4-28 | | | | | Overcharge Controlling Agent (12-2) | 74 |
| Example 4-4-29 | | | LiBF₃(C₂F₅) | 3.48 | Overcharge Controlling Agent (1-10) | 72 |
| Example 4-4-30 | | | | | Overcharge Controlling Agent (1-18) | 71 |
| Example 4-4-31 | | | | | Overcharge Controlling Agent (4-71) | 76 |
| Example 4-4-32 | | | | | Overcharge Controlling Agent (5-3) | 73 |
| Example 4-4-33 | | | | | Overcharge Controlling Agent (8-4) | 73 |
| Example 4-4-34 | | | | | Overcharge Controlling Agent (12-1) | 78 |
| Example 4-4-35 | | | | | Overcharge Controlling Agent (12-2) | 76 |
| Example 4-4-36 | | | LiN(SO₂CF₃)₂ | 2.34 | Overcharge Controlling Agent (1-10) | 74 |
| Example 4-4-37 | | | | | Overcharge Controlling Agent (1-18) | 69 |
| Example 4-4-38 | | | | | Overcharge Controlling Agent (4-71) | 70 |
| Example 4-4-39 | | | | | Overcharge Controlling Agent (5-3) | 74 |
| Example 4-4-40 | | | | | Overcharge Controlling Agent (8-4) | 74 |
| Example 4-4-41 | | | | | Overcharge Controlling Agent (12-1) | 74 |
| Example 4-4-42 | | | | | Overcharge Controlling Agent (12-2) | 74 |
| Example 4-4-43 | | | LiN(SO₂C₂F₅)₂ | 3.13 | Overcharge Controlling Agent (1-10) | 70 |
| Example 4-4-44 | | | | | Overcharge Controlling Agent (1-18) | 67 |
| Example 4-4-45 | | | | | Overcharge Controlling Agent (4-71) | 75 |
| Example 4-4-46 | | | | | Overcharge Controlling Agent (5-3) | 75 |
| Example 4-4-47 | | | | | Overcharge Controlling Agent (8-4) | 75 |
| Example 4-4-48 | | | | | Overcharge Controlling Agent (12-1) | 82 |
| Example 4-4-49 | | | | | Overcharge Controlling Agent (12-2) | 72 |

TABLE 47
[Negative electrode active material: Lithium titanate]

| | | | | | | Retention |
|---|---|---|---|---|---|---|
| | Electrolyte salt | | Compound | | | rate of load |
| | | Mixing amount | | Mixing amount | | characteristics after |
| | Material | [moles/kg] | Material | [wt %] | Overcharge controlling agent | the overcharge [%] |
| Example 4-4-50 | LiPF₆ | 0.9 | LiN(SO₂F)₂ | 1.54 | Overcharge Controlling Agent (1-10) | 71 |
| Example 4-4-51 | | | | | Overcharge Controlling Agent (1-18) | 71 |
| Example 4-4-52 | | | | | Overcharge Controlling Agent (4-71) | 75 |
| Example 4-4-53 | | | | | Overcharge Controlling Agent (5-3) | 76 |
| Example 4-4-54 | | | | | Overcharge Controlling Agent (8-4) | 73 |
| Example 4-4-55 | | | | | Overcharge Controlling Agent (12-1) | 79 |
| Example 4-4-56 | | | | | Overcharge Controlling Agent (12-2) | 77 |
| Comparative | LiPF₆ | 0.9 | LiPF₃(C₂F₅)₃ | 3.63 | — | 49 |
| Example 4-4-1 | | | | | | |
| Comparative | | | LiPF₄(CF₃)₂ | 2.06 | | 53 |
| Example 4-4-2 | | | | | | |
| Comparative | | | LiBF(C₂F₅)₃ | 3.18 | | 48 |
| Example 4-4-3 | | | | | | |
| Comparative | | | LiBF₂(C₂F₅)₂ | 2.40 | | 52 |
| Example 4-4-4 | | | | | | |
| Comparative | | | LiBF₃(C₂F₅) | 3.48 | | 51 |
| Example 4-4-5 | | | | | | |
| Comparative | | | LiN(SO₂CF₃)₂ | 2.34 | | 55 |
| Example 4-4-6 | | | | | | |
| Comparative | | | LiN(SO₂C₂F₅)₂ | 3.13 | | 52 |
| Example 4-4-7 | | | | | | |
| Comparative | | | LiN(SO₂F)₂ | 1.54 | | 49 |
| Example 4-4-8 | | | | | | |

TABLE 48
[Negative electrode active material: Lithium titanate]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent | | amount | | amount | | amount | controlling | after the |
| | [mass ratio] | Material | [moles/kg] | Material | [wt %] | Material | [wt %] | agent | overcharge [%] |
| Example 4-5-1 | EC/DMC/ | LiPF₆ | 1.0 | Succinic | 1.0 | 1,3-Dixoane | 4.08 | Overcharge | 76 |
| Example 4-5-2 | EMC = | | | anhydride | | FEC | | controlling | 79 |
| Example 4-5-3 | 25/40/30 | | | Propanedisulfonic | | 1,3-Dixoane | | agent (1-10) | 87 |
| Example 4-5-4 | | | | anhydride | | FEC | | | 91 |
| Example 4-5-5 | | | | VC | | 1,3-Dixoane | | | 83 |
| Example 4-5-6 | | | | | | FEC | | | 83 |
| Example 4-5-7 | | | | t-DFEC | | 1,3-Dixoane | | | 83 |
| Example 4-5-8 | | | | | | FEC | | | 86 |
| Example 4-5-9 | | LiPF₆ | 0.9 | LiBF₄ | 0.78 | 1,3-Dixoane | | | 78 |
| Example 4-5-10 | | | | | | FEC | | | 81 |
| Example 4-5-11 | | LiPF₆ | 1.0 | Succinic | 1.0 | 1,3-Dixoane | 4.08 | Overcharge | 71 |
| Example 4-5-12 | | | | anhydride | | FEC | | controlling | 76 |
| Example 4-5-13 | | | | Propanedisulfonic | | 1,3-Dixoane | | agent (1-18) | 79 |
| Example 4-5-14 | | | | anhydride | | FEC | | | 76 |
| Example 4-5-15 | | | | VC | | 1,3-Dixoane | | | 68 |
| Example 4-5-16 | | | | | | FEC | | | 71 |
| Example 4-5-17 | | | | t-DFEC | | 1,3-Dixoane | | | 80 |
| Example 4-5-18 | | | | | | FEC | | | 77 |
| Example 4-5-19 | | LiPF₆ | 0.9 | LiBF₄ | 0.78 | 1,3-Dixoane | | | 86 |
| Example 4-5-20 | | | | | | FEC | | | 85 |
| Example 4-5-21 | | LiPF₆ | 1.0 | Succinic | 1.0 | 1,3-Dixoane | 4.08 | Overcharge | 86 |
| Example 4-5-22 | | | | anhydride | | FEC | | controlling | 85 |
| Example 4-5-23 | | | | Propanedisulfonic | | 1,3-Dixoane | | agent (4-71) | 76 |
| Example 4-5-24 | | | | anhydride | | FEC | | | 77 |
| Example 4-5-25 | | | | VC | | 1,3-Dixoane | | | 91 |
| Example 4-5-26 | | | | | | FEC | | | 88 |
| Example 4-5-27 | | | | t-DFEC | | 1,3-Dixoane | | | 73 |
| Example 4-5-28 | | | | | | FEC | | | 72 |
| Example 4-5-29 | | LiPF₆ | 0.9 | LiBF₄ | 0.78 | 1,3-Dixoane | | | 80 |
| Example 4-5-30 | | | | | | FEC | | | 75 |
| Example 4-5-31 | | LiPF₆ | 1.0 | Succinic | 1.0 | 1,3-Dixoane | 4.08 | Overcharge | 78 |
| Example 4-5-32 | | | | anhydride | | FEC | | controlling | 73 |
| Example 4-5-33 | | | | Propanedisulfonic | | 1,3-Dixoane | | agent (5-3) | 76 |
| Example 4-5-34 | | | | anhydride | | FEC | | | 86 |
| Example 4-5-35 | | | | VC | | 1,3-Dixoane | | | 83 |
| Example 4-5-36 | | | | | | FEC | | | 86 |

TABLE 49
[Negative electrode active material: Lithium titanate]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent | | amount | | amount | | amount | controlling | after the |
| | [mass ratio] | Material | [moles/kg] | Material | [wt %] | Material | [wt %] | agent | overcharge [%] |
| Example 4-5-37 | EC/DMC/ | LiPF₆ | 1.0 | t-DFEC | 1.0 | 1,3-Dixoane | 4.08 | Overcharge | 82 |
| Example 4-5-38 | EMC = | | | | | FEC | | controlling | 85 |
| Example 4-5-39 | 25/40/30 | LiPF₆ | 0.9 | LiBF₄ | 0.78 | 1,3-Dixoane | | agent (5-3) | 80 |
| Example 4-5-40 | | | | | | FEC | | | 85 |
| Example 4-5-41 | | LiPF₆ | 1.0 | Succinic | 1.0 | 1,3-Dixoane | 4.08 | Overcharge | 74 |
| Example 4-5-42 | | | | anhydride | | FEC | | controlling | 72 |
| Example 4-5-43 | | | | Propanedisulfonic | | 1,3-Dixoane | | agent (8-4) | 87 |
| Example 4-5-44 | | | | anhydride | | FEC | | | 85 |
| Example 4-5-45 | | | | VC | | 1,3-Dixoane | | | 85 |
| Example 4-5-46 | | | | | | FEC | | | 81 |
| Example 4-5-47 | | | | t-DFEC | | 1,3-Dixoane | | | 79 |
| Example 4-5-48 | | | | | | FEC | | | 79 |
| Example 4-5-49 | | LiPF₆ | 0.9 | LiBF₄ | 0.78 | 1,3-Dixoane | | | 76 |
| Example 4-5-50 | | | | | | FEC | | | 73 |
| Example 4-5-51 | | LiPF₆ | 1.0 | Succinic | 1.0 | 1,3-Dixoane | 4.08 | Overcharge | 76 |
| Example 4-5-52 | | | | anhydride | | FEC | | controlling | 80 |
| Example 4-5-53 | | | | Propanedisulfonic | | 1,3-Dixoane | | agent (12-1) | 82 |
| Example 4-5-54 | | | | anhydride | | FEC | | | 79 |
| Example 4-5-55 | | | | VC | | 1,3-Dixoane | | | 87 |
| Example 4-5-56 | | | | | | FEC | | | 91 |
| Example 4-5-57 | | | | t-DFEC | | 1,3-Dixoane | | | 85 |
| Example 4-5-58 | | | | | | FEC | | | 85 |
| Example 4-5-59 | | LiPF₆ | 0.9 | LiBF₄ | 0.78 | 1,3-Dixoane | | | 80 |
| Example 4-5-60 | | | | | | FEC | | | 85 |
| Example 4-5-61 | | LiPF₆ | 1.0 | Succinic | 1.0 | 1,3-Dixoane | 4.08 | Overcharge | 62 |
| Example 4-5-62 | | | | anhydride | | FEC | | controlling | 64 |
| Example 4-5-63 | | | | Propanedisulfonic | | 1,3-Dixoane | | agent (12-2) | 78 |
| Example 4-5-64 | | | | anhydride | | FEC | | | 80 |
| Example 4-5-65 | | | | VC | | 1,3-Dixoane | | | 85 |
| Example 4-5-66 | | | | | | FEC | | | 85 |
| Example 4-5-67 | | | | t-DFEC | | 1,3-Dixoane | | | 80 |
| Example 4-5-68 | | | | | | FEC | | | 77 |
| Example 4-5-69 | | LiPF₆ | 0.9 | LiBF₄ | 0.78 | 1,3-Dixoane | | | 71 |
| Example 4-5-70 | | | | | | FEC | | | 79 |

TABLE 50
[Negative electrode active material: Lithium titanate]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent | | amount | | amount | | amount | controlling | after the |
| | [mass ratio] | Material | [moles/kg] | Material | [wt %] | Material | [wt %] | agent | overcharge [%] |
| Example 4-6-1 | EC/DMC/ | LiPF₆ | 1.0 | Succinonitrile | 1.0 | 1,3-Dixoane | 4.08 | Overcharge | 71 |
| Example 4-6-2 | EMC = | | | | | FEC | | controlling | 72 |
| Example 4-6-3 | 25/40/30 | | | Adiponitrile | | 1,3-Dixoane | | agent (1-10) | 81 |
| Example 4-6-4 | | | | | | FEC | | | 76 |
| Example 4-6-5 | | | | 7,7,8,8- | | 1,3-Dixoane | | | 74 |
| Example 4-6-6 | | | | Tetracyano- | | FEC | | | 78 |
| | | | | quinodimentane | | | | | |
| Example 4-6-7 | | | | Acetonitrile | | 1,3-Dixoane | | | 75 |
| Example 4-6-8 | | | | | | FEC | | | 75 |
| Example 4-6-9 | | LiPF₆ | 1.0 | Succinonitrile | 1.0 | 1,3-Dixoane | 4.08 | Overcharge | 75 |
| Example 4-6-10 | | | | | | FEC | | controlling | 78 |
| Example 4-6-11 | | | | Adiponitrile | | 1,3-Dixoane | | agent (1-18) | 82 |
| Example 4-6-12 | | | | | | FEC | | | 81 |
| Example 4-6-13 | | | | 7,7,8,8- | | 1,3-Dixoane | | | 85 |
| Example 4-6-14 | | | | Tetracyano- | | FEC | | | 81 |
| | | | | quinodimentane | | | | | |
| Example 4-6-15 | | | | Acetonitrile | | 1,3-Dixoane | | | 79 |
| Example 4-6-16 | | | | | | FEC | | | 84 |
| Example 4-6-17 | | LiPF₆ | 1.0 | Succinonitrile | 1.0 | 1,3-Dixoane | 4.08 | Overcharge | 82 |
| Example 4-6-18 | | | | | | FEC | | controlling | 79 |
| Example 4-6-19 | | | | Adiponitrile | | 1,3-Dixoane | | agent (4-71) | 86 |
| Example 4-6-20 | | | | | | FEC | | | 81 |
| Example 4-6-21 | | | | 7,7,8,8- | | 1,3-Dixoane | | | 78 |
| Example 4-6-22 | | | | Tetracyano- | | FEC | | | 80 |
| | | | | quinodimentane | | | | | |
| Example 4-6-23 | | | | Acetonitrile | | 1,3-Dixoane | | | 80 |
| Example 4-6-24 | | | | | | FEC | | | 82 |
| Example 4-6-25 | | LiPF₆ | 1.0 | Succinonitrile | 1.0 | 1,3-Dixoane | 4.08 | Overcharge | 77 |
| Example 4-6-26 | | | | | | FEC | | controlling | 79 |
| Example 4-6-27 | | | | Adiponitrile | | 1,3-Dixoane | | agent (5-3) | 86 |
| Example 4-6-28 | | | | | | FEC | | | 82 |
| Example 4-6-29 | | | | 7,7,8,8- | | 1,3-Dixoane | | | 74 |
| Example 4-6-30 | | | | Tetracyano- | | FEC | | | 76 |
| | | | | quinodimentane | | | | | |
| Example 4-6-31 | | | | Acetonitrile | | 1,3-Dixoane | | | 82 |
| Example 4-6-32 | | | | | | FEC | | | 76 |

TABLE 51
[Negative electrode active material: Lithium titanate]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent | | amount | | amount | | amount | controlling | after the |
| | [mass ratio] | Material | [moles/kg] | Material | [wt %] | Material | [wt %] | agent | overcharge [%] |
| Example 4-6-33 | EC/DMC/ | LiPF₆ | 1.0 | Succinonitrile | 1.0 | 1,3-Dixoane | 4.08 | Overcharge | 84 |
| Example 4-6-34 | EMC = | | | | | FEC | | controlling | 80 |
| Example 4-6-35 | 25/40/30 | | | Adiponitrile | | 1,3-Dixoane | | agent (8-4) | 80 |
| Example 4-6-36 | | | | | | FEC | | | 82 |
| Example 4-6-37 | | | | 7,7,8,8- | | 1,3-Dixoane | | | 85 |
| Example 4-6-38 | | | | Tetracyano- | | FEC | | | 85 |
| | | | | quinodimentane | | | | | |
| Example 4-6-39 | | | | Acetonitrile | | 1,3-Dixoane | | | 74 |
| Example 4-6-40 | | | | | | FEC | | | 75 |
| Example 4-6-41 | | LiPF₆ | 1.0 | Succinonitrile | 1.0 | 1,3-Dixoane | 4.08 | Overcharge | 72 |
| Example 4-6-42 | | | | | | FEC | | controlling | 78 |
| Example 4-6-43 | | | | Adiponitrile | | 1,3-Dixoane | | agent (12-1) | 87 |
| Example 4-6-44 | | | | | | FEC | | | 80 |
| Example 4-6-45 | | | | 7,7,8,8- | | 1,3-Dixoane | | | 87 |
| Example 4-6-46 | | | | Tetracyano- | | FEC | | | 88 |
| | | | | quinodimentane | | | | | |
| Example 4-6-47 | | | | Acetonitrile | | 1,3-Dixoane | | | 83 |
| Example 4-6-48 | | | | | | FEC | | | 80 |
| Example 4-6-49 | | LiPF₆ | 1.0 | Succinonitrile | 1.0 | 1,3-Dixoane | 4.08 | Overcharge | 82 |
| Example 4-6-50 | | | | | | FEC | | controlling | 85 |
| Example 4-6-51 | | | | Adiponitrile | | 1,3-Dixoane | | agent (12-2) | 84 |
| Example 4-6-52 | | | | | | FEC | | | 79 |
| Example 4-6-53 | | | | 7,7,8,8- | | 1,3-Dixoane | | | 87 |
| Example 4-6-54 | | | | Tetracyano- | | FEC | | | 85 |
| | | | | quinodimentane | | | | | |
| Example 4-6-55 | | | | Acetonitrile | | 1,3-Dixoane | | | 84 |
| Example 4-6-56 | | | | | | FEC | | | 86 |

TABLE 52
[Negative electrode active material: Lithium titanate]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent [mass | | amount | | amount | | amount | controlling | after the |
| | ratio] | Material | [moles/kg] | Material | [wt %] | Material | [wt %] | agent | overcharge [%] |
| Example 4-7-1 | EC/DMC/ | LiPF₆ | 0.9 | LiPF₃(C₂F₅)₃ | 3.63 | 1,3-Dixoane | 4.02 | Overcharge | 74 |
| Example 4-7-2 | EMC = | | | | | FEC | | controlling | 69 |
| Example 4-7-3 | 25/40/30 | | | LiBF₂(C₂F₅)₂ | 2.40 | 1,3-Dixoane | | agent (1-10) | 63 |
| Example 4-7-4 | | | | | | FEC | | | 65 |
| Example 4-7-5 | | | | LiN(SO₂CF₃)₂ | 2.34 | 1,3-Dixoane | | | 76 |
| Example 4-7-6 | | | | | | FEC | | | 78 |
| Example 4-7-7 | | | | LiN(SO₂F)₂ | 1.54 | 1,3-Dixoane | | | 79 |
| Example 4-7-8 | | | | | | FEC | | | 75 |
| Example 4-7-9 | | LiPF₆ | 0.9 | LiPF₃(C₂F₅)₃ | 3.63 | 1,3-Dixoane | 4.02 | Overcharge | 70 |
| Example 4-7-10 | | | | | | FEC | | controlling | 80 |
| Example 4-7-11 | | | | LiBF₂(C₂F₅)₂ | 2.40 | 1,3-Dixoane | | agent (1-18) | 74 |
| Example 4-7-12 | | | | | | FEC | | | 72 |
| Example 4-7-13 | | | | LiN(SO₂CF₃)₂ | 2.34 | 1,3-Dixoane | | | 69 |
| Example 4-7-14 | | | | | | FEC | | | 66 |
| Example 4-7-15 | | | | LiN(SO₂F)₂ | 1.54 | 1,3-Dixoane | | | 72 |
| Example 4-7-16 | | | | | | FEC | | | 70 |
| Example 4-7-17 | | LiPF₆ | 0.9 | LiPF₃(C₂F₅)₃ | 3.63 | 1,3-Dixoane | 4.02 | Overcharge | 68 |
| Example 4-7-18 | | | | | | FEC | | controlling | 68 |
| Example 4-7-19 | | | | LiBF₂(C₂F₅)₂ | 2.40 | 1,3-Dixoane | | agent (4-71) | 72 |
| Example 4-7-20 | | | | | | FEC | | | 68 |
| Example 4-7-21 | | | | LiN(SO₂CF₃)₂ | 2.34 | 1,3-Dixoane | | | 67 |
| Example 4-7-22 | | | | | | FEC | | | 75 |
| Example 4-7-23 | | | | LiN(SO₂F)₂ | 1.54 | 1,3-Dixoane | | | 75 |
| Example 4-7-24 | | | | | | FEC | | | 77 |
| Example 4-7-25 | | LiPF₆ | 0.9 | LiPF₃(C₂F₅)₃ | 3.63 | 1,3-Dixoane | 4.02 | Overcharge | 72 |
| Example 4-7-26 | | | | | | FEC | | controlling | 76 |
| Example 4-7-27 | | | | LiBF₂(C₂F₅)₂ | 2.40 | 1,3-Dixoane | | agent (5-3) | 70 |
| Example 4-7-28 | | | | | | FEC | | | 73 |
| Example 4-7-29 | | | | LiN(SO₂CF₃)₂ | 2.34 | 1,3-Dixoane | | | 77 |
| Example 4-7-30 | | | | | | FEC | | | 71 |
| Example 4-7-31 | | | | LiN(SO₂F)₂ | 1.54 | 1,3-Dixoane | | | 76 |
| Example 4-7-32 | | | | | | FEC | | | 73 |

TABLE 53
[Negative electrode active material: Lithium titanate]

| | | | | | | | | | Retention rate |
|---|---|---|---|---|---|---|---|---|---|
| | | Electrolyte salt | | Compound 1 | | Compound 2 | | | of load |
| | Nonaqueous | | Mixing | | Mixing | | Mixing | Overcharge | characteristics |
| | solvent [mass | | amount | | amount | | amount | controlling | after the |
| | ratio] | Material | [moles/kg] | Material | [wt %] | Material | [wt %] | agent | overcharge [%] |
| Example 4-7-33 | EC/DMC/ | LiPF₆ | 0.9 | LiPF₃(C₂F₅)₃ | 3.63 | 1,3-Dixoane | 4.02 | Overcharge | 78 |
| Example 4-7-34 | EMC = | | | | | FEC | | controlling | 80 |
| Example 4-7-35 | 25/40/30 | | | LiBF₂(C₂F₅)₂ | 2.40 | 1,3-Dixoane | | agent (8-4) | 82 |
| Example 4-7-36 | | | | | | FEC | | | 77 |
| Example 4-7-37 | | | | LiN(SO₂CF₃)₂ | 2.34 | 1,3-Dixoane | | | 71 |
| Example 4-7-38 | | | | | | FEC | | | 74 |
| Example 4-7-39 | | | | LiN(SO₂F)₂ | 1.54 | 1,3-Dixoane | | | 77 |
| Example 4-7-40 | | | | | | FEC | | | 71 |
| Example 4-7-41 | | LiPF₆ | 0.9 | LiPF₃(C₂F₅)₃ | 3.63 | 1,3-Dixoane | 4.02 | Overcharge | 76 |
| Example 4-7-42 | | | | | | FEC | | controlling | 85 |
| Example 4-7-43 | | | | LiBF₂(C₂F₅)₂ | 2.40 | 1,3-Dixoane | | agent (12-1) | 79 |
| Example 4-7-44 | | | | | | FEC | | | 83 |
| Example 4-7-45 | | | | LiN(SO₂CF₃)₂ | 2.34 | 1,3-Dixoane | | | 79 |
| Example 4-7-46 | | | | | | FEC | | | 77 |
| Example 4-7-47 | | | | LiN(SO₂F)₂ | 1.54 | 1,3-Dixoane | | | 85 |
| Example 4-7-48 | | | | | | FEC | | | 80 |
| Example 4-7-49 | | LiPF₆ | 0.9 | LiPF₃(C₂F₅)₃ | 3.63 | 1,3-Dixoane | 4.02 | Overcharge | 69 |
| Example 4-7-50 | | | | | | FEC | | controlling | 69 |
| Example 4-7-51 | | | | LiBF₂(C₂F₅)₂ | 2.40 | 1,3-Dixoane | | agent (12-2) | 78 |
| Example 4-7-52 | | | | | | FEC | | | 72 |
| Example 4-7-53 | | | | LiN(SO₂CF₃)₂ | 2.34 | 1,3-Dixoane | | | 78 |
| Example 4-7-54 | | | | | | FEC | | | 74 |
| Example 4-7-55 | | | | LiN(SO₂F)₂ | 1.54 | 1,3-Dixoane | | | 79 |
| Example 4-7-56 | | | | | | FEC | | | 74 |

As is clear from Tables 41 to 53, by adding the compound according to the present technology and the overcharge controlling agent to the nonaqueous electrolytic solution, even in the case of using lithium titanate as the negative electrode active material, similar to the case of using a carbon based negative electrode active material, the effect for inhibiting a lowering of the retention rate of load characteristics after the overcharge was obtained. Also, even in the case of using not only a battery of a cylindrical type but a battery of a laminated film type as the battery configuration, the effect for inhibiting a lowering of the retention rate of load characteristics after the overcharge was similarly obtained.

While the present technology has been described with reference to the embodiments and working examples, it should not be construed that the present technology is limited to the foregoing embodiments and working examples, but various modifications can be made. For example, in the foregoing embodiments and working examples, the secondary battery having a winding structure has been described. However, the present technology is similarly applicable to a secondary battery in which a positive electrode and a negative electrode are folded or are superimposed. In addition, the present technology is similarly applicable to a nonaqueous electrolyte battery of a so-called coin type, button type or rectangular type.

Moreover, in the foregoing embodiments and working examples, while a so-called lithium ion secondary battery in which the capacity of a negative electrode is expressed by a capacity component due to intercalation and deintercalation of lithium has been described, the present technology is also applicable to a so-called lithium metal secondary battery in which a lithium metal is used for a negative electrode active material, and the capacity of the negative electrode is expressed by a capacity component due to deposition and dissolution of lithium; or a secondary battery in which by making the charge capacity of a negative electrode material capable of intercalating and deintercalating lithium smaller than the charge capacity of a positive electrode, the capacity of a negative electrode includes a capacity component due to intercalation and deintercalation of lithium and a capacity component due to deposition and dissolution of lithium and is expressed by a total sum thereof.

Also, in the foregoing embodiments and working examples, while a battery using lithium as an electrode reactant has been described, the present technology is also applicable to the case of using other alkali metal such as sodium (Na) and potassium (K), an alkaline earth metal such as magnesium and calcium (Ca), or other light metal such as aluminum.

The present technology can also be implemented as the following configurations.

[1] A nonaqueous electrolyte including a nonaqueous electrolytic solution containing

a nonaqueous solvent,

an electrolyte salt,

an overcharge controlling agent capable of generating a redox reaction at a prescribed potential, and

at least one member selected from the following compounds (1) to (10):

Li[PFₘ₁R11₆₋ₘ₁] Compound (1)

wherein

R11 represents a perfluoroalkyl group or a perfluoroaryl group; and m1 represents an integer of from 0 to 6,

LiN(SO₂R21)₂ Compound (2)

wherein

R21 represents a perfluoroalkyl group, a perfluoroaryl group, or a halogen group,

Li[BFₘ₃R31₄₋ₘ₃] Compound (3)

wherein

R31 represents a perfluoroalkyl group or a perfluoroaryl group; and m3 represents an integer of from 0 to 4,

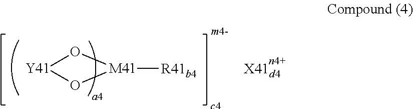

wherein

X41 represents a Group 1 element or a Group 2 element in the long form of the periodic table, or aluminum; M41 represents a transition metal element, or a Group 13 element, a Group 14 element or a Group 15 element in the long form periodic table; R41 represents a halogen group; Y41 represents —C(═O)—R42-C(═O)—, —C(═O)—C(R43)₂-, or —C(═O)—C(═O)—; R42 represents an alkylene group, a halogenated alkylene group, an arylene group, or a halogenated arylene group; each R43 independently represents an alkyl group, a halogenated alkyl group, an aryl group, or a halogenated aryl group; a4 represents an integer of from 1 to 4; b4 represents 0, 2, or 4; and each of c4, d4, m4, and n4 represents an integer of from 1 to 3,

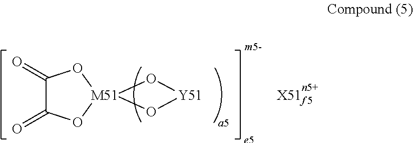

wherein

X51 represents a Group 1 element or a Group 2 element in the long form of the periodic table; M51 represents a transition metal element, or a Group 13 element, a Group 14 element or a Group 15 element in the long form of the periodic table; Y51 represents —C(═O)—(C(R51)₂)_{b5}-C(═O)—, —(R53)₂C—(C(R52)₂)_{c5}-C(═O)—, —(R53)₂C—(C(R52)₂)_{c5}-C(R53)₂-, —(R53)₂C—(C(R52)₂)_{c5}-S(═O)₂—, —S(═O)₂—(C(R52)₂)_{d5}-S(═O)₂—, or —C(═O)—(C(R52)₂)_{d5}-S(═O)₂—; each of R51 and R53 independently represents a hydrogen group, an alkyl group, a halogen group, or a halogenated alkyl group, provided that at least one of R51 and R53 represents a halogen group or a halogenated alkyl group; each R52 independently represents a hydrogen group, an alkyl group, a halogen group, or a halogenated alkyl group; each of a5, e5, and n5 represents 1 or 2; each of b5 and d5 represents an integer of from 1 to 4; c5 represents an integer of from 0 to 4; and each of f5 and m5 represents an integer of from 1 to 3,

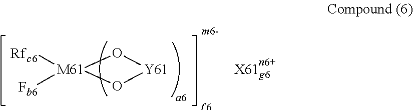

wherein

X61 represents a Group 1 element or a Group 2 element in the long form of the periodic table; M61 represents a transition metal element, or a Group 13 element, a Group 14 element or a Group 15 element in the long form of the periodic table; Rf represents a fluorinated alkyl group or a fluorinated aryl group, each having a carbon number of from 1 to 10; Y61 represents —C(═O)—(C(R61)₂)_{d6}-C(═O)—, —(R62)₂C—(C(R61)₂)_{d6}-C(═O)—, —(R62)₂C—(C(R61)₂)_{d6}-C(R62)₂-, —(R62)₂C—(C(R61)₂)_{d6}-S(═O)₂—, —S(═O)₂—(C(R61)₂)ₑ₆-S(═O)₂—, or —C(═O)—(C(R61)₂)ₑ₆-S(═O)₂—; each R61 independently represents a hydrogen group, an alkyl group, a halogen group, or a halogenated alkyl group; each R62 independently represents a hydrogen group, an alkyl group, a halogen group, or a halogenated alkyl group, provided that at least one of R62s represents a halogen group or a halogenated alkyl group; each a6, f6, and n6 represents 1 or 2; each of b6, c6, and e6 represents an integer of from 1 to 4; d6 represents an integer of from 0 to 4; and each of g6 and m6 represents an integer of from 1 to 3,

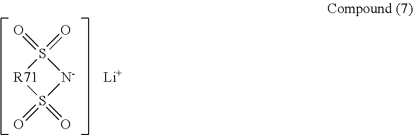

wherein

R71 represents a linear or branched perfluoroalkylene group having a carbon number of from 2 to 4,

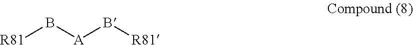

wherein

each of R81 and R81′ independently represents an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or each of which may be a halogenated group, and R81 and R81′ may be the same as or different from each other and may be connected to each other to form a ring; each of A, B, and B′ represents an oxygen atom, a sulfur atom, —C(═O)—, —S(═O)—, —S(═O)₂—, —C(Rd)(Re)—, —Si(Rd)(Re)—, or —N(Rf)—, and A, B, and B′ may be the same as or different from each other; and each of Rd, Re, and Rf independently represents a hydrogen group, a halogen group, an alkyl group, an alkenyl group, an alkynyl group, an aryl group, or a heterocyclic group, or an alkyl group, an alkenyl group, an alkynyl group, each of which is substituted with an aromatic hydrocarbon group or an alicyclic hydrocarbon group, or each of which may be a halogenated group, provided that the case where all of A, B, and B′ are —C(Rd)(Re)—, and the case where B and A, or B′ and A, are an oxygen atom are excluded,

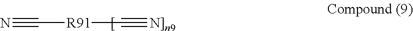

wherein

R91 represents a single bond or a divalent connecting group; and n9 represents 0 or a natural number, and

O═C═N—R101N═C═O]ₙ₁₀| Compound (10)

wherein

R101 represents a single bond or a divalent connecting group; and n10 represents 0 or a natural number.

[2] The nonaqueous electrolyte as set forth in [1], wherein a mixing amount of the at least one member selected from the compounds (1) to (10) is 0.001% by mass or more and not more than 30% by mass relative to the overcharge controlling agent.

[3] The nonaqueous electrolyte as set forth in [1] or [2], wherein the overcharge controlling agent is at least one member selected from the following overcharge controlling agents (1) to (12):

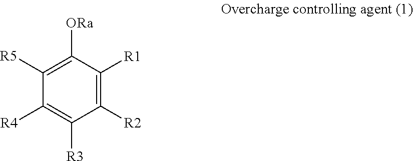

wherein

Ra represents a linear or branched alkyl group, or a partially or wholly halogenated group thereof; and each of R1 to R5 independently represents an alkoxy group, a halogen group, a nitrile group, or a linear or branched alkyl group, or a partially or wholly halogenated group thereof; or Ra and R1 to R5 are connected to each other between the adjacent groups, provided that the connection of Ra and R1 to R5 excludes the case where all of R1 to R5 are an alkoxy group,

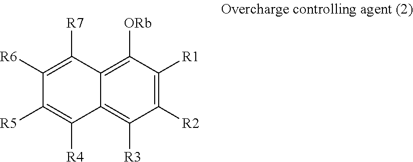

wherein

Rb represents a linear or branched alkyl group, or a partially or wholly halogenated group thereof; and each of R1 to R7 independently represents an alkoxy group, a halogen group, or a linear or branched alkyl group, or a partially or wholly halogenated group thereof; or Rb and R1 to R7 are connected to each other between the adjacent groups, provided that the connection of Rb and R1 to R7 excludes the case where all of R1 to R7 are an alkoxy group,

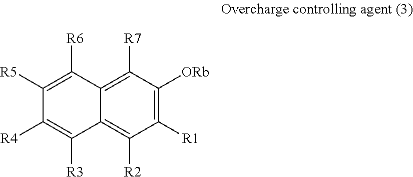

wherein

Rb and R1 to R7 are the same as those in the overcharge controlling agent (2),

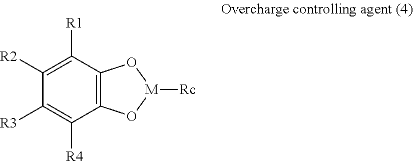

wherein

M represents a transition metal element, or a Group 13 element, a Group 14 element or a Group 15 element in the long form of the periodic table; Rc represents an aryl group or a heterocyclic group, or a partially or wholly halogenated group thereof; each of R1 to R4 independently represents an alkoxy group, a halogen group, or a linear or branched alkyl group, or a partially or wholly halogenated group thereof, or R1 to R4 are connected to each other between the adjacent groups,

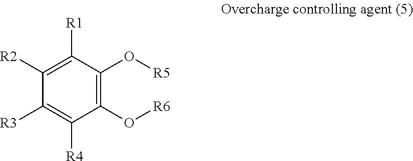

wherein

each of R1 to R4 independently represents an alkoxy group, a halogen group, or a linear or branched alkyl group, or a partially or wholly halogenated group thereof, or R1 to R4 are connected to each other between the adjacent groups; each of R5 and R6 represents an alkoxy group, a halogen group, or a linear or branched alkyl group, or a partially or wholly halogenated group thereof, or R5 and R6 are connected to each other to form a group; and the group formed by connection of R5 and R6 to each other is an alkylene group, a partially or wholly halogenated alkylene group, or a connecting group represented by the following general formula (A),

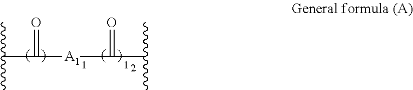

wherein

each of l₁ and l₂ independently represents an integer of from 0 to 2; and A represents an alkylene group having a carbon number of from 0 to 2, or a partially or wholly halogenated alkylene group,

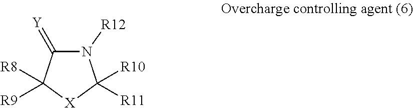

wherein

X represents N-oxide or an N-oxo group; Y represents an oxygen atom or a sulfur group; each of R8 to R11 independently represents an alkyl group, an alkenyl group, or an alkynyl group, or a partially or wholly halogenated group, or R8 and R9, or R10 and R11 are connected to each other to form a connecting group; and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with a nitrile group, a heterocyclic group, an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group,

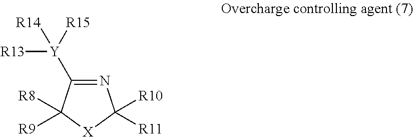

wherein

X, Y, and R8 to R11 are the same as those in the overcharge controlling agent (6); when Y is an oxygen atom, then each of R14 and R15 represents a lone electron pair, and when Y is a sulfur atom, then each of R14 and R15 independently represents a lone electron pair or an oxo group; and R13 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group,

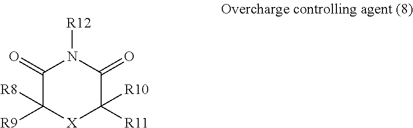

wherein

X and R8 to R11 are the same as those in the overcharge controlling agent (6); and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group,

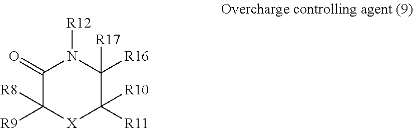

wherein

X, R8 to R11, and R12 are the same as those in the overcharge controlling agent (8); and each of R16 and R17 independently represents an alkyl group, an alkenyl group, or an alkynyl group, or a partially or wholly halogenated group thereof, or R16 and R17 are connected to each other to form a connecting group.

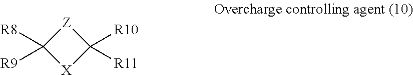

wherein

X and R8 to R11 are the same as those in the overcharge controlling agent (8); and Z represents anyone of the following general formulae (B1) to (B6):

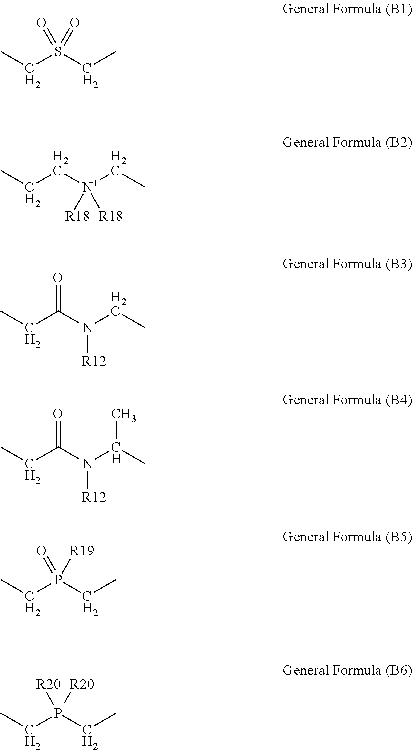

wherein

R12 is the same as that in the overcharge controlling agent (8); each R18 independently represents an alkyl group, an alkenyl group, or an alkynyl group, or a partially or wholly halogenated group thereof, or R18 and R19 are connected to each other to form a group; R19 represents a hydrogen group, a hydroxyl group, an alkyl group, an aryl group, an aralkyl group, a cycloalkyl group, or an ether group; and each R20 independently represents a hydrogen group, an alkyl group, an aryl group, an aralkyl group, an alkenyl group, an alkynyl group, a cycloalkyl group, or a glycidyl group,

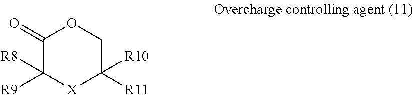

wherein

X is the same as that in the overcharge controlling agent (8); each of R8 to R11 independently represents an alkyl group, an alkenyl group, or an alkynyl group, or a carbonate group, or a partially or wholly halogenated group, or R8 and R9, or R10 and R11 are connected to each other to form a connecting group, and

Overcharge Controlling Agent (12)

Li₂B₁₂FₛD₁₂₋ₛ

wherein

s is 4 or more and not more than 12 in average; and D represents hydrogen, chlorine, or bromine.

[4] The nonaqueous electrolyte as set forth in any one of [1] to [3], wherein a mixing amount of the overcharge controlling agent is 0.1% by mass or more and not more than 50% by mass relative to the nonaqueous electrolytic solution.

[5] A nonaqueous electrolyte battery including

a group of electrodes including a positive electrode and a negative electrode, and

a nonaqueous electrode including a nonaqueous electrolytic solution, wherein

the nonaqueous electrolytic solution contains

a nonaqueous solvent,

an electrolyte salt,

an overcharge controlling agent capable of generating a redox reaction at a prescribed potential, and

at least one member selected from the following compounds (1) to (10):

Li[PFₘ₁R11₆₋ₘ₁] Compound (1)

wherein

R11 represents a perfluoroalkyl group or a perfluoroaryl group; and m1 represents an integer of from 0 to 6,

LiN(SO₂R21)₂ Compound (2)

wherein

R21 represents a perfluoroalkyl group, a perfluoroaryl group, or a halogen group,

Li[BFₘ₃R31₄₋ₘ₃] Compound (3)

wherein

R31 represents a perfluoroalkyl group or a perfluoroaryl group; and m3 represents an integer of from 0 to 4,

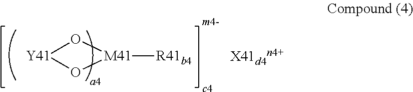

wherein

X41 represents a Group 1 element or a Group 2 element in the long form of the periodic table, or aluminum; M41 represents a transition metal element, or a Group 13 element, a Group 14 element or a Group 15 element in the long form periodic table; R41 represents a halogen group; Y41 represents —C(═O)—R42-C(═O)—, —C(═O)—C(R43)₂-, or —C(═O)—C(═O)—; R42 represents an alkylene group, a halogenated alkylene group, an arylene group, or a halogenated arylene group; each R43 independently represents an alkyl group, a halogenated alkyl group, an aryl group, or a halogenated aryl group; a4 represents an integer of from 1 to 4; b4 represents 0, 2, or 4; and each of c4, d4, m4, and n4 represents an integer of from 1 to 3,

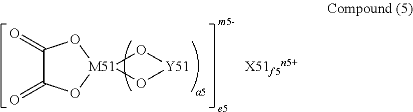

wherein

X51 represents a Group 1 element or a Group 2 element in the long form of the periodic table; M51 represents a transition metal element, or a Group 13 element, a Group 14 element or a Group 15 element in the long form of the periodic table; Y51 represents —C(═O)—(C(R51)₂)_{b5}-C(═O)—, —(R53)₂C—(C(R52)₂)_{c5}-C(═O)—, —(R53)₂C—(C(R52)₂)_{c5}-C(R53)₂-, —(R53)₂C—(C(R52)₂)_{c5}-S(═O)₂—, —S(═O)₂—(C(R52)₂)_{d5}-S(═O)₂—, or —C(═O)—(C(R52)₂)_{d5}-S(═O)₂—; each of R51 and R53 independently represents a hydrogen group, an alkyl group, a halogen group, or a halogenated alkyl group, provided that at least one of R51 and R53 represents a halogen group or a halogenated alkyl group; each R52 independently represents a hydrogen group, an alkyl group, a halogen group, or a halogenated alkyl group; each of a5, e5, and n5 represents 1 or 2; each of b5 and d5 represents an integer of from 1 to 4; c5 represents an integer of from 0 to 4; and each of f5 and m5 represents an integer of from 1 to 3,

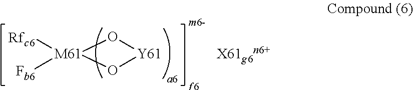

wherein

X61 represents a Group 1 element or a Group 2 element in the long form of the periodic table; M61 represents a transition metal element, or a Group 13 element, a Group 14 element or a Group 15 element in the long form of the periodic table; Rf represents a fluorinated alkyl group or a fluorinated aryl group, each having a carbon number of from 1 to 10; Y61 represents —C(═O)—(C(R61)₂)_{d6}-C(═O)—, —(R62)₂C—(C(R61)₂)_{d6}-C(═O)—, —(R62)₂C—(C(R61)₂)_{d6}-C(R62)₂-, —(R62)₂C—(C(R61)₂)_{d6}-S(═O)₂—, —S(═O)₂—(C(R61)₂)ₑ₆-S(═O)₂—, or —C(═O)—(C(R61)₂)ₑ₆-S(═O)₂—; each R61 independently represents a hydrogen group, an alkyl group, a halogen group, or a halogenated alkyl group; each R62 independently represents a hydrogen group, an alkyl group, a halogen group, or a halogenated alkyl group, provided that at least one of R62s represents a halogen group or a halogenated alkyl group; each a6, f6, and n6 represents 1 or 2; each of b6, c6, and e6 represents an integer of from 1 to 4; d6 represents an integer of from 0 to 4; and each of g6 and m6 represents an integer of from 1 to 3,

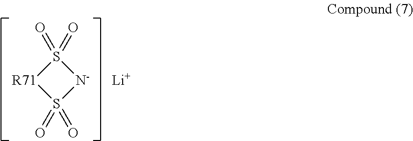

wherein

R71 represents a linear or branched perfluoroalkylene group having a carbon number of from 2 to 4,

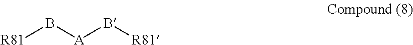

wherein

each of R81 and R81′ independently represents an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or each of which may be a halogenated group, and R81 and R81′ may be the same as or different from each other and may be connected to each other to form a ring; each of A, B, and B′ represents an oxygen atom, a sulfur atom, —C(═O)—, —S(═O)—, —S(═O)₂—, —C(Rd)(Re)—, —Si(Rd)(Re)—, or —N(Rf)—, and A, B, and B′ may be the same as or different from each other; and each of Rd, Re, and Rf independently represents a hydrogen group, a halogen group, an alkyl group, an alkenyl group, an alkynyl group, an aryl group, or a heterocyclic group, or an alkyl group, an alkenyl group, an alkynyl group, each of which is substituted with an aromatic hydrocarbon group or an alicyclic hydrocarbon group, or each of which may be a halogenated group, provided that the case where all of A, B, and B′ are —C(Rd)(Re)—, and the case where B and A, or B′ and A, are an oxygen atom are excluded,

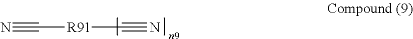

wherein

R91 represents a single bond or a divalent connecting group; and n9 represents 0 or a natural number, and

O═C═N—R101N═C═O]ₙ₁₀| Compound (10)

wherein

R101 represents a single bond or a divalent connecting group; and n10 represents 0 or a natural number.

[6] The nonaqueous electrolyte battery as set forth in [5], wherein a mixing amount of the at least one member selected from the compounds (1) to (10) is 0.001% by mass or more and not more than 30% by mass relative to the overcharge controlling agent.

[7] The nonaqueous electrolyte battery as set forth in [5] or [6], wherein the overcharge controlling agent is at least one member selected from the following overcharge controlling agents (1) to (12):

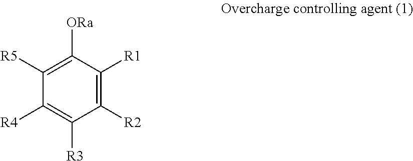

wherein

Ra represents a linear or branched alkyl group, or a partially or wholly halogenated group thereof; and each of R1 to R5 independently represents an alkoxy group, a halogen group, a nitrile group, or a linear or branched alkyl group, or a partially or wholly halogenated group thereof; or Ra and R1 to R5 are connected to each other between the adjacent groups, provided that the connection of Ra and R1 to R5 excludes the case where all of R1 to R5 are an alkoxy group,

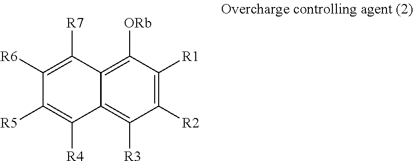

wherein

Rb represents a linear or branched alkyl group, or a partially or wholly halogenated group thereof; and each of R1 to R7 independently represents an alkoxy group, a halogen group, or a linear or branched alkyl group, or a partially or wholly halogenated group thereof; or Rb and R1 to R7 are connected to each other between the adjacent groups, provided that the connection of Rb and R1 to R7 excludes the case where all of R1 to R7 are an alkoxy group,

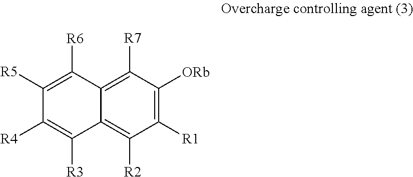

wherein

Rb and R1 to R7 are the same as those in the overcharge controlling agent (2),

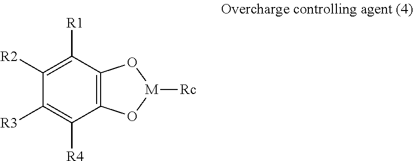

wherein

M represents a transition metal element, or a Group 13 element, a Group 14 element or a Group 15 element in the long form of the periodic table; Rc represents an aryl group or a heterocyclic group, or a partially or wholly halogenated group thereof; each of R1 to R4 independently represents an alkoxy group, a halogen group, or a linear or branched alkyl group, or a partially or wholly halogenated group thereof, or R1 to R4 are connected to each other between the adjacent groups,

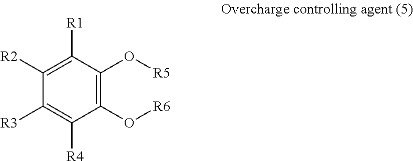

wherein

each of R1 to R4 independently represents an alkoxy group, a halogen group, or a linear or branched alkyl group, or a partially or wholly halogenated group thereof, or R1 to R4 are connected to each other between the adjacent groups; each of R5 and R6 represents an alkoxy group, a halogen group, or a linear or branched alkyl group, or a partially or wholly halogenated group thereof, or R5 and R6 are connected to each other to form a group; and the group formed by connection of R5 and R6 to each other is an alkylene group, a partially or wholly halogenated alkylene group, or a connecting group represented by the following general formula (A),

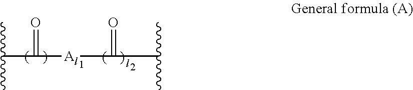

wherein

each of l₁ and l₂ independently represents an integer of from 0 to 2; and A represents an alkylene group having a carbon number of from 0 to 2, or a partially or wholly halogenated alkylene group,

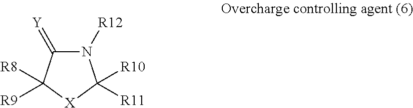

wherein

X represents N-oxide or an N-oxo group; Y represents an oxygen atom or a sulfur group; each of R8 to R11 independently represents an alkyl group, an alkenyl group, or an alkynyl group, or a partially or wholly halogenated group, or R8 and R9, or R10 and R11 are connected to each other to form a connecting group; and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with a nitrile group, a heterocyclic group, an aromatic hydrocarbon group, or an alicyclic hydrocarbon group, or a halogenated group thereof, an ether group, an amide group, a carbonate group, a phosphate group, a thio ester group, or a cyclic ether- or chain ether-substituted alkyl group,

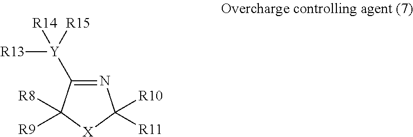

wherein

X, Y, and R8 to R11 are the same as those in the overcharge controlling agent (6); when Y is an oxygen atom, then each of R14 and R15 represents a lone electron pair, and when Y is a sulfur atom, then each of R14 and R15 independently represents a lone electron pair or an oxo group; and R13 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group,

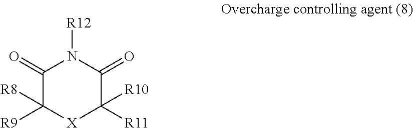

wherein

X and R8 to R11 are the same as those in the overcharge controlling agent (6); and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group,

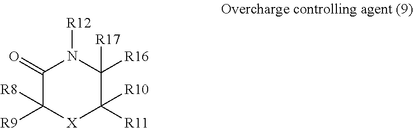

wherein

X, R8 to R11, and R12 are the same as those in the overcharge controlling agent (8); and each of R16 and R17 independently represents an alkyl group, an alkenyl group, or an alkynyl group, or a partially or wholly halogenated group thereof, or R16 and R17 are connected to each other to form a connecting group.

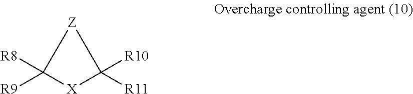

wherein

X and R8 to R11 are the same as those in the overcharge controlling agent (8); and Z represents anyone of the following general formulae (B1) to (B6):

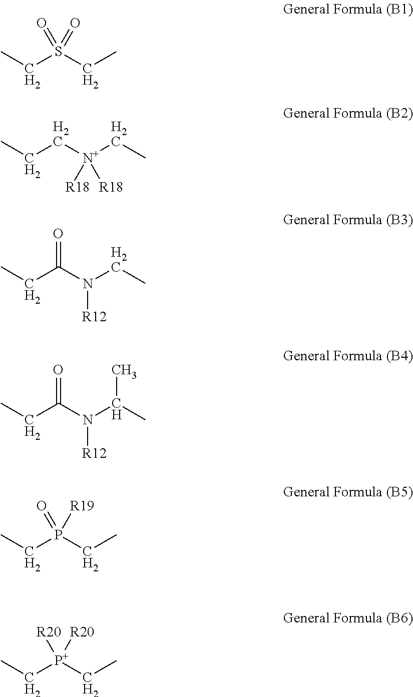

wherein

R12 is the same as that in the overcharge controlling agent (8); each R18 independently represents an alkyl group, an alkenyl group, or an alkynyl group, or a partially or wholly halogenated group thereof, or R18 and R19 are connected to each other to form a group; R19 represents a hydrogen group, a hydroxyl group, an alkyl group, an aryl group, an aralkyl group, a cycloalkyl group, or an ether group; and each R20 independently represents a hydrogen group, an alkyl group, an aryl group, an aralkyl group, an alkenyl group, an alkynyl group, a cycloalkyl group, or a glycidyl group,

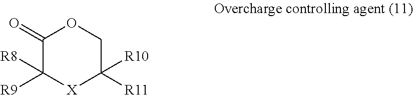

wherein

X is the same as that in the overcharge controlling agent (8); each of R8 to R11 independently represents an alkyl group, an alkenyl group, or an alkynyl group, or a carbonate group, or a partially or wholly halogenated group, or R8 and R9, or R10 and R11 are connected to each other to form a connecting group, and

Overcharge controlling agent (12)

Li₂B₁₂FₛD₁₂₋ₛ

wherein

s 4 or more and not more than 12 in average; and D represents hydrogen, chlorine, or bromine.

[8] The nonaqueous electrolyte battery as set forth in anyone of [5] to [7], wherein a mixing amount of the overcharge controlling agent is 0.1% by mass or more and not more than 50% by mass relative to the nonaqueous electrolytic solution.

[9] A battery pack including

the nonaqueous electrolyte battery as set forth in [5],

a control part for controlling the nonaqueous electrolyte battery, and

a package for including the nonaqueous electrolyte battery.

[10] An electronic appliance including

the nonaqueous electrolyte battery as set forth in [5], and

receiving the supply of an electric power from the nonaqueous electrolyte battery.

[11] An electric vehicle including

the nonaqueous electrolyte battery as set forth in [5],

a conversion apparatus of receiving the supply of an electric power from the nonaqueous electrolyte battery and converting it to a driving force, and

a control apparatus for performing information processing regarding the vehicle control on the basis of the information regarding the nonaqueous electrolyte battery.

[12] An electricity storage apparatus including

the nonaqueous electrolyte battery as set forth in [5], and

supplying an electric power to an electronic appliance to be connected to the nonaqueous electrolyte battery.

[13] The electricity storage apparatus as set forth in [12], including

an electric power information control apparatus for transmitting and receiving signals relative to other appliance via a network, and

performing charge and discharge control of the nonaqueous electrolyte battery on the basis of the information which the electric power information control apparatus receives.

[14] An electric power system for receiving the supply of an electric power from the nonaqueous electrolyte battery as set forth in [5], or supplying an electric power to the nonaqueous electrolyte battery from an electric power generation apparatus or an electric power network.

The present disclosure contains subject matter related to that disclosed in Japanese Priority Patent Application JP 2011-128606 filed in the Japan Patent Office on Jun. 8, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A nonaqueous electrolyte comprising:
a nonaqueous electrolytic solution containing
a nonaqueous solvent,
an electrolyte salt,
an overcharge controlling agent capable of generating a redox reaction at a prescribed potential, and
at least one member selected from the following compounds (1) to (10):
Li[PFₘ₁R11₆₋ₘ₁] Compound (1)
wherein
R11 represents a perfluoroalkyl group or a perfluoroaryl group; and m1 represents an integer of from 0 to 6,
LiN(SO₂R21)₂ Compound (2)
wherein
R21 represents a perfluoroalkyl group, a perfluoroaryl group, or a halogen group,
Li[BFₘ₃R31₄₋ₘ₃] Compound (3)
wherein
R31 represents a perfluoroalkyl group or a perfluoroaryl group; and m3 represents an integer of from 0 to 4, 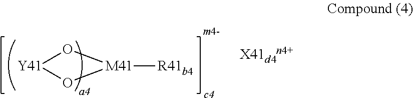
wherein
X41 represents a Group 1 element or a Group 2 element in the long form of the periodic table, or aluminum; M41 represents a transition metal element, or a Group 13 element, a Group 14 element or a Group 15 element in the long form periodic table; R41 represents a halogen group; Y41 represents —C(═O)—R42-C(═O)—, —C(═O)—C(R43)₂-, or —C(═O)—C(═O)—; R42 represents an alkylene group, a halogenated alkylene group, an arylene group, or a halogenated arylene group; each R43 independently represents an alkyl group, a halogenated alkyl group, an aryl group, or a halogenated aryl group; a4 represents an integer of from 1 to 4; b4 represents 0, 2, or 4; and each of c4, d4, m4, and n4 represents an integer of from 1 to 3, 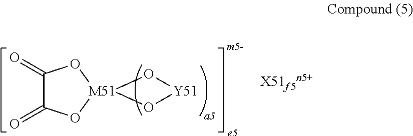
wherein
X51 represents a Group 1 element or a Group 2 element in the long form of the periodic table; M51 represents a transition metal element, or a Group 13 element, a Group 14 element or a Group 15 element in the long form of the periodic table; Y51 represents —C(═O)—(C(R51)₂)_{b5}-C(═O)—, —(R53)₂C—(C(R52)₂)_{c5}-C(═O)—, —(R53)₂C—(C(R52)₂)_{c5}-C(R53)₂-, —(R53)₂C—(C(R52)₂)_{c5}-S(═O)₂—, —S(═O)₂—(C(R52)₂)_{d5}-S(═O)₂—, or —C(═O)—(C(R52)₂)_{d5}—S(═O)₂—; each of R51 and R53 independently represents a hydrogen group, an alkyl group, a halogen group, or a halogenated alkyl group, provided that at least one of R51 and R53 represents a halogen group or a halogenated alkyl group; each R52 independently represents a hydrogen group, an alkyl group, a halogen group, or a halogenated alkyl group; each of a5, e5, and n5 represents 1 or 2; each of b5 and d5 represents an integer of from 1 to 4; c5 represents an integer of from 0 to 4; and each of f5 and m5 represents an integer of from 1 to 3, 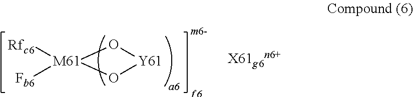
wherein
X61 represents a Group 1 element or a Group 2 element in the long form of the periodic table; M61 represents a transition metal element, or a Group 13 element, a Group 14 element or a Group 15 element in the long form of the periodic table; Rf represents a fluorinated alkyl group or a fluorinated aryl group, each having a carbon number of from 1 to 10; Y61 represents —C(═O)—(C(R61)₂)_{d6}-C(═O)—, —(R62)₂C—(C(R61)₂)_{d6}-C(═O)—, —(R62)₂C—(C(R61)₂)_{d6}-C(R62)₂-, —(R62)₂C—(C(R61)₂)_{d6}-S(═O)₂—, —S(═O)₂—(C(R61)₂)ₑ₆-S(═O)₂—, or —C(═O)—(C(R61)₂)ₑ₆-S(═O)₂—; each R61 independently represents a hydrogen group, an alkyl group, a halogen group, or a halogenated alkyl group; each R62 independently represents a hydrogen group, an alkyl group, a halogen group, or a halogenated alkyl group, provided that at least one of R62s represents a halogen group or a halogenated alkyl group; each a6, f6, and n6 represents 1 or 2; each of b6, c6, and e6 represents an integer of from 1 to 4; d6 represents an integer of from 0 to 4; and each of g6 and m6 represents an integer of from 1 to 3, 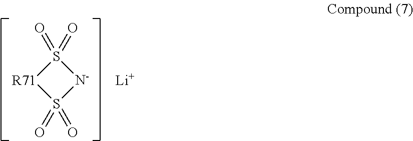
wherein
R71 represents a linear or branched perfluoroalkylene group having a carbon number of from 2 to 4, 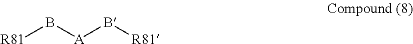
wherein
each of R81 and R81′ independently represents an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or each of which may be a halogenated group, and R81 and R81′ may be the same as or different from each other and may be connected to each other to form a ring; each of A, B, and B′ represents an oxygen atom, a sulfur atom, —C(═O)—, —S(═O)—, —S(═O)₂—, —C(Rd)(Re)—, —Si(Rd)(Re)—, or —N(Rf)—, and A, B, and B′ may be the same as or different from each other; and each of Rd, Re, and Rf independently represents a hydrogen group, a halogen group, an alkyl group, an alkenyl group, an alkynyl group, or a heterocyclic group, or an alkyl group, an alkenyl group, an alkynyl group, each of which is substituted with an aromatic hydrocarbon group or an alicyclic hydrocarbon group, or each of which may be a halogenated group, provided that the case where all of A, B, and B′ are —C(Rd)(Re)—, and the case where B and A, or B′ and A, are an oxygen atom are excluded, 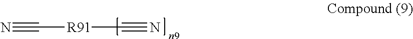
wherein
R91 represents a single bond or a divalent connecting group; and n9 represents 0 or a natural number, and
O̅═̅C̅═̅N̅—̅R̅1̅0̅1̅̅N̅═̅C̅═̅O̅]̅ₙ̅₁̅₀̅|̅ Compound (10)
wherein
R101 represents a single bond or a divalent connecting group; and n10 represents 0 or a natural number.

2. The nonaqueous electrolyte according to claim 1, wherein a mixing amount of the at least one member selected from the compounds (1) to (10) is 0.001% by mass or more and not more than 30% by mass relative to the overcharge controlling agent.

3. The nonaqueous electrolyte according to claim 1, wherein the overcharge controlling agent is at least one member selected from the following overcharge controlling agents (1) to (12): 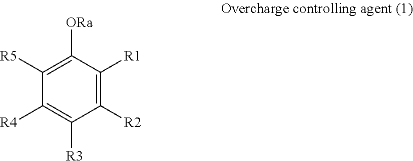
wherein
Ra represents a linear or branched alkyl group, or a partially or wholly halogenated group thereof; and each of R1 to R5 independently represents an alkoxy group, a halogen group, a nitrile group, or a linear or branched alkyl group, or a partially or wholly halogenated group thereof; or Ra and R1 to R5 are connected to each other between the adjacent groups, provided that the connection of Ra and R1 to R5 excludes the case where all of R1 to R5 are an alkoxy group, 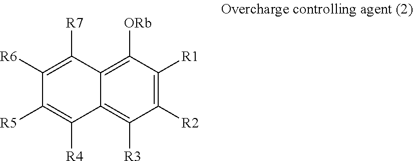
wherein
Rb represents a linear or branched alkyl group, or a partially or wholly halogenated group thereof; and each of R1 to R7 independently represents an alkoxy group, a halogen group, or a linear or branched alkyl group, or a partially or wholly halogenated group thereof; or Rb and R1 to R7 are connected to each other between the adjacent groups, provided that the connection of Rb and R1 to R7 excludes the case where all of R1 to R7 are an alkoxy group, 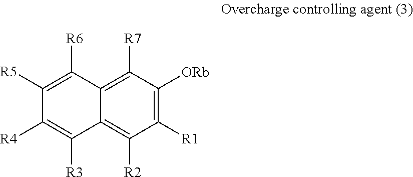
wherein
Rb and R1 to R7 are the same as those in the overcharge controlling agent (2), 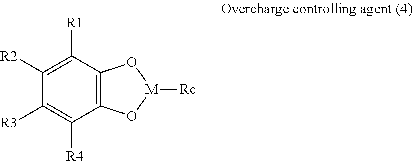
wherein
M represents a transition metal element, or a Group 13 element, a Group 14 element or a Group 15 element in the long form of the periodic table; Rc represents an aryl group or a heterocyclic group, or a partially or wholly halogenated group thereof; each of R1 to R4 independently represents an alkoxy group, a halogen group, or a linear or branched alkyl group, or a partially or wholly halogenated group thereof, or R1 to R4 are connected to each other between the adjacent groups, 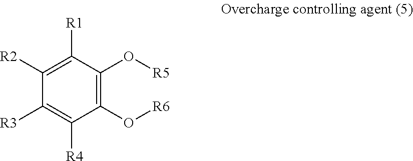
wherein
each of R1 to R4 independently represents an alkoxy group, a halogen group, or a linear or branched alkyl group, or a partially or wholly halogenated group thereof, or R1 to R4 are connected to each other between the adjacent groups; each of R5 and R6 represents an alkoxy group, a halogen group, or a linear or branched alkyl group, or a partially or wholly halogenated group thereof, or R5 and R6 are connected to each other to form a group; and the group formed by connection of R5 and R6 to each other is an alkylene group, a partially or wholly halogenated alkylene group, or a connecting group represented by the following general formula (A), 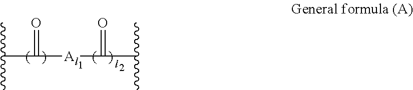
wherein
each of l₁ and l₂ independently represents an integer of from 0 to 2; and A represents an alkylene group having a carbon number of from 0 to 2, or a partially or wholly halogenated alkylene group, 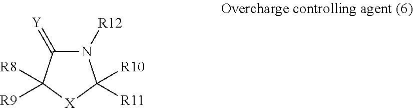
wherein
X represents N-oxide or an N-oxo group; Y represents an oxygen atom or a sulfur group; each of R8 to R11 independently represents an alkyl group, an alkenyl group, or an alkynyl group, or a partially or wholly halogenated group, or R8 and R9, or R10 and R11 are connected to each other to form a connecting group; and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with a nitrile group, a heterocyclic group, an aromatic hydrocarbon group, or an alicyclic hydrocarbon group, or a halogenated group thereof, an ether group, an amide group, a carbonate group, a phosphate group, a thio ester group, or a cyclic ether- or chain ether-substituted alkyl group, 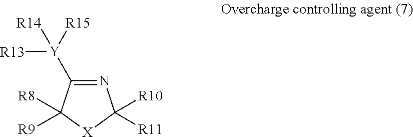
wherein
X, Y, and R8 to R11 are the same as those in the overcharge controlling agent (6); when Y is an oxygen atom, then each of R14 and R15 represents a lone electron pair, and when Y is a sulfur atom, then each of R14 and R15 independently represents a lone electron pair or an oxo group; and R13 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group, 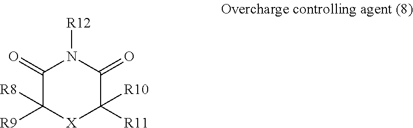
wherein
X and R8 to R11 are the same as those in the overcharge controlling agent (6); and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group, 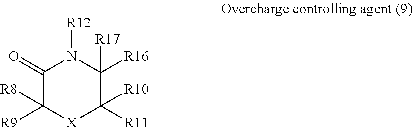
wherein
X, R8 to R11, and R12 are the same as those in the overcharge controlling agent (8); and each of R16 and R17 independently represents an alkyl group, an alkenyl group, or an alkynyl group, or a partially or wholly halogenated group thereof, or R16 and R17 are connected to each other to form a connecting group. 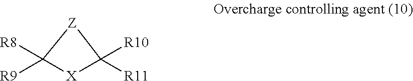
wherein
X and R8 to R11 are the same as those in the overcharge controlling agent (8); and Z represents anyone of the following general formulae (B1) to (B6): 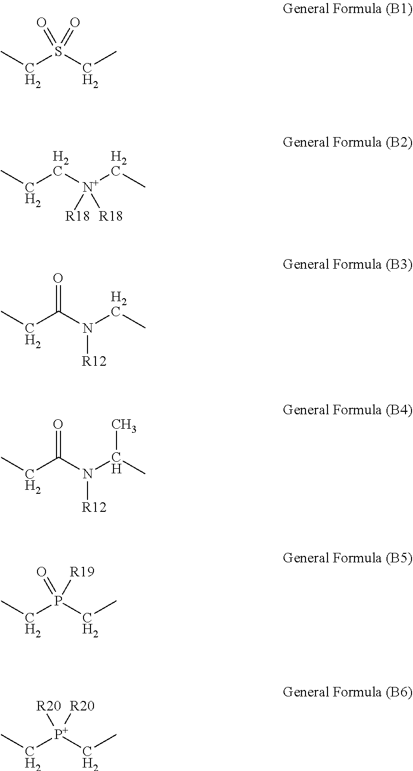
wherein
R12 is the same as that in the overcharge controlling agent (8); each R18 independently represents an alkyl group, an alkenyl group, or an alkynyl group, or a partially or wholly halogenated group thereof, or R18 and R19 are connected to each other to form a group; R19 represents a hydrogen group, a hydroxyl group, an alkyl group, an aryl group, an aralkyl group, a cycloalkyl group, or an ether group; and each R20 independently represents a hydrogen group, an alkyl group, an aryl group, an aralkyl group, an alkenyl group, an alkynyl group, a cycloalkyl group, or a glycidyl group, 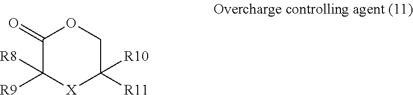
wherein
X is the same as that in the overcharge controlling agent (8); each of R8 to R11 independently represents an alkyl group, an alkenyl group, or an alkynyl group, or a carbonate group, or a partially or wholly halogenated group, or R8 and R9, or R10 and R11 are connected to each other to form a connecting group, and
Overcharge controlling agent (12)
Li₂B₁₂FₛD₁₂₋ₛ
wherein
s is 4 or more and not more than 12 in average; and D represents hydrogen, chlorine, or bromine.

4. The nonaqueous electrolyte according to claim 3, wherein a mixing amount of the overcharge controlling agent is 0.1% by mass or more and not more than 50% by mass relative to the nonaqueous electrolytic solution.

5. A nonaqueous electrolyte battery comprising:
a group of electrodes including a positive electrode and a negative electrode, and
a nonaqueous electrode including a nonaqueous electrolytic solution, wherein
the nonaqueous electrolytic solution contains
a nonaqueous solvent,
an electrolyte salt,
an overcharge controlling agent capable of generating a redox reaction at a prescribed potential, and
at least one member selected from the following compounds (1) to (10):
Li[PFₘ₁R11₆₋ₘ₁] Compound (1)
wherein
R11 represents a perfluoroalkyl group or a perfluoroaryl group; and m1 represents an integer of from 0 to 6,
LiN(SO₂R21)₂ Compound (2)
wherein
R21 represents a perfluoroalkyl group, a perfluoroaryl group, or a halogen group,
Li[BFₘ₃R31₄₋ₘ₃] Compound (3)
wherein
R31 represents a perfluoroalkyl group or a perfluoroaryl group; and m3 represents an integer of from 0 to 4, 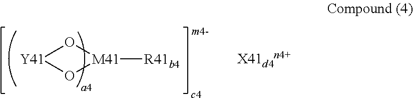
wherein
X41 represents a Group 1 element or a Group 2 element in the long form of the periodic table, or aluminum; M41 represents a transition metal element, or a Group 13 element, a Group 14 element or a Group 15 element in the long form periodic table; R41 represents a halogen group; Y41 represents —C(═O)—R42-C(═O)—, —C(═O)—C(R43)₂-, or —C(═O)—C(═O)—; R42 represents an alkylene group, a halogenated alkylene group, an arylene group, or a halogenated arylene group; each R43 independently represents an alkyl group, a halogenated alkyl group, an aryl group, or a halogenated aryl group; a4 represents an integer of from 1 to 4; b4 represents 0, 2, or 4; and each of c4, d4, m4, and n4 represents an integer of from 1 to 3, 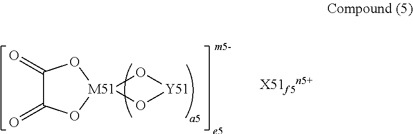
wherein
X51 represents a Group 1 element or a Group 2 element in the long form of the periodic table; M51 represents a transition metal element, or a Group 13 element, a Group 14 element or a Group 15 element in the long form of the periodic table; Y51 represents —C(═O)—(C(R51)₂)_{b5}-C(═O)—, —(R53)₂C—(C(R52)₂)_{c5}-C(═O)—, —(R53)₂C—(C(R52)₂)_{c5}-C(R53)₂-, —(R53)₂C—(C(R52)₂)_{c5}-S(═O)₂—, —S(═O)₂—(C(R52)₂)_{d5}-S(═O)₂—, or —C(═O)—(C(R52)₂)_{d5}-S(═O)₂—; each of R51 and R53 independently represents a hydrogen group, an alkyl group, a halogen group, or a halogenated alkyl group, provided that at least one of R51 and R53 represents a halogen group or a halogenated alkyl group; each R52 independently represents a hydrogen group, an alkyl group, a halogen group, or a halogenated alkyl group; each of a5, e5, and n5 represents 1 or 2; each of b5 and d5 represents an integer of from 1 to 4; c5 represents an integer of from 0 to 4; and each of f5 and m5 represents an integer of from 1 to 3, 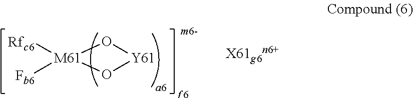
wherein
X61 represents a Group 1 element or a Group 2 element in the long form of the periodic table; M61 represents a transition metal element, or a Group 13 element, a Group 14 element or a Group 15 element in the long form of the periodic table; Rf represents a fluorinated alkyl group or a fluorinated aryl group, each having a carbon number of from 1 to 10; Y61 represents —C(═O)—(C(R61)₂)_{d6}-C(═O)—, —(R62)₂C—(C(R61)₂)_{d6}-C(═O)—, —(R62)₂C—(C(R61)₂)_{d6}-C(R62)₂-, —(R62)₂C—(C(R61)₂)_{d6}-S(═O)₂—, —S(═O)₂—(C(R61)₂)ₑ₆-S(═O)₂—, or —C(═O)—(C(R61)₂)ₑ₆-S(═O)₂—; each R61 independently represents a hydrogen group, an alkyl group, a halogen group, or a halogenated alkyl group; each R62 independently represents a hydrogen group, an alkyl group, a halogen group, or a halogenated alkyl group, provided that at least one of R62s represents a halogen group or a halogenated alkyl group; each a6, f6, and n6 represents 1 or 2; each of b6, c6, and e6 represents an integer of from 1 to 4; d6 represents an integer of from 0 to 4; and each of g6 and m6 represents an integer of from 1 to 3, 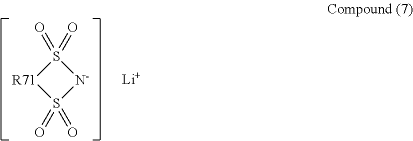
wherein
R71 represents a linear or branched perfluoroalkylene group having a carbon number of from 2 to 4, 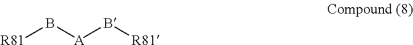
wherein
each of R81 and R81′ independently represents an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or each of which may be a halogenated group, and R81 and R81′ may be the same as or different from each other and may be connected to each other to form a ring; each of A, B, and B′ represents an oxygen atom, a sulfur atom, —C(═O)—, —S(═O)—, —S(═O)₂—, —C(Rd)(Re)—, —Si(Rd)(Re)—, or —N(Rf)—, and A, B, and B′ may be the same as or different from each other; and each of Rd, Re, and Rf independently represents a hydrogen group, a halogen group, an alkyl group, an alkenyl group, an alkynyl group, or a heterocyclic group, or an alkyl group, an alkenyl group, an alkynyl group, each of which is substituted with an aromatic hydrocarbon group or an alicyclic hydrocarbon group, or each of which may be a halogenated group, provided that the case where all of A, B, and B′ are —C(Rd)(Re)—, and the case where B and A, or B′ and A, are an oxygen atom are excluded, 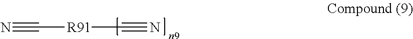
wherein
R91 represents a single bond or a divalent connecting group; and n9 represents 0 or a natural number, and
O═C═N—R101N═C═O]ₙ₁₀| Compound (10)
wherein
R101 represents a single bond or a divalent connecting group; and n10 represents 0 or a natural number.

6. The nonaqueous electrolyte battery according to claim 5, wherein a mixing amount of the at least one member selected from the compounds (1) to (10) is 0.001% by mass or more and not more than 30% by mass relative to the overcharge controlling agent.

7. The nonaqueous electrolyte battery according to claim 5, wherein the overcharge controlling agent is at least one member selected from the following overcharge controlling agents (1) to (12): 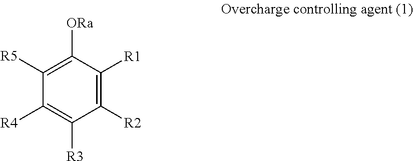
wherein
Ra represents a linear or branched alkyl group, or a partially or wholly halogenated group thereof; and each of R1 to R5 independently represents an alkoxy group, a halogen group, a nitrile group, or a linear or branched alkyl group, or a partially or wholly halogenated group thereof; or Ra and R1 to R5 are connected to each other between the adjacent groups, provided that the connection of Ra and R1 to R5 excludes the case where all of R1 to R5 are an alkoxy group, 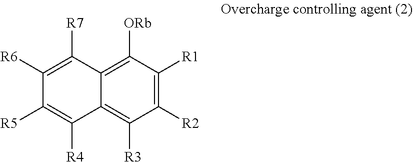
wherein
Rb represents a linear or branched alkyl group, or a partially or wholly halogenated group thereof; and each of R1 to R7 independently represents an alkoxy group, a halogen group, or a linear or branched alkyl group, or a partially or wholly halogenated group thereof; or Rb and R1 to R7 are connected to each other between the adjacent groups, provided that the connection of Rb and R1 to R7 excludes the case where all of R1 to R7 are an alkoxy group, 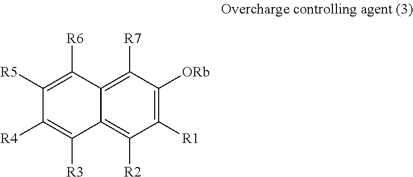
wherein
Rb and R1 to R7 are the same as those in the overcharge controlling agent (2), 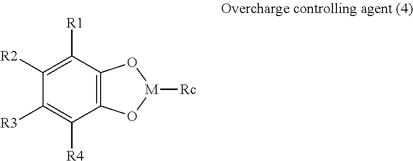
wherein
M represents a transition metal element, or a Group 13 element, a Group 14 element or a Group 15 element in the long form of the periodic table; Rc represents an aryl group or a heterocyclic group, or a partially or wholly halogenated group thereof; each of R1 to R4 independently represents an alkoxy group, a halogen group, or a linear or branched alkyl group, or a partially or wholly halogenated group thereof, or R1 to R4 are connected to each other between the adjacent groups, 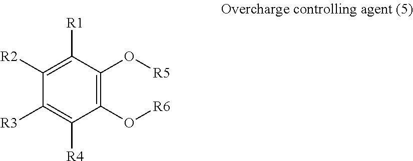
wherein
each of R1 to R4 independently represents an alkoxy group, a halogen group, or a linear or branched alkyl group, or a partially or wholly halogenated group thereof, or R1 to R4 are connected to each other between the adjacent groups; each of R5 and R6 represents an alkoxy group, a halogen group, or a linear or branched alkyl group, or a partially or wholly halogenated group thereof, or R5 and R6 are connected to each other to form a group; and the group formed by connection of R5 and R6 to each other is an alkylene group, a partially or wholly halogenated alkylene group, or a connecting group represented by the following general formula (A), 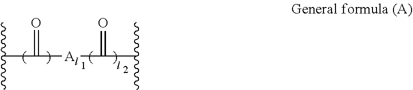
wherein
each of l₁ and l₂ independently represents an integer of from 0 to 2; and A represents an alkylene group having a carbon number of from 0 to 2, or a partially or wholly halogenated alkylene group, 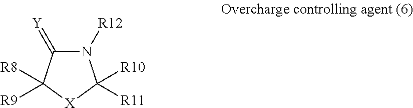
wherein
X represents N-oxide or an N-oxo group; Y represents an oxygen atom or a sulfur group; each of R8 to R11 independently represents an alkyl group, an alkenyl group, or an alkynyl group, or a partially or wholly halogenated group, or R8 and R9, or R10 and R11 are connected to each other to form a connecting group; and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with a nitrile group, a heterocyclic group, an aromatic hydrocarbon group, or an alicyclic hydrocarbon group, or a halogenated group thereof, an ether group, an amide group, a carbonate group, a phosphate group, a thio ester group, or a cyclic ether- or chain ether-substituted alkyl group, 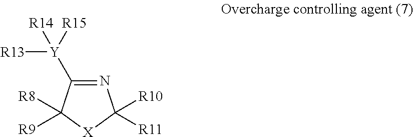
wherein
X, Y, and R8 to R11 are the same as those in the overcharge controlling agent (6); when Y is an oxygen atom, then each of R14 and R15 represents a lone electron pair, and when Y is a sulfur atom, then each of R14 and R15 independently represents a lone electron pair or an oxo group; and R13 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group, 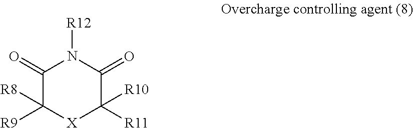
wherein
X and R8 to R11 are the same as those in the overcharge controlling agent (6); and R12 represents a hydrogen group, a hydroxyl group, an alkyl group, an alkenyl group, an alkynyl group, an aryl group, or a heterocyclic group, or an alkyl group, an alkenyl group, or an alkynyl group, each of which is substituted with an aromatic hydrocarbon group or an alicyclic hydrocarbon group, or a halogenated group thereof, an ether group, an amide group, a carbonate group, a phosphate group, a thio ester group, or a cyclic ether- or chain ether-substituted alkyl group, 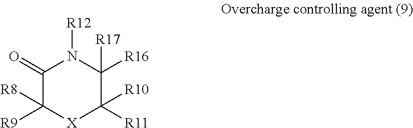
wherein
X, R8 to R11, and R12 are the same as those in the overcharge controlling agent (8); and each of R16 and R17 independently represents an alkyl group, an alkenyl group, or an alkynyl group, or a partially or wholly halogenated group thereof, or R16 and R17 are connected to each other to form a connecting group. 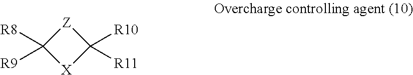
wherein
X and R8 to R11 are the same as those in the overcharge controlling agent (8); and Z represents any one of the following general formulae (B1) to (B6): 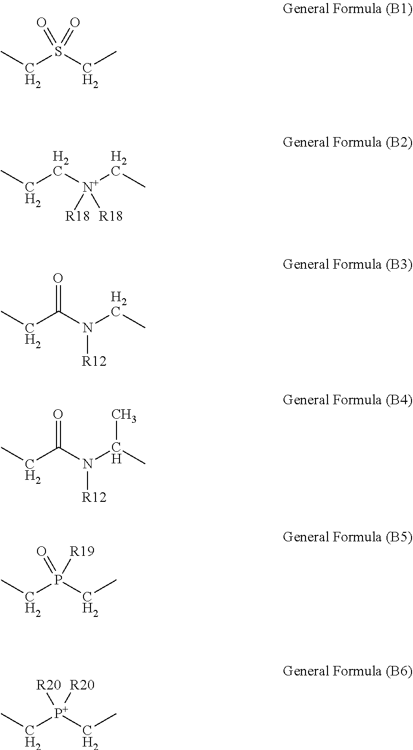
wherein
R12 is the same as that in the overcharge controlling agent (8); each R18 independently represents an alkyl group, an alkenyl group, or an alkynyl group, or a partially or wholly halogenated group thereof, or R18 and R19 are connected to each other to form a group; R19 represents a hydrogen group, a hydroxyl group, an alkyl group, an aryl group, an aralkyl group, a cycloalkyl group, or an ether group; and each R20 independently represents a hydrogen group, an alkyl group, an aryl group, an aralkyl group, an alkenyl group, an alkynyl group, a cycloalkyl group, or a glycidyl group, 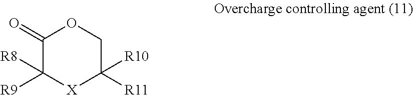
wherein
X is the same as that in the overcharge controlling agent (8); each of R8 to R11 independently represents an alkyl group, an alkenyl group, or an alkynyl group, or a carbonate group, or a partially or wholly halogenated group, or R8 and R9, or R10 and R11 are connected to each other to form a connecting group, and
Overcharge controlling agent (12)
Li₂B₁₂FₛD₁₂₋ₛ
wherein
s is 4 or more and not more than 12 in average; and D represents hydrogen, chlorine, or bromine.

8. The nonaqueous electrolyte battery according to claim 7, wherein a mixing amount of the overcharge controlling agent is 0.1% by mass or more and not more than 50% by mass relative to the nonaqueous electrolytic solution.

9. A battery pack comprising:
the nonaqueous electrolyte battery according to claim 5,
a control part for controlling the nonaqueous electrolyte battery, and
a package for including the nonaqueous electrolyte battery.

10. An electronic appliance comprising:
the nonaqueous electrolyte battery according to claim 5, and
receiving the supply of an electric power from the nonaqueous electrolyte battery.

11. An electric vehicle comprising:
the nonaqueous electrolyte battery according to claim 5,
a conversion apparatus of receiving the supply of an electric power from the nonaqueous electrolyte battery and converting it to a driving force, and
a control apparatus for performing information processing regarding the vehicle control on the basis of the information regarding the nonaqueous electrolyte battery.

12. An electricity storage apparatus comprising:
the nonaqueous electrolyte battery according to claim 5, and
supplying an electric power to an electronic appliance to be connected to the nonaqueous electrolyte battery.

13. The electricity storage apparatus according to claim 12, comprising:
an electric power information control apparatus for transmitting and receiving signals relative to other appliance via a network, and
performing charge and discharge control of the nonaqueous electrolyte battery on the basis of the information which the electric power information control apparatus receives.

14. An electric power system for receiving the supply of an electric power from the nonaqueous electrolyte battery according to claim 5, or supplying an electric power to the nonaqueous electrolyte battery from an electric power generation apparatus or an electric power network.
